(19) United States
(12) Patent Application Publication
(10) Pub. No.: US 2010/0036676 A1
(43) Pub. Date: Feb. 11, 2010

(54) COMPUTER IMPLEMENTED MEDICAL TREATMENT MANAGEMENT SYSTEM

(75) Inventors: Michael Safdi, Cincinnati, OH (US); Alan Safdi, Cincinnati, OH (US); Pradeep Bekal, Cincinnati, OH (US); Manish Chokshi, Mason, OH (US); Daniel Walker, Cincinnati, OH (US); Bharat Saini, Mason, OH (US)

Correspondence Address: WOOD, HERRON & EVANS, LLP, 2700 CAREW TOWER, 441 VINE STREET, CINCINNATI, OH, 45202, US

(73) Assignee: E-MERGE HEALTH SOLUTIONS, LTD., Cincinnati, OH (US)

(21) Appl. No.: 12/187,989

(22) Filed: Aug. 7, 2008

(51) Int. Cl. G06Q 50/00

(52) U.S. Cl. 705/2

(57) ABSTRACT

A system and method to provide a computer implemented endoscopic procedure management system. The system may be configured with functionality to gather data before, during, and after the endoscopic procedure report. In particular, the system may be operable to capture video from endoscopic procedure equipment, provide voice recognition capabilities, and assist in the automatic generation of endoscopic procedure reports. The system may be configured to automatically fill in drug, symptom, patient, and other data in response to user input. The system may limit user access to functionalities of the system based on user roles.

### FIELD OF THE INVENTION

The present invention relates generally to the field of managing the delivery of medical services, including the management of information associated with a patient, employees, group practice, and/or specifics of a medical procedure.

### BACKGROUND OF THE INVENTION

Medical services represent a substantial share of the gross national product and efficiency in the delivery of such services is an important national concern. It is frequently asserted that the overhead involved in management of a medical practice is an important factor in the cost of the delivery of medical services. While many management challenges are unique to a particular practice area, many challenges are common among many different forms of medical practice.

The difficulties and issues involved in medical practice will be explained herein in the context of the practice of endoscopic medicine, although the issues and difficulties are common to many other types of practice and the principles of the present invention are not limited to the practice of one type of medicine. Typically, an endoscopic procedure requires that a patient register with an endoscopic practice. The patient typically provides their contact information, insurance information, and medical history. The patient's medical history may contain information about medication, previous procedures, allergy information, and other patient information that can be used for treatment of the patient. However, neither the patient nor the group practice have ready access to his or her own medical histories. For example, after relocation or during a trip the patient may need access to their medical history. The need may arise in an emergency situation at an unreasonable time. Thus, there is a need for a system that better manages patient profiles.

After enrollment of the patient, a medical assistant typically schedules the patient for an endoscopic procedure appointment. The medical assistant updates the calendar of both the physician and any nurse(s) that assists the physician to indicate the scheduling of an endoscopic procedure. The medical assistant also typically schedules the endoscopic procedure for a particular time, location (if there are multiple locations of the group practice), and room. However, this is a difficult and ungainly process that may lead to scheduling errors for any person involved. Thus, there is a need for a system that better manages the appointments and calendar of a group practice.

Before the procedure, the patient typically undergoes a pre-operative assessment by a pre-operative nurse. The pre-operative nurse typically performs a physical assessment of the patient, and may also inquire as to patient history to determine allergies or generally assess the history of the patient's health. However, the pre-operative nurse may miss an answer, or otherwise fail to ask about an important subject. Thus, there is a need for a system that more effectively tracks the patient's pre-operative assessment and medical history to ensure patient safety.

Typically during an endoscopic procedure, the physician utilizes an endoscopic tube with a camera to take multiple pictures of relevant portions of the procedure. This camera is typically an endoscope that can generate live video during the procedure and capture an image, then print off a copy. The patient also has their vital signs monitored during the endoscopic procedure by vital signs equipment. Furthermore, the physician and assisting nurses may make notes during the endoscopic procedure for future reference. For example, the physician could note that he has snared and removed a polyp. As such, there is a significant amount of data that must be tracked, cached, or otherwise accounted for. As a result, there is a need for a an efficient way to manage various data including images taken by the physician, dictation or notes of the physician, patient vital signs, and medication administered to the patient during the endoscopic procedure.

After the procedure, the patient typically requires time for recovery. A recovery room is typically staffed by a nurse that monitors and discharges the patient. The patient is typically discharged from the recovery room with important information explaining the endoscopic procedure and potential future side effects of treatment. However, these documents are easily lost and displaced, and may not be retained by a patient. Moreover, it is difficult for the group practice to determine which documents have been given to a patient at any given time. Thus, there is a need for an efficient way to track the recovery and discharge of a patient after an endoscopic procedure.

During the procedure, tissue may be taken from the organ. After the procedure, the tissue is typically sent to a pathology lab for processing and a determination of malignancy. The pathology lab generally processes the tissue and sends the results of tests performed on the tissue back to the physician. The pathology lab may generate a report that must be integrated into the physician's report. This integration may be labor intensive, and furthermore, a completed lab report may take days to arrive. Thus, there is a need for improvement in the way that pathology lab reports are integrated with other information on the patient at the practice.

Various equipment is used during the procedure. The equipment may include vital signs equipment, endoscopes, and typical medical equipment. Over time, the equipment may become damaged, or otherwise past its useful life. Typically, there is no way to track the useful life of equipment other than a physical inspection every few months. This is a labor intensive process that can waste valuable time of the group practice employees and staff. Thus, there is a need for a better system for tracking the useful life of equipment used during an endoscopic procedure.

After the endoscopic procedure the physician will review all the data generated during the procedure (i.e., images, physician notations, medical equipment used, time of procedure, patient vital signs, medication administered) and generate a report. However, data from the various devices such as the camera and monitoring devices, writings or reports from other entities, forms and documents are difficult to integrate. The physician may only have a choice to perform a quick write-up that only has a general description of the procedure and findings, then rely on the patient's records to fill in gaps. Additionally, the patient is typically sent nothing more than a letter informing them of the findings without any substance that may be useful to future physicians or care persons. Thus, there is a need for an improvement in handling of the information gathered before, during, and after the endoscopic procedure and the multiple documents that can be utilized by physicians or patients to convey information relating to the endoscopic procedure, diagnoses, and findings.

Thus, there is a need of an improved system for managing the information generated before, during, and after an endoscopic procedure. The art has not provided a comprehensive, fully supported, front-end and back-end integrated solution that seamlessly manages all of these tasks with efficient administrative controls user access portals. A single, comprehensive system is needed to effectively manage the information associated with an endoscopic procedure in order to reduce costs while improving patient safety, satisfaction, comfort, and medical standards.

### SUMMARY OF THE INVENTION

Embodiments of the present invention provide for managing data associated with an endoscopic procedure.

In accordance with embodiments of the present invention, an endoscopic management system is provided that facilitates a central repository for data related to all aspects of an endoscopic procedure. The system incorporates multiple elements that may be used to configure a group practice that performs endoscopic procedures. Group practices may have various facilities, rooms, and equipment that the system manages and tracks. The system may be configured with functionality to gather data before, during, and after the endoscopic procedure. In particular, the system may be operable to capture video from endoscopic procedure equipment, provide voice recognition capabilities, and assist in the automatic generation of endoscopic procedure reports. The system may be configured to automatically fill in drug, symptom, patient, and other data in response to user input. The system may also be configured to assist in generating reports about the endoscopic procedure. The system may limit user access to functionalities of the system based on user roles.

In alternate embodiments of the present invention, a medical treatment management system is provided that facilitates a central repository for data related to all aspects of a medical procedure. The system incorporates multiple elements that may be used to perform medical procedures and is configured with functionality to gather data before, during, and after the medical procedure. In particular, the system may be operable assist in the automatic generation of medical procedure reports through medical procedure report templates, as well as capture a users voice in response to activation of an external interface or a voice command.

These and other advantages will be apparent in light of the following figures and detailed description.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is an exemplary hardware illustration environment suitable for the computer implemented endoscopic procedure management system consistent with the invention,

FIGS. 2-10 are data diagrams illustrating data structures for storing information collected and used in accordance with principles of the present invention,

FIGS. 11 and 12 are illustrations of a login and PIN screen of a server providing services in accordance with principles of the invention,

FIG. 13 is an illustration of an administrator's screen showing the general elements of the screens in that provide services in accordance with principles of the invention,

FIG. 14 is a flowchart detailing operations performed on the server in setting up a group practice to perform endoscopic procedures in accordance with principles of the invention,

FIG. 15 is an illustration of a screen to create a group practice to perform endoscopic procedures in accordance with principles of the invention,

FIGS. 16-17B are illustrations of screens to create a location for the group practice to perform endoscopic procedures in accordance with principles of the invention,

FIGS. 18-19 are illustrations of screens to create a room for locations of the group practice to perform endoscopic procedures in accordance with principles of the invention,

FIGS. 20-21 are illustrations of screens to create instruments for the group practice to perform endoscopic procedures in accordance with principles of the invention,

FIGS. 22-23D are illustrations of screens to assign and create a role for users of the system in accordance with principles of the invention,

FIGS. 24-25 are illustrations of screens to create a user of the system in accordance with principles of the invention,

FIGS. 26-27 are illustrations of screens to upload a form for use by users of the system in accordance with principles of the invention,

FIG. 28 is a flowchart detailing operations on the server that follow the process of a patient having an endoscopic procedure performed in providing services in accordance with principles of the present invention,

FIGS. 29-39E are illustrations of screens accessible by users during an endoscopic procedure to record data associated with the endoscopic procedure in accordance with principles of the invention,

FIGS. 40-41E are illustrations of screens accessible by users during a pathology examination to record data associated with the pathology examination in accordance with principles of the invention,

FIGS. 42-44 are illustrations of screens accessible by users to create endoscopic procedure reports associated with an endoscopic procedure in accordance with principles of the invention,

FIGS. 45-47B are illustrations of screens accessible by users to create templates to automatically input data into endoscopic procedure reports in accordance with principles of the invention,

FIGS. 48-49 are illustrations of screens accessible by users to view and transcribe transcriptions recorded by users of the system in accordance with principles of the invention,

FIGS. 50-52 are illustrations of screens accessible by users to view and approve, then fax, endoscopic procedure reports in accordance with principles of the invention,

FIGS. 53-59 are illustrations of screens accessible by patients provided by the system as a patient portal in accordance with principles of the invention,

FIGS. 60-63 are illustrations of screens accessible by users to manage patient recalls in accordance with principles of the invention,

FIGS. 64-65 are illustrations of screens accessible by users to manage block bookings in accordance with principles of the invention,

FIGS. 66-67 are illustrations of screens accessible by users to manage tasks in accordance with principles of the invention,

FIGS. 68-69 are illustrations of billing reports accessible by billing users to view and print billing reports in accordance with principles of the invention,

FIGS. 70-71 are illustrations of screens accessible by users to manage other physicians who are not a part of the group practice in accordance with principles of the invention,

FIGS. 72-73 are illustrations of user information screens accessible by users to manage their information maintained by the system in accordance with principles of the invention,

FIG. 74 is an illustration of a dashboard accessible by users to view tasks and information in accordance with principles of the invention, and

FIG. 75 is an illustration of a recovery room dashboard accessibly by users to view patients in a recovery room, as well as monitor the time between each patient's individual checkup by a user.

### DETAILED DESCRIPTION

A fully integrated endoscopic procedure management system consistent with the principles of the present invention includes several elements that account for endoscopic procedure management. Specifically, the system includes a computer, a database server, an application server, and a web server. The database server maintains system data and includes a database that stores information relating to system users and any information generated before, during, or after an endoscopic procedure. The application server is comprised of various business objects and entities, integrated with voice recognition and hardware interfaces, playback and security components, and accesses the database server to add, modify, or delete data in the database. The web server is the access point to the system for the users of the system and returns formatted web pages in response to requests to access information on the system. Additionally, the web server may, in response to the user's actions or requests, transmit various software controls (i.e., ActiveX controls, AJAX controls, programs, applications, etc.) to the user's computer to interact with the user, computer, or equipment. In particular, various users of the system may include patients, medical assistants, billing users, scheduling nurses, pre-operative nurses, operative nurses, physicians, recovery room nurses (a.k.a., post-operative nurses), pathologists, pathology technicians, transcribers, system administrators, facility managers, and/or other physicians not affiliated with an endoscopic group practice.

The database utilized in embodiments of the invention is populated with tables, which are in turn populated with multiple data entries. In general, the database may be accessed by users across a network, such as a local network or the Internet. Each user is associated with a particular set of rights that determine their access to information in the database. These sets of rights, or “roles,” limit operations that each user can perform on the database.

The database is configured on the database server and is accessed through the application server. Program code, or an “application,” is configured on the application server and determines the role and corresponding level of access for a particular user. In this way, the application may be said to generate a point of access, or “portal,” to the database that is specific to the role of each source. The application can be utilized before, during, and after an endoscopic procedure to manage information associated with the endoscopic procedure. The application may furthermore be utilized to manage the facility for the endoscopic treatment, track and manage equipment and inventory, interface with equipment during the endoscopic procedure, manage various actions during an endoscopic procedure, utilize templates to automatically generate reports and letters, display and generate information important to the endoscopic procedure, and otherwise interface with the users and database. The application generates web pages corresponding to the particular portal of the source that are served to the user by the web server, as well as provides the computer of a user with program code, such as software controls, that are operable to interact with the user, computer, database, and system.

### Hardware Environment

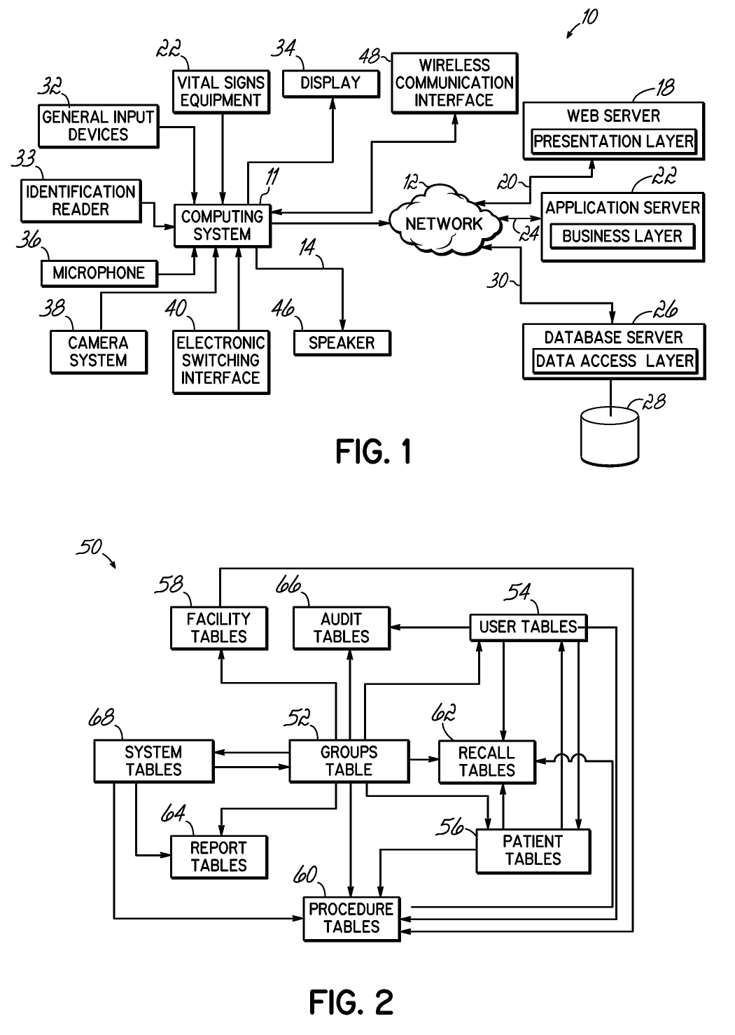

FIG. 1 illustrates an endoscopic management system 10 that may be used to implement an endoscopic procedure management system in accordance with principles of the present invention. A user may access the system 10 through a computing device, or computing system, 11. Computing device 11 typically runs a version of the Microsoft Windows® operating system. Computing device 11 may be any type of computer, computer system, server, disk array, programmable device, multi-user computer, single-user computer, handheld device, networked device, mobile phone, etc. Computing device 11 will be referred to as “computer” 11 for the sake of brevity.

Users typically access the endoscopic procedure management system 10 (system) by opening a network browser on their computer 11 and navigating across a network 12 to a point of access, or “portal,” maintained by a web server 18. The network 12 can be an internal network of computers connected by communications wires, a network of computers connected wirelessly, or a worldwide publicly accessible series of interconnected computer networks such as the Internet. The network browser may be an Internet browser (commonly known as “web” browsers), such as a version of Microsoft Internet Explorer®, Mozilla Firefox®, or another web browser of the type well known in the art (i.e., Safari®, Opera®, etc.). Computer 11 is typically connected to the network 12 through one or more communications connections as at 14.

Access to the system provided in accordance with embodiments of the invention is provided by the web server 18 at a remote hosting facility, such as a third party hosting facility. In alternate embodiments, web server 18 is located at a medical facility in which an endoscopic procedure is to take place. Web server 18 may be accessible by way of the network 12 through a broadband connection as at 20. Web server 18 transmits data to computer 11 from an application server 22. Similarly, web server 18 transmits data from computer 11 to the application server 22.

The application server 22 provides information processing capabilities of the system 10 in accordance with embodiments of the invention. In the illustrated embodiment, application server 22 is connected to web server 18 through the network 12 by way of a broadband connection as at 24. In alternate embodiments, application server 22 may be in direct electrical communication with web server 18. In further alternate embodiments, web server 18 and application server 22 may be located in the same physical housing. Application server 22 implements functionality consistent with embodiments of the invention by communicating with a database server 26 to input, modify, or delete data stored in a database 28. In addition, application server 22 communicates with web server 18 to load specific reusable software components or data from the database 28, database server 26, and/or application server 22 onto computer 11. Web server 18, in turn, transmits the data in a format that is suitable to be displayed by the browser of computer 11.

The database server 26 provides information management capabilities in accordance with embodiments of the invention. In the illustrated embodiment, database server 26 manages the database 28 and is connected to application server 22 through the network 12 by way of a broadband connection as at 30. In alternate embodiments, database server 26 may be in direct electrical connection with web server 18 and/or application server 22. In further alternate embodiments, web server 18, application server 22, and/or database server 26 may be located in the same physical housing. Database server 26 manages multiple tables as well as the creation, editing, or deletion of data in the database 28.

Data may be input through a number of devices connected to computer 11. Data is primarily input into the primary the system 10 through the general input devices 32 of the computer 11. The general input devices 32 typically include a keyboard and a mouse. The general input devices 32 may also include a scanner to input digital representations of physical documents. Data may also be input through an identification reader 33, which may be operable to read radio-frequency identification tags, smart cards, or biometrics of the user or patient. The computer displays images and data through a display 34, which may be a CRT or LCD monitor. In some embodiments, the general input devices 32 may be incorporated with the display 34, such as in a touchscreen display.

In addition to general input devices 32, the computer 11 may be in communication with a microphone 36. In this way, the computer 11 may be configured to record and/or analyze spoken words, or other voiced utterances of the user. For example, voiced utterances of the user picked up by the microphone 36 may be received by computer 11 and stored in the database 28 in response to a user action, a command from the system, or whenever otherwise designated. Also for example, voiced utterances of the user picked up by the microphone 36 may be analyzed by the computer 11 and converted into machine readable input, then processed by the system 10.

The computer may be in electrical communication with a camera system 38. In some embodiments, the camera system 38 is an endoscopic camera system (i.e., an endoscope) that is operable to capture a video stream (i.e. a video signal). The system 10 may interface with the camera system 38 to display the video stream on the display 34 of the computer 11 in real time. In one embodiment, the camera system 38 is connected to computer 11 through a separate video (S-video) port. In another embodiment, the camera system 38 is connected to computer through a different communications port, such as an RS-232 port, universal serial bus (USB) port, super video graphics array (SVGA) port, high-definition multimedia interface (HDMI) port, or another video port suitable for communication between the camera system 38 and the computer 11.

The computer 11 may further be in electrical communication with an external electronic switching interface 40. The electronic switching interface 40 may be any electrical interface that is operable to indicate an activation. For example, the electronic switching interface 40 may be activated in response to an action taken by the user, such as an image captured from the camera system 38, a measurement taken by the user, the user taking an x-ray, or some other action. In some embodiments, the electronic switching interface 40 is a pushbutton connected to the computer 11 through a USB port or a floor pedal similarly connected to the computer 11. In other embodiments, the electronic switching interface 40 is internal to equipment connected to the computer 11. Upon activation of the electronic switching interface 40, the computer 11 may interface with connected equipment to perform an action, receive data, transmit data, and/or capture a voiced utterance of the user. More generally, any external interface may be configured to provide an activation signal, and should not be limited to the electronic switching interface 40 described herein. For example, and in the alternative, the external switching interface 40 may be an radio frequency identification (RFID) chip that, when placed within proximity of an RFID reader, causes the system 10 to record voiced utterances of the user. As such, the external switching interface 40 may be any interface that may be used to indicate that the computer 11 should perform an action, such as capture voiced utterances of a user and/or convert voiced utterances of a user into machine readable input.

The computer 11 may be in electrical communication with equipment that monitors vital signs, shown generally at 42. As such, the system 10 is configured to interface with at least one vital signs monitor, or “vital signs equipment 42,” to track and store the vital signs of the patient. The vital signs equipment 42 may monitor heart rate, blood pressure, oxygen saturation of the blood, and/or other vital signs that may be desired to be known before, during, or after an endoscopic procedure. In one embodiment, the system 10 interfaces with the vital signs equipment 42 through computer 11 to record patient vital signs. These vital signs may be stored in the database 28 in discrete intervals or in real time.

The computer 11 may be in communication to at least one speaker shown generally at 46. In some embodiments, the speaker 46 may be part of a headset connected to the microphone 36 or may be part of a set of speakers that are connected to the computer 11. In one specific embodiment, the speaker 46 and microphone 36 may be incorporated into a wireless headset in electrical communication with the computer 11 through a wireless frequency communication protocol. As such, the computer 11 may be in communication with a wireless communication interface 48 that provides an interface for bi-directional communication between the computer 11 and wireless headset. As such, the wireless headset and wireless communication interface 41 may communicate by way of one or more wireless communication standard, such as Bluetooth®. One having ordinary skill in the art will appreciate that other wireless communication standards, such as any of the other IEEE 802 family of wireless communications standards and protocols, may be used to communicate between the computer 11 and wireless headset without departing from the scope of the invention.

Although not shown in FIG. 1, it will be apparent to one having ordinary skill in the art that the web server 18, application server 22, and/or database server 26 may be located in a data center as is well known in the art. Furthermore, program code sufficient to implement the web server 18, application server, and/or database server 26 may be configured on one server as is well known in the art. As such, and although not shown, the system 10 may include a fourth server located at the same medical facility as the computer 11 that is used to perform a medical procedure. This fourth server may be utilized to store data about the group practice located at that medical facility. In this manner, the user may use an embodiment of computer 11 to input information, which is sent to a data center and may be stored on the database 28. In turn, this information is sent to the fourth server and stored. In operation, then, the system 10 may manage multiple group practices and multiple facilities with individual backup information for each group practice at their medical facilities.

The various components, screens, data processing capabilities, and resources illustrated throughout the various figures may be implemented in a number of manners, including using various computer software applications, routines, components, programs, objects, modules, data structures, etc., which may be referred to as “program code.” Program code typically comprises one or more instructions that are resident at various times in various memory and storage devices in a computing system, and that, when read and executed by at least one processor in a computing system, cause that computing system to perform the steps necessary to execute steps or elements embodying the various aspects of the invention.

One having ordinary skill in the art will recognize that the environment illustrated in FIG. 1 is not intended to limit the present invention. For example, it will be appreciated by one having ordinary skill in the art that more than one computer 11 may be configured as a part of the system 10. In a typical embodiment, a plurality of computers 11 are configured to access the system 10, wherein each computer 11 may be configured with configurations varying from that shown in FIG. 1. Additionally, it will be appreciated by one having ordinary skill in the art that the computer 11 may be further configured with a scanner (not shown), a printer (not shown), and a fax machine (not shown) as is well known in the art to convert documents into an electronic format, print documents or data, and send or receive facsimiles, respectively. Furthermore, the wireless communication interface 48 may be in direct communication with the network 12, servers 18, 22, 26, or another computer (not shown) rather than in direct communication with computer 11. Therefore, those of ordinary skill in the art will recognize that other alternative hardware environments may be used without departing from the scope of the invention.

### Database Overview

FIG. 2 is a schematic illustration of an overview of the database tables, shown generally at 50, which make up embodiments of the database 28 of the present invention. These tables store and manage data associated with all aspects of the system. Details of the tables shown in FIG. 2 are provided in the listing of the tables and fields, which will follow the overview description below.

Physician offices may be referred to as “group practices.” The system 10 is configured to store the data for each group practice in one location, and then access data by group practice. Basic information for each group practice, including a unique ID for each group practice, is stored in a Groups Table 52. In one embodiment, the Groups Table 52 stores information such as:

Groups Table

| NAME | TYPE | DESCRIPTION |
|---|---|---|
| Group_ID | String/Integer | Unique group ID for that |
| | | endoscopic practice. |
| Group_Name | STRING | Name of the group. |
| Group_Description | STRING | Description of the group. |
| System_Flag | BOOLEAN | Yes/No - Group active in |
| | | the system? |
| Group_Identifier | STRING | Text identifying the group. |
| Street_Address | STRING | Street address of the group. |
| City | STRING | City of group. |
| State | STRING | State of the group. |
| Zip | STRING | Zip code of the group. |
| Legal_Name | STRING | Legal name of the group. |
| DBA_Name | STRING | “Doing Business As” name. |
| Federal_Tax_ID | STRING | Federal tax ID of the group. |
| Customer_ID | STRING | Customer ID of the group. |
| Office_Phone_Number | STRING | Group office phone |
| | | number. |
| Office_Fax_Number | STRING | Group office fax number. |
| Office_Email_Address | STRING | Group office e-mail |
| | | address. |
| Contact_Name | STRING | Group contact name. |
| Contact_Title | STRING | Group contact title. |
| Contact_Phone_Number | STRING | Group contact phone |
| | | number. |
| Contact_Fax_Number | STRING | Group contact fax number. |
| Contact_Email_Address | STRING | Group contact e-mail |
| | | address. |
| Remit_Street_Address | STRING | Group practice address for |
| | | sending payments. |
| Group_Logo | BINARY | Image file for group. |

Data associated with each user is stored in a plurality of User Tables, shown generally at 54. The User Tables 54 store data associated with persons or employees of the group practice that have access to the system. This data may include their demographics, privileges, tasks, and roles. Similarly, data associated with each patient is stored in a plurality of Patient Tables, shown generally at 56.

Because each group practice may have more than one physical facility at which they perform endoscopic procedures or have offices, data associated with each group practice facility is stored in a plurality of Facility Tables, shown generally at 58. The Facility Tables 58 maintains data associated with facility locations, facility rooms, equipment, and instruments.

Data associated with each endoscopic procedure is stored a plurality of Procedure Tables, shown generally at 60. The Procedure Tables 60 store data gathered before, during, or after an endoscopic procedure, as well as the actual appointments for procedures. In the event that a follow-up visit, or “recall,” is required, data associated with each recall is stored in a plurality of Recall Tables, shown generally at 62.

After the completion of an endoscopic procedure a report may be generated. Data associated with the endoscopic procedure report, including template information and text of the report, is stored in a plurality of Report Tables, shown generally at 64.

The system utilizes a plurality of Audit Tables shown generally at 66, to track the creation or changes to entities in the system 10. The entities audited may include any data entry assigned a unique ID. Additionally, the system utilizes a plurality of System Tables, shown generally at 68, to enable and execute functions consistent with principles of the invention.

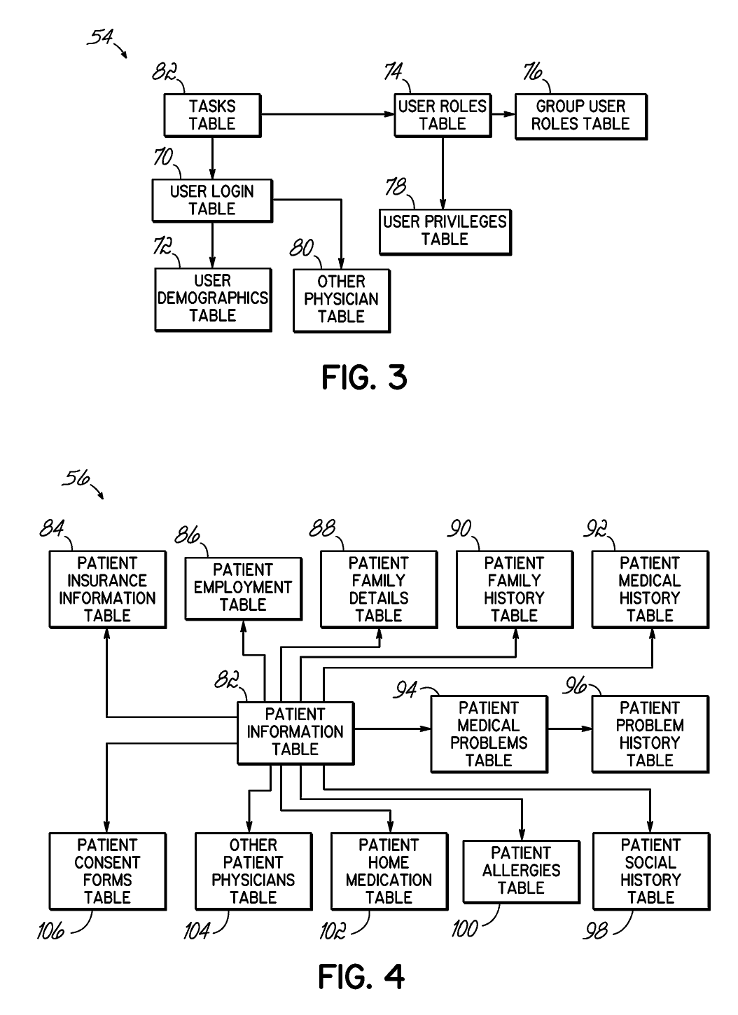

Users of the system may include medical assistants, billing users, pre-operative nurses, operative nurses, physicians, recovery room nurses (a.k.a., post-operative nurses), pathologists, pathology technicians, transcribers, system administrators, facility managers, other group practice employees, or other physicians not affiliated with the group practice. Each user is associated with a unique ID that permits that user to access the system. The user may also be associated with unique data corresponding to their personal information. FIG. 3 is a schematic illustration of a plurality tables that may comprise the plurality of User Tables at 54 of FIG. 2. Again referring to FIG. 3, in this embodiment, the login data for a user is associated with a role and other data in a User Login Table 70 as follows:

User Login Table

| NAME | TYPE | DESCRIPTION |
|---|---|---|
| User_Id | Long integer/ | Unique user ID. |
| | Decimal | |
| First_Name | String | User's first name. |
| Last_Name | String | User's last name. |
| Create_Dttm | String | Date record created. |
| Status | NUMERIC | Status of user ID, including |
| | | whether it has been |
| | | activated or not. |
| Demographics_ID | NUMERIC | Unique Demographics ID |
| | | of user. Used to link to |
| | | User Demographics Table. |
| Login_Name | STRING | Unique name for user login. |
| Group_ID | NUMERIC | Practice group ID of user. |
| Email_Address | STRING | User's e-mail address. |
| User_Identifier | STRING | |
| Activation_URL | STRING | URL for user to click on |
| | | and activate their account. |
| Image_Data | Binary | Image chosen by user for |
| | | PIN screen. |
| Guid | STRING | Globally unique identifier |
| | | for the user. This may be |
| | | the same as User_Id. |
| Send_Email_Flag | BOOLEAN | Yes/No - Should this user |
| | | be sent an e-mail? |
| Initial_Middle_Name | STRING | User middle initial. |
| Login_Email_Flag | Boolean | Yes/No - Has user been |
| | | sent a login activation e- |
| | | mail? |
| Pin | STRING | PIN of the user. |
| Pin_Email_Flag | Boolean | Yes/No - Has user been |
| | | sent an e-mail with their |
| | | PIN? |

Personal data associated with the users of the system is maintained in the User Demographics Table 72. The User Demographics Table 72 stores basic identifying information for the users such as their address, email, telephone and fax number. In one embodiment, User Demographics Table 72 fields are as follows:

User Demographics Table

| NAME | TYPE | DESCRIPTION |
|---|---|---|
| Demographics_Id | NUMERIC | User's unique demographics |
| | | ID. |
| Social_Security_Number | STRING | User's Social Security |
| | | number. |
| Birthdate | DATETIME | User's birthday. |
| Marital_Status | STRING | User's marital status. |
| Gender | STRING | User's original gender. |
| Parent_Name | STRING | User's parent's names. |
| | | Inapplicable for users that |
| | | are not minors. |
| Guardian_Name | STRING | User's guardian's name. |
| | | Inapplicable for users that |
| | | are not minors. |
| Street_Address | STRING | User's street address. |
| City | STRING | User's city of residence. |
| State | STRING | User's state of residence. |
| Zip | STRING | User's zip code of |
| | | residence. |
| Home_Phone_Number | STRING | User's home phone number. |
| Group_ID | NUMERIC | Group practice user is |
| | | associated with. |
| Work_Phone_Number | STRING | User's work phone number. |
| Email_Address | STRING | User's e-mail address. |
| Preferred_Phone_Number | STRING | User's preferred phone |
| | | number. |
| Cell_Phone_Number | STRING | User's cell-phone number. |
| Other_Phone_Number1 | STRING | Alternate user phone |
| | | number. |
| Other_Phone_Number2 | STRING | Second alternate user phone |
| | | number. |
| Fax_Number | STRING | User's fax number. |
| User_Photo | BINARY | User's photo. |
| Notes | STRING | Notes on user. |

To protect information the system assigns each user a role. The user role determines the functionality available to the user as well as the information the user can access. The User Roles Table 74 maps the users to specific roles. In one embodiment, the User Roles Table 74 includes the following entries:

User Roles Table

| NAME | TYPE | DESCRIPTION |
|---|---|---|
| User_ID | NUMERIC | User ID. |
| Role_ID | NUMERIC | Unique ID of the role for |
| | | the user. |

Each group practice may enable different functionality of the system 10 than that provide by default for various users. The Group User Roles Table 76 maintains the roles created by each group practice. In one embodiment, the Group User Roles Table 76 includes the following information:

Group User Roles Table

| NAME | TYPE | DESCRIPTION |
|---|---|---|
| Role_ID | NUMERIC | Specified role ID. |
| Name | STRING | Name for the Role - |
| | | Patient, Billing, Physician, |
| | | Pathologist, etc. |
| Group_ID | NUMERIC | Practice group associated |
| | | with this group user role. |
| System_Flag | YES/NO | Yes/No - System defined |
| | | role? |
| Role_Description | STRING | Description of the role. |
| System_Template_Flag | YES/NO | Yes/No - System template |
| | | role? |

Once the roles have been defined, the system maps the privileges assigned to specific roles in the User Privileges Table 78. In one embodiment, the User Privileges Table 78 may include the following data:

User Privileges Table

| NAME | TYPE | DESCRIPTION |
|---|---|---|
| Privilege_ID | NUMERIC | Unique ID of the privilege. |
| Role_ID | NUMERIC | Role associated with this |
| | | privilege. |
| Entity_ID | NUMERIC | Entity associated with this |
| | | privilege. |
| AllowView_Flag | YES/NO | Yes/No - May this privilege |
| | | view the specified entity? |
| AllowAdd_Flag | YES/NO | Yes/No - May this privilege |
| | | add a new entity? |
| AllowEdit_Flag | YES/NO | Yes/No - May this privilege |
| | | edit the specified entity? |
| AllowDelete_Flag | YES/NO | Yes/No - May this privilege |
| | | delete the specified entity? |
| Group_ID | NUMERIC | Group practice associated |
| | | with the privilege. |
| System_Template_Flag | YES/NO | Yes/No - System template |
| | | role? |

Contact with external physicians is maintained to ensure patient safety and track referrals. Contact information, or other basic data of all other physicians that could be primary or referring physicians of a particular patient, is maintained in an Other Physician Table 80. Demographics of the other physicians are maintained in the User Demographics Table 72. In one embodiment, the Other Physician Table 80 includes the following:

Other Physician Table

| NAME | TYPE | DESCRIPTION |
|---|---|---|
| Other_Physician_ID | NUMERIC | Unique ID for the other |
| | | physician. |
| First_Name | STRING | Physician first name. |
| Last_Name | STRING | Physician last name. |
| Initial_Middle_Name | STRING | Physician middle initial. |
| Demographics_ID | NUMERIC | Demographics ID |
| | | associated with this |
| | | physician. |
| Comments | STRING | Comments about physician. |
| Group_ID | NUMERIC | Practice group ID of the |
| | | user. |
| Group_Name | STRING | Group practice name of |
| | | other physician. |
| Specialty | STRING | Specialty of other |
| | | physician. |

Users may be assigned tasks by other users. In particular, tasks may be assigned as part of an appointment or administrative duties. A Tasks Table 82 keeps track of task information is assigned to the users. In one embodiment, the Tasks Table 82 may include the following information:

Tasks Table

| NAME | TYPE | DESCRIPTION |
|---|---|---|
| Task_ID | NUMERIC | Unique ID for the particular |
| | | task. |
| Subject | STRING | Subject of the task. |
| Description | STRING | Description of the task. |
| Create_User_ID | NUMERIC | ID of the user that created |
| | | the task. |
| Assigned_User_ID | NUMERIC | ID of the user assigned the |
| | | task. |
| Priority | NUMERIC | Priority of the task - High, |
| | | Medium, Low, etc. |
| Due_Date | DATETIME | Date task to be completed. |
| Status | NUMERIC | Status of the task. |
| Parent_Task_Id | NUMERIC | Parent task ID. |
| Type | STRING | Type of task - Medical, |
| | | Administrative, etc. |
| Group_ID | NUMERIC | Group practice assigned this |
| | | task. |
| Task_Identifier | STRING | Task identifier. |
| Start_Date | STRING | Date task is to begin. |

Patients that undergo the endoscopic procedure are typically required to provide information, for example, such that the patient can be tracked and the patient can be treated safely. Patient information is generally maintained in the plurality of Patient Tables shown generally at 56 in FIG. 2. FIG. 4 is an illustration 56 of the plurality of tables that may maintain patient information. Data associated with each patient is stored in a Patient Information Table 82. The Patient Information Table 82 links each patient to their personal data and is the master table for the Patient Tables 56. Referring back to FIG. 4, in one embodiment, data is stored in the Patient Information Table 82 includes the following:

Patient Information Table

| NAME | TYPE | DESCRIPTION |
|---|---|---|
| Patient_ID | NUMERIC | Unique ID of the patient. |
| Group_ID | NUMERIC | Practice group ID of the |
| | | user. |
| Last_Name | STRING | Patient last name. |
| First_Name | STRING | Patient first name. |
| Status | NUMERIC | Patient status - Active |
| | | patient, inactive patient. |
| Privacy_Statement | BINARY | Privacy statement for |
| | | patient to read. |
| Personal_Notes | STRING | Personal notes on the |
| | | patient. |
| Initial_Middle_Name | STRING | Patient middle initial. |

Patients may have insurance that can be used to pay for some, or all, of the endoscopic procedure. Data relating to insurance may be stored in a Patient Insurance Information Table 84. In one embodiment, the data in the Patient Insurance Information Table 84 is as follows:

Patient Insurance Information Table

| NAME | TYPE | DESCRIPTION |
|---|---|---|
| Insurance_Info_Id | NUMERIC | Unique insurance ID number. |
| Group_ID | NUMERIC | Practice group |
| | | associated with this |
| | | insurance information. |
| Patient_ID | NUMERIC | Patient associated with |
| | | this insurance |
| | | information. |
| Carrier_Name | STRING | Name of insurance |
| | | company. |
| Street_Address | STRING | Street address of |
| | | insurance company. |
| Insurance_Type | NUMERIC | Type of insurance. |
| Coverage | STRING | Coverage of insurance |
| | | in relation to this |
| | | patient. |
| City | STRING | City of address of insurance. |
| State | STRING | State of address of insurance. |
| Zip | STRING | Zip code of address of insurance. |
| Policy_Holder_First_Name | STRING | Policyholder's first |
| | | name. |
| Policy_Holder_Last_Name | STRING | Policyholder's last |
| | | name. |
| Relation_To_Patient | STRING | Relationship of |
| | | policyholder to patient. |
| Policy | STRING | Policy number. |
| Group_Name | STRING | Group policy name. |
| Claim_Street_Address | STRING | Street address to send |
| | | claim. |
| Claim_City | STRING | City to send claim. |
| Claim_State | STRING | State to send claim. |
| Claim_Zip | STRING | Zip code to send claim. |
| PreCertification_Phone_Number | STRING | Claim pre-certification |
| | | phone number. |
| MemberServices_Phone_Number | STRING | Insurance member |
| | | services phone number. |
| ID_Number | STRING | ID number of policy. |
| Policy_Holder_Initial_Middle_Name | STRING | Policyholder's middle |
| | | initial. |

Patients are typically required to give their employment information. Data regarding the employment information of the patient is stored in a Patient Employment Table 86. In one embodiment, the Patient Employment Table 86 includes the following:

Patient Employment Table

| NAME | TYPE | DESCRIPTION |
|---|---|---|
| Employment_Detail_Id | NUMERIC | Unique employment detail |
| | | ID number. |
| Patient_ID | NUMERIC | Patient associated with this |
| | | employment information. |
| Group_ID | NUMERIC | Practice group associated |
| | | with this employment |
| | | information. |
| Occupation | STRING | Occupation of patient. |
| Employer | STRING | Employer of patient. |
| Employment_duration | NUMERIC | Employment duration. |
| Street_Address | STRING | Street address of employer. |
| City | STRING | City of employer. |
| State | STRING | State of employer. |
| Zip | STRING | Zip code of employer. |
| Business_Phone | STRING | Phone number of employer. |

Family related information of patients may be used to determine who is to pay the group practice, especially when the patient is a child. Detailed information about the family of the patient is stored in a Patient Family Details Table 88. In one embodiment, the Patient Family Details Table 88 includes the following:

Patient Family Details Table

| NAME | TYPE | DESCRIPTION |
|---|---|---|
| Family_Details_Id | NUMERIC | Unique family details |
| | | ID. |
| Group_ID | NUMERIC | Practice group |
| | | associated with |
| | | this patient. |
| Patient_ID | NUMERIC | Patient associated with |
| | | these family details. |
| First_Name | STRING | Family member of |
| | | patient's first name. |
| Last_Name | STRING | Family member of |
| | | patient's last name. |
| Relation_To_Patient | STRING | Relationship of this |
| | | family member to |
| | | patient. |
| Demographics_Id | NUMERIC | Demographics ID |
| | | associated with family |
| | | member, if any. |
| Payment_Guarantor_First_Name | STRING | Patient's guarantor of |
| | | payment first name. |
| Payment_Guarantor_Last_Name | STRING | Patient's guarantor of |
| | | payment last name. |
| Guarantor_Demographics_Id | NUMERIC | Guarantor of payment |
| | | unique demographics |
| | | ID. |
| Guarantor_Relation_To_Patient | STRING | Guarantor's |
| | | relationship to |
| | | patient. |
| Initial_Middle_Name | STRING | Family member of |
| | | patient's middle initial. |
| Guarantor_Initial_Middle_Name | STRING | Guarantor of payment |
| | | middle initial. |
| Employer | STRING | Employer of family |
| | | member of patient. |
| Occupation | STRING | Occupation of family |
| | | member of patient. |
| Employment_Duration | NUMERIC | Duration of |
| | | employment of |
| | | family member of |
| | | patient. |
| Guarantor_Employer | STRING | Employer of guarantor |
| | | of payment. |
| Guarantor_Occupation | STRING | Occupation of |
| | | guarantor of |
| | | payment. |
| Guarantor_Employment_Duration | NUMERIC | Employment duration |
| | | of guarantor of |
| | | payment. |

Family history of the patient is also important to determining the condition of the patient or possible future conditions. Detailed information about the family history, including a particular family member, of the patient is stored in a Patient Family History Table 90. In one embodiment, the Patient Family History Table 90 includes the following

Patient Family History Table

| NAME | TYPE | DESCRIPTION |
|---|---|---|
| Family_History_Id | NUMERIC | Unique family history ID. |
| Patient_Id | NUMERIC | Patient associated with this |
| | | family history information. |
| IsFH_Unknown_Flag | YES/NO | Yes/No - Is patient family |
| | | history unknown? |
| Who | STRING | Name of family member. |
| Comments | STRING | Comments on family |
| | | member. |
| Disease | STRING | Disease suffered by family |
| | | member. |
| Group_ID | NUMERIC | Practice group associated |
| | | with this family history. |

A medical history of the patient, in a manner similar to that as the family history of the patient, may also be crucial to determining the affliction of the patient or possible treatment options. The medical history and medical problems of the patient are stored in a Patient Medical History Table 92. In one embodiment, the Patient Medical History Table 92 includes the following:

Patient Medical History Table

| NAME | TYPE | DESCRIPTION |
|---|---|---|
| Medical_History_Id | NUMERIC | Unique medical history ID. |
| Patient_ID | NUMERIC | Patient associated with this |
| | | medical history. |
| Group_ID | NUMERIC | Group practice associated |
| | | with this patient medical |
| | | history. |
| Recent_Tests | STRING | Recent tests performed on |
| | | patient. |
| Substance_Abuse | STRING | Substance abuse history of |
| | | patient. |
| Other_Medical_Conditions | STRING | Known medical conditions |
| | | of patient. |
| Existing_Physical_Injuries | STRING | Existing physical injuries of |
| | | patient. |

The physician often needs to know and understand all current and past medical problems the patient currently has. The problems experienced by the patient are stored in a Patient Medical Problems Table 94, while the history of particular problems are stored in a Patient Problem History Table 96. The Patient Medical Problems Table 94 typically includes the following in one embodiment:

Patient Medical Problems Table

| NAME | TYPE | DESCRIPTION |
|---|---|---|
| Problem_ID | NUMERIC | Unique ID associated with |
| | | the patient problem. |
| Problem_Name | STRING | Name of the problem. |
| ICD_Code_ID | STRING | International Statistical |
| | | Classification of Diseases |
| | | and Related Health |
| | | Problems (ICD) code |
| | | associated with the |
| | | problem. |
| DisplayAs | STRING | Display name of the |
| | | problem. |
| Patient_ID | NUMERIC | Patient associated with the |
| | | problem. |
| Start_Date | DATETIME | Date problem first entered |
| | | into system. |
| Group_ID | NUMERIC | Group practice associated |
| | | with the problem. |
| Description | STRING | Description of problem. |
| Start_Year | STRING | Year problem started. |
| Start_Month | STRING | Month problem started. |
| Start_Day | STRING | Day problem started. |

In one embodiment, the Patient Problem History Table 96 includes the following:

Patient Problem History Table

| NAME | TYPE | DESCRIPTION |
|---|---|---|
| Problem_History_ID | NUMERIC | Unique problem history |
| | | ID. |
| Problem_ID | NUMERIC | Problem associated with |
| | | the problem history. |
| Problem_History_Date | DATETIME | Date problem reported by |
| | | patient. |
| Problem_History_Description | STRING | Description of problem. |
| Start_Year | STRING | Year problem began. |
| Start_Month | STRING | Month problem began. |
| Start_Day | STRING | Day problem began. |
| Group_ID | NUMERIC | Group practice associated |
| | | with the patient problem |
| | | history. |

Equally important to the patient medical history is a patient's social history. The patient social history may include information associated with the patient's use of alcohol, tobacco, and other drugs. As such, social history data of the patient is stored in a Patient Social History Table 98. In a particular embodiment, the Patient Social History Table 98 includes the following:

Patient Social History Table

| NAME | TYPE | DESCRIPTION |
|---|---|---|
| Patient_ID | NUMERIC | Patient ID associated with |
| | | social history. |
| Alcohol | STRING | Alcohol use by patient. |
| Tobacco | STRING | Tobacco use by patient. |
| Drinks | STRING | Drinks consumed by |
| | | patient. |
| Per | STRING | Unit of time in which drinks |
| | | are consumed by patient - |
| | | Hour, Day, Week, Month, |
| | | Year. |
| Tobacco_Amount | STRING | Amount of tobacco |
| | | regularly consumed by |
| | | patient. |
| How_Long | STRING | How long patient has |
| | | consumed |
| | | alcohol/tobacco/drugs. |
| Other_Drugs | STRING | Other drugs used by patient. |
| Group_ID | NUMERIC | Group practice associated |
| | | with this social history. |

To ensure a safe endoscopic procedure, the patient must disclose any drug allergy they may have. As such, the known allergies of the patient are stored in a Patient Allergies Table 100 and may be displayed during the endoscopic procedure. In one embodiment, the Patient Allergies Table 100 includes the following:

Patient Allergies Table

| NAME | TYPE | DESCRIPTION |
|---|---|---|
| Patient_Allergy_ID | NUMERIC | Unique patient allergy ID. |
| Group_ID | NUMERIC | Practice group associated |
| | | with this patient allergy |
| | | information. |
| Patient_ID | NUMERIC | Patient associated with this |
| | | allergy information. |
| Drug_Name | STRING | Drug name of allergy. |
| Symptoms | STRING | Symptoms of allergy. |
| Not_Known_Flag | YES/NO | Yes/No - Patient allergies |
| | | unknown? |

To ensure that the procedure or medications that the patient is taking will not contradict with other treatment or medication the patient may be receiving, a Patient Home Medication Table 102 is maintained to store data corresponding to medications that the patient has been taking. In one embodiment, the Patient Home Medication Table 102 is configured to include the following:

Patient Home Medication Table

| | | |
|---|---|---|
| Home_Medication_ID | NUMERIC | Unique ID for the home |
| | | medication. |
| Drug_Name | STRING | Drug name. |
| Dosage_Form | STRING | Dosage. |
| Route | STRING | Delivery route - Ingestion, |
| | | infusion, suppository, |
| | | injection, etc. |
| Frequency | STRING | Frequency of administration |
| | | of home medication. |
| Medication_Month | STRING | Month home medication |
| | | prescribed. |
| Medication_Day | STRING | Day home medication |
| | | prescribed. |
| Medication_Year | STRING | Year home medication |
| | | prescribed. |
| Medication_End_Date | DATETIME | End date of home |
| | | medication. |
| Patient_ID | NUMERIC | Patient associated with the |
| | | home medication. |
| Group_ID | NUMERIC | Practice group associated |
| | | with the home medication. |
| Medication_Start_Year | STRING | Year home medication |
| | | began. |
| Medication_Start_Month | STRING | Month home medication |
| | | began. |
| Medication_Start_Day | STRING | Day home medication |
| | | began. |
| Medication_End_Year | STRING | Year home medication |
| | | stops. |
| Medication_End_Month | STRING | Month home medication |
| | | stops. |
| Medication_End_Day | STRING | Day home medication stops. |

The patient typically has a relationship to an external physician. For example, the patient could have obtained a referral for the endoscopic physician by the external physician. A relationship of the patient with other physicians is stored in an Other Patient Physician Table 104. The information in this table may be cross-referenced with the information in the Other Physicians Table 80 shown in FIG. 3. Returning to FIG. 4, in one embodiment, the Other Patient Physician Table 104 includes the following:

Other Patient Physician Table

| NAME | TYPE | DESCRIPTION |
|---|---|---|
| Patient_ID | NUMERIC | Patient associated with this |
| | | physician. |
| Other_Physician_ID | NUMERIC | ID associated with this |
| | | physician. |
| Type | STRING | Type of physician. |

Before an endoscopic procedure the patient may be given a consent form to sign. The system 10 is operable to store original and signed copies of the consent forms in a Patient Consent Forms Table 106. In one embodiment, the Patient Consent Forms Table 106 may be configured with the following information:

Patient Consent Forms Table

| NAME | TYPE | DESCRIPTION |
|---|---|---|
| Patient_Consent_Form_ID | NUMERIC | Unique ID of the patient |
| | | consent form. |
| Patient_ID | NUMERIC | Patient associated with the |
| | | consent form. |
| Consent_Form | BINARY | The consent form. |
| Group_ID | NUMERIC | Practice group associated |
| | | with the consent form. |

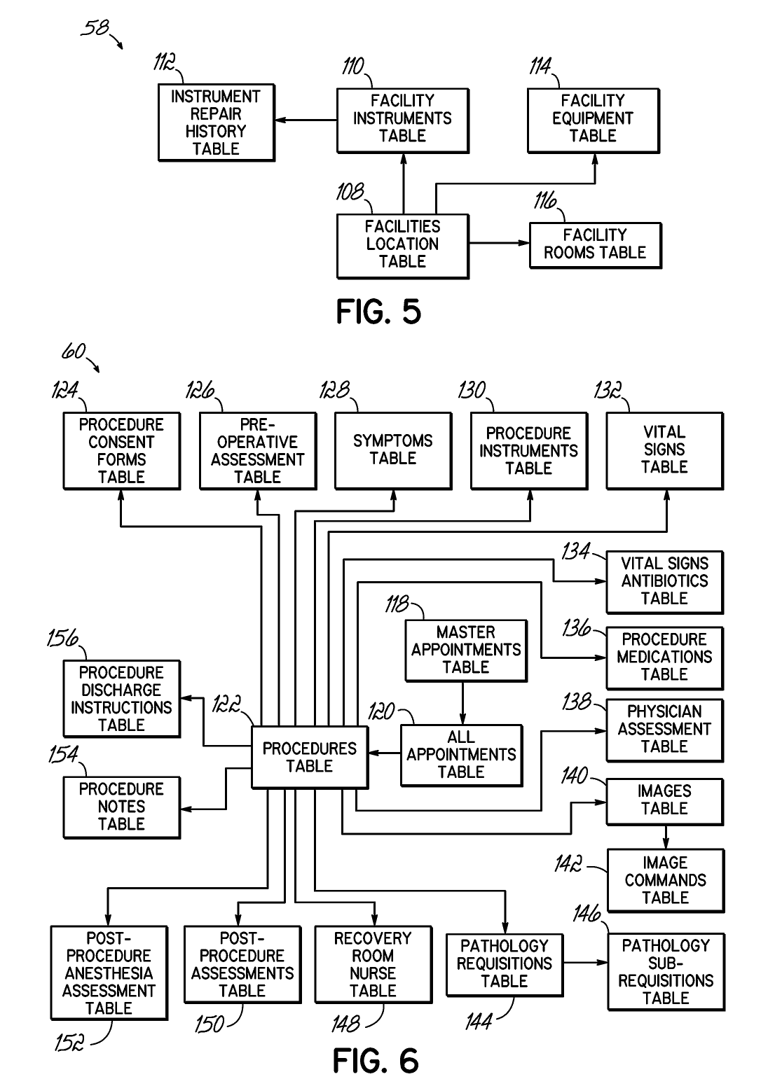

The system is configured to maintain data for each facility of each endoscopic group practice. Detailed information about each facility is stored in the plurality of Facility Tables shown generally at 58 in FIG. 2. FIG. 5 is an illustration 58 of the plurality of tables that may maintain facility information.

When a group practice has multiple locations the system 10 is operable to differentiate between each facility of the group practice. For example, the system 10 is configured to determine that the patient has a preference for a first facility of a group practice, as opposed to a second facility (i.e., patient information is associated with the first facility, and not the second). However, the system 10 is configured such that information about the patient is easily accessible between facilities of a group practice. In one embodiment, information about the various facilities for each group practice is maintained in a Facilities Location Table 108, which may include the following:

Facilities Location Table

| NAME | TYPE | DESCRIPTION |
|---|---|---|
| Location_Id | NUMERIC | Unique ID associated with |
| | | the facility or office. |
| Location_Name | STRING | Name of the facility. |
| Status | NUMERIC | Status of the facility. |
| Street_Address | STRING | Street address of the facility. |
| City | STRING | City of the facility. |
| State | STRING | State of the facility |
| Zip | STRING | Zip code of the facility. |
| Description | STRING | Description of the |
| | | facility. |
| Location_Abbreviation | STRING | Location abbreviation. |
| Primary_Contact_Name | STRING | Primary contact for the |
| | | facility. |
| Primary_Contact_Phone_Number | STRING | Phone number of |
| | | the primary contact of the facility. |
| Group_Id | NUMERIC | Group practice associated with |
| | | the location. |
| Office_Phone_Number | STRING | Phone number of the |
| | | facility. |
| Office_Fax_Number | STRING | Fax number of the |
| | | facility. |
| Office_Email_Address | STRING | E-mail address of the facility. |
| Primary_Contact_Title | STRING | Title of the primary |
| | | contact for the facility. |
| Primary_Contact_Fax_Number | STRING | Fax number of the |
| | | primary contact for the |
| | | facility. |
| Primary_Contact_Email_Address | STRING | E-mail address of the |
| | | primary contact for the |
| | | facility. |
| CLIA_Number | STRING | Clinical Laboratory |
| | | Improvement |
| | | Amendments (CLIA) |
| | | number for the facility. |
| Medicare_Provider | STRING | Medicare provider for the |
| | | facility. |
| Medicaid_Provider_Number | STRING | Medicare provider |
| | | number for the facility. |
| UPIN | STRING | Unique Provider |
| | | Identification number |
| | | (UPIN) for the facility. |
| Non_Facility_Flag | YES/NO | Yes/No - Facility is not a |
| | | medical facility? |

From group practice to group practice, and even facility to facility, the instruments and equipment in each may vary. The system 10 is configured to track inventory and equipment for each facility. As such, a Facility Instrument Table 110 maintains data associated with the instruments used by each facility of each group practice. In one embodiment, the Facility Instruments Table 110 may include the following:

Facility Instruments Table

| NAME | TYPE | DESCRIPTION |
|---|---|---|
| Instrument_ID | NUMERIC | Unique ID for the |
| | | instrument. |
| Instrument_Name | STRING | Name of the instrument. |
| Instrument_Description | STRING | Description of the |
| | | instrument. |
| Group_ID | NUMERIC | Group practice associated |
| | | with the instrument. |
| Manufacturer | STRING | Manufacturer of the |
| | | Instrument. |
| Instrument_Type | STRING | Type of instrument. |
| Procedure_Use | STRING | Usage history of the |
| | | instrument. |
| Date_Purchased | DATETIME | Date instrument purchased. |
| Purchase_Price | NUMERIC | Price of instrument when |
| | | purchased. |
| Model_ID | STRING | Model of instrument. |
| Location_ID | NUMERIC | Facility associated with |
| | | instrument. |
| Serial_ID | STRING | Serial number of |
| | | instrument. |
| Equipment_Number | STRING | Equipment number of |
| | | instrument. |
| Status | NUMERIC | Status of instrument. |
| Placed_In_Service_Date | DATETIME | Date instrument placed in |
| | | service. |

Information regarding the repair history of an instrument is maintained in an Instrument Repair History Table 112. When an instrument is out for repair, a notification can be set in this table then forwarded to a user to indicate the date the instrument was sent out, the type of repair needed, and the costs of repair. In one embodiment, the Instrument Repair History Table 112 is as follows:

Instrument Repair History Table

| NAME | TYPE | DESCRIPTION |
|---|---|---|
| Repair_History_ID | NUMERIC | Unique ID for the |
| | | instrument history. |
| Instrument_ID | NUMERIC | Instrument associated |
| | | with the repair history. |
| Out_Date | STRING | Date instrument sent |
| | | out for repair. |
| In_Date | STRING | Date instrument returned |
| | | from repair. |
| Type_Of_Repair | STRING | Type of repair required. |
| Cost_Of_Repair | STRING | Cost of repair. |
| Group_ID | NUMERIC | Group practice associated |
| | | with repair history. |

A Facility Equipment Table 114 maintains data associated with the equipment at each facility of a group practice. In one embodiment, the Facility Equipment Table 114 is as follows:

Facility Equipment Table

| NAME | TYPE | DESCRIPTION |
|---|---|---|
| Equipment_ID | NUMERIC | Unique ID for the |
| | | equipment. |
| Equipment_Type | STRING | Type of equipment. |
| Location_ID | NUMERIC | Facility associated with the |
| | | equipment. |
| Group_ID | NUMERIC | Group practice associated |
| | | with the equipment. |

Information regarding the rooms in each facility may be maintained in a Facility Rooms Table 116. The Facility Rooms Table 116, in one embodiment, may include the following:

Facility Rooms Table

| NAME | TYPE | DESCRIPTION |
|---|---|---|
| Room_Id | NUMERIC | Unique ID for the room. |
| Room_Name | STRING | Name of the room. |
| Status | NUMERIC | Status of the room. |
| Group_ID | NUMERIC | Group practice associated |
| | | with the room. |
| Location_ID | NUMERIC | Facility associated with the |
| | | room. |
| Description | STRING | Description of the room. |

After basic information about the patient has been entered and the patient has been registered in the system 10, an endoscopic procedure appointment may be scheduled for the patient. Information about each endoscopic procedure is maintained in the plurality of Procedure Tables shown generally at 60 in FIG. 2. FIG. 6 is an illustration 60 of the plurality of tables that may maintain information about an endoscopic procedure.

An appointment for an endoscopic procedure may be generated from a Master Appointments Table 118 that maintains master appointment data. Data in this master table may include whether the appointment is a recurring appointment and a configurable number of recurrences for the appointment. In one embodiment, the Master Appointments Table 118 includes the following:

Master Appointments Table

| NAME | TYPE | DESCRIPTION |
|---|---|---|
| Master_Appointment_ID | NUMERIC | Unique ID |
| | | associated with |
| | | this master |
| | | appointment. |
| Patient_ID | NUMERIC | Patient |
| | | associated with the |
| | | master |
| | | appointment. |
| Pathologist_ID | NUMERIC | Pathologist associated |
| | | with the master |
| | | appointment. |
| Appointment_Type | STRING | Specifies type of the |
| | | appointment. |
| Start_Dttm | DATETIME | Start date and |
| | | time of the |
| | | appointment. |
| End_Dttm | DATETIME | End date and |
| | | time of the |
| | | appointment. |
| Recurrence_Type | STRING | Recurrence - Weekly, |
| | | Monthly, Bi-Yearly, |
| | | Yearly, etc. |
| Occurrence_Count | NUMERIC | Count of the |
| | | occurrences |
| | | of the appointment |
| | | already completed. |
| Week_Recurrence_Days | STRING | Day of a weekly |
| | | recurrence. |
| Month_Recurrence_Week | NUMERIC | Week of a monthly |
| | | recurrence. |
| Month_Recurrence_Day | STRING | Day of a monthly |
| | | recurrence. |
| Month_Appointment_Date_Flag | YES/NO | Yes/No - Monthly |
| | | appointment made? |
| Room_ID | NUMERIC | Room associated |
| | | with the |
| | | master appointment. |
| Location_ID | NUMERIC | Facility |
| | | associated with |
| | | the master |
| | | appointment. |
| Status | NUMERIC | Status of the master |
| | | appointment. |
| Notes | STRING | Notes about the master |
| | | appointment. |
| Group_ID | NUMERIC | Group practice |
| | | associated |
| | | with this master data. |
| Physician_ID | NUMERIC | Physician |
| | | associated with |
| | | the master |
| | | appointment. |
| Subject | STRING | Name for the |
| | | appointment. |
| Recurrence_End_Dttm | DATETIME | Recurrence |
| | | ending date |
| | | and time. |
| Master_Appointment_Identifier | STRING | Unique ID |
| | | for this master |
| | | appointment. |
| Procedure_Type | STRING | Type of procedure to |
| | | perform at the |
| | | appointments. |
| Reason_For_Appointment | STRING | Reason for the |
| | | appointments. |
| Patient_Type | STRING | Type of patient seen in |
| | | appointment - |
| | | Referral, |
| | | primary patient, etc. |
| End_Time | STRING | End time for the |
| | | appointment. |
| Recurr_After | NUMERIC | Number |
| | | indicating how |
| | | many occurrences |
| | | are left. |

An All Appointments Table 120 maintains data of individual patient appointments. The data in the All Appointments Table 120 may include the group practice, facility, room, physician, and other entities assigned to the endoscopic procedure. In one embodiment, the data in the All Appointments Table 120 is as follows:

All Appointments Table

| NAME | TYPE | DESCRIPTION |
|---|---|---|
| All_Appointment_ID | NUMERIC | Unique ID for this |
| | | appointment. |
| Group_ID | NUMERIC | Practice group associated |
| | | with the appointment. |
| Patient_ID | NUMERIC | Patient associated |
| | | with the |
| | | appointment. |
| Physician_ID | NUMERIC | Physician associated with |
| | | the appointment. |
| Pathologist_ID | NUMERIC | Pathologist |
| | | associated with |
| | | the appointment. |
| Master_Appointment_ID | NUMERIC | Master appointment |
| | | information |
| | | associated with |
| | | this appointment. |
| Room_ID | NUMERIC | Room associated |
| | | with this |
| | | appointment. |
| Location_ID | NUMERIC | Facility |
| | | associated with this |
| | | appointment. |
| Appointment_Type | STRING | Type of appointment. |
| Start_Dttm | DATETIME | Start date and time of the |
| | | appointment. |
| End_Dttm | DATETIME | End date and time of the |
| | | appointment. |
| Status | NUMERIC | Status of |
| | | the appointment. |
| Notes | STRING | Notes associated with the |
| | | appointment. |
| Subject | STRING | Name for the |
| | | appointment. |
| Procedure_Type | STRING | Type of procedure |
| | | associated with the |
| | | appointment. |
| Reason_For_Appointment | STRING | Reason for the |
| | | appointment. |
| Patient_Type | NUMERIC | Type of patient seen in |
| | | appointment - Referral, |
| | | primary patient, etc. |
| Send_Email_Flag | YES/NO | Yes/No - Send e-mail to |
| | | remind patient of |
| | | appointment? |
| Appointment_Identifier | STRING | Unique internal identifier |
| | | for appointment. |
| Parent_All_Appointment_ID | NUMERIC | Unique ID for parent |
| | | appointments |
| | | that may have |
| | | created this appointment. |

Basic data about each endoscopic procedure is stored in a Procedures Table 122. The Procedures Table 122 maintains the procedure-appointment relationship as well as general information about each endoscopic procedure. In one embodiment, the Procedures Table 122 may be configured to include the following information:

Procedures Table

| NAME | TYPE | DESCRIPTION |
|---|---|---|
| Procedure_ID | NUMERIC | Unique ID associated with |
| | | a procedure. |
| Name | STRING | Name of the procedure. |
| Type | STRING | Type of procedure. |
| Status | NUMERIC | Status of the procedure. |
| Start_Dttm | DATETIME | Start date and time of the |
| | | procedure. |
| End_Dttm | DATETIME | End date and time of the |
| | | procedure. |
| Group_ID | NUMERIC | Group practice associated |
| | | with the procedure. |
| Referring_Report_Requested | YES/NO | Yes/No - Referring report |
| | | for procedure requested? |
| CC_Report_To_Physician | STRING | Physicians to receive copies |
| | | of the endoscopic |
| | | procedure report. |
| CC_Recipients | STRING | Recipients of copies of the |
| | | endoscopic procedure |
| | | report. |
| Referring_Comments | STRING | Comments from referral. |
| Appointment_ID | NUMERIC | Appointment associated |
| | | with the procedure. |
| Procedure_Identifier | STRING | Identification of the |
| | | procedure. |
| ICD_Codes_For_Report | STRING | ICD codes associated with |
| | | the procedure to use in the |
| | | report. |
| CPT_Codes_For_Report | STRING | CPT codes associated with |
| | | the procedure to use in the |
| | | report. |

Consent forms specific to an endoscopic procedure are maintained in a Procedures Consent Forms Table 124. The Procedures Consent Forms Table 124, unlike the Patient Consent Forms Table 106, stores signed and unsigned consent forms that are specific to an endoscopic procedure. In one embodiment, the Procedures Consent Forms Table 124 includes the following entries:

Procedures Consent Forms Table

| NAME | TYPE | DESCRIPTION |
|---|---|---|
| Procedure_Consent_Form_ID | NUMERIC | Unique ID of the |
| | | procedure consent form. |
| Procedure_Id | NUMERIC | Procedure associated |
| | | with the consent form. |
| Consent_Form | BINARY | The consent form. |
| Group_ID | NUMERIC | Group practice associated |
| | | with the consent form. |

A pre-operative assessment may be administered before the patient undergoes the endoscopic procedure. Information associated with the pre-operative assessment is stored in a Pre-Operative Assessment Table 126. In one embodiment, the Pre-Operative Assessment Table 126 includes the following:

Pre-Operative Assessment Table

| NAME | TYPE | DESCRIPTION |
|---|---|---|
| Procedure_ID | NUMERIC | Procedure associated |
| | | with the pre-operative assessment. |
| NOP_p | STRING | Indicates the time of last |
| | | food or drink of patient. |
| Prep | STRING | Notes on preparation of the patient. |
| Anxiety | STRING | Notes on patient anxiety. |
| Cultural_Spiritual_Needs | YES/NO | Yes/No - Are there cultural or spiritual |
| | | needs |
| | | that must be addressed? |
| Patient_Reason_For_Procedure | STRING | Patient's reason for the procedure. |
| Group_ID | NUMERIC | Group practice associated |
| | | with the procedure. |
| Pain_Education | YES/NO | Yes/No - Has patient been |
| | | educated about possible |
| | | pain during or from the |
| | | procedure? |
| History | STRING | Notes on patient history. |
| IV_Placed | STRING | Indicates location of IV |
| | | placement. |
| Blood_Sugar | NUMERIC | Blood sugar of the patient. |
| Watched_Video_Flag | YES/NO | Yes/No - Patient watched |
| | | a video outlining the |
| | | procedure? |
| Agree_Consent_Flag | YES/NO | Yes/No - Patient |
| | | has consented to the procedure? |
| Answered_All_Flag | YES/NO | Yes/No - Patient |
| | | answered all required |
| | | information? |
| Patient_Needs | STRING | Notes on patient needs |
| | | during the procedure - |
| | | Anesthesia, particular |
| | | attention, etc. |
| Blood_Sugar_Range | STRING | Blood sugar range of the |
| | | patient. |
| INR_Result | STRING | Blood coagulation level. |
| INR_Range | STRING | Blood coagulation range |
| | | of the patient. |
| Mental_Status | STRING | Notes on patient mental |
| | | status. |

During the pre-operative assessment the patient may describe the symptoms that they are experiencing. These symptoms may be useful to diagnose the patient, and are maintained in the Symptoms Table 128. These symptoms are typically accessible during the endoscopic procedure for reference. In one embodiment, the Symptoms Table 128 includes:

Symptoms Table

| NAME | TYPE | DESCRIPTION |
|---|---|---|
| Procedure_ID | NUMERIC | Procedure associated with |
| | | the symptom. |
| Symptom | STRING | Symptom description. |
| Group_ID | NUMERIC | Group practice associated |
| | | with the symptom. |
| Input_Type | STRING | Additional typed input |
| | | about the symptom. |

At any phase of the endoscopic procedure various instruments and equipment may be used. The instruments and equipment used may include endoscopic cameras, vital signs monitors, computers, IV needles, microphones, surgical equipment, or other instruments or equipment used during a part of the endoscopic procedure (i.e., during the pre-operative assessment, during the endoscopic procedure, during a post-operative assessment, during recovery of the patient). Information related to each instrument or piece of equipment used during a part endoscopic procedure is maintained in a Procedure Instruments Table 130. In one embodiment, the Procedure Instruments Table 130 includes:

Procedure Instruments Table

| NAME | TYPE | DESCRIPTION |
|---|---|---|
| Usage_ID | NUMERIC | Indication of the times the |
| | | instrument has been used. |
| Procedure_ID | NUMERIC | Procedure associated with |
| | | this instrument entry. |
| Instrument_ID | NUMERIC | Instrument associated with |
| | | this instrument entry. |
| Usage_Time | STRING | Amount of time the |
| | | instrument was used. |
| Group_ID | NUMERIC | Group practice associated |
| | | with this instrument entry. |

Patient vital signs are monitored and stored in a Vital Signs Table 132. Other information relevant to the patient's physical health may also be stored in the Vital Signs Table 132, such as whether the patient has a hearing aid, glasses, contacts, or the start and end times of various procedures. The vital signs of the patient may be stored in the Vital Signs Table 132 in real time or in discrete intervals, depending on the configuration of the equipment, system 10, or personal preference of a user. In one embodiment, the Vital Signs Table 132 includes the following:

Vital Signs Table

| NAME | TYPE | DESCRIPTION |
|---|---|---|
| Procedure_ID | NUMERIC | Procedure associated with these |
| | | vital signs. |
| Blood_Pressure | STRING | Patient blood pressure. |
| P | STRING | Pulse of patient fetched from |
| | | vital signs equipment. |
| R | STRING | Respiratory measurement of |
| | | patient fetched from vital |
| | | signs equipment. |
| IV_Number | STRING | ID of the IV. |
| Site | STRING | Site of the IV insertion. |
| Solution | STRING | Solution of IV used with the |
| | | patient. |
| Rate | STRING | Rate of infusion from the IV. |
| Time | STRING | Time for infusion of the IV. |
| Reached_Caecum | STRING | Indication of whether the |
| | | caecum has been reached. |
| Proc_Start_Time | STRING | Start time of the procedure. |
| Group_ID | NUMERIC | Group practice associated |
| | | with the procedure. |
| SiteSide | STRING | Side (left or right) where |
| | | abnormality is located. |
| SiteLocation | STRING | Location (pelvic colon, |
| | | ascending colon, small |
| | | intestine, etc.) where |
| | | abnormality is located. |
| SiteOther | STRING | Other comments about the |
| | | site where abnormality is |
| | | located. |
| Photographed_Flag | YES/NO | Yes/No - Photographs taken? |
| Height | STRING | Patient height. |
| Weight | STRING | Patient weight. |
| Pulse | NUMERIC | Pulse rate of the patient. |
| Pulse_Ox | NUMERIC | Pulse oxygen of the patient. |
| Dentures_Flag | YES/NO | Yes/No - Patient has |
| | | dentures? |
| Contacts_Flag | YES/NO | Yes/No - Patient has |
| | | contacts? |
| EyeGlasses_Flag | YES/NO | Yes/No - Patient has |
| | | eyeglasses? |
| NoIVPlaced_Flag | YES/NO | Yes/No - IV was not placed? |
| Size | STRING | Size of the abnormality. |
| IV_Start_Time | STRING | Start time of the IV. |
| Comments | STRING | Comments by physician, pre- |
| | | operative nurse, or recovery |
| | | room nurse. |
| Procedure_Start_Discomfort | STRING | Discomfort experienced by |
| | | the patient during the start of |
| | | the procedure. |
| Procedure_Start_RR | STRING | Time when respiratory |
| | | measurement was fetched |
| | | from vital signs equipment. |
| Procedure_Start_Conscious | STRING | Patient consciousness during |
| | | start of procedure. |
| RR | NUMERIC | Respiratory rate of patient |
| | | fetched from vital signs |
| | | equipment. |
| Instrument_ID | NUMERIC | Instrument associated with |
| | | the recorded vital sign. |
| Vital_Sign_Type | STRING | Indication of the type of vital |
| | | sign taken, i.e. pulse, pulse |
| | | ox, breathing rate, etc. |
| Vital_Sign_ID | NUMERIC | Unique ID of the vital sign. |
| Height_Inches | STRING | Height of patient, in inches. |
| Weigh_Unit | STRING | Unit of weight used to weigh |
| | | patient, i.e. pounds, |
| | | kilograms, etc. |
| Reached_Caecum_Time | STRING | Time caecum reached. |
| TimeOut_Flag | YES/NO | Yes/No - Timeout reached? |
| Patient_Confirmation | YES/NO | Yes/No - Patient confirmed |
| | | for procedure? |
| Wristband | YES/NO | Yes/No - Patient issued |
| | | wristband for procedure. |
| Timeout_Time | STRING | Time associated with the |
| | | timeout. |
| EGD_Proc_Start_Time | STRING | Esophagogastroduodenoscopy |
| | | (EGD) start time. |
| EGD_Proc_End_Time | STRING | EGD end time. |
| Colonoscopy_Proc_Start_Time | STRING | Colonoscopy start time. |
| Colonoscopy_Proc_End_Time | STRING | Colonoscopy end time. |
| Colonoscopy_EGD_Proc_Start_Time | STRING | Colonoscopy and EGD start |
| | | time. |
| Colonoscopy_EGD_Proc_End_Time | STRING | Colonoscopy and EGD end |
| | | time. |
| ERCP_Proc_Start_Time | STRING | Endoscopic retrograde |
| | | cholangiopancreatography |
| | | (ERCP) start time. |
| ERCP_Proc_End_Time | STRING | ERCP end time. |
| EUS_Proc_Start_Time | STRING | Endoscopic ultrasound (EUS) |
| | | start time. |
| EUS_Proc_End_Time | STRING | EUS end time. |
| Bronchoscopy_Proc_Start_Time | STRING | Bronchoscopy start time. |
| Bronchoscopy_Proc_End_Time | STRING | Bronchoscopy end time. |
| Flex_Sigmoid_Proc_Start_Time | STRING | Flexible Sigmoidoscopy start |
| | | time. |
| Flex_Sigmoid_Proc_End_Time | STRING | Flexible Sigmoidoscopy end |
| | | time. |
| PEG_Change_Proc_Start_Time | STRING | Percutaneous endoscopic |
| | | gastrostomy (PEG) start time. |
| PEG_Change_Proc_End_Time | STRING | PEG end time. |
| Hearing_Aid | Yes/No | Yes/No - Patient has a |
| | | hearing aid? |

The patient may be administered antibiotics during the pre-operative assessment or endoscopic procedure in response to specific vital signs. A Vital Sign Antibiotics Table 134 maintains and tracks all data related to the antibiotics administered to the patient during the pre-operative assessment or the endoscopic procedure that are administered in response to specific vital signs. In one embodiment, the Vital Sign Antibiotics Table 134 includes the following:

Vital Signs Antibiotics Table

| NAME | TYPE | DESCRIPTION |
|---|---|---|
| Vital_Sign_Antibiotics_ID | NUMERIC | Unique ID of the antibiotic |
| | | administered. |
| Procedure_ID | NUMERIC | Procedure associated with |
| | | the antibiotic. |
| Drug_Name | STRING | Name of the antibiotic. |
| Quantity | STRING | Quantity of the antibiotic. |
| Group_ID | NUMERIC | Group practice associated |
| | | with the antibiotic. |
| Route | STRING | Delivery route of the |
| | | antibiotic, i.e. pill, IV, etc. |

The patient may be administered medication during the pre-operative assessment or the endoscopic procedure. A Procedure Medications Table 136 maintains and tracks all data related to the medication administered to the patient during the pre-operative assessment or the endoscopic procedure, including antibiotics that are not administered in response to vital signs. In one embodiment, the Procedure Medications Table 136 includes the following:

Procedure Medications Table

| NAME | TYPE | DESCRIPTION |
|---|---|---|
| Procedure_Medications_ID | NUMERIC | Unique ID of the |
| | | medication. |
| Procedure_ID | NUMERIC | Procedure associated with |
| | | the medication. |
| Drug_Name | STRING | Name of the medication. |
| Start | STRING | Time medication began. |
| Stop | STRING | Time medication ended. |
| Quantity | STRING | Quantity of medication |
| | | administered, if applicable. |
| Unit | STRING | Unit of medication, i.e. |
| | | grams, mg, ml, etc. |
| Group_ID | NUMERIC | Group practice associated |
| | | with the medication. |
| Dosage | STRING | Dosage of the medication. |

During the endoscopic procedure the physician may make an assessment of the patient. The physician assessment may be input directly into the system 10 by the physician, transcribed by the operative nurse during the endoscopic procedure, or recorded by the system 10 with the microphone 36. This recording may be converted to machine-readable input by the system 10. A Physician Assessment Table 138 maintains each physician assessment. In one embodiment, the Physician Assessment Table 138 is as follows:

Physician Assessment Table

| NAME | TYPE | DESCRIPTION |
|---|---|---|
| Procedure_ID | NUMERIC | Procedure associated with |
| | | the assessment. |
| ASA_Text | STRING | American Society of |
| | | Anesthesiologists (ASA) |
| | | score. |
| Mallampatti_Score | STRING | Mallampatti score. |
| Reviewed_Flag | YES/NO | Yes/No - Patient reviewed? |
| Group_ID | NUMERIC | Group practice associated |
| | | with the assessment. |
| Review_Time | STRING | Time patient was assessed. |
| General | STRING | General assessment of |
| | | patient. |
| Heent | STRING | Patient Head, Eyes, Ears, |
| | | Nose and Throat (HEENT) |
| | | assessment. |
| Neck | STRING | Patient neck assessment. |
| Heart | STRING | Patient heart assessment. |
| Lungs | STRING | Patient lungs assessment. |
| Abdomen | STRING | Patient abdomen |
| | | assessment. |
| Rectal | STRING | Patient rectal assessment. |
| Lymphatic | STRING | Patient lymphatic system |
| | | assessment. |
| Neuro | STRING | Patient neurological system |
| | | assessment. |
| Psychiatric | STRING | Patient psychiatric |
| | | condition assessment. |
| Extremities | STRING | Patient extremities |
| | | assessment. |

The system 10 is operable to store images captured by the physician. In one embodiment consistent with the invention, the physician activates the electronic switching interface 40, which causes the system 10 to capture an image from the camera system 38 and store it in the database 28. The image is maintained in an Images Table 140. The Images Table 140 also maintains data related to the image, such as image mapping and image annotations made by the physician. Other information associated with the image, such as metadata, is stored in an Image Commands Table 142. In one embodiment, the Images Table 140 includes the following:

Images Table

| NAME | TYPE | DESCRIPTION |
|---|---|---|
| Image_ID | NUMERIC | Unique ID of the image. |
| Procedure_ID | NUMERIC | Procedure associated |
| | | with the image. |
| Report_ID | NUMERIC | Report associated with |
| | | the image |
| Image_Data | BINARY | Image file. |
| Image_Notes | STRING | Notes on the image. |
| Group_ID | NUMERIC | Group practice associated |
| | | with the image. |
| Annotated_Image_Data | BINARY | Image data with |
| | | annotations shown. |
| Seq_No | NUMERIC | Indication of number, |
| | | in a sequence, |
| | | in which image |
| | | was taken. |
| Mapping_Info | STRING | Mapping information |
| | | regarding the image. |
| DICOM_Image_Data | BINARY | Image file in |
| | | Digital Image |
| | | and Communications in |
| | | Medicine (DICOM) |
| | | standard. |
| Exclude_From_Report | YES/NO | Yes/No - Image to be |
| | | excluded from |
| | | all reports? |
| Exclude_From_Patient_Report | YES/NO | Yes/No - Image to be |
| | | excluded from patient |
| | | report? |
| Procedure_Type | STRING | Type of procedure during |
| | | which image |
| | | was captured. |

In one embodiment, the Image Commands Table 142 includes the following:

Image Commands Table

| NAME | TYPE | DESCRIPTION |
|---|---|---|
| Image_command_ID | NUMERIC | Unique ID of the image |
| | | command. |
| Image_ID | NUMERIC | Image associated with |
| | | the image command. |
| Image_Location | STRING | Location image taken. |
| Image_Lesion | STRING | Lesion associated with |
| | | image. |
| Image_Action | STRING | Action taken after image |
| | | capture. |
| Image_Size | STRING | Size of the image. |
| Group_ID | NUMERIC | Group practice associated |
| | | with the image command. |

During the endoscopic procedure the physician may remove, or “snare,” a growth of tissue. In particular, the physician may snare what appears to be abnormal tissue, typically called a “polyp.” The physician may send the tissue to a pathology lab to determine if the tissue is abnormal. As such, after snaring tissue the physician may generate a pathology requisition. The tissue is placed in a container marked with the requisition and sent to the pathology lab. Information related to pathology requisitions, if any, is stored by the system in a Pathology Requisitions Table 144 during the endoscopic procedure. In one embodiment, the Pathology Requisitions Table 144 includes the following:

Pathology Requisitions Table

| NAME | TYPE | DESCRIPTION |
|---|---|---|
| Pathology_Requisition_Id | NUMERIC | Unique ID of the |
| | | pathology requisition. |
| Location_ID | NUMERIC | Facility associated |
| | | with |
| | | pathology requisition. |
| Procedure_ID | NUMERIC | Procedure |
| | | associated with |
| | | pathology requisition |
| Group_ID | NUMERIC | Group practice |
| | | associated |
| | | with pathology |
| | | requisition. |
| Requisition_Date | DATETIME | Date requisition |
| | | requested. |
| Status | NUMERIC | Status of the |
| | | requisition. |
| Pathology_Requisition_Identifier | NUMERIC | User that initiated |
| | | pathology requisition. |
| Pathologist_ID | NUMERIC | Pathologist associated |
| | | with requisition. |
| Report_Id | NUMERIC | Report associated with |
| | | requisition. |
| Specimen_Number | STRING | Number that identifies |
| | | specimen. |
| Date_Received | STRING | Date requisition |
| | | received. |

A pathology requisition may be associated with a pathology sub-requisition, or requisition that must take place before that pathology requisition is completed. A Pathology Sub-Requisitions Table 146 maintains all information associated with pathology sub-requisitions. In one embodiment, the Pathology Sub-Requisitions Table 146 is as follows:

Pathology Sub-Requisitions Table

| NAME | TYPE | DESCRIPTION |
|---|---|---|
| Sub_Requisition_ID | NUMERIC | Unique ID of the sub- |
| | | requisition. |
| Bottle_Number | STRING | Bottle number for the |
| | | specimen for the sub- |
| | | requisition. |
| Location | STRING | Facility associated with the |
| | | sub-requisition. |
| ICD_Code | STRING | ICD code associated with |
| | | sub-requisition. |
| Problem_Name | STRING | Problem name associated |
| | | with sub-requisition. |
| Comments | STRING | Comments associated with |
| | | sub-requisition. |
| Type | STRING | Type of sub-requisition. |
| Pathology_Requisition_Id | NUMERIC | ID of pathology requisition |
| | | associated with sub- |
| | | requisition. |
| Group_Id | NUMERIC | Group practice associated |
| | | with sub-requisition. |
| Requisition_Date | DATETIME | Date and time of sub- |
| | | requisition. |
| Location_List | STRING | List of locations where |
| | | specimens were taken. |

A user in a recovery room may monitor the patient before discharge. Information collected during the recovery is recorded in a Recovery Room Nurse Table 148. In one embodiment, the Recovery Room Nurse Table 148 is as follows:

Recovery Room Nurse Table

| NAME | TYPE | DESCRIPTION |
|---|---|---|
| Recovery_Room_Nurse_ID | NUMERIC | ID of the user associated |
| | | with this entry. |
| Procedure_ID | NUMERIC | Procedure associated |
| | | with this entry. |
| HOB_Elevated | STRING | Elevation of the Head of |
| | | the Bed (HOB) during |
| | | recovery. |
| Fluid_Intake | STRING | Fluid intake by patient. |
| IV_DCD | STRING | Indication of whether an |
| | | IV was discontinued. |
| Dangle_At_Beside | STRING | Time when the patient is |
| | | able to sit on the side of |
| | | the recovery room bed. |
| Ambulate_Assistance | STRING | Notation of whether |
| | | patient needs assistance |
| | | moving about. |
| Blood_Sugar | STRING | Blood sugar of the |
| | | patient. |
| Range | STRING | Blood sugar range of the |
| | | patient. |
| Spoke_With_PT_Family_Flag | YES/NO | Yes/No - Nurse has |
| | | spoken with the |
| | | patient's family? |
| PT_Instructions_Flag | YES/NO | Yes/No - Patient |
| | | has been |
| | | given instructions? |
| Belonging_To_PT_Flag | YES/NO | Yes/No - Patient |
| | | has been |
| | | given their belongings? |
| Discharge_Steady_Flag | YES/NO | Yes/No - Patient was |
| | | steady when discharged? |
| Discharge_WC_Flag | YES/NO | Yes/No - Patient used the |
| | | water closet before |
| | | discharge? |
| Discharge_Stretcher | YES/NO | Yes/No - Patient requires |
| | | stretcher for discharge? |
| Call_Number | STRING | Number to |
| | | call for patient |
| | | assistance or pickup. |
| Time | STRING | Time patient discharged. |
| Discharge_To | STRING | Person patient is |
| | | discharged to. |
| Group_ID | NUMERIC | Group practice associated |
| | | with this entry. |
| MD_Evaluated_Patient_Flag | YES/NO | Yes/No - Physician |
| | | evaluated patient? |

Information related to a post-procedure assessment is maintained in a Post-Procedure Assessment Table 150. Furthermore, information related to the post-procedure anesthesia assessment after a patient has been administered anesthesia for an endoscopic procedure is maintained in a Post-Procedure Anesthesia Assessment Table 152. In one embodiment, the Post-Procedure Assessment Table 150 includes the following:

Post-Procedure Assessment Table

| NAME | TYPE | DESCRIPTION |
|---|---|---|
| Post_Procedure_Assesment_ID | NUMERIC | Unique post-procedure |
| | | assessment ID. |
| Procedure_ID | NUMERIC | Procedure |
| | | associated with |
| | | the post-procedure |
| | | assessment. |
| Time | STRING | Time post-procedure |
| | | assessment taken. |
| Conscious | STRING | Consciousness |
| | | of patient |
| | | during post-procedure |
| | | assessment. |
| Colour | STRING | Colour of |
| | | patient during |
| | | post-procedure |
| | | assessment. |
| Skin | STRING | Skin condition |
| | | of patient |
| | | during post-procedure |
| | | assessment. |
| Pain | STRING | Pain experienced |
| | | by patient |
| | | relayed during |
| | | the post- |
| | | procedure assessment. |
| Blood_Pressure | STRING | Patient blood pressure |
| | | during post-procedure |
| | | assessment. |
| Pulse | STRING | Patient pulse |
| | | during post- |
| | | procedure assessment. |
| Respiration | STRING | Patient |
| | | respiration during |
| | | post-procedure |
| | | assessment. |
| Oxygen_Saturation_PRN | STRING | Patient |
| | | oxygen saturation |
| | | during post-procedure |
| | | assessment. |
| IV_Site | STRING | Condition of |
| | | site where IV |
| | | inserted into |
| | | patient during |
| | | procedure. |
| IV_Amount | STRING | Amount of fluid |
| | | administered to patient |
| | | during post-procedure |
| | | assessment. |
| Group_ID | NUMERIC | Group practice |
| | | associated |
| | | with the |
| | | post-procedure |
| | | assessment. |
| Pain_Location | STRING | Location of |
| | | pain relayed by |
| | | patient during post- |
| | | procedure assessment. |
| Treatment | STRING | Treatment |
| | | prescribed for |
| | | patient during post- |
| | | procedure assessment. |

In one embodiment, the Post-Procedure Anesthesia Assessment Table 152 is as follows:

Post-Procedure Anesthesia Assessment Table

| NAME | TYPE | DESCRIPTION |
|---|---|---|
| Procedure_ID | NUMERIC | Procedure associated with |
| | | the post-procedure |
| | | anesthesia assessment. |
| Procedure_Name | STRING | Name of the procedure |
| | | associated with the post- |
| | | procedure anesthesia |
| | | assessment. |
| Biopsy | STRING | Assessment of patient after |
| | | biopsy. |
| Polyp | STRING | Assessment of patient after |
| | | polyp removed. |
| Tolerated | STRING | Assessment of patient |
| | | tolerance of the procedure. |
| Skin | STRING | Assessment of patient skin |
| | | after the procedure. |
| Colour | STRING | Assessment of patient |
| | | colour after the procedure. |
| LOC | STRING | Assessment of patient Level |
| | | of Consciousness (LOC) |
| | | after the procedure. |
| Abdomen | STRING | Assessment of patient |
| | | abdomen after the |
| | | procedure. |
| Respiration | STRING | Assessment of patient |
| | | respiration after the |
| | | procedure. |
| Ground_Unit | STRING | Assessment of the location |
| | | of the grounding pad. |
| Location | STRING | Location of a grounding |
| | | pad. |
| Post_Site | STRING | Indicates whether there was |
| | | an abnormality at the |
| | | ground pad post removal. |
| MAL#_hem | STRING | Indicates whether there was |
| | | bleeding after a maloony |
| | | dilation. |
| BAL#_hem | STRING | Indicates whether there was |
| | | bleeding after a balloon |
| | | dilation. |
| SAV#_hem | STRING | Indicates whether there was |
| | | bleeding after a savory |
| | | dilation. |
| Group_ID | NUMERIC | Group practice associated |
| | | with this post-procedure |
| | | anesthesia assessment. |
| Polyp_Snare | STRING | Assessment of patient after |
| | | polyp snared. |
| Polyp_Forcep | STRING | Assessment of patient after |
| | | polyp removed by forceps. |
| Consciousness | STRING | Consciousness of patient |
| | | during post-procedure |
| | | anesthesia assessment. |
| Comments | STRING | Comments recorded during |
| | | the post-procedure |
| | | anesthesia assessment. |
| Grounding_Comments | STRING | Comments on the |
| | | grounding of the patient. |
| Skin_At_Grounding_Pad | STRING | Assessment of the skin at |
| | | the location of the |
| | | grounding pad. |

Before, during, and/or after the procedure, various users may make notes. Notes are maintained in the Procedure Notes Table 154. In one embodiment, the Procedure Notes Table 154 is as follows:

Procedure Notes Table

| NAME | TYPE | DESCRIPTION |
|---|---|---|
| Procedure_ID | NUMERIC | Procedure associated |
| | | with the notes. |
| Pre_Op_Notes | STRING | Pre-operative nurse |
| | | notes. |
| Op_Notes | STRING | Operative nurse notes. |
| Physician_Notes | STRING | Physician notes. |
| Recovery_Room_Nurse_Notes | STRING | Recovery room nurse |
| | | notes. |
| Group_ID | NUMERIC | Group practice associated |
| | | with the notes. |
| Notes | STRING | Text of the notes. |

After the procedure, the physician may give various instructions regarding the discharge of the patient. Any documents or forms associated with patient discharge instructions are stored in a Patient Discharge Instructions Table 156. In one embodiment, the Patient Discharge Instructions Table 156 is as follows:

Procedure Discharge Instructions Table

| NAME | TYPE | DESCRIPTION |
|---|---|---|
| Procedure_ID | NUMERIC | Procedure associated with |
| | | the patient discharge |
| | | instructions. |
| Form_Contents | BINARY | File containing the patient |
| | | discharge instructions |
| Group_ID | NUMERIC | Group practice associated |
| | | with the patient discharge |
| | | instructions. |

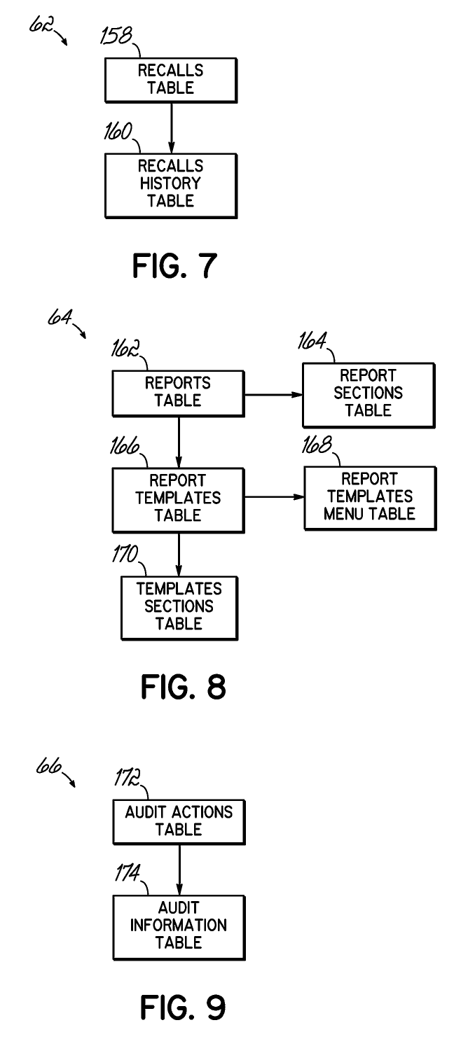

After the procedure has been completed, the patient may be required to visit the endoscopic practice for further treatment or follow-up. When follow-up treatments or procedures are required, a subsequent appointment of the patient in regards to that treatment may be referred to as a “recall.” Recalls may be scheduled on a specific basis, such as yearly, monthly, or weekly. Information about each recall is maintained in the plurality of Recall Tables shown generally at 62 in FIG. 2. FIG. 7 is an illustration 62 of the plurality of tables that may contain information about the recalls. Basic information about patient recalls is maintained in the Recalls Table 158. Historical information associated with a patient's recalls is stored in a Recall History Table 160. In one embodiment, the Recalls Table 158 includes the following:

Recalls Table

| NAME | TYPE | DESCRIPTION |
|---|---|---|
| Recall_ID | NUMERIC | Unique ID assigned to the |
| | | recall. |
| Patient_ID | NUMERIC | Patient associated with the |
| | | recall. |
| Physician_ID | NUMERIC | Physician associated with |
| | | the recall. |
| Group_ID | NUMERIC | Group practice associated |
| | | with the recall. |
| Reason | STRING | Reason for the recall. |
| Status | NUMERIC | Status of the recall. |
| Recall_Appointment_ID | NUMERIC | Appointment ID of the |
| | | recall. |
| Notes | STRING | Notes regarding the recall. |
| Date | DATETIME | Date assigned to the recall. |
| Recall_Identifier | STRING | User that initiated the recall. |
| Choices | STRING | Procedure type for which |
| | | the recall is configured. |
| Send_Email_Flag | YES/NO | Yes/No - Send patient an e- |
| | | mail associated with the |
| | | recall? |
| Recent_Procedure_ID | NUMERIC | Most recent procedure of |
| | | the patient associated with |
| | | this recall. |
| Recall_Years | STRING | Number of years between |
| | | each recall. |
| Recall_Months | STRING | Number of months between |
| | | each recall. |
| Recall_Weeks | STRING | Number of weeks between |
| | | each recall. |

In one embodiment, the Recall History Table 160 is as follows:

Recall History Table

| NAME | TYPE | DESCRIPTION |
|---|---|---|
| Recall_History_ID | NUMERIC | Unique ID assigned to |
| | | the recall history. |
| Recall_ID | NUMERIC | Recall associated with |
| | | the recall history. |
| Modified_Date | DATETIME | Date recall history last |
| | | modified. |
| Notes | STRING | Notes regarding the |
| | | recall history. |
| Group_ID | NUMERIC | Group practice associated |
| | | with the recall history. |

Functionality consistent with embodiments of the invention utilizes data in the database 28 to assist the physician in generating reports after the endoscopic procedure. In particular, the system may utilize templates for report layouts, sections, text, and other multimedia data to assist the physician and increase efficiency in generating the report. The physician may utilize the templates and data from the database 28 to quickly and efficiently aggregate data related to the patient, the pre-operative assessment, any assessment made during the endoscopic procedure, the endoscopic procedure, the post-operative assessment, and the pathology results. For example, the templates may provide for gathering information from the database and then form sentences by inserting the gathered information into sentences. Thus, the user does not have to hand type, or dictate, parts of the report. This increases the speed with which the user can generate reports and increases the time the user has for other tasks. As such, the templates may include sections to include images, other multimedia data, physician assessments, and physician notes in the report. After the report is generated, the system also archives the report in the database 28 and may generate a report specifically for the patient.

Information about the report is maintained in the plurality of Report Tables shown generally at 64 in FIG. 2. FIG. 8 is an illustration 64 of the plurality of tables that may maintain information about reports. Basic data associated with the endoscopic procedure and that may be used in the report is stored in a Reports Table 162. In one embodiment, the Reports Table 162 is as follows:

Report Information Table

| NAME | TYPE | DESCRIPTION |
|---|---|---|
| Report_ID | NUMERIC | Unique ID assigned to the |
| | | report. |
| Report_Name | STRING | Name of the report. |
| Approved | NUMERIC | Indication of whether the |
| | | report has been approved. |
| Approver | STRING | Person who approved the |
| | | report. |
| Report_Type | STRING | Type of report. |
| Procedure_ID | NUMERIC | Procedure associated with |
| | | this report. |
| Group_ID | NUMERIC | Group practice associated |
| | | with the report. |
| Report_Html | STRING | Hypertext Markup |
| | | Language (HTML) version |
| | | of the report. |
| Status | NUMERIC | Status of the report. |
| Transcription_Flag | YES/NO | Yes/No - Transcription |
| | | complete for report? |
| Report_Main_Type | STRING | Indication of whether report |
| | | is Endoscopy or Pathology |
| | | report. |

Detailed report data is stored in various sections of the report. For example, information regarding the procedure is input into a procedure section, information regarding indications is input into an indications section, information regarding medication is input into a medication section, and so forth. Information in each section is maintained in a Report Sections Table 164. In one embodiment, the Report Sections Table 164 includes the following:

Report Sections Table

| NAME | TYPE | DESCRIPTION |
|---|---|---|
| Report_Section_Id | NUMERIC | Unique ID assigned to the |
| | | report section. |
| Report_Section_Type | STRING | Type of section. |
| Report_Id | NUMERIC | Report associated with this |
| | | section. |
| Group_ID | NUMERIC | Group practice associated |
| | | with this section. |
| Control_ID | STRING | Control ID of section of a |
| | | report. |
| Control_Text | STRING | Text of the section. |
| Audio_File | BINARY | Audio file associated with |
| | | the section. |
| Image_Section | BINARY | Image associated with the |
| | | section. |
| Preview_Status | YES/NO | Yes/No - Preview of the |
| | | section allowed? |

The users may use templates to speed report generation. The templates may be provided by the system 10 or customized by the users. Basic data associated with the templates is stored in the Report Templates Table 166. The Report Templates Table 166 stores data associated with the type of template and the owner (i.e., primary user) of the template. In this way, a user can use templates created for that user, the group practice of that user, or the system templates. In one embodiment, the Report Templates Table 166 is as follows:

Report Templates Table

| NAME | TYPE | DESCRIPTION |
|---|---|---|
| Template_ID | NUMERIC | Unique ID of the template. |
| Name | STRING | Name of the template. |
| Type | STRING | Type of template. |
| Version_Number | NUMERIC | Version number of |
| | | template. |
| Enabled | YES/NO | Yes/No - Template |
| | | enabled? |
| Group_ID | NUMERIC | Group practice associated |
| | | with the template. |
| Group_Template_Flag | YES/NO | Yes/No - Template is a |
| | | group practice template? |
| User_ID | NUMERIC | User associated with the |
| | | template. |
| System_Template_Flag | YES/NO | Yes/No - Template is a |
| | | system template? |
| xmlMenu | STRING | Extensible Markup |
| | | Language (XML) menu for |
| | | the template. |
| xmlMenuForReport | STRING | XML menu for the report. |

Detailed data related to the menus of templates is maintained in the Report Templates Menu Table 168. In one embodiment, the Report Templates Menu Table 168 is as follows:

Report Templates Menu Table

| NAME | TYPE | DESCRIPTION |
|---|---|---|
| Template_Menu_ID | NUMERIC | Unique ID of the template |
| | | menu. |
| Menu_Type | STRING | Type of template menu. |
| Menu_Caption | STRING | Caption for the template |
| | | menu. |
| Parent_Menu_ID | NUMERIC | ID of parent template menu, |
| | | if applicable. |
| Group_ID | NUMERIC | Group practice associated |
| | | with the template menu. |
| Menu_Pronounciation | STRING | Pronounciation diagram of |
| | | the template menu. |
| User_ID | NUMERIC | User associated with the |
| | | template menu. |
| Template_ID | NUMERIC | Template associated with |
| | | the template menu. |
| Menu_Text | STRING | Text of the template menu. |
| Menu_Order | NUMERIC | Order of the template menu. |
| CPT_CODE_ID | STRING | CPT code associated with |
| | | the template menu. |
| ICD_CODE_ID | STRING | ICD code associated with |
| | | the template menu. |
| Complex_Sentence | STRING | Template for a complex |
| | | sentence. This may include |
| | | fields that are linked to the |
| | | database and automatically |
| | | include data associated with |
| | | that field into the sentence. |
| | | The complex sentence may |
| | | be multiple sentences, or |
| | | even paragraphs. |
| Display_In_Menu_Flag | YES/NO | Yes/No - Display this |
| | | template in the menu? |
| Diagnosis | STRING | Diagnosis template. |
| Exclusive_Menu | NUMERIC | ID of user who may use this |
| | | template menu exclusively, |
| | | if any. |

Information about each template's section is stored in a Template Sections Table 170. In one embodiment, the Template Sections Table 170 is as follows:

Template Sections Table

| NAME | TYPE | DESCRIPTION |
|---|---|---|
| Template_Section_Id | NUMERIC | Unique ID for the template |
| | | section. |
| Template_Section_Text | STRING | Text of the template |
| | | section. |
| Group_ID | NUMERIC | Group practice associated |
| | | with the template section. |
| Image_Section | BINARY | Image associated with the |
| | | template section. |
| Template_ID | NUMERIC | Template associated with |
| | | the template section. |
| Template_Section_Type | STRING | Type of template section. |
| System_Template_Flag | YES/NO | Yes/No - Template section |
| | | is a system template |
| | | section? |

The user may wish to know the history of a particular entity maintained by the system 10. To this end, the system 10 maintains the plurality of Audit Tables shown generally at 66 on FIG. 2. FIG. 9 is an illustration 66 of the plurality of tables that may maintain information about the status of data. In particular, the Audit Actions Table 172 maintains general information for each audit record. In one embodiment, the Audit Actions Table 172 includes the following:

Audit Actions Table

| NAME | TYPE | DESCRIPTION |
|---|---|---|
| Action_Id | NUMERIC | Unique ID for the action |
| | | being taken during the |
| | | audit. |
| Entity_Id | NUMERIC | Entity associated with the |
| | | action. Can be a user, |
| | | group practice, etc. |
| Action_Description | STRING | Description of the action |
| | | taken. |
| Auditing_Disabled | YES/NO | Yes/No - Is auditing for |
| | | this action disabled? |
| Action_Name | STRING | Name of the action taken. |
| Action_Audit_Text | STRING | Text associated with the |
| | | results of the action taken |
| | | during the audit. |

Other audit information, such as the specific user who performed the action on an entity, or the list of actions performed on an entity, is maintained in an Audit Information Table 174. The Audit Information Table 174 is generally used to manage audit information, and in one embodiment includes the following:

Audit Information Table

| NAME | TYPE | DESCRIPTION |
|---|---|---|
| Audit_Record_ID | NUMERIC | Unique ID for that audit |
| | | record. |
| Action_Id | NUMERIC | Audit action associated with |
| | | the record. |
| Entity_Id | NUMERIC | Entity associated with the |
| | | audit. |
| Record_Id | NUMERIC | ID of another record |
| | | associated with this audit |
| | | record. |
| Audit_TimeStamp | DATETIME | Time and date of the audit. |
| Action_Login_Name | STRING | Login name of the person |
| | | who performed the audit. |
| Audit_Log_Text | STRING | Text describing the audit. |
| Group_ID | NUMERIC | Group practice associated |
| | | with the action. |
| Optional_Record_Id_1 | NUMERIC | Associated record that may |
| | | relate to this record. |
| Parent_Record_Id | NUMERIC | Parent record of this record, |
| | | if applicable |

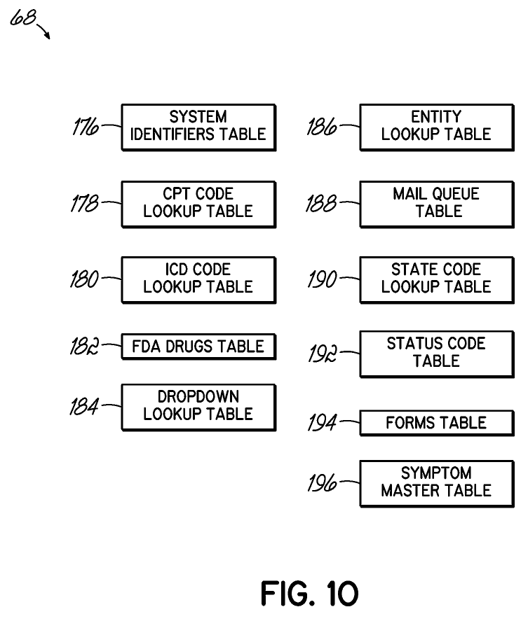

A plurality of System Tables shown generally at 68 in FIG. 2 are maintained to implement functionality of the system consistent with embodiments of the invention. FIG. 10 is an illustration 68 of the plurality of tables that may maintain information needed by the system. A System Identifiers Table 176 is maintained to provide the system 10 with an updated list of unique identifiers that can be used for any system 10 entity, such as users, patients, appointments, recalls, procedures, pathology requisitions, etc. The System Identifiers Table 176, in one embodiment, may include the following:

System Identifiers Table

| NAME | TYPE | DESCRIPTION |
|---|---|---|
| Identifier_Name | STRING | Unique ID for the identifier |
| | | stored in this entry. |
| Seed | NUMERIC | Original seed value for the |
| | | system identifiers. |
| Incr | NUMERIC | Incremental value for each |
| | | identifier. |
| CurrVal | NUMERIC | Current value for |
| | | identifiers. |

Users may utilize different nomenclatures to describe medical, surgical, and diagnostic services, or otherwise communicate uniform information about medical services and procedures among physicians, coders, patients, accreditation organizations, and for administrative, financial, or analytical purposes. One nomenclature is the Current Procedural Terminology (CPT) code maintained by the American Medical Association. In one embodiment, appropriate current CPT codes, along with a short description of each code, is maintained in a CPT Code Lookup Table 178, and may include the following:

CPT Code Lookup Table

| NAME | TYPE | DESCRIPTION |
|---|---|---|
| CPT_Code_ID | STRING | Unique CPT code. |
| CPT_Code_Version | NUMERIC | Unique ID for that CPT |
| | | code version. |
| Long_Desc | STRING | Long description of the |
| | | CPT code. |
| Short_Desc | STRING | Short description of the |
| | | CPT code. |
| Last_Updated | DATETIME | Date and time this CPT |
| | | code was last updated. |

Users also utilize different nomenclatures to describe a wide variety of signs, symptoms, abnormal findings, complaints, social circumstances and external causes of injury or disease. One nomenclature is the International Statistical Classification of Diseases and Related Health Problems (ICD) code. By using an ICD code, every health condition can be assigned to a unique category and given a code up to six characters long. In one embodiment, the current ICD code, along with a short description of each code, is maintained in an ICD Code Lookup Table 180, and may include the following:

ICD Code Lookup Table

| NAME | TYPE | DESCRIPTION |
|---|---|---|
| ICD_Code_ID | STRING | Unique ICD code. |
| ICD_Code_Version | NUMERIC | Unique ID for that ICD |
| | | code version. |
| Description | STRING | Description of the ICD |
| | | code. |
| Last_Updated | DATETIME | Date and time this ICD was |
| | | last updated. |

Physicians typically prescribe medications for patient treatment. The patient may also be administered medications before, during, or after an endoscopic treatment. Physicians must be aware of current dosing requirements for each drug they prescribe to ensure patient safety. In one embodiment, an appropriate table of current drugs approved by the Food and Drug Administration (FDA), along with their dosage and other data, is maintained in an FDA Drugs Table 182, which may include the following:

FDA Drugs Table

| NAME | TYPE | DESCRIPTION |
|---|---|---|
| Ingredient | STRING | Drug name. |
| Dosage form; Route of | STRING | Dosage and Route of |
| Administration | | administration. |
| Trade_Name | STRING | Trade name of the drug. |
| Applicant | STRING | Name of entity that applied |
| | | to clear drug through FDA. |
| Strength | STRING | Strength of drug. |
| New Drug Application | NUMERIC | NDA number. |
| (NDA) Number | | |
| Product Number | NUMERIC | FDA specified product |
| | | number. |
| Therapeutic Equivalence | STRING | TE code. |
| (TE) Code | | |
| Approval Date | DATETIME | Date drug approved by |
| | | FDA. |
| Reference Listed Drug | STRING | Drugs that are |
| (RLD) | | therapeutically equivalent. |
| Type | STRING | Type of drug. |
| Applicant Full Name | STRING | Full name of drug applicant. |

It will be appreciated by one having ordinary skill in the art that the data associated with the CPT Code Lookup Table 178, ICD Code Lookup Table 180, and FDA Drugs Table 182 may be updated by directly access those tables and inserting new information, or the tables 178, 180 and 182 may be updated by replacing those tables with newer versions.

The system is configured to utilize drop-down menus to enable functionality consistent with embodiments of the invention. Each drop-down menu includes at least one value (i.e., text or an identifier that can be referenced to display text) that corresponds to a drop-down control. In order to provide flexibility of the system 10 for future updates (i.e., in order to prevent mainline code of the system 10 from having to be replaced with each new version of the code or software) values for various drop-down controls are maintained in a Dropdown Lookup Table 184. The Dropdown Lookup Table 184 permits drop-down values to be changed dynamically and quickly. In one embodiment, the Dropdown Lookup Table 184 may include the following:

Dropdown Lookup Table

| NAME | TYPE | DESCRIPTION |
|---|---|---|
| Dropdown_lookup_ID | NUMERIC | Unique ID for that |
| | | dropdown entry. |
| Entity | STRING | Entity associated with this |
| | | drop down. |
| Dropdown_Text | STRING | Text for the dropdown. |

To track all the entities of the system 10, an Entity Lookup Table 186 is maintained. The Entity Lookup Table 186 generally stores the master list of all entities of the system 10, and in one embodiment includes the following:

Entity Lookup Table

| NAME | TYPE | DESCRIPTION |
|---|---|---|
| Entity_Id | NUMERIC | Unique ID for that entity. |
| Group_ID | NUMERIC | Group practice associated |
| | | with the entity. |
| Entity_Name | STRING | Name of the entity. |
| Parent_Entity_Id | NUMERIC | Parent entity, if applicable. |
| Entity_Display_Name | STRING | Display name for the entity. |
| PrimaryKey_Field | STRING | Name of the primary key of |
| | | an entity. |
| PrimaryKey_Field_1 | STRING | Name of the secondary key |
| | | of an entity, if any. |
| Parent_PrimaryKey_Field | STRING | Name of the primary key of |
| | | the parent entity. |
| Entity_DB_Name | STRING | Database name of the |
| | | entity. |
| Show_For_RBAC | YES/NO | Yes/No - Show this entity |
| | | for Role-Based Access |
| | | Control? |

The system 10 is configured to automatically track and send e-mail to various users, as well as other entities that may not be system 10 users. The e-mails are stored in the Mail Queue Table 188 along with associated information for future reference. The system 10 processes e-mail in a first-in-first-out (FIFO) manner. In particular, one embodiment of the Mail Queue Table 188 may include the following:

Mail Queue Table

| NAME | TYPE | DESCRIPTION |
|---|---|---|
| Mail_Id | NUMERIC | Unique ID for this e-mail. |
| Email_To | STRING | Recipient of the e-mail. |
| Group_Id | NUMERIC | Group practice associated |
| | | with the e-mail. |
| User_Id | NUMERIC | User sending the e-mail. |
| Mail_Type | STRING | Description of the type of e- |
| | | mail. |
| Subject | STRING | Subject line of the e-mail. |
| Body | STRING | Body of the e-mail. |
| When_DateTime | DATETIME | Time and date when e-mail |
| | | drafted. |
| Sent_DateTime | DATETIME | Time and date when e-mail |
| | | sent. |
| Send_Flag | YES/NO | Yes/No - Send e-mail? |

The system 10 includes a State Code Lookup Table 190 that maintains the names and codes for all states in the United States of America. In one embodiment, the State Code Lookup Table 190 includes the following:

State Code Lookup Table

| NAME | TYPE | DESCRIPTION |
|---|---|---|
| State_Code_Lookup_ID | NUMERIC | Unique ID for the state |
| | | code. |
| State | STRING | State name. |
| Abbr | STRING | State abbreviation. |
| State_Code | STRING | State code. |

To manage the workflow in the system, the Status Code Lookup Table 192 may act as a master table for various statuses of various entities of the system 10. The Status Code Lookup Table 192, in one embodiment, includes the following:

Status Code Lookup Table

| NAME | TYPE | DESCRIPTION |
|---|---|---|
| Status_Code_Lookup_ID | NUMERIC | Unique ID for the status |
| | | code lookup. |
| Entity | STRING | Name of the entity |
| | | associated with the status. |
| Status | NUMERIC | Numeric status indicator. |
| Status_Text | STRING | Text status of the entity. |
| Description | STRING | Description associated with |
| | | the status. |
| Workflow_Order_No | NUMERIC | Workflow order number of |
| | | the entity. |

Various forms, other than patient consent forms, procedure discharge instructions, and reports may be uploaded to the system and maintained in a Forms Table 194. The Forms Table 194 may also maintain the documents for each group practice. In certain embodiments, the Forms Table 194 may include the following:

Forms Table

| NAME | TYPE | DESCRIPTION |
|---|---|---|
| Form_ID | NUMERIC | Unique ID for the form. |
| Group_ID | NUMERIC | Group practice utilizing the |
| | | form. |
| Form_Name | STRING | Name of the form. |
| Form_Doc | BINARY | Uploaded form. |
| Description | STRING | Description of the form. |

The system maintains a Symptom Master Table 196, which is a master table for symptoms. In one embodiment, the Symptom Master Table 196 includes the following:

Symptom Master Table

| NAME | TYPE | DESCRIPTION |
|---|---|---|
| Symptom_ID | NUMERIC | Unique ID associated with |
| | | the symptom. |
| Symptom | STRING | Text describing the |
| | | symptom. |
| Symptom_Category | STRING | Category of the symptom. |

It will be realized by one skilled in the art that the database scheme described is merely exemplary in nature, and that an alternate combination of tables, or data comprising the tables, may be configured. For instance, it will be appreciated by one skilled in the art that the database 28 may contain one large table or be organized in a different way than illustrated and described without departing from the scope of the present invention. Each table may also include more or fewer data fields than shown. For example, each table may include a data field that indicates that the data of that entry is to be deleted (such as at a later time, or when the database is next updated), a data field that indicates a timestamp associated with the time and date that an entry in that table was last modified, and a data field that indicates that an entry is to be archived (i.e., made read-only). Accordingly, departures may be made from such details without departing from the spirit or scope of applicants' general inventive concept.

### System Functionality

A group practice record may be created such that each user (for example, an employee) within the group practice can use and access the system 10 in accordance with principles of the invention. The group practice may include at least one physician, pre-operative nurse, operative nurse, recovery room nurse, medical assistant, facility manager, billing user, other employees, or combinations thereof, that help maintain the group practice or are involved with endoscopic procedures. Typically, the facility manager or system administrator enters the information about each group practice that includes the basic information associated with facilities, rooms, inventory, equipment, and other information of the group practice in the system 10 using an embodiment of computer 11.

After the group practice has been configured, the users and their information are added. During user configuration, each user is assigned a login, password, and role. The role determines the functionality of the system 10 the user may access. Before a user can access data, or open a screen, the system 10 determines if the role of the user is allowed access. If it is not, the system 10 will prohibit access to that functionality or data. The system 10 provides a user interface for each role using common components and screens. For example, a medical assistant can schedule patient appointments, but cannot add instruments and equipment to the inventory. As another example, a pre-operative nurse cannot edit an endoscopic procedure report, but can add data about a patient's pre-operative assessment that may be used in an endoscopic procedure report. Role based rules for users are established by the system administrator or facility manager and specify the data that users are permitted to view, add, and/or change. The roles may incorporate different classifications such as patients, medical assistants, billing users, scheduling nurses, pre-operative nurses, operative nurses, physicians, recovery room nurses, pathologists, pathology technicians, transcribers, system administrators, facility managers, and other physicians who may wish to access the system 10.

Once the user and group practice information has been established, patients may be enrolled and registered in the system 10. Users generally register patients into the system 10 as they contact the group practice for endoscopic procedure appointments, information, consultations, curiosity, or other reasons. Patients may be scheduled for an appointment then provided access to the system 10 to enter information that hasn't been recorded. In particular, patients that have not been previously registered may be provided a uniform resource locator (URL) link in an e-mail that, when selected, registers the patient. Patients that have already registered may simply be scheduled an appointment.

When an appointment is scheduled, the system 10 typically automatically allocates a facility, room, pre-operative nurse, operative nurse, recovery room nurse, and pathologist to the appointment when the user allocates a physician and time for the appointment. This allocation may be based on one or more free facilities, rooms, pre-operative nurses, operative nurses, recovery room nurses, and pathologists that are available at the time of the appointment. Physicians and the time for the appointment are typically scheduled as requested by the patient.

When the patient arrives at the group practice office on the day of the appointment, the appointment is confirmed. The confirmation materializes the appointment in the calendars of all users involved with the appointment. Various users may also validate patient information and gather any remaining information that may be useful for the endoscopic procedure.

Upon registration, the patient is assigned a unique identification number. The patient may be provided with an RFID chip that includes the unique identification number. In this manner, the system 10 is responsive to detecting the unique identification of the patient through the identification reader 33. For example, users may pass the patient's RFID chip proximate to the identification reader 33 and the system 10 may access a patient's information to display to the user, or allow the user to enter data about the patient. Alternately, the user can navigate through screens presented by the system 10 with the general input devices 32.

Before the actual endoscopic procedure, the patient may undergo a pre-operative assessment. The pre-operative nurse may administer the pre-operative assessment. The pre-operative nurse may also perform a physical exam and enter information associated with medical problems of the patient, home medication of the patient, family and social history of the patient, the range of symptoms of the patient, and otherwise take notes about the patient. The pre-operative nurse may use an embodiment of computer 11 that in electrical communication with the vital signs equipment 42. The computer 11 of the pre-operative nurse may also include the microphone 36 and speaker 46, or a wireless headset. The system 10 may load interfaces that are appropriate to interface with the pre-operative nurse's embodiment of computer 11 for the pre-operative assessment. Before undergoing the endoscopic procedure, the patient will be prompted to sign all required consent forms, which may be scanned into the system 10.

The endoscopic procedure is typically performed by the physician utilizing an embodiment of computer 11 that includes the camera system 38 and electronic switching interface 40. The computer 11 of the physician may also include the microphone 36 and speaker 46, or a wireless headset. The system 10 may load interfaces that are appropriate to interface with the physician's embodiment of computer 11 for the endoscopic procedure. The physician may review the pre-operative assessment and perform a physician's assessment on the patient after discussing the risks of the endoscopic procedure with the patient. The physician may start the endoscopic procedure after the informed consent of the patient. During the endoscopic procedure, the physician may capture video and images with the camera capture system 38 and electronic switching interface 40, respectively. The physician may utilize the computer 11 and dictate comments for transcription, have voiced utterances converted into machine readable input, map images to particular points of reference of organs of the patient, make annotations to captured images, and begin the endoscopic procedure report generation. The physician may also take tissue samples for tissue analysis by a pathology lab. The computer 11 of the operative nurse may also include the microphone 36 and speaker 46, or a wireless headset

During the endoscopic procedure the operative nurse may assist the physician. The operative nurse may utilize an embodiment of the computer 11 that that is in electrical communication with the vital signs equipment 42. The system 10 may load interfaces that are appropriate to interface with the operative nurse's embodiment of computer 11. The operative nurse may utilize the computer 11 to gather patient vital signs data from the vital signs equipment 42, record dictation associated with medication administered to the patient, and convert voiced utterances into machine readable input. The operative nurse may also perform a post-procedure assessment before the patient is transferred to a recovery room. The operative nurse may also generate labels for tissue samples to send to the pathology lab, print pathology requisition forms, and send off the tissue samples for analysis.

After the endoscopic procedure the patient may be provided with time to recover in a recovery room supervised by the recovery room nurse. The recovery room nurse may perform a post-operative assessment, record the final observation of the patient, and discharge the patient. The recovery room nurse may use an embodiment of computer 11 that in electrical communication with the vital signs equipment 42. The computer 11 of the recovery room nurse may also include the microphone 36 and speaker 46, or a wireless headset. The system 10 may load interfaces that are appropriate to interface with the recovery room nurse's embodiment of computer 11 to monitor the patient during discovery. The recovery room nurse may provide the patient with handouts or educational material based on the physician diagnosis, a survey form, and/or a preliminary endoscopic procedure report. Before discharge, the recovery room nurse may contact someone to retrieve the patient and communicate prescriptions to a pharmacy.

After receiving a pathology requisition, the pathology lab analyzes the corresponding tissue sample. The pathologist may be assisted by the pathology technician to analyze the tissue sample. The results of the analysis may be stored by the system 10 in a pathology report. The pathologist may dictate text and associate that text with specific report sections, then send that dictation to be transcribed by the transcriber. The transcriber may transcribe any dictation into the associated section for later review. The pathologist may utilize report templates stored in the system and automatically generate text and/or sections for the pathology report. The pathologist may also utilize a voice recognition functionality of the system 10 to interact with the system 10 and/or generate pathology reports without using general input devices 32.

Before or after the patient has been discharged the physician may generate the endoscopic procedure report. The physician may utilize an embodiment of the computer 11 that includes the microphone 36 and speaker 46, or the wireless headset. The system 10 may load interfaces that are appropriate to interface with the physician's embodiment of computer 11 during endoscopic procedure report generation. The endoscopic procedure report may be generated by the system through templates and include information collected before, during, or after the endoscopic procedure, such as the various assessments, diagnoses, procedure details, images captured during the endoscopic procedure, results of the pathology requisition detailed in the pathology report, and other information the physician feels merits inclusion. The physician may use the computer 11 to dictate text and associate that text with specific report sections, then send that dictation to be transcribed by the transcriber. The transcriber may transcribe the dictation into the associated section for later review. Alternatively, the physician may use the computer 11 to convert voiced utterances into machine readable input. The physician may utilize report templates stored in the system to interface with data gathered before, during, or after the endoscopic procedure and automatically generate text and/or sections for the endoscopic procedure report. When the endoscopic procedure report is approved, it may be faxed to other physicians and stored in the system 10 for later access by users or the patient.

During the endoscopic procedure, or during a medical procedure, it may be desired to record and/or analyze a voice of the user. Thus, the user may make sounds or voiced utterances that include information, commands or other data that can be converted into machine readable input by the computer 11 of the user. For example, and in one embodiment, the physician may activate the electronic switching interface 40, or other external interface, and cause the system to record the physician's voice for about twenty-five seconds. The computer 11 of the physician may receive the voiced utterances and analyze the recorded voice for commands or information to associate with that activation. In one embodiment, the activation of the electronic switching interface 40 causes the system 10 to capture an image from the video stream from the camera system 38 and record the voice from the physician for about twenty-five seconds. As such, the computer 11 may be selectively activated to convert voiced utterances into machine readable input. The system 10 is also configured to provide extra levels of authentication when converting voiced utterances into machine readable input by time stamping the converted machine readable input and repeating back the converted machine readable input for verification by the user.

The system 10 may be configured may be configured to receive the voiced utterances of the user and convert the voiced utterances of the user into machine readable input at substantially any time. In particular, the system 10 may be responsive to quickly provide access to the user and be configured to accept voiced utterances from the user to navigate throughout the system 10, accept voiced utterances of the user and convert them into data, generate text for reports or other documentation from stored data, store information related to medical procedures, interface with various equipment connected to the computer 11, selectively accept voiced utterances of the user in response to actions of the user or interfaces from equipment connected to the computer 11, and monitor data to prevent mistakes, such as determine patient drug allergies, cross reactions with medications, and other drug interactions, among other mistakes.

The patient may be granted access to the system 10 through a patient portal. The patient may use an embodiment of computer 11 to access the system 10. The patient may use the patient portal to update personal information, view educational information about their endoscopic procedure(s), view endoscopic procedure report(s), and schedule future appointments.

With the foregoing overview, specific operations of the system 10 can be discussed in detail. The system 10 that is the subject herein is a web-based enterprise endoscopic procedure management software application. The endoscopic management software application is operable to automatically generate reports, convert voiced utterances into machine readable input, as well as perform management of endoscopic practices and procedures among other things.

The system 10 has been designed to perform on a variety of distribution networks, including a local area network, wide area network, or the Internet. Referring to FIG. 1, the core of the system 10 is a Structured Query Level (SQL) Server 2005 database 28 configured on the database server 26. The database server 26 is configured with a Data Access Layer to communicate with the application server 22. In response to user interaction, the database 28 may be accessed by the application server 22 and data inserted, modified, or deleted.

The application server 22 is configured with a Business Layer to communicate with the web server 18. The Business Layer is comprised of various business objects and entities used in the system 10. The Business Layer is integrated with voice recognition and hardware integration ActiveX controls and communicates with the database 28 by way of the Data Access Layer. The voice recognition ActiveX control is operable to interface with computer 11 and analyze user speech picked up by microphone 36 then convert it into machine readable input, such as text or commands. The voice recognition ActiveX control also includes a “talk-back” feature that relays the last command to the user through the speaker 46 to allow quick correction of errors. The voice recognition ActiveX control is loaded onto computer 11 and may store data in the database server 28 in an asynchronous manner.

The hardware integration ActiveX control interfaces with the camera system 38, electronic switching interface 40, vital signs equipment 42, and other equipment connected to embodiments of computer 11 to allow the user to control that equipment. For example, other equipment connected to embodiments of computer 11 may include x-ray machines, medical pumps, printers, scanners, imaging equipment, or other medical equipment. The hardware integration ActiveX control is loaded onto computer 11 and interfaces with the equipment to store captured data in the database server 28 in an asynchronous manner. A security block in the Business Layer provides access to Business Layer components and the Data Access Layer based on the role of the user (e.g., physicians may access the functionality to stream videos and capture images from an camera system 38, but patients and medical assistants may not). It will be appreciated by one having ordinary skill in the art that various hardware integration ActiveX control interfaces may be provided by the system 10, including one hardware integration ActiveX control for each piece of equipment connected to computer 11. As such, the Business Layer may periodically be provided with new hardware integration ActiveX controls that are associated with new equipment to easily upgrade system capabilities.

The web server 18 is configured to provide a Presentation Layer to the computer 11. The Presentation Layer contains user interface components and is operable to load asynchronous JavaScript and XML (AJAX) components. In this way, the computer 11 may be loaded with an AJAX engine, allowing content from the system 10 to be loaded individually and without waiting for entire components to load or re-load. The AJAX engine is configured to communicate asynchronously with the Business Layer on the application server 22. An Internet browser, such as Internet Explorer 7.0, renders data from the Presentation Layer and AJAX engine on the computer 11 in a web browser. The user may login and be presented with various pages that define the functionality of the system 10 that they may access. The system 10 may load software controls, such as ActiveX controls, AJAX engines, or JAVA run-time environments, on computer 11 in response to user interaction with the system 10. When the user performs an action or data is entered into text boxes, check boxes, menu items, interfaces, controls, or other data collection entities, the data is transmitted to the web server 18 Presentation Layer, which in turn communicates the data to the Business Layer of the application server 22. The Business Layer determines the appropriate action to perform with the data, such as store it in the database 28 or process it and respond through the Presentation Layer. In this way, the user may interact with the system 10. Similarly, when the user interacts with the software controls to load data from the database 28, the Business Layer determines the rule of the user and whether that user is allowed access to that data. When the user is allowed access to that data, it is loaded from the database server 26 to the Business Layer of application server 22 and forwarded to the Presentation Layer of the web server 18. The Presentation Layer formats the data and sends it to the computer 11.

In one embodiment, users access data and the servers 18, 22, and 26 by way of an Internet browser on the computer 11 through an Internet connection that may be anything from a dial-up connection (i.e., a 28k or 56k connection) to a fully secure virtual private network. As such, the servers 18, 22, and 26 may be hosted in a third party hosting facility and operate twenty-four hours a day, seven days a week, and 365 days a year. All data on database 28 may be backed up at the hosting facility daily and taken to a secure site weekly. Whether accessed on a local area network or across the Internet, the system 10 has been designed to use multiple levels of security, from user name, password, and PIN authentication for users, to encryption for data transmission and firewall protection at the place where the servers 18, 22, and 26 are hosted.

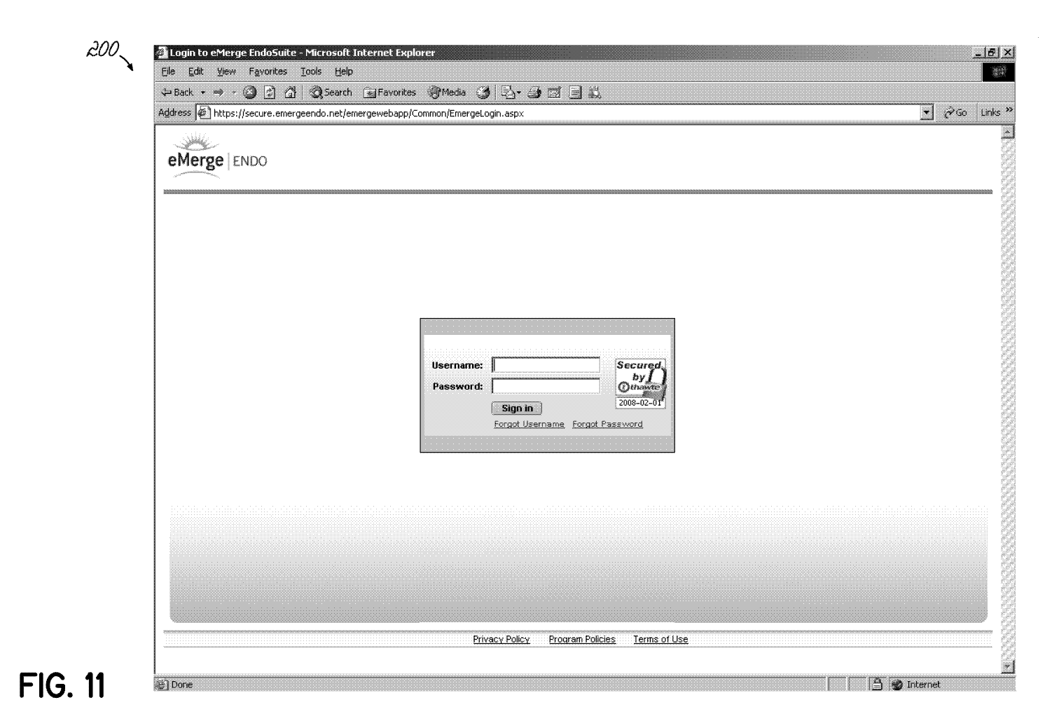

The system 10 is designed to be intuitive to use and based on a process flow that follows various “life cycles” associated with an endoscopic group practice configuration and performance of the endoscopic procedure. Before any functionality can be accessed, the users must login to the system 10. Referring now to FIG. 11, the system 10 has a universal login screen 200 accessed by the user. At the login screen 200, the user must enter their user name, their password, and press enter or select the Sign-In button to log onto the system 10. The system 10 compares the user name and password against information stored in the database 28 and displays a message on the login screen 200 that the login has failed when the username and/or password are invalid.

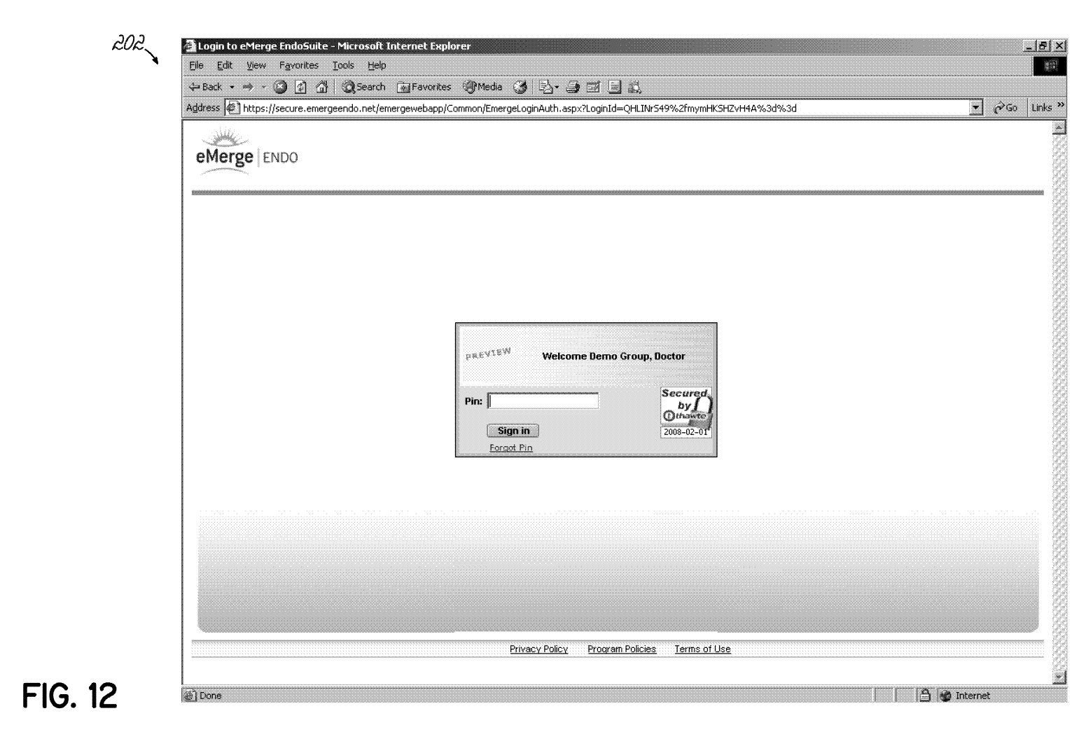

Once the information has been validated, the user is provided a screen to enter their personal identification number (PIN) on a PIN screen 202 illustrated in FIG. 12. In this way, the system 10 provides for a three-level layer of security of username, password, and PIN. When the user enters their PIN and presses enter or selects the Sign-In button to log onto the system 10. The system 10 compares the PIN against information stored in the database 28 and displays a message on the PIN screen 202 that the login has failed when the PIN does not match the username and/or password, or when the PIN is invalid. When the user password and PIN match the user name, that user is directed towards the default page of the role of the user. In some embodiments, patients do not have to enter a PIN to access the system 10.

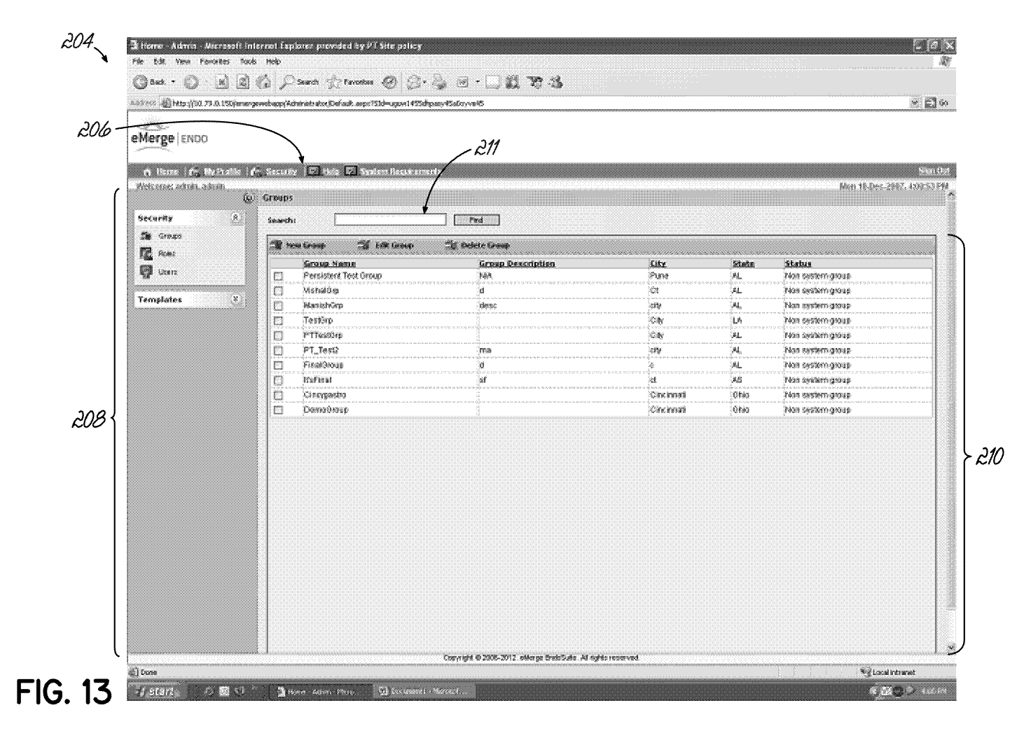

The default user allowed access to initiate configuration of the system 10 for a group practice is the system administrator. FIG. 13 is an illustration of the system administrator default screen 204. The system administrator default screen 204 illustrates four main static components displayed on most system 10 screens: a system menu 206, a user menu 208, a desktop 210, and a search area 211. When the user selects in the system menu 206, the desktop 210 displays that system menu 206 selection's default page. The system menu selection default pages may contain basic information about the user currently logged in, the system 10 itself, a screen to change the user's password, interactive help pages, and the system 10 hardware and software requirements. Each selection in the user menu 208 links to a separate page where a user may perform some function. The user menu 208 groups related components in dropdown menus. When the user selects a dropdown in the user menu 208 followed by a selection in that dropdown, that user menu 208 selection's default page is displayed. As shown in the system administrator default screen, the system menu 208 contains components from which the user may perform functions on the group practices that access the system 10 as well as the roles and users for each group practice. The user may also perform functions on system 10 templates.

The desktop 210 is generally a listing of entries associated with that screen and buttons that enable actions on those entries. One or more entries in each desktop 210 may be highlighted in order to perform a subsequent action on those entities, or an entity may be double selected to open. For example, as shown in the system administrator default screen 204, any entry may be edited by double clicking on that entry, or selecting the entry then selecting the Edit Group button. One or more entries may be selected and deleted by subsequently selecting the Delete Group button.

The search area 211 is incorporated into screens that include the desktop 210. The search area 211 may include a text search bar in which the user may enter text and search through entries in the desktop 210 for entries with that text. The search bar may also include filters with dropdown menus to filter entries in the desktop 210 by various associated data. The search bar may also include an Advanced Search button. By selecting the Advanced Search button, a new window appears to perform an advanced search. The system administrator default screen 204, though specific to the system administrator, demonstrates the general components that may be viewed by users of the system 10.

The system 10 is configured with multiple levels of administrative control that are responsive to the roles of users. For example, when users are associated with roles that are denied access to data or portions of the system 10, links corresponding to that data or portion may be removed, presented in shadow, or otherwise blocked. As such, the administrative controls permit each role some portion of control over the data stored in the database.

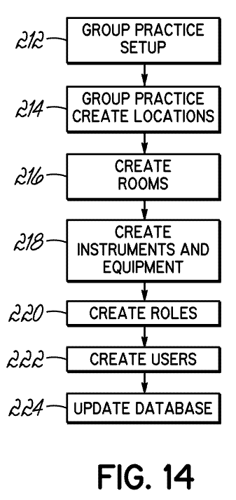

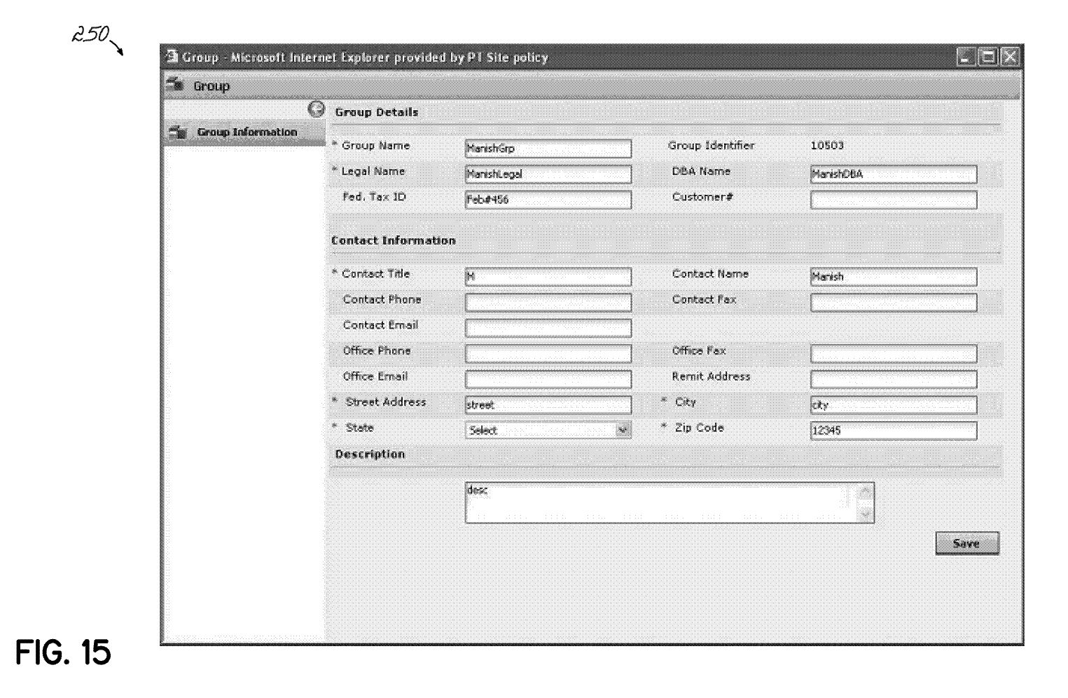

FIG. 14 is a general illustration of one configuration of a group practice. In block 212, the user (i.e., system administrator) may configure a group practice. The system administrator has a pre-defined role that allows them to add the group practice, user, and user role data maintained by the system 10. Referring to FIG. 13, the user may create at least one group practice by selecting the New Group button on the system administrator default screen 204. FIG. 15 is an illustration of the new group screen 250 that appears for the user to configure the group practice. From the new group screen 250, the user may enter information corresponding to the group practice's group name, legal name, Doing-Business-As (DBA) name, federal tax identification, and customer number. From the new group screen 250, the user may also enter contact information for the group practice, including at least one of the following: a contact title, a name of the contact, a phone number of the contact, a fax number of the contact, an email of the contact, an office phone of the contact, an office fax number of the contact, an office email of the contact, an address to remit correspondence, a street address of the contact, a city of the contact, a state of the contact, and a zip code of the contact. From the new group screen 250, the user may further enter a brief description about the group practice. The user may complete the data fields on the new group desktop 250 and select the Save button to create the group practice. Group practice data is saved in the Groups Table 52. Referring back to FIG. 13, the user may edit or delete a group practice by selecting that group practice on the system administrator default screen 204 desktop 210 and selecting the Edit Group or Delete Group buttons, respectively. After creating the group practice, the user may create a facility administrator for a group practice by selecting the “User” link in the “Security” dropdown in the user menu 208 and adding the facility manager.

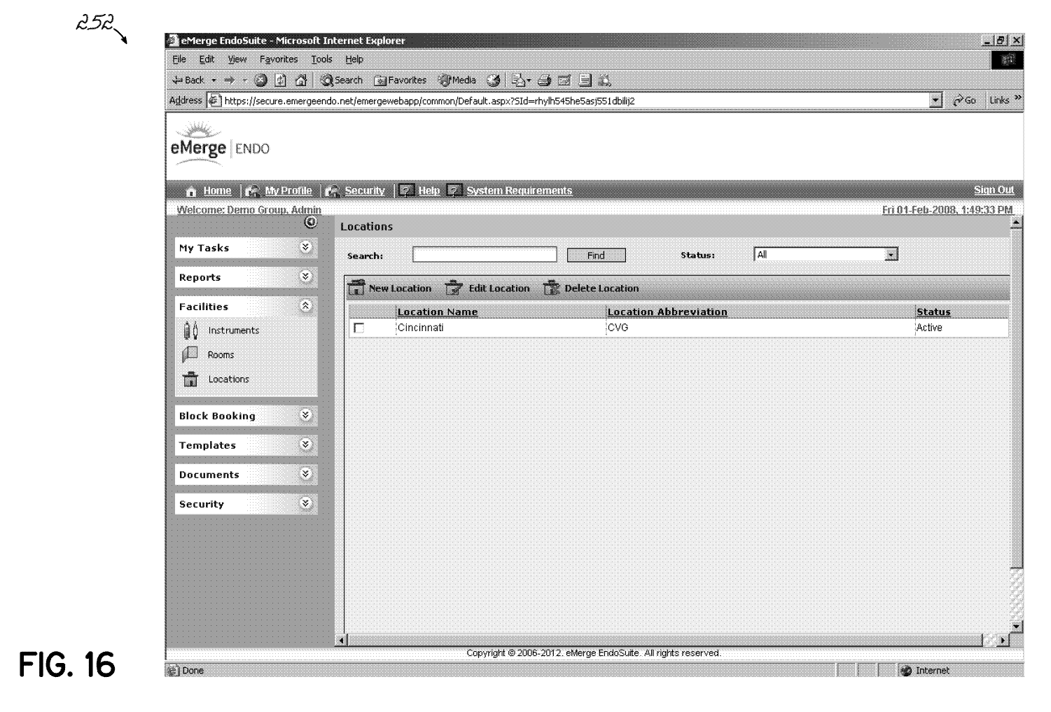

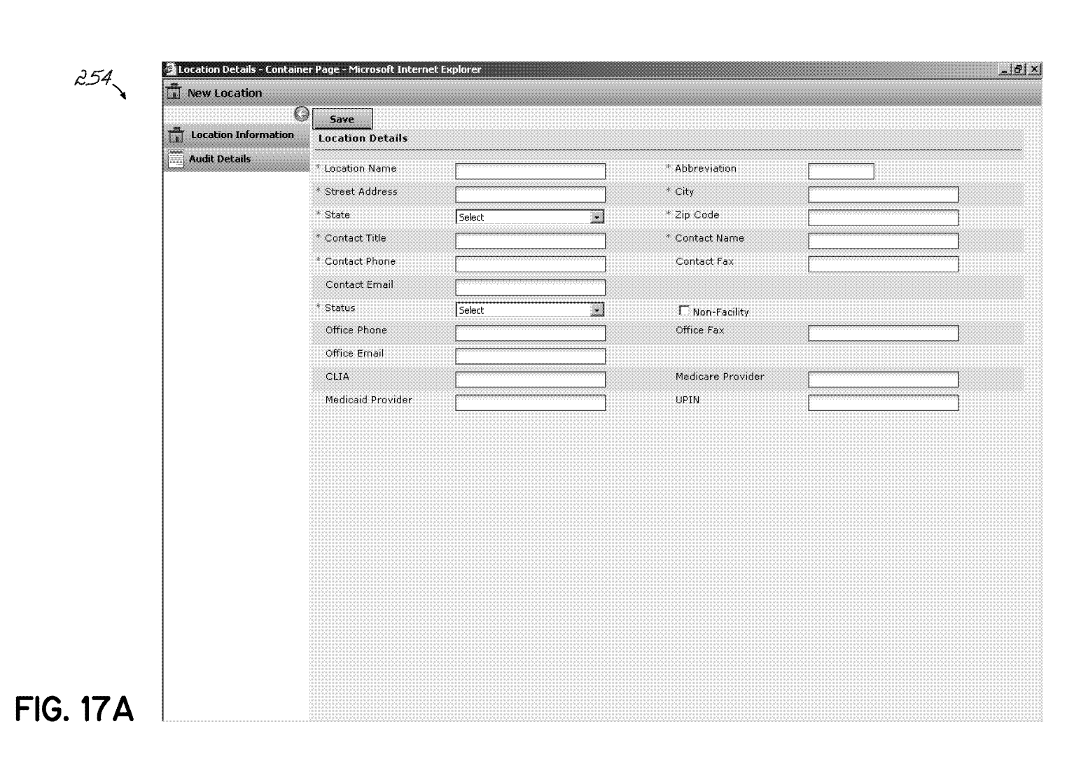

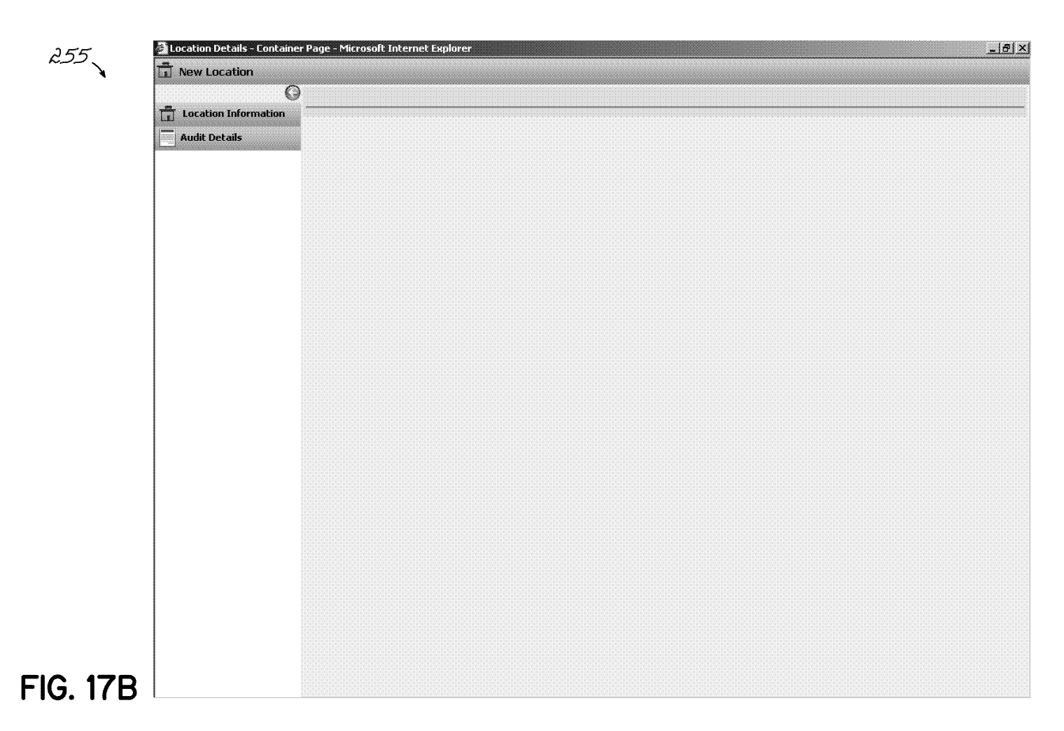

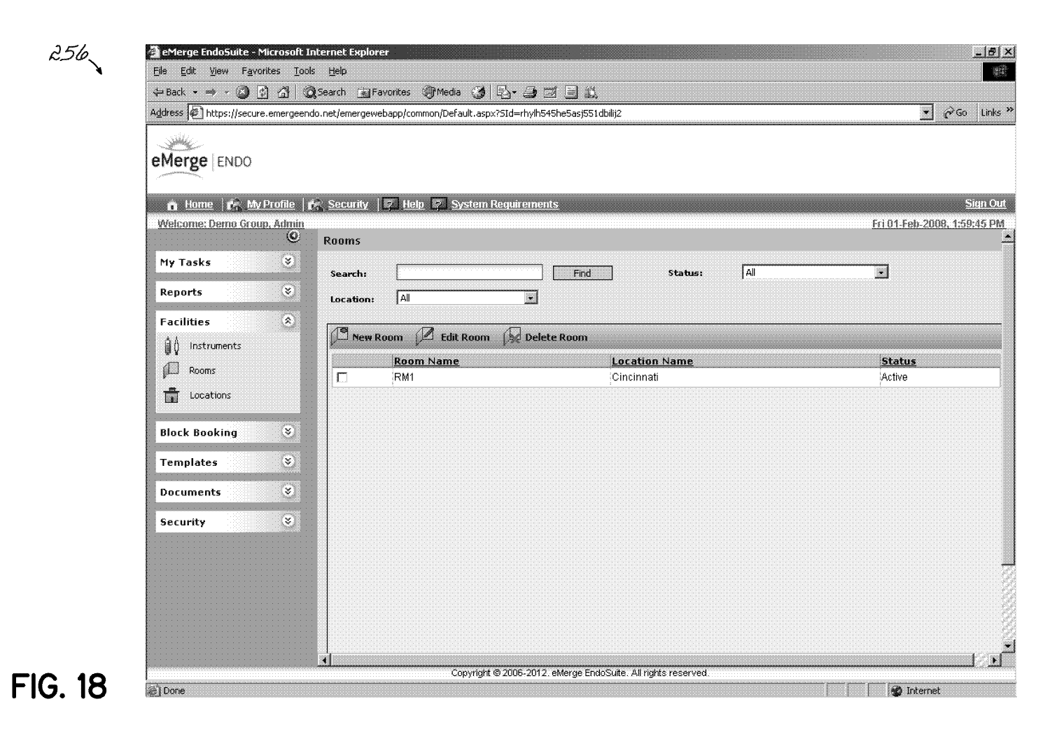

Once a facility manager has been created, the facility manager may configure facilities for each group practice in block 214. FIG. 16 is an illustration of the location screen 252 accessible by a user (i.e., facility manager) by selecting the “Facilities” link from the “Facilities” dropdown in the user menu 208. The user may create a new location (or facility) for the group practice by selecting the New Location button. FIG. 17A is an illustration of a new location desktop 254 that appears for the facility manager to configure a new location for the group practice. From the new location desktop 254, the user may enter information about the location of the group practice, including at least one of the following: a location name, an abbreviation for the location, a street address for the location, a city for the location, a state of the location, a zip code of the location, a contact title for the location, a contact name for the location, a contact phone number for the location, a contact fax for the location, a contact email for the location, and a status of the location, including whether it is a non-facility (i.e., whether it is a facility that does not perform medical procedures). On the new location desktop 254, the user may also enter information about an office phone number, an office fax number, and an office email of the location. From the new location desktop 254, the user may also enter information about the Clinical Laboratory Improvement Act and its relation to the location, the Medicare provider for the location, the Medicaid provider for the location, and the unique physician identification number or numbers for the location. The user may complete the data fields on the new location desktop 254 and select the Save button to create the group practice facility location. Facility data for the group practice is saved in the Facility Tables 58. FIG. 17B is an illustration of a location audit details screen 255 that appears when the user selects the “Audit Details” selection. Each audit details screen contains information about the creation, deletion, or modification of any data field associated with that function. In the illustrated screen, the location audit details screen 255 contains information associated with the creation, deletion, or modification of locations for a group practice. In this particular location audit details screen 255 no location has been created (since the New Group button was chosen), and thus there are no audit details. Referring back to FIG. 16, the user may edit or delete a location by selecting the location on the location screen 252 desktop 210 and selecting the Edit Location or Delete Location buttons, respectively.

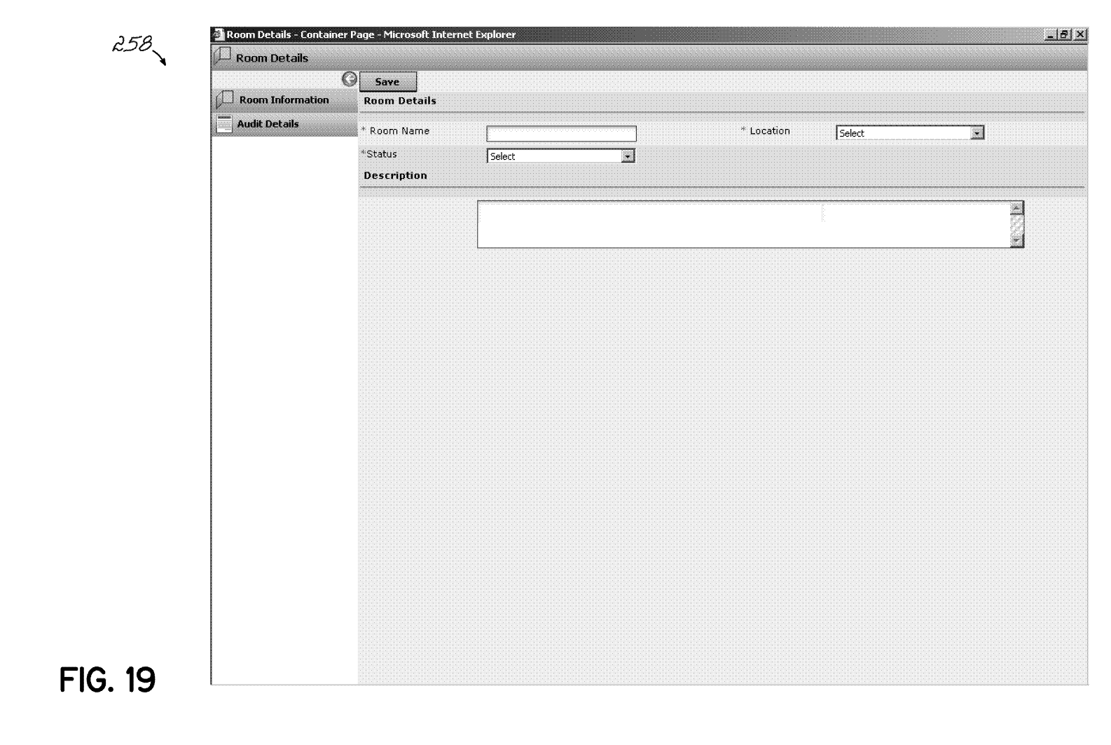

Referring back to FIG. 14, after a facility location has been created, the user may configure rooms for each group practice in block 216. FIG. 18 is an illustration of a rooms screen 256 accessible by the facility manager by selecting the “Rooms” link from the “Facilities” dropdown in the user menu 208. The rooms screen 256 allows the user to create rooms at the location of the group practice by selecting the New Room button. FIG. 19 is an illustration of a room creation screen 258 that appears for the user to configure a new room for a location of the group practice. From the room creation screen 258, the user may enter information, including at least one of the following: a room name, a location of the room, a status of the room, and a brief description of the room. The user may complete the data fields on the room creation screen 258 and select the Save button to create the room. Room data is saved in the Facility Tables 58. Referring back to FIG. 18, the user may edit or delete a room by selecting the room on the rooms screen 256 desktop 210 and selecting the Edit Room or Delete Room buttons, respectively.

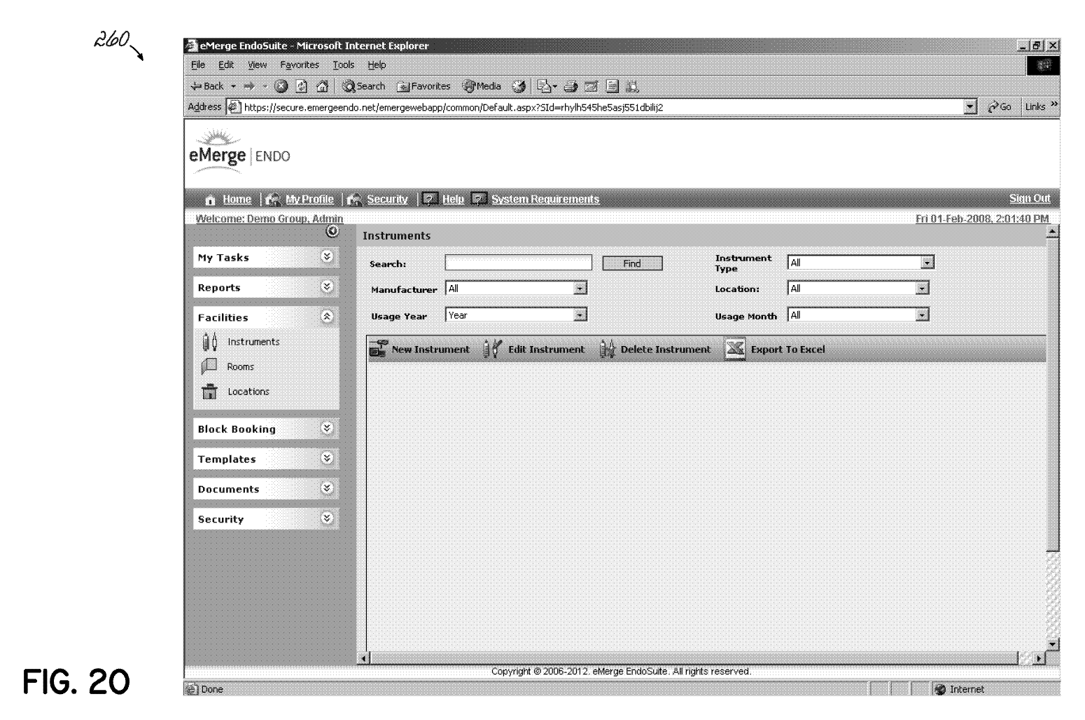

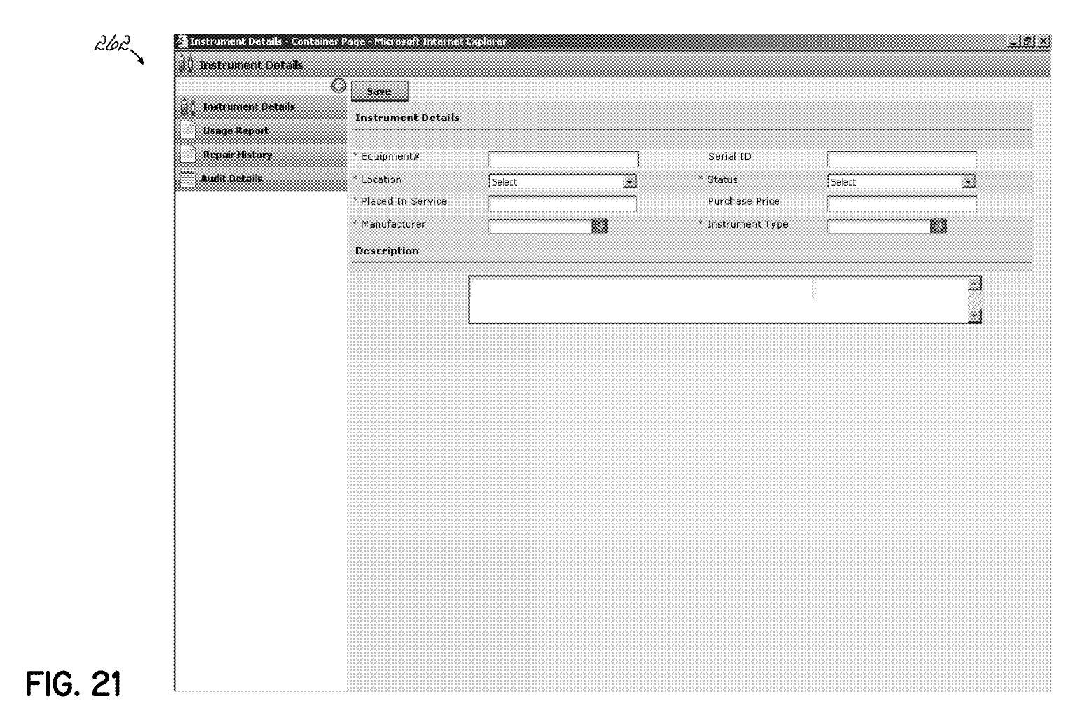

Referring back to FIG. 14, once a room has been created, the user may configure instruments and equipment for each location in block 218. FIG. 20 is an illustration of an instruments screen 260 accessible by the facility manager by selecting the “Instruments” link from the “Facilities” dropdown in the user menu 208. The user (i.e., facility manager) may create instruments or pieces of equipment by selecting the New Instrument button. FIG. 21 is an illustration of an instrument creation screen 262 that appears for the user to configure a new instrument or piece of equipment. The instrument creation screen 262 provides components for the user to configure the details of an instrument or piece of equipment as well as view and update the usage history of an instrument or piece of equipment, the repair history of an instrument or piece of equipment, and view the audit details of the data associated with an instrument or piece of equipment. From the instrument creation screen 262, the user may enter information about the equipment, including at least one of the following: a serial identification number, a location of the equipment (including a room for the equipment), a status of the equipment, when the equipment was placed in service, a purchase price of the equipment, a manufacturer of the equipment, and an instrument type of the equipment. The user may also configure the status of the instrument or piece of equipment by adjusting the status of the instrument or piece of equipment and text associated with its status change in the “Description” text box. The facility manager may complete the data fields on the new instrument creation screen 262 and select the Save button to create the instrument or piece of equipment. Instrument or equipment data is saved in the Facility Tables 58.

The system 10 automatically tracks the usage of an instrument or piece of equipment. As the instrument or piece of equipment is used, the system 10 increments a counter and stores data associated with the amount of time the instrument or piece of equipment was used, the status of the instrument or piece of equipment after use, and the procedure the instrument or piece of equipment was used for. This information is displayed by the system 10 in an instrument usage report that the user may view by selecting the “Usage Report” selection on the new instrument creation screen 262. Similarly, the system 10 tracks the repair history of a piece of equipment. This information is stored by the system 10 and may be displayed an instrument repair history report that the user may view by selecting the “Repair History” selection on the new instrument creation screen 262. The instrument usage report and instrument repair history report are inaccessible in the screen 262 illustrated in FIG. 21 because the user choose to create a new instrument or piece of equipment, which leaves those reports blank.

Referring back to FIG. 20, the facility manager may edit or delete an instrument or piece of equipment by selecting that corresponding entry on the instrument screens 260 desktop 210 and selecting the Edit Instrument or Delete Instrument buttons, respectively. The facility manager may also export a list of selected instruments and equipment to an Excel spreadsheet by selecting those corresponding entries on the instrument screen 260 desktop 210 and selecting the Export to Excel button.

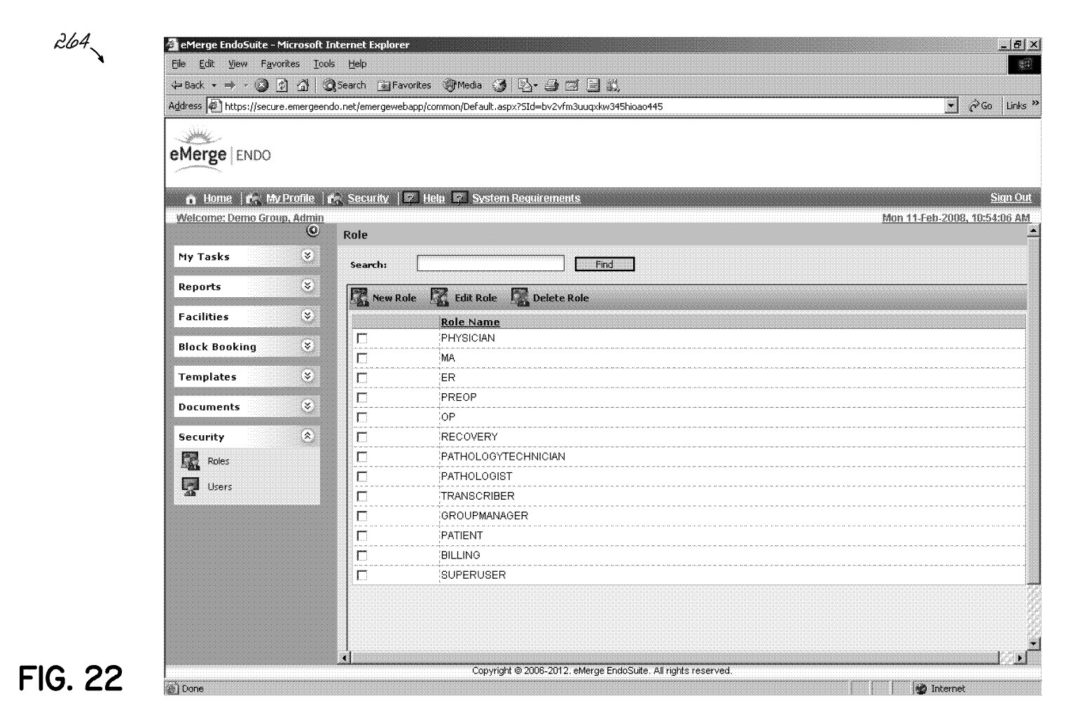

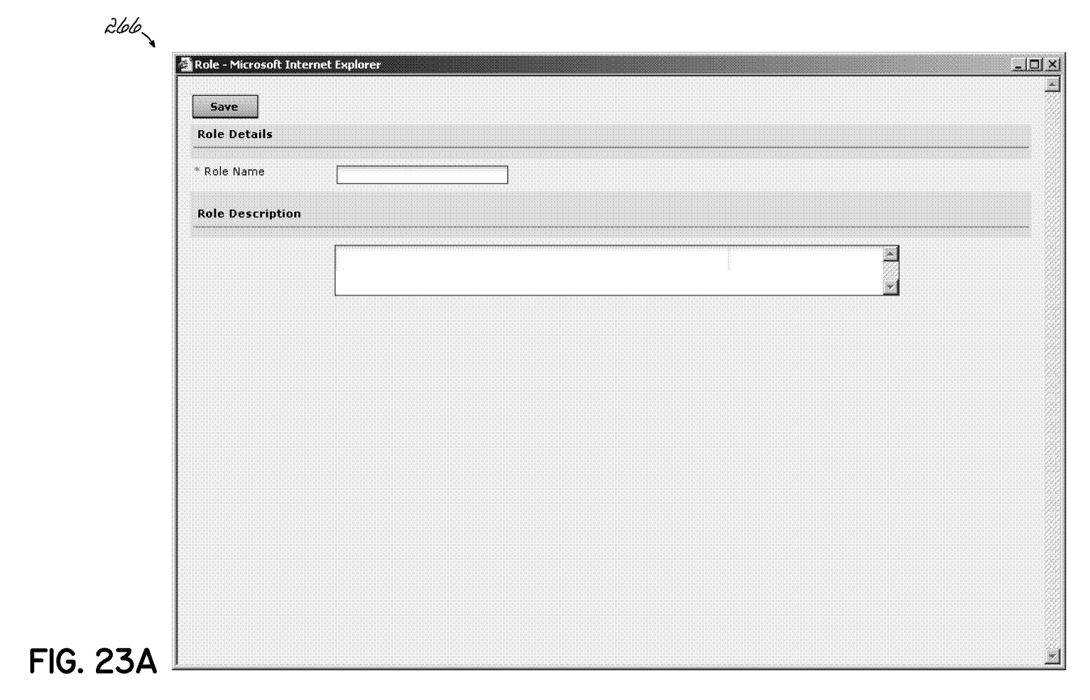

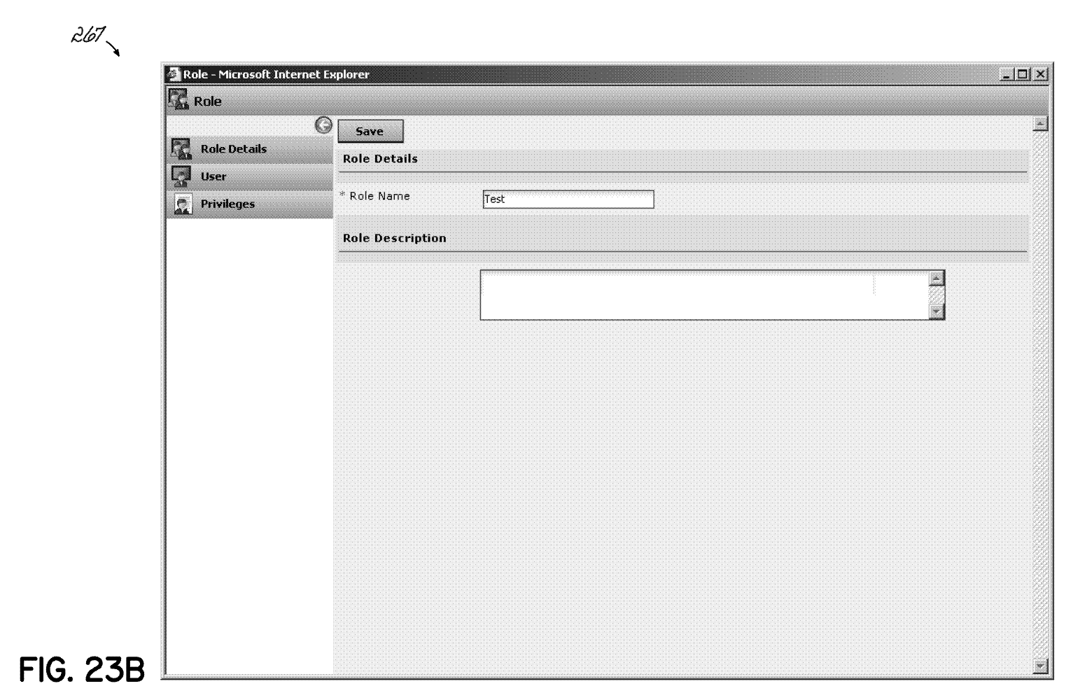

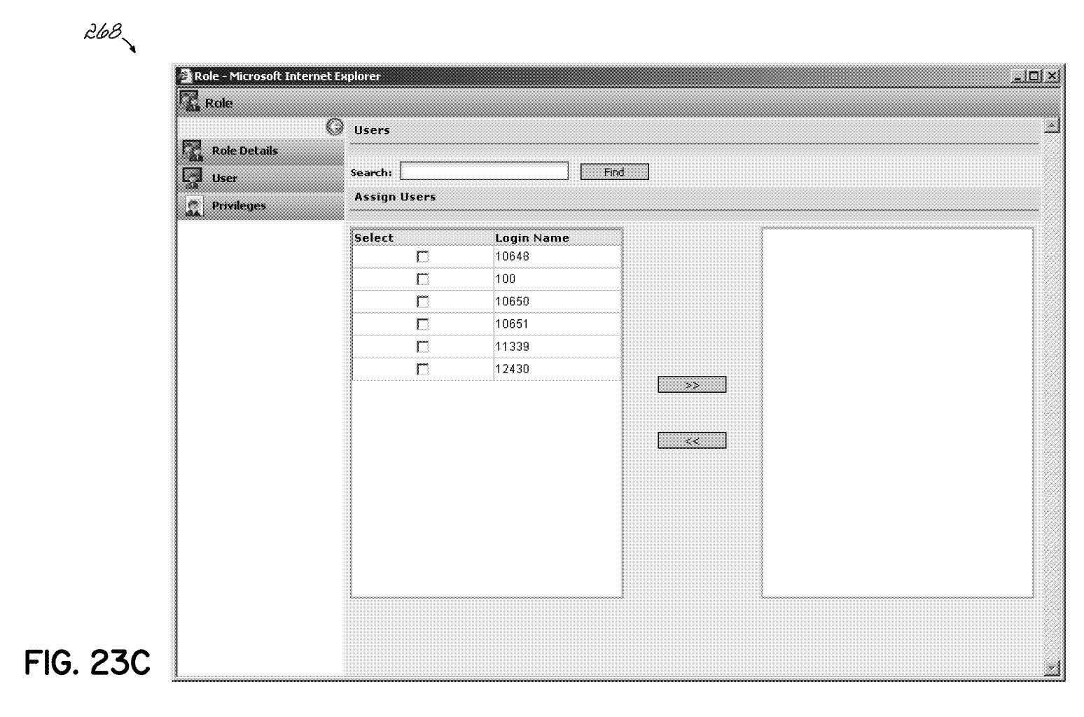

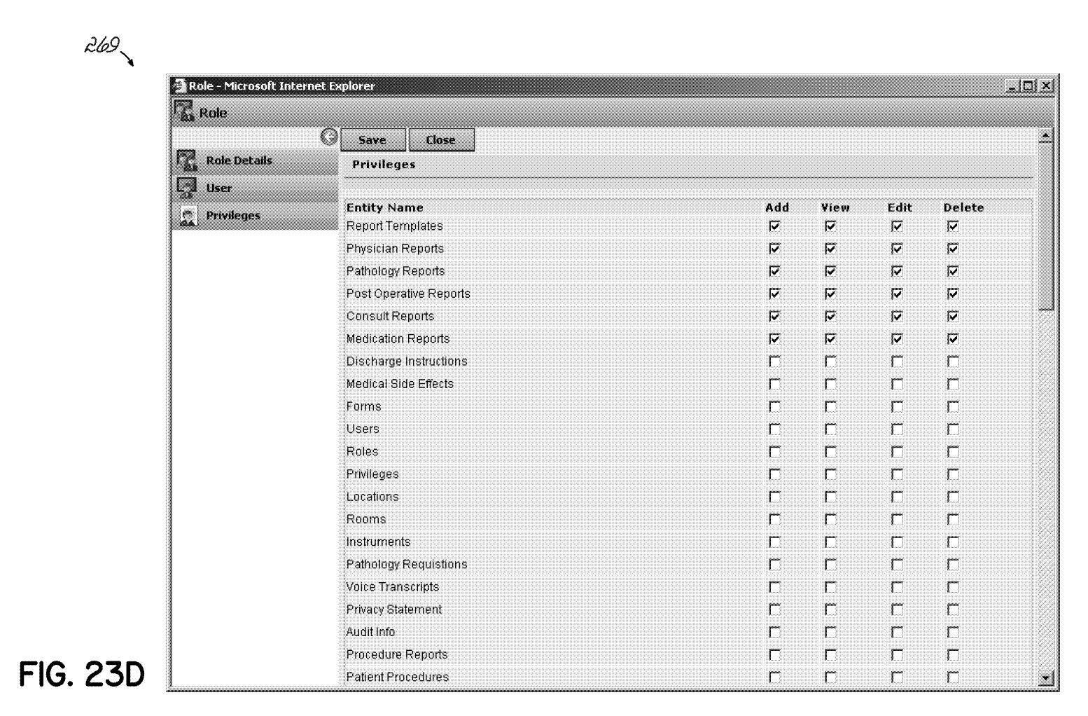

The system 10 controls access to various components by providing access to the user based on their role. Referring back to FIG. 14, each role has some level of access to the system 10 that is configured by the system administrator or the facility manager in block 220. The system administrator initially configures the role of the facility manager, but thereafter roles are configured by the system administrator or facility manager. FIG. 22 is an illustration of a role screen 264 accessible by a user (i.e., the system administrator or facility manager) by selecting the “Roles” link in the “Security” dropdown of the user menu 208. The user may create a new role by selecting the New Role button. FIG. 23A is an illustration of a role creation screen 266 that appears for the user to configure a role. From the role creation screen 266, the user may enter information corresponding to the role name and a brief description of the role. The user may complete the data fields on the role creation screen 266 and select the Save button to create the new role.

Referring back to FIG. 22, once a role is created the user may edit the role by selecting the role from the role screen 264 desktop 210 and selecting the Edit Role button. FIG. 23B is an illustration of a role editing screen 267 that appears for the user to edit the basic data of the role. FIG. 23C is an illustration of a role assignment screen 268 that may be selected by selecting the “User” selection shown in FIG. 23B. The role assignment screen 268 provides components for assigning or removing users from the role. The user may search for other users with the search function displayed at the top of the role assignment screen 268. FIG. 23D is an illustration of the privileges selection screen 269 that may be selected by selecting the “Privileges” selection shown in FIG. 23B. The privileges selection screen 269 provides components for assigning or removing privileges to roles, including assigning or removing specific rights of specific privileges. Thus, the user may configure privileges of roles on the privileges selection screen 269 to include adding, viewing, editing or deleting at least one of the following: report templates, physician reports, pathology reports, post-operative reports, consult reports, medication reports, discharge instructions, medical side effects, forms, users, roles, groups, privileges, locations, rooms, instruments, pathology requisitions, voice transcripts, privacy statements, audit information, procedure reports, patient procedures, tasks, reports, digestive disorders, procedure notes, calendars, appointments, group logos, billing reports, other physicians, dashboards, faxes, recovery dashboards, home medications, other data, profiles, allergies, family histories, patient visit histories, patient scheduled visits, demographics, family details, insurance information, patient employment details, primary and referring physicians, problem lists, procedures, pre-operative assessments, physical complaints, medical histories, consent forms, notes on operative assessments, notes on pre-operative assessments, notes on physician assessments, vital signs, procedural medications, post anesthesia assessments, procedure videos, image mappings, image annotations, recalls, system reviews, physician assessments, medical prescription education materials, post procedure assessments, recovery room data, recall histories, role user mappings, role privilege mappings, and block bookings.

In FIGS. 23A through 23D the user may save privilege data by selecting the Save button. Role data is saved in the User Tables 54.

Referring back to FIG. 22, the user may edit or delete a role by selecting the role on the role screen 264 desktop 210 and selecting the Edit Role or Delete Role buttons, respectively.

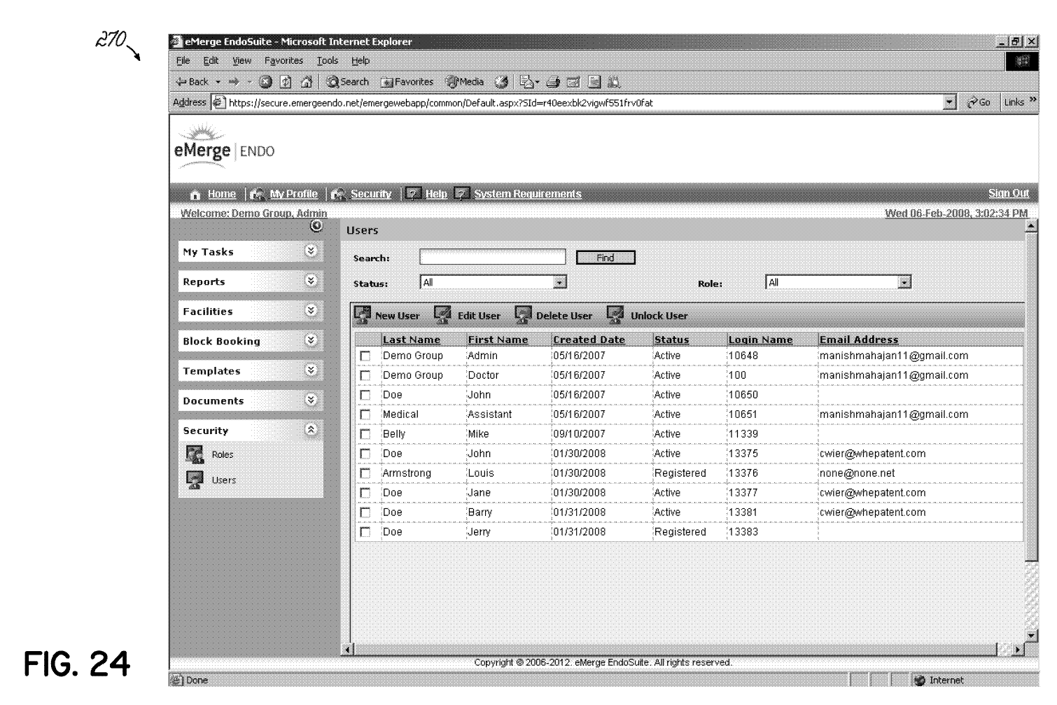

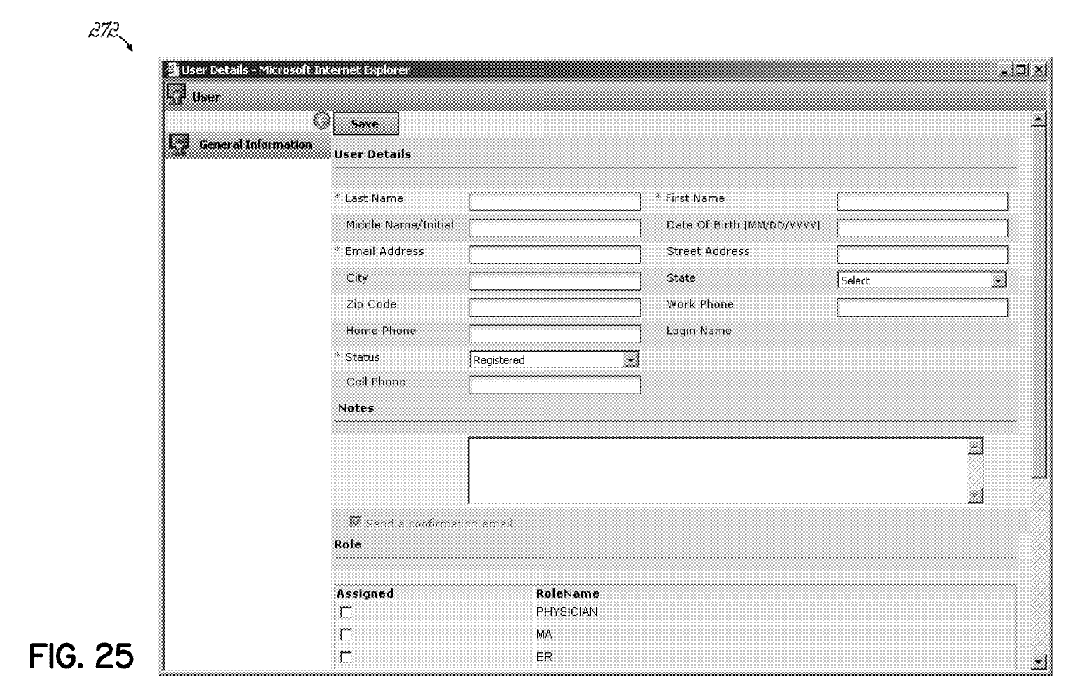

Referring back to FIG. 14, users are added to the system 10 by the system administrator or the facility manager in block 222. FIG. 24 is an illustration of a users screen 270 accessible by the system administrator or facility manager by selecting the “Users” link from the “Securities” dropdown in the user menu 208. The system administrator or facility manager may create a new user by selecting the New User button. FIG. 25 is an illustration of a user creation screen 272 that appears for the system administrator or facility manager to configure a new user. The system administrator or facility manager may assign a role to the user by checking a role for the user on the user creation screen 272. From the user creation screen 272, the system administrator or facility manager may enter information including at least one of the following: the user's last name, first name, middle name or middle initial, date of birth, email address, street address, city, state, zip code, work phone, home phone, their status (including whether they are registered or unregistered), their cell phone, and notes about the user. From the user creation screen 272, the system admin or facility manager may also assign the user a role. The system administrator or facility manager may complete the data fields on the user creation screen 272 and select the Save button to create the user. User data is stored in the User Tables 52. Referring back to FIG. 24, the system administrator or facility manager may edit or delete a user by selecting the user on the user screen 270 desktop 210 and selecting the Edit User or Delete User buttons, respectively.

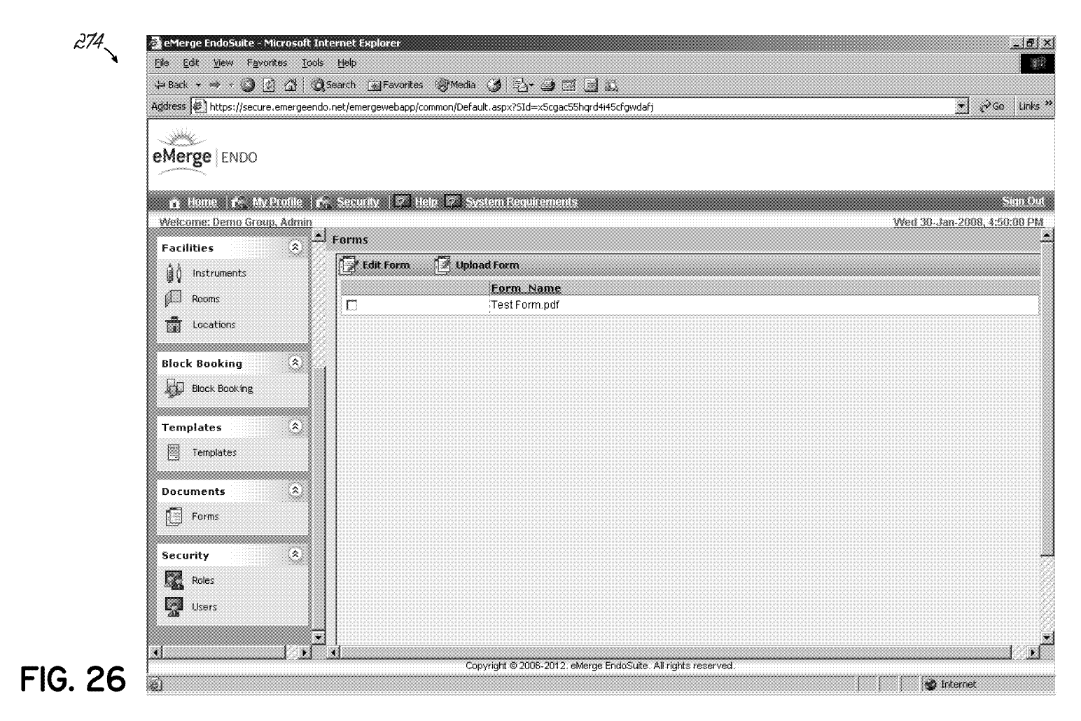

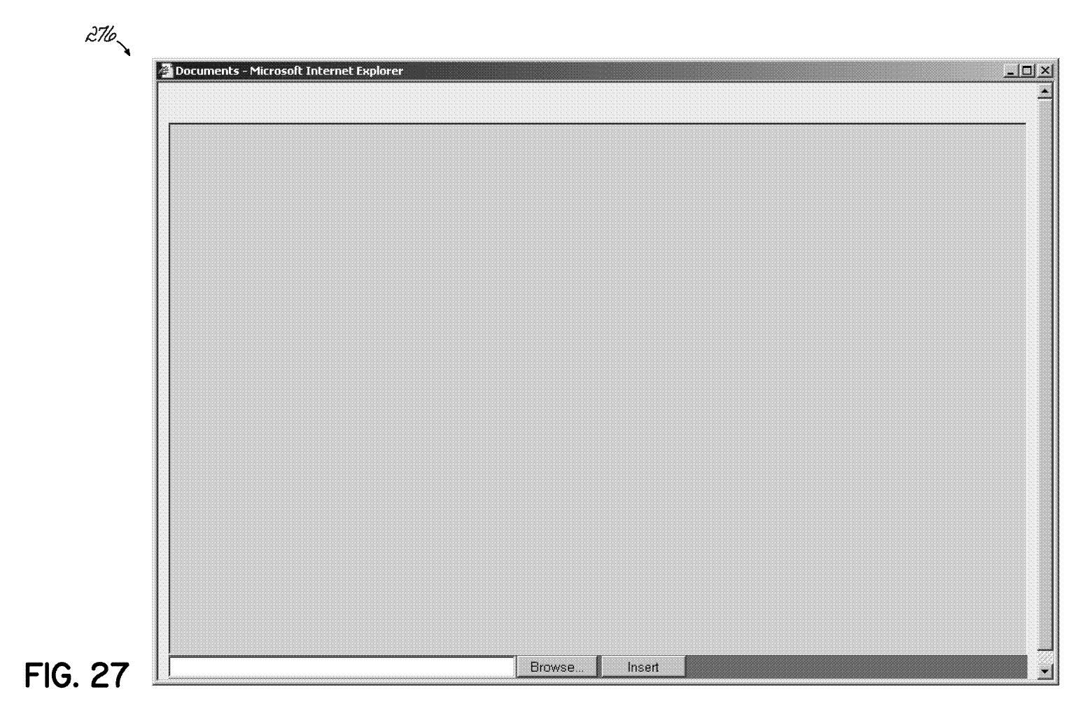

Referring back to FIG. 14, the user may update data in the database 28 in block 224. Typically, the user will upload various forms to the Forms Table 194. FIG. 26 is an illustration of a forms screen 274 accessible by the user by selecting the “Forms” selection from the “Documents” dropdown in the user menu 208. The user may upload a document by selecting the Upload Form button. FIG. 27 is an illustration of the form upload screen 276 that appears for the user to upload a document. The form upload screen 276 provides a standard Microsoft Windows control to browse the computer 11 and the networked devices in communication with computer 11 for the document by selecting the Browse . . . button. Once the document has been selected, the document is uploaded to the system 10 by selecting the Insert button. Documents that may be uploaded include consent forms (signed or unsigned), educational material, care instructions, prescriptions, or other documents useful to the group practice.

In block 224, the user may also update menu items in the Dropdown Lookup Table 184, edit the CPT codes in the CPT Code Lookup Table 178, edit the ICD codes in the ICD Code Lookup Table 180, edit FDA approved drugs in the FDA Drugs Table 182, or otherwise update information in the database 28 by directly accessing the database 28.

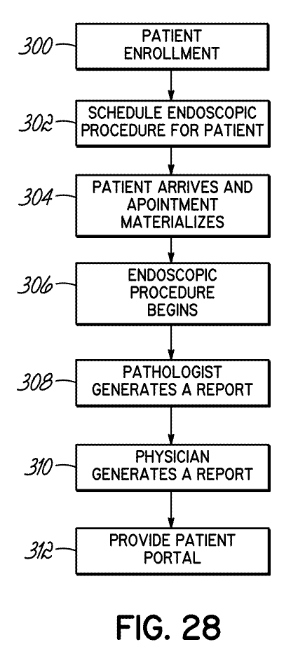

After the group practice has been configured, patients may be registered in the system. FIG. 28 is a diagrammatic illustration a process flow that follows the patient through registration and the endoscopic procedure, as well as providing patients with a patient portal to view endoscopic treatment information.

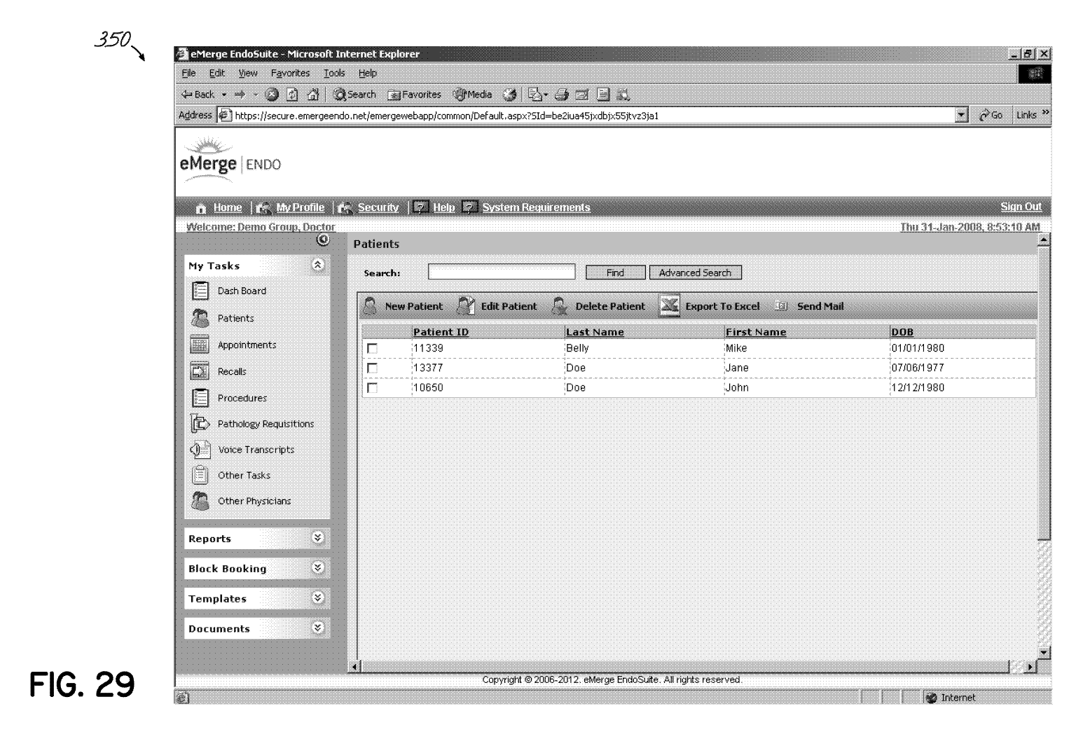

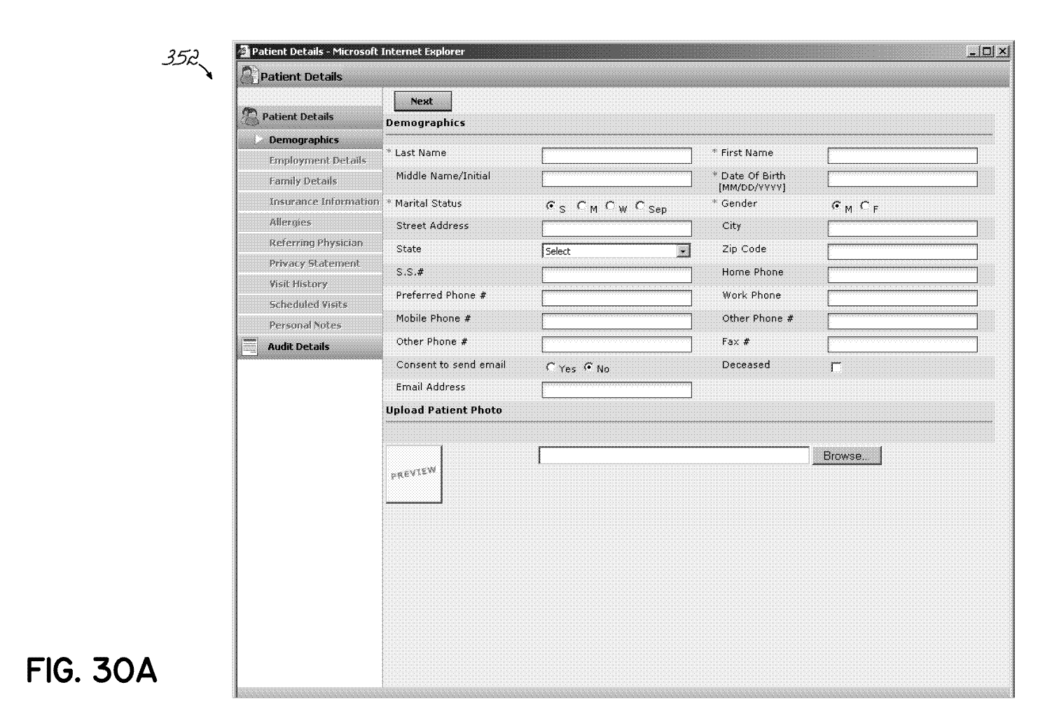

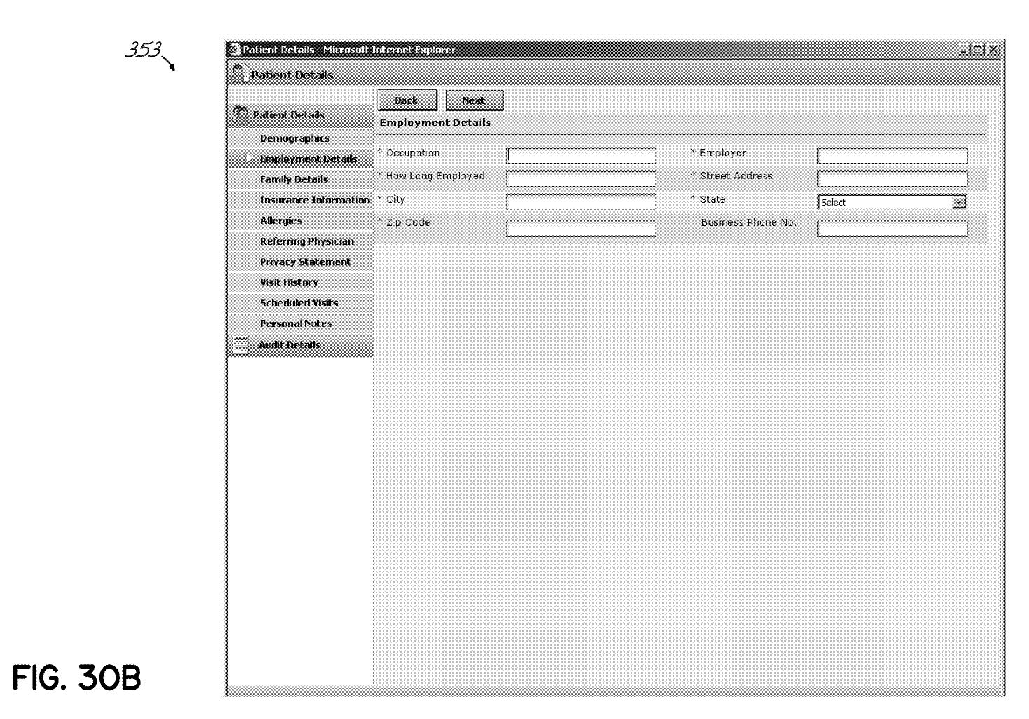

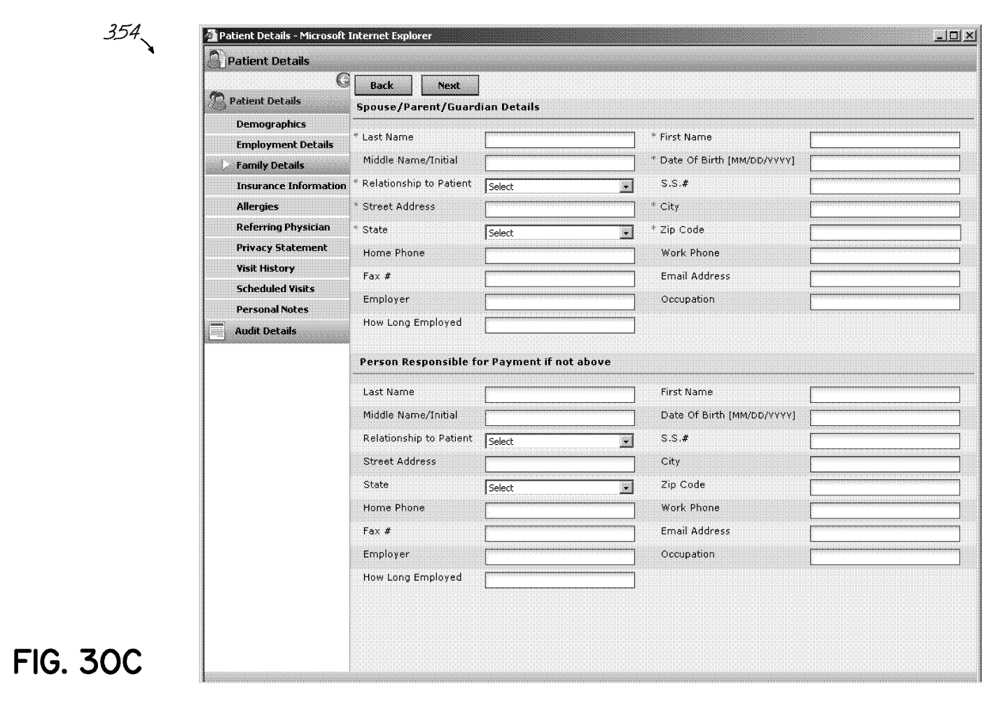

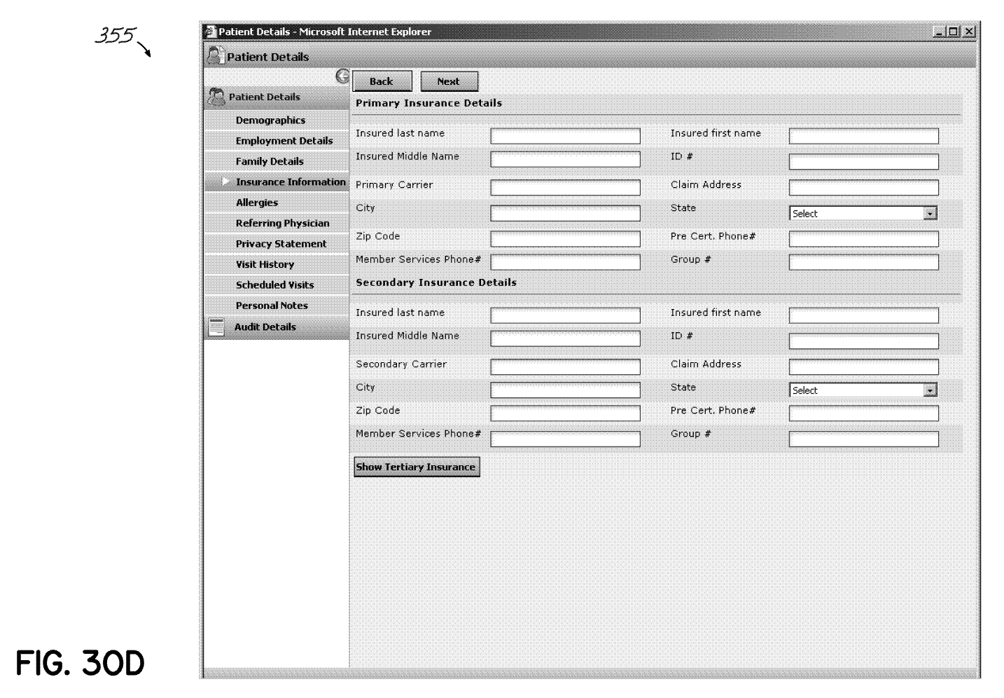

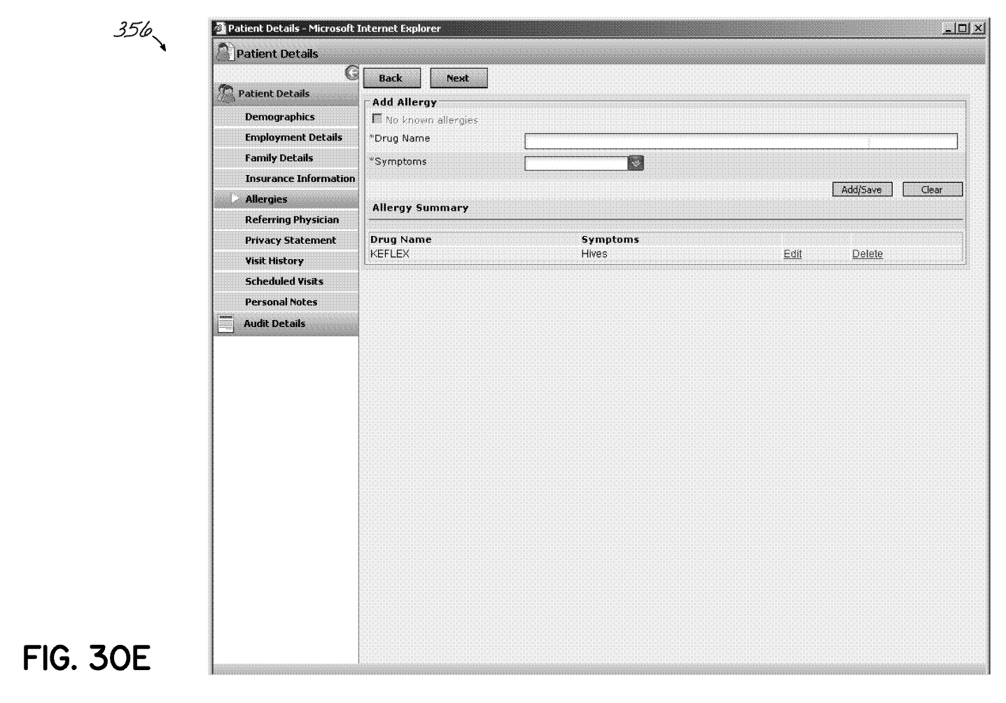

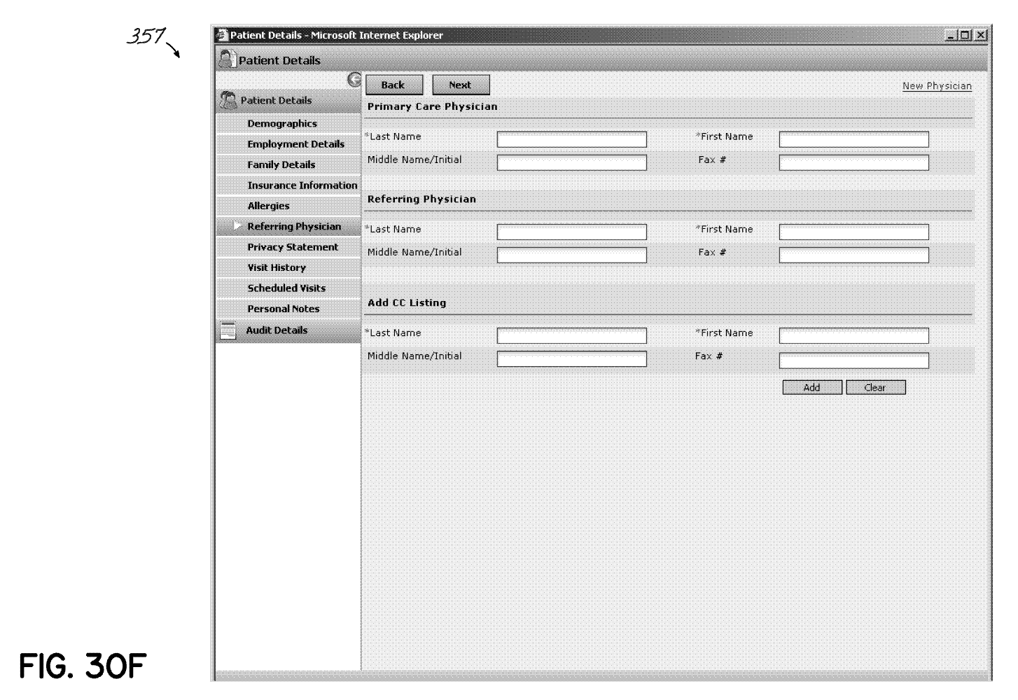

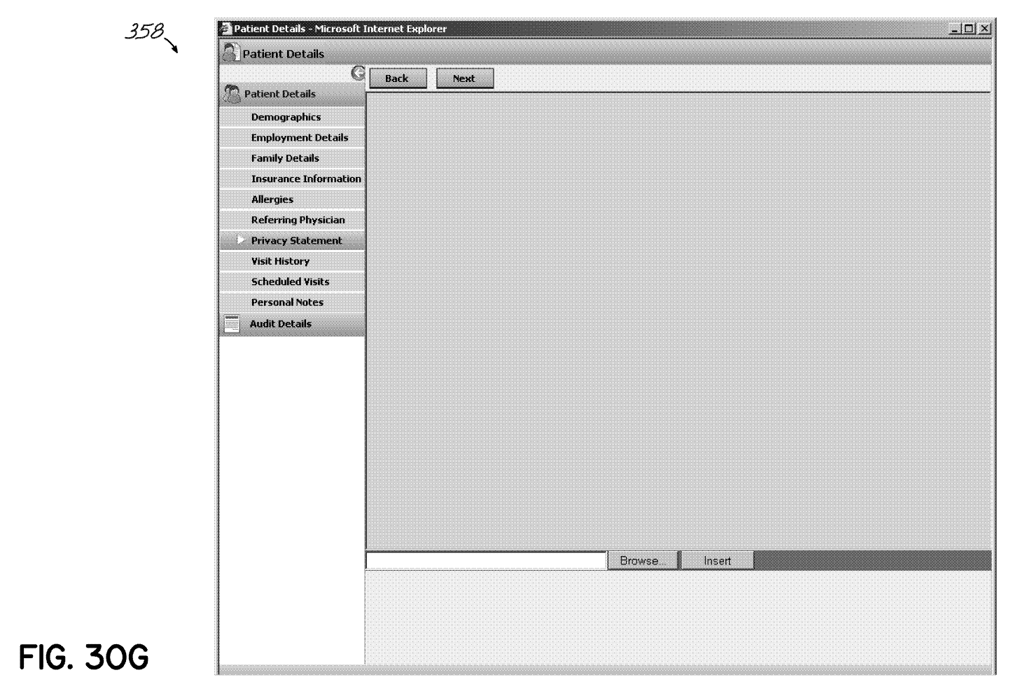

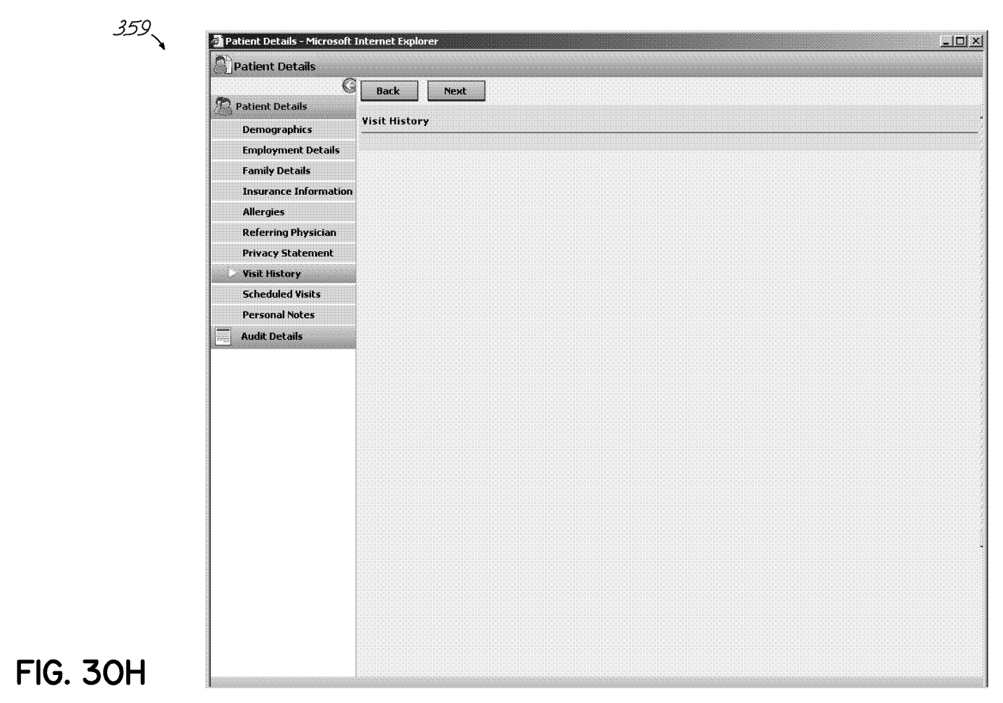

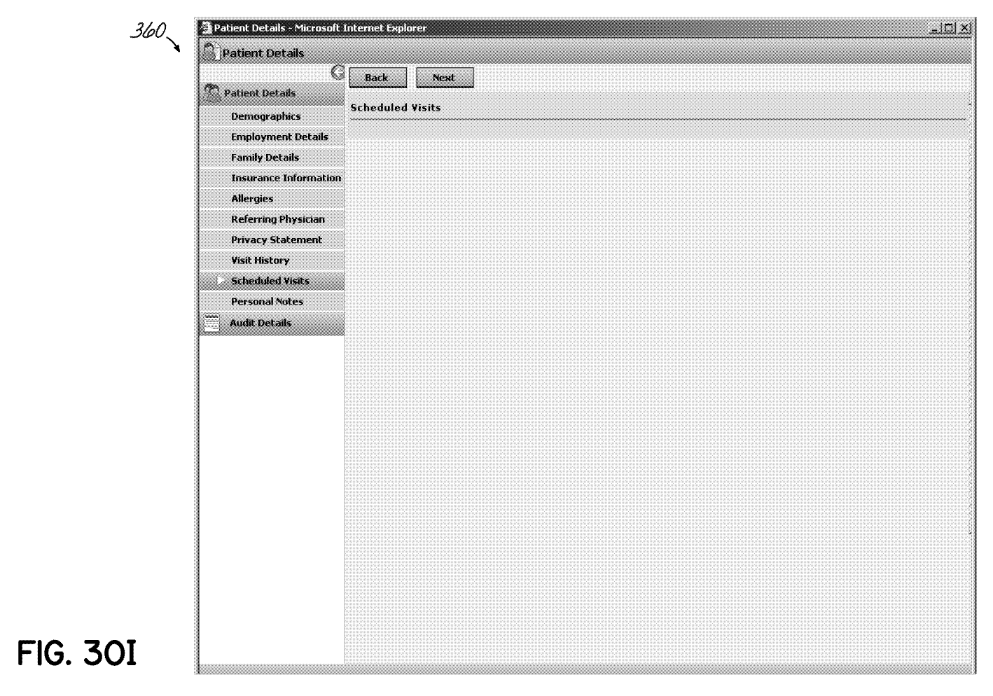

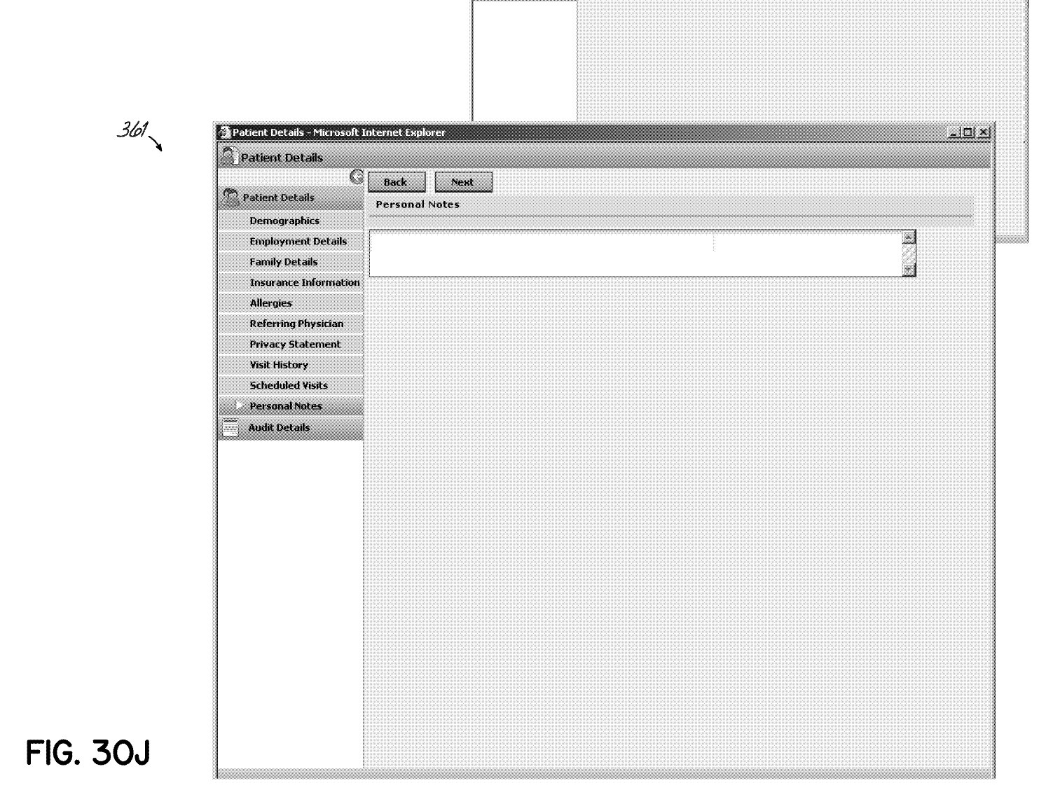

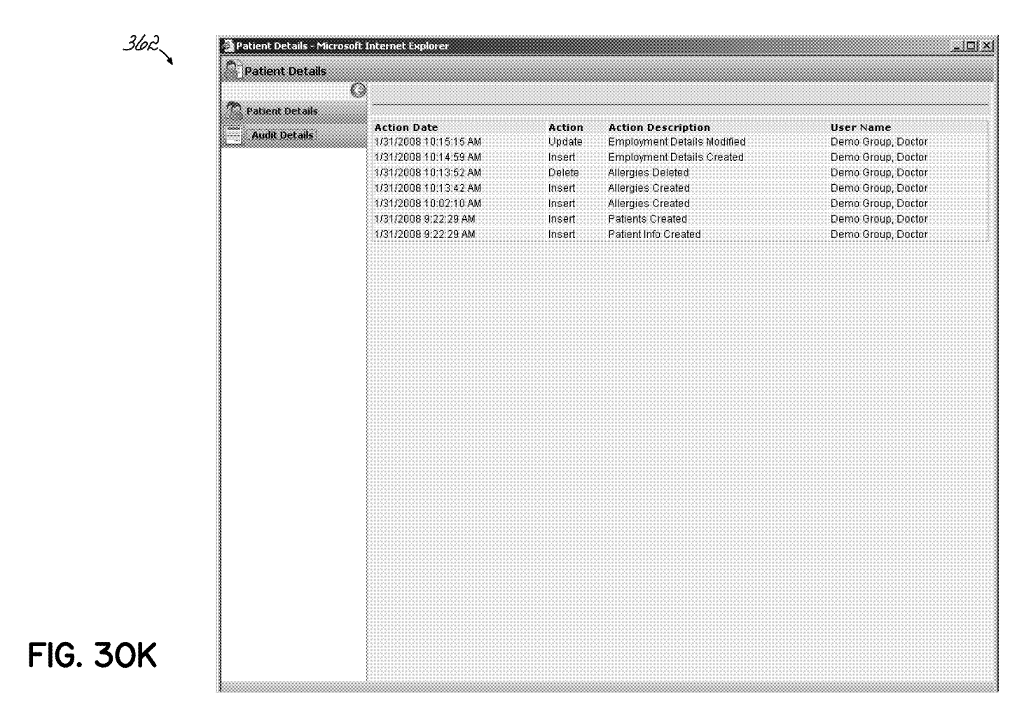

In block 300, a patient may contact a location of the group practice to schedule an endoscopic treatment or an endoscopic procedure. During this inquiry, the patient may be in contact with a user of the system 10 (i.e., the medical assistant, various nurses, or physician) that has authority to add patients. FIG. 29 is an illustration of a patient management screen 350 that the user views after selecting the “Patients” link in the “My Tasks” dropdown in the user menu 208. The user may create a new patient by selecting the New Patient button. FIG. 30A is an illustration of a patient creation screen 352 that appears for the user to configure a new patient by inputting basic patient demographics. From the patient creation screen 352, the user may enter information about the patient, including at least one of the following: the patient's last name, first name, middle name or middle initial, date of birth, marital status, gender, street address, city, state, zip code, social security number, home phone number, preferred phone number, work phone number, mobile phone number, two alternate phone numbers, fax number, email address, as well as an indication of whether the patient consents to have email sent to them and whether the patient is deceased. From the patient creation screen 352, the user may also assign the patient an image. The user may complete the data fields on the patient creation screen 352 and select the Next button to create the patient. Selecting the Next button saves patient data in the User Tables 54 and the Patient Tables 56, and also causes the system 10 to automatically assign the patient role to the patient. Selecting the Next button also enables the user to configure data in the patient information screens illustrated throughout FIGS. 30B-30J. Each of these screens may be navigated to or from each other by selecting their respective selections, utilizing the Next or Back buttons, or through voice commands. Navigating to or from one of the patient information screens illustrated throughout FIGS. 30B-30J automatically saves the information on that particular screen in the Patient Tables 56.

FIG. 30B is an illustration of a patient employment details screen 353 that the user may configure with patient employment data. From the patient employment details screen 353, the user may enter information about the patient's employment, including at least one of the following: a patient's occupation, employer, how long they have been employed, a street address of the employer, a city of the employer, a state of the employer, a zip code of the employer, and a business phone number of the employer.

FIG. 30C is an illustration of a patient family details screen 354 that the user may configure with patient family data. From the patient family details screen 354, the user may enter information about the patient's family details, including at least one of the following: a spouse, parent, or guardian of the patient, as well as a person responsible for payment of a medical procedure if the spouse, patient or guardian is not the responsible party for the payment of the medical procedure. The user may also enter information about the spouse, parent, guardian or person responsible for payment including their last name, first name, middle name or middle initial, their date of birth, relationship to the patient, their social security number, street address, city, state, zip code, home phone number, work phone number, fax number, email address, employer, occupation, and how long they have been employed.

FIG. 30D is an illustration of a patient insurance information screen 355 that the user may configure with patient insurance information data. The patient insurance information screen 355 provides input for a third insurance of the patient by selecting the Show Tertiary Insurance button. Thus, from the patient insurance information screen 355, the user may enter information about the patient's insurance, including information about a primary, secondary, and/or tertiary insurance that further includes at least one of the following: the insured's last name, the insured's first name, the insured's middle name or middle initial, an identification number, the carrier of the insurance, a claim address, a city, state, and zip code for the insurance carrier, a pre-certification phone number, a member services phone number, and a group insurance number.

FIG. 30E is an illustration of a patient allergies screen 356 that the user may configure with patient allergy data. The user configures the required text boxes and selects the Add/Save button to add and save an allergy of the patient. The text box to enter the name of the drug is configured with an autocomplete function. As the user enters the drug name or the drug allergy, the system 10 may display a list of drugs that match, or are equivalent to, the drug entered in the text box. The drugs, or equivalents, that match the drug name are retrieved from drug data stored in the System Tables 68. In this way, the user can select the correct drug the patient is allergic to from the list of drugs. The user may select the appropriate symptoms suffered by the patient when administered the medication from the dropdown menu on the patient allergies screen 356. As shown in FIG. 30E, the patient is allergic to Keflex and suffers hives when it is administered.

FIG. 30F is an illustration of a referring physician screen 357 that the user may configure with information about a patient's primary care physician, referring physician, or other patient physicians to send copies of the endoscopic procedure report. From the referring physician's screen 357, the user may enter information about referring physicians, including at least one of the following: a primary care physician, a referring physician, or a physician to carbon copy on correspondence. Thus, the user may enter information corresponding to a last name, first name, middle name or middle initial, or fax number for a physician.

FIG. 30G is an illustration of a privacy statement screen 358 from which the user may view, read, and/or print a privacy statement informing the patient of their privacy rights. As shown in FIG. 30G, the privacy statement screen 358 provides a standard Microsoft Windows control to browse the computer 11 and the networked devices in communication with computer 11 for a privacy document by selecting the Browse . . . button. Once the document has been selected, the document may be uploaded to, and saved by, the system 10 by selecting the Insert button.

FIG. 30H is an illustration of a visit history screen 359 that indicates the visit history of the patient. This data associated with this screen is automatically updated by the system 10 in response to discharge of the patient after a scheduled endoscopic procedure. The visit history screen 359 may include a plurality of visit histories, which may include data associated with the date of the visit, the reason for the visit, whether an endoscopic procedure was performed, and the physician that normally treats the patient, among other information. As shown in FIG. 30H, the visit history screen 359 is blank because the user is attempting to add a new patient.

FIG. 30I is an illustration of a scheduled visit screen 360 that the user may view to determine future endoscopic appointments of the patient. This screen is automatically updated by the system 10 in response to the user scheduling an appointment for the patient. The scheduled visit screen 360 may include one or more scheduled visits, which may in turn include data associated with an appointment for an endoscopic procedure or other scheduled visit of the patient to the group practice. As shown in FIG. 30I, the scheduled visit screen 360 is blank because the user is attempting to add a new patient.

FIG. 30J is an illustration of a personal notes screen 361 in which the user may make notes about the patient.

FIG. 30K is an illustration of a patient audit screen 362 specific to the patient in which the user may view the data associated with the history of the patient. The illustrated patient audit screen 362 generally shows the actions performed by users when entering data about the patient. Each action, or data entry, is time stamped, indicates the action taken, the user that took the action, and a description of the action.

After creation of the patient, the user informs the patient of their login and password to access the system 10. Alternatively, the system 10 may e-mail the login and password of the patient to the patient if a valid e-mail address has been provided. As such, the system 10 may provide the patient with an e-mail that includes a link specific to that patient to register their account and the patient may be provided with an opportunity to configure their login and password. The patient may use their login and password to log onto the system 10 and edit their information.

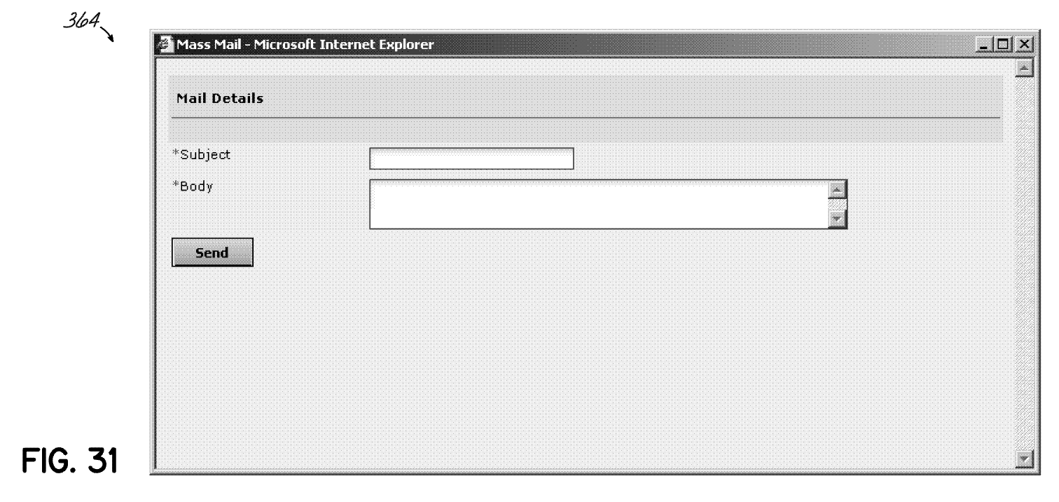

Referring back to FIG. 29, the user has the ability to edit patient information or delete a patient by selecting a patient in the patient management screen 350 desktop 210 and selecting the Edit Patient or Delete Patient buttons, respectively. The user may export a list of patients selected in the patient management screen 350 desktop 210 to an Excel spreadsheet by selecting the Export to Excel button. Furthermore, the user may send at least one patient an e-mail when the patients have consented to this communication and provided their e-mail by selecting those patients in the patient management screen 350 desktop 210 and selecting the Send Mail button. FIG. 31 is an illustration of an e-mail screen 364 that appears for the user to fill in the subject line and body of an e-mail to send to the selected patient(s). The user sends the e-mail by selecting the Send button.

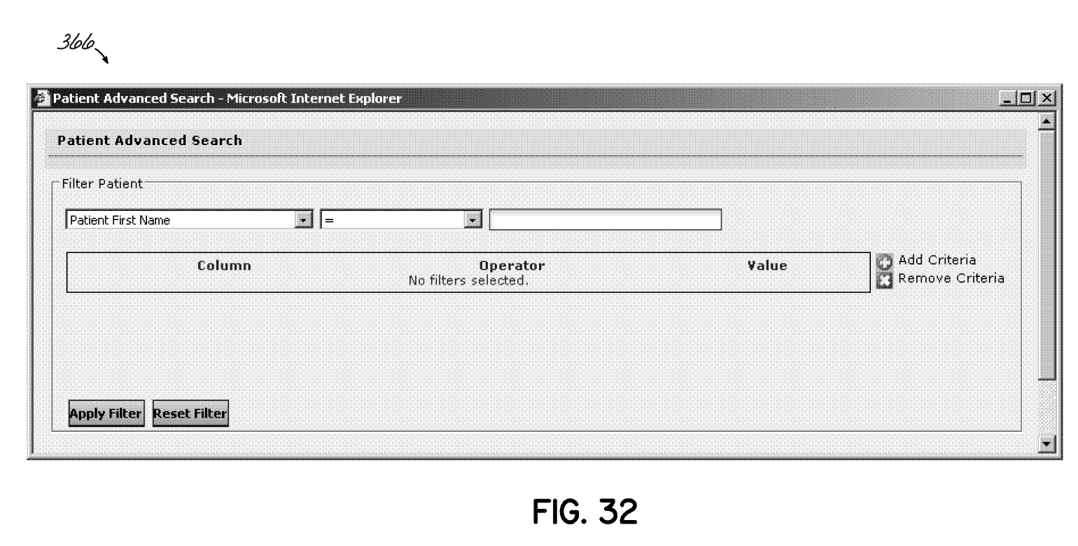

Referring back to FIG. 29, the user has the ability to search for patients using an advanced search configured in the search area 211. The user may launch the advanced search by selecting the Advanced Search button. FIG. 32 is an illustration of the advanced search screen 366 that appears for the user to filter patients in order to find a particular patient. The user may configure the filter, then select the Add Criteria button to add the criteria to the filter. The user can remove criteria by selecting the Remove Criteria button. The criteria in the filter are applied by selecting the Apply Filter button. The filter is removed by selecting the Remove Filter button on the advanced search screen 366. When the filter is applied, the patient management screen 350 of FIG. 29 displays those patients that match the criteria specified in the filter.

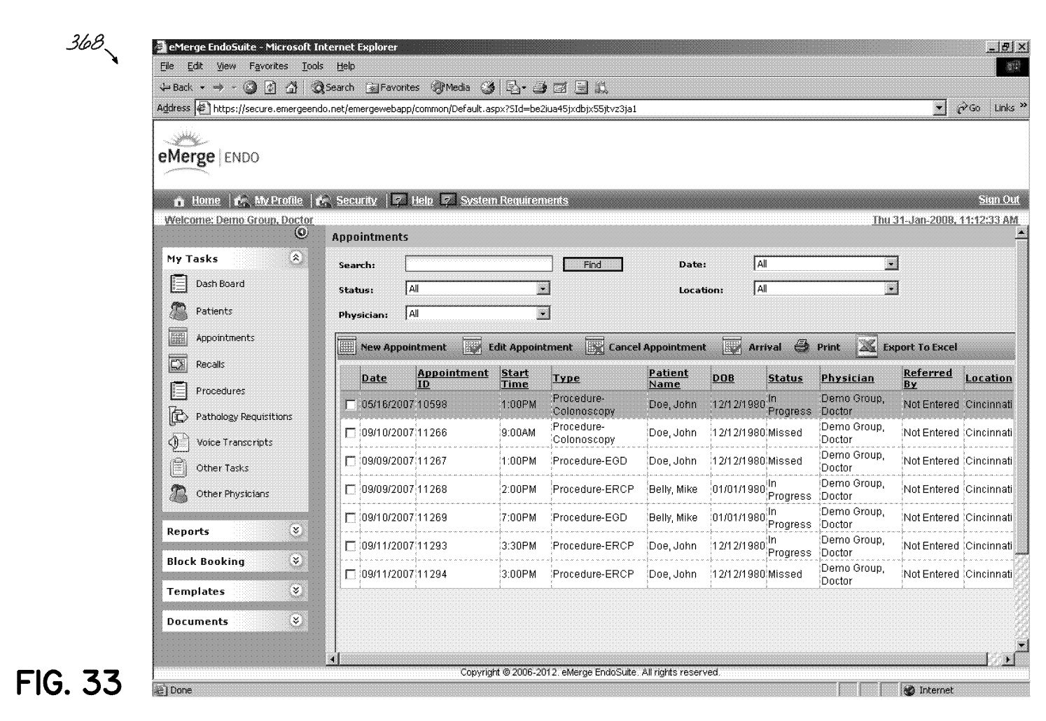

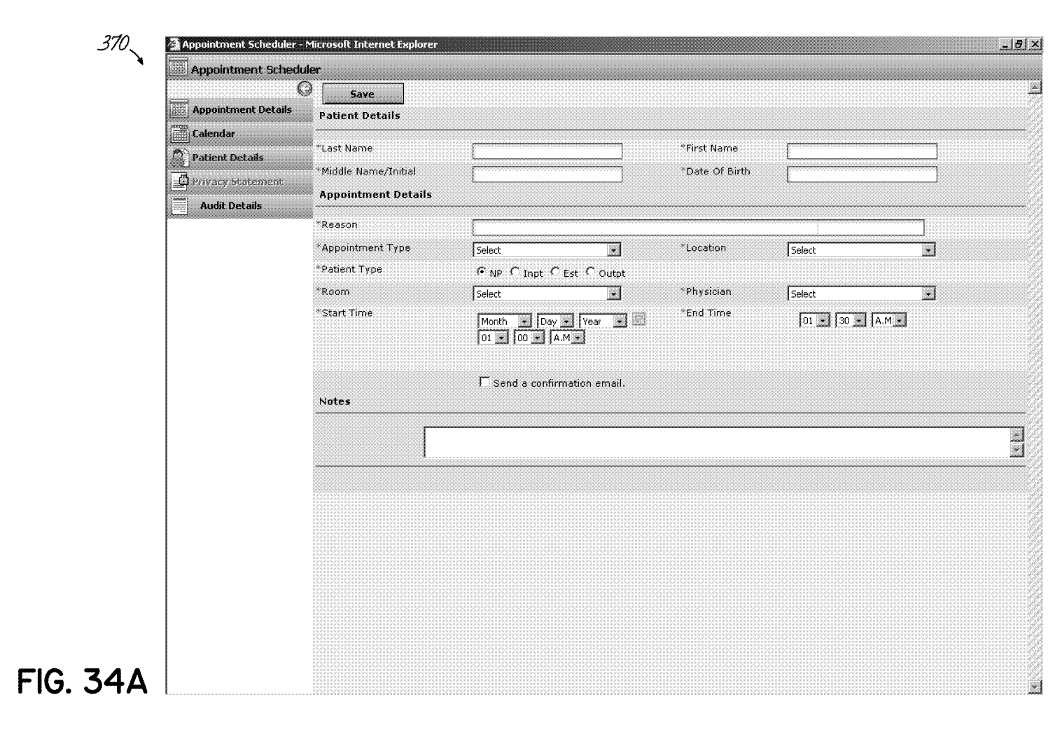

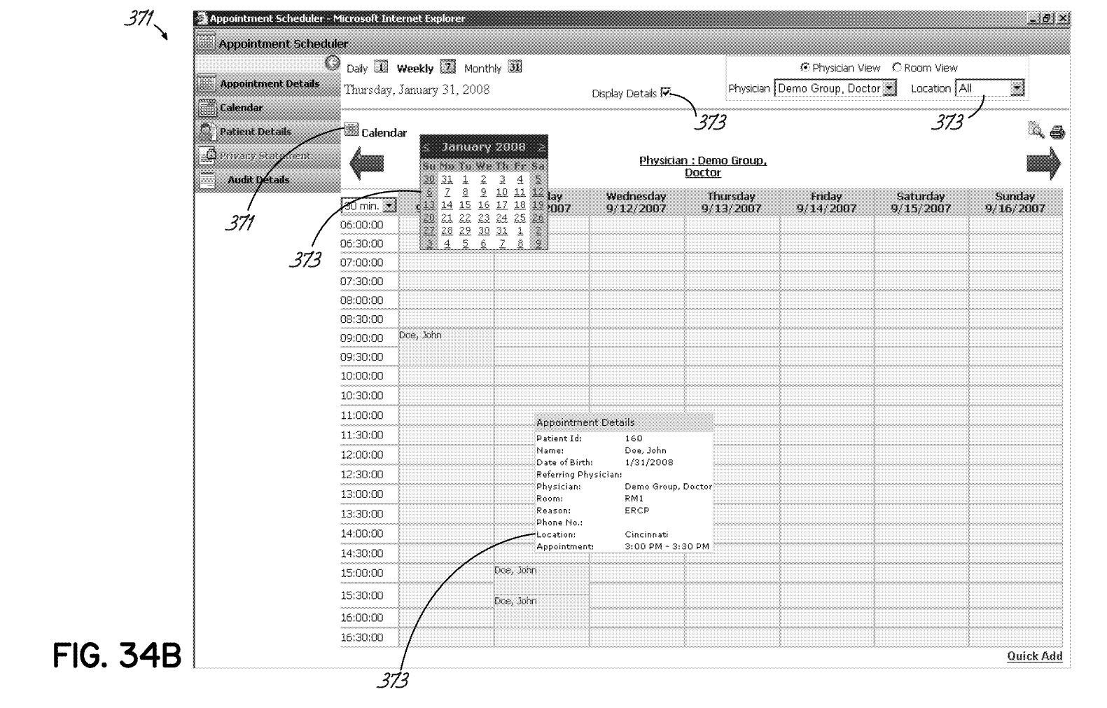

Referring back to FIG. 28, once the patient has been enrolled in the system 10, a user (i.e., the medical assistant, various nurses, physician, or facility manager) may schedule an endoscopic procedure for the patient in block 302. FIG. 33 is an illustration of an appointment management screen 368 accessible by the user by selecting the “Appointments” link in the “My Tasks” dropdown in the user menu 208. The user may create a new appointment by selecting the New Appointment button. FIG. 34A is an illustration of an appointment scheduler screen 370 that appears for the user to configure the new appointment for the patient. The appointment scheduler screen 370 provides components to speed appointment scheduling. The text box to enter the last name of the patient is configured with an autocomplete function. As the user enters the name of the patient, the system 10 may display a list of names (i.e., first and/or last names) that correspond to the name entered in the text box. The displayed names may partially or fully match the entered name. The names are retrieved from data stored in the User Tables 54 and Patient Tables 56 for that group practice. In this way, the user can select the correct patient from the list of patients even though a name is only partially entered. By selecting this patient, the system 10 automatically fills in the information available for the patient in the appropriate boxes on the appointment scheduler screen 370. The dropdown menus on the appointment scheduler screen 370 are also populated with appropriate data maintained by the system 10 in the database 28. From the appointment scheduler screen 370, the user may also enter information about the reason for the appointment, including at least one of the following: an appointment type, a location of the appointment, a patient type, a room for the appointment, a physician scheduled for the appointment, a start time and end time, whether to send the user a confirmation email, and notes about the appointment. The start time and end time may include information corresponding to the month, day, year and hour of the appointment. The user may complete the data fields on the appointment scheduler screen 370 and select the Save button to create the appointment. Selecting the Save button saves patient data in the User Tables 54, Patient Tables 56, and Procedure Tables 60. Selecting the Save button further causes the system 10 to automatically create an endoscopic procedure entry and assign a pre-operative nurse, operative nurse, and recovery room nurse to the appointment. The users may be assigned to the endoscopic procedure based on their availability or by their association with a physician.

FIG. 34B is an illustration of an appointment calendar 371 accessible by the user by selecting the Calendar button from the appointment scheduler screen. The user may view appointments for the group practice on a daily, weekly, or monthly basis. The user may navigate to a date by selecting the navigation calendar button 372 and using the navigation calendar 373. The user may display the appointments by physician, room, and location using the filters shown generally at 374. The user may view appointment details 375 by positioning a general input device 32 cursor (for example, a mouse cursor) over an appointment on the appointment calendar 372 for about two seconds when the “Display Details” checkbox 376 is checked.

In a similar manner as disclosed above for editing patient information, the user may select the “Patient Details” selection shown in FIGS. 34A and 34B to edit patient data of the patient scheduled for the appointment.

FIGS. 34A and 34B illustrate a “Privacy Statement” selection that the user may not access. The system 10 may display a lock, display shadowed text, or otherwise prevent access to a user when that user is denied access to that data or functionality.

Referring back to FIG. 33, the user may edit or delete an appointment by selecting the appointment in the appointment management screen 368 desktop 210 and selecting the Edit Appointment or Cancel Appointment buttons, respectively. When the patient arrives at the group practice location the day of the appointment, the user may select the appropriate appointment in the appointment management screen 368 desktop 210 and select the Arrival button to finalize the appointment, materializing each appointment in the calendar of those users assigned to the appointment and endoscopic procedure. The user may print an appointment by selecting the appointment in the appointment management screen 368 desktop 210 and selecting the Print Appointment button. The user may export a list of appointments selected in the appointment management screen 368 desktop 210 to an Excel spreadsheet by selecting the Export to Excel button.

Referring back to FIG. 28, when the patient arrives for the endoscopic procedure appointment, the appointment for the patient is materialized in the calendars of all users who will be involved in block 304. A user materializes the appointment by navigating to the appointment management screen 368, selecting the appointment associated with that patient, and selecting the Arrival button. When the endoscopic procedure begins and throughout the endoscopic procedure, data associated with each endoscopic procedure is saved in the Patient Tables 56, Procedure Tables 60, and/or Report Tables 64.

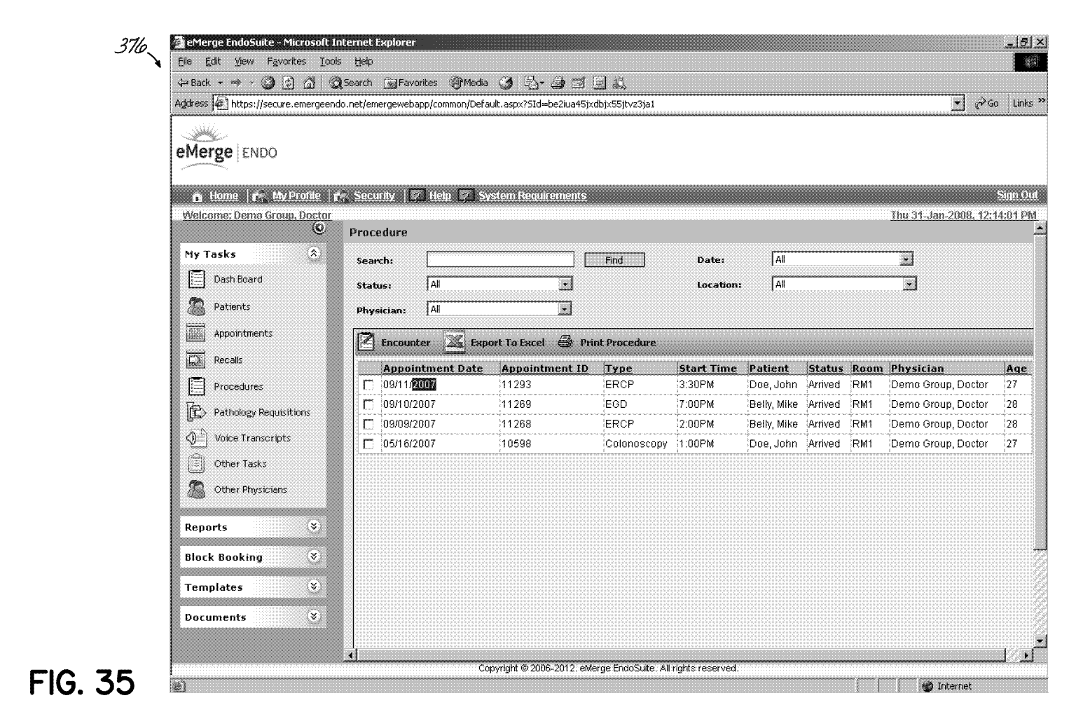

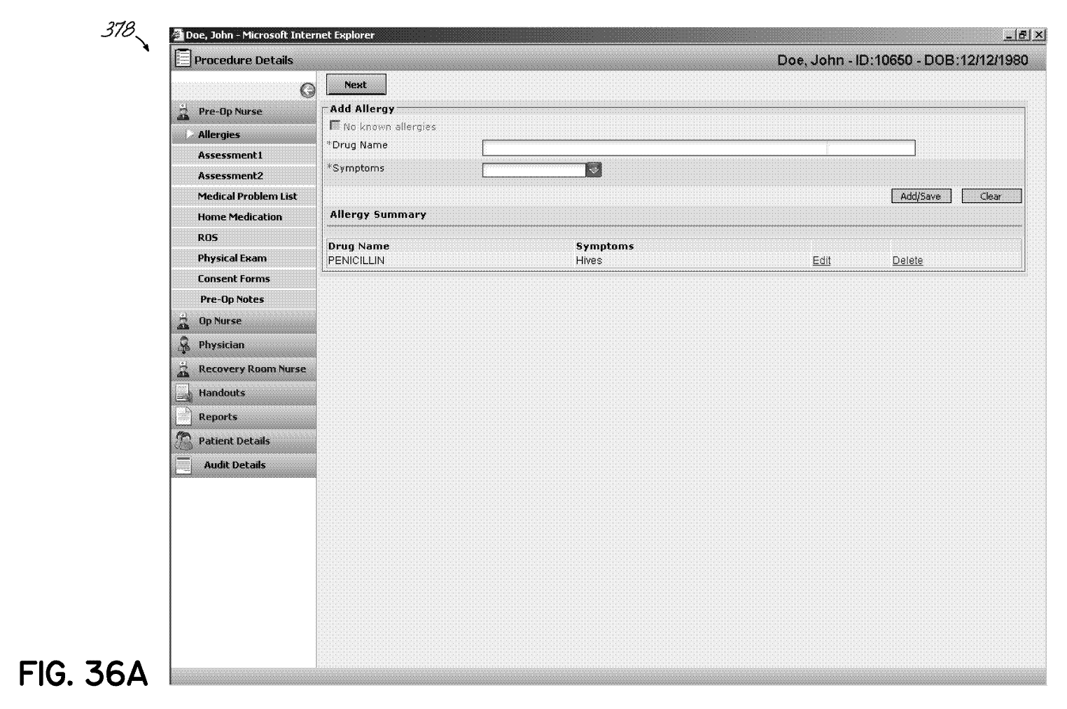

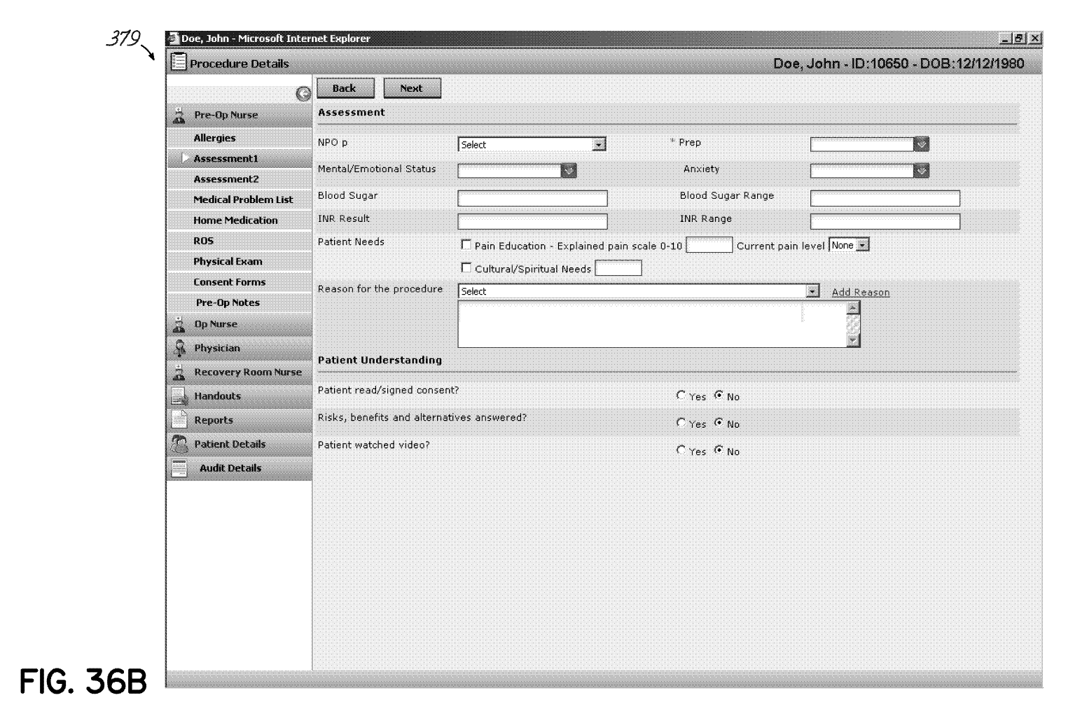

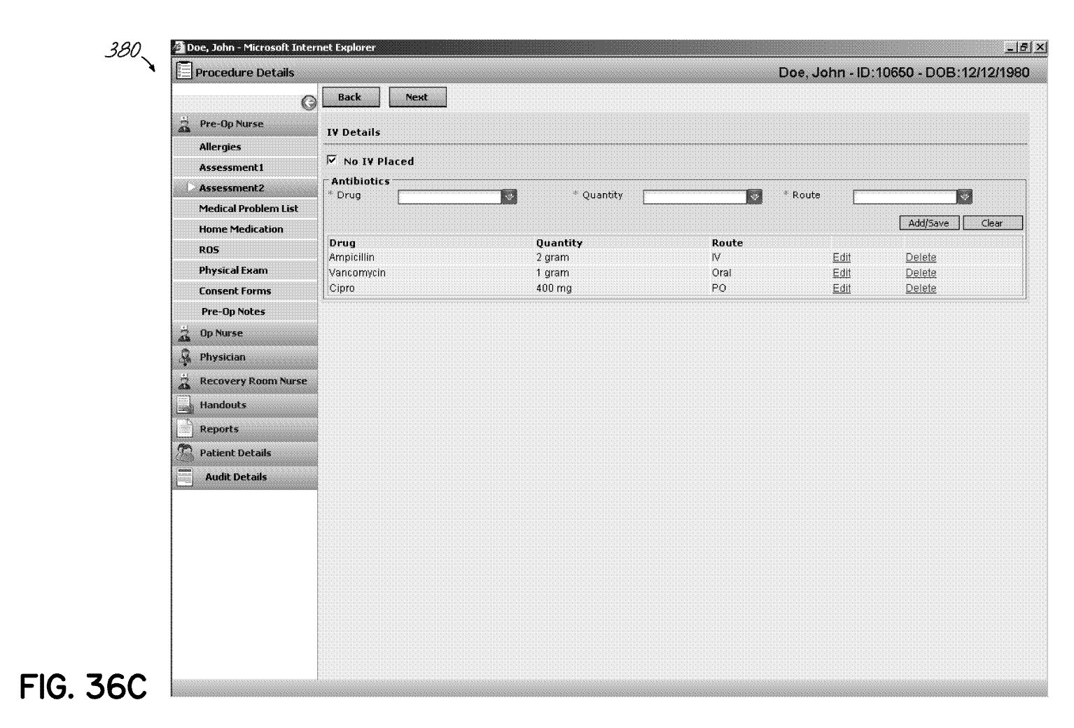

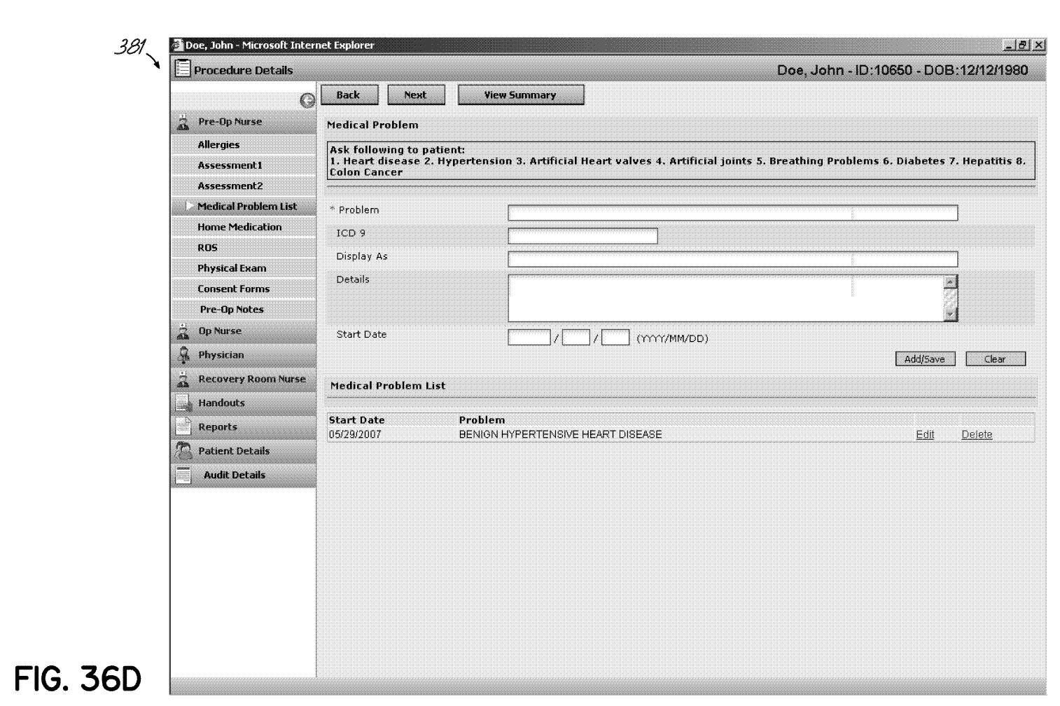

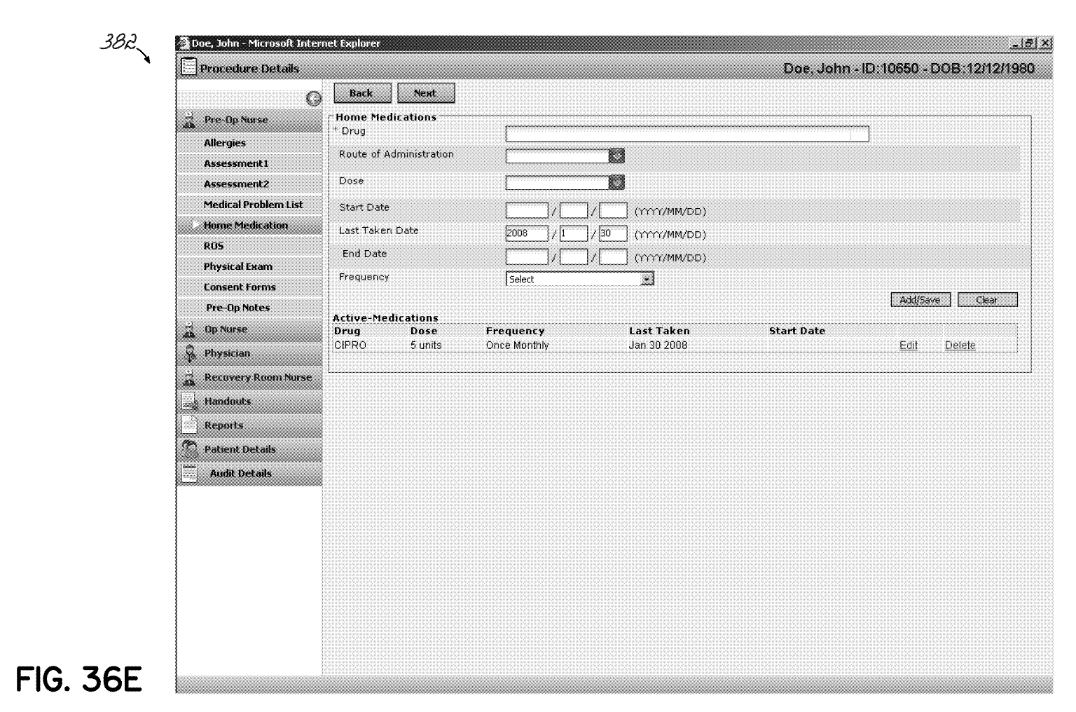

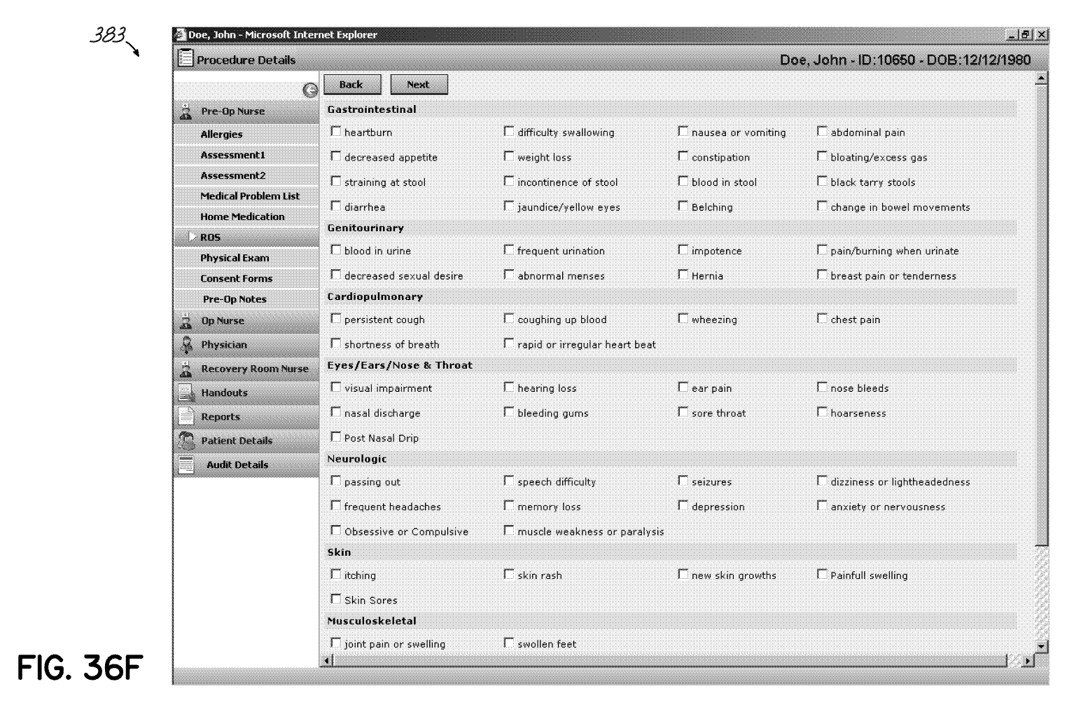

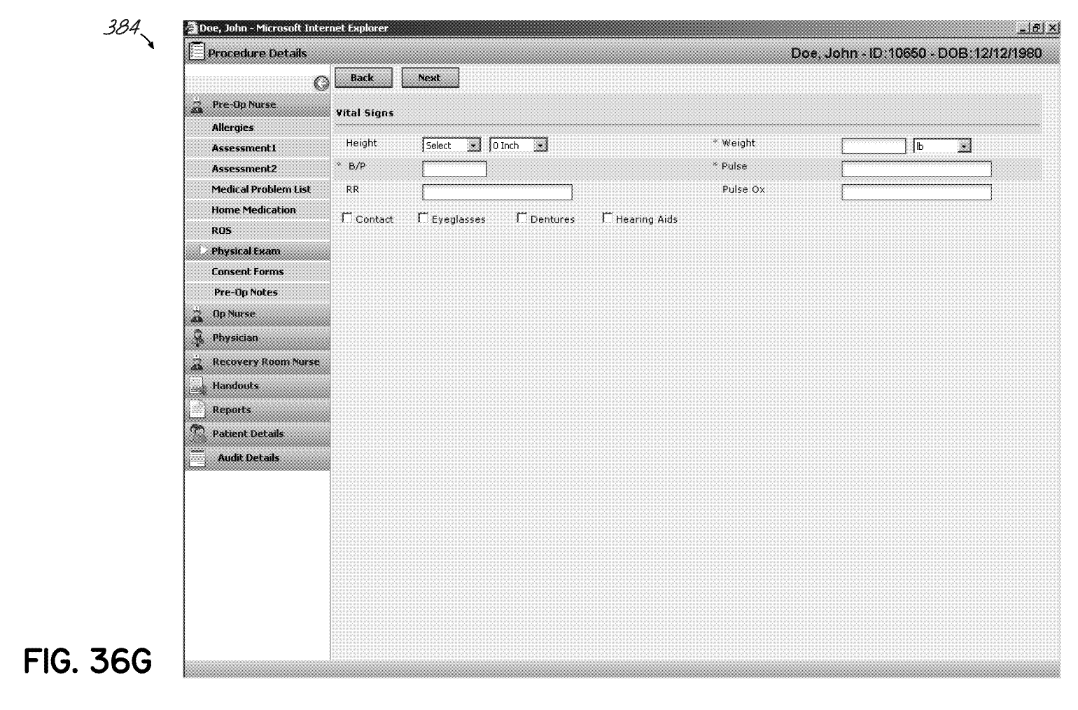

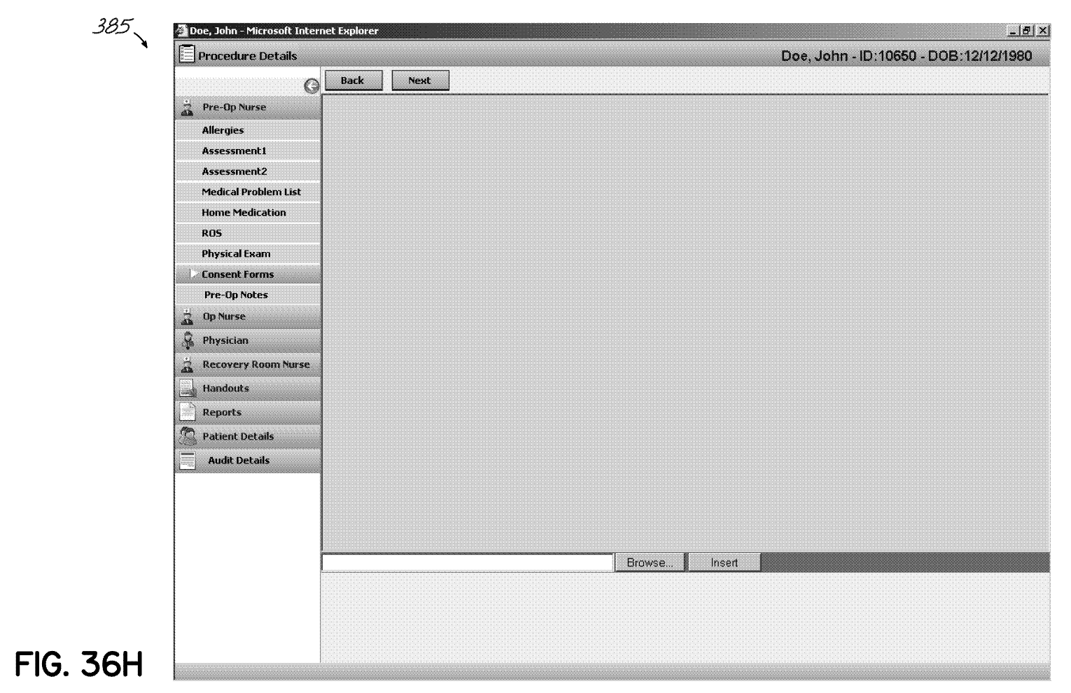

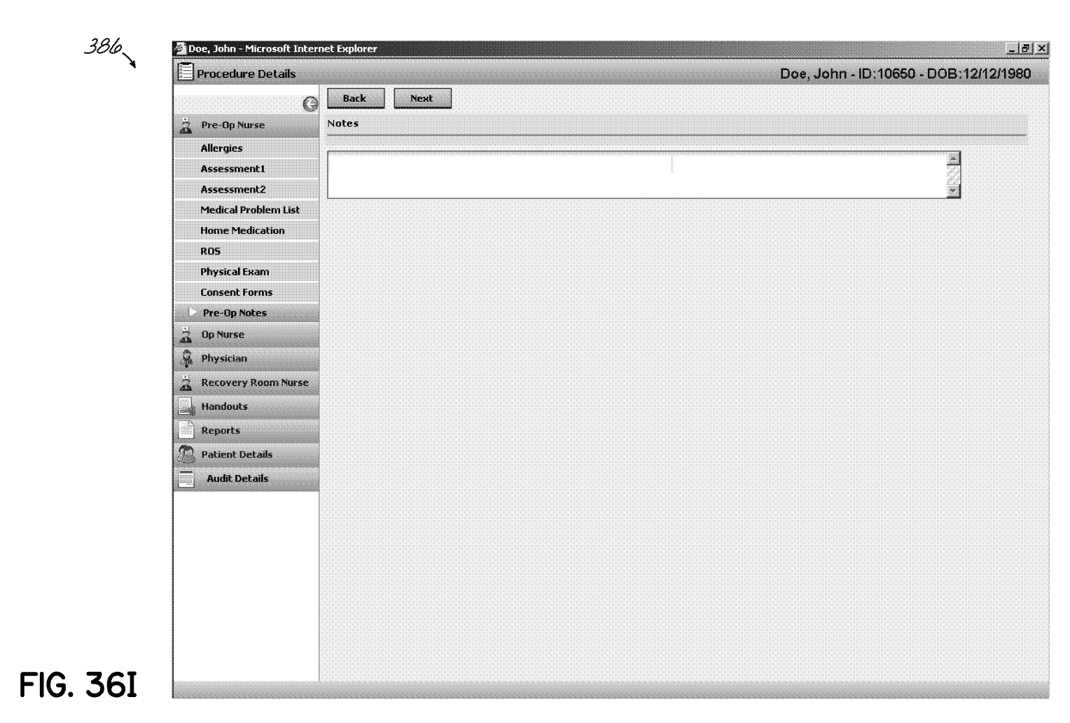

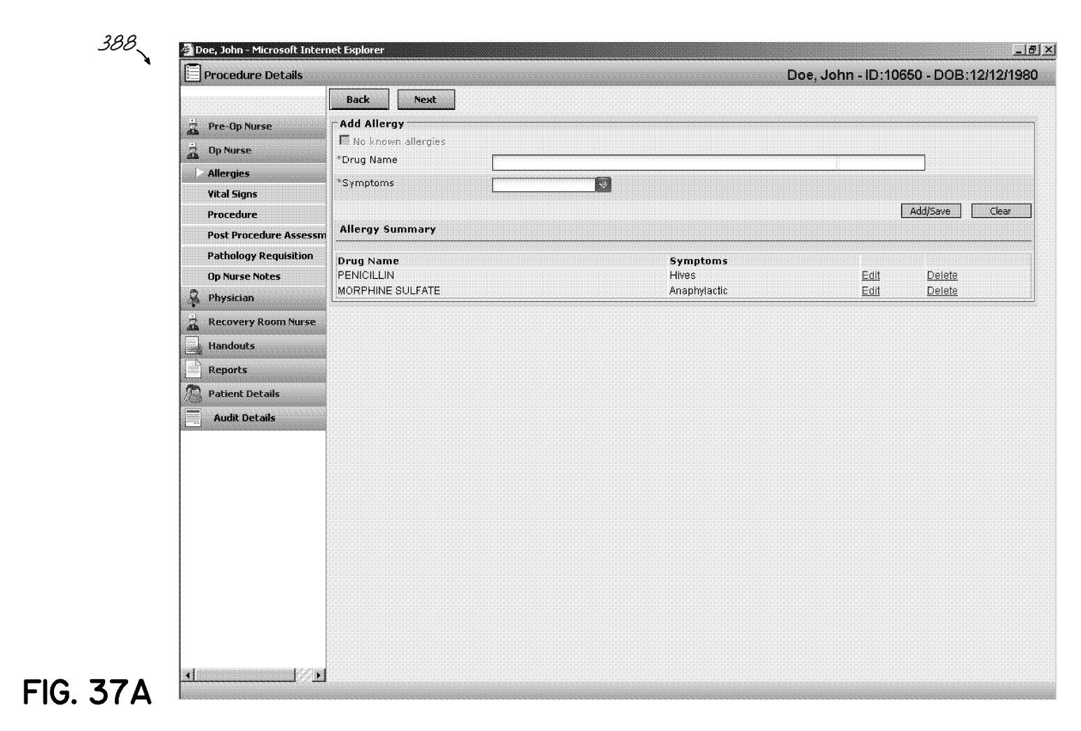

FIG. 35 is an illustration of a procedure screen 376 that each user assigned to the endoscopic procedure (i.e., pre-operative nurse, operative nurse, physician, and/or recovery room nurse) views after selecting the “Procedures” link in the “My Tasks” dropdown in the user menu 208. Each appointment entry in the procedure screen 376 desktop 210 is automatically generated after the appointment is created and associated with an endoscopic procedure. The user may access an appointment by selecting the appointment from the procedure screen 376 desktop 210 and selecting the Encounter button. FIG. 36A is an illustration of an allergy screen 378 that appears for the user to configure patient allergies. This screen operates in a similar manner as described above in the discussion of FIG. 30E. Returning to FIG. 36A, the user may complete the data fields on the allergy screen 378, review the allergies, and select the Next button to save the data and advance the pre-operative assessment. Selecting the Next button saves patient allergy data in the Patient Tables 56. Selecting the Next button also enables the user to fill data in the procedure information screens illustrated in FIGS. 36B-36I, FIGS. 37A-37G, and 38A-39E. Each of these screens may be navigated to from each other by selecting their respective selections, utilizing the Next or Back buttons, or using voice commands. Utilizing the Next or Back buttons to Navigate to or from one of the patient information screens illustrated in FIGS. 36B-36I, FIGS. 37A-37G, and 38A-39E automatically saves the information entered on that particular screen in the Patient Tables 56, Procedure Tables 60, or Report Tables 64.

FIG. 36B is an illustration of the first pre-operative assessment screen 379 that appears for the user to document general results of the pre-operative assessment. From the first pre-operative assessment screen 379, the user may enter information about at least one of the following: whether a patient was able to take a pill, preparation of the patient, a mental and emotional status of the patient, whether the patient exhibits any anxiety, a blood sugar of the patient, a blood sugar range of the patient, an IMP result of the patient, an INR range of the patient, patient needs (including whether the patient has been provided pain education or has cultural and spiritual needs), whether an explanation of a pain scale has been provided, and the current pain level of the patient. In addition, the user may enter a reason for the procedure, whether the patient has read and signed a consent form, whether the risks, benefits and alternatives of the procedure have been answered, as well as whether the patient has watched an explanatory video about the procedure.

FIG. 36C is an illustration of a second pre-operative assessment screen 380 that appears for the user to document any medications administered to the patient during the pre-operative assessment. From the second pre-operative assessment screen 380, the user may enter data corresponding to an IV administered to the patient, including antibiotic the patient has been administered. Information corresponding to the antibiotics may include the drug name, the quantity and the route that the antibiotics were administered. From the second pre-operative assessment screen 380, the user may also indicate that no IV was placed.

FIG. 36D is an illustration of a medical problem screen 381 that appears for the user to document any medical problems suffered by the patient. The text box to enter the medical problem is configured with an autocomplete function. As the user enters the medical problem of the patient, the system 10 may display a list of medical problems that match the medical problem entered in the text box. The medical problems that match are retrieved from data stored in the System Tables 68. By selecting a medical problem, the system 10 automatically fills in the information for the medical problem in the appropriate boxes on the appointment medical problem screen 381. The user may fill in the remaining details of the medical problem, such as when the problem began, and select the medical problem Add/Save button to save the medical problem. Problem descriptions may be added by the user and saved by selecting the problem details Add/Save button to save the problem description. The user may view all medical problems by selecting the View Summary button.

FIG. 36E is an illustration of a home medications screen 382 that appears for the user to document any medications taken by the patient that are prescribed by another physician, as well as over-the-counter drugs taken by the patient. The text box to enter the medication is configured with an autocomplete function. As the user enters the medication, the system 10 may display a list of specific medications that match the medication entered in the text box. The medications that match are retrieved from data stored in the System Tables 68. In this way, the user can select the specific medication from the list of medications. From the home medication screen 382, the user may also enter remaining information about home medications, including: the route of administration of the home medication, the dose of home medication, the start date of home medications, the date home medication was last taken, the end date of the home medication, and the frequency of the home medication. The user may complete the data fields and select the Add/Save button to add the medication.

FIG. 36F is an illustration of a range of symptoms screen 383 that appears for the user to document the range of symptoms suffered by the patient. From the range of symptoms screen 383, the user may enter information about at least one of the following range of symptoms suffered by the patient: gastrointestinal, genitourinary symptoms, cardiopulmonary symptoms, eyes, ears, nose and throat symptoms, neurological symptoms, skin symptoms, musculoskeletal symptoms and general symptoms.

FIG. 36G is an illustration of a physical examination screen 384 that appears for the user to document the physical examination of the patient during the pre-operative assessment. From the physical examination screen 384, the user may enter information about at least one of the following: a height, weight, resting rate, pulse, pulse oxygen, and blood pressure of the patient. The user may also enter information corresponding to whether the user wears contacts, eyeglasses, dentures or hearing aids.

FIG. 36H is an illustration of a consent forms screen 385 that appears for the user to print or upload signed consent forms. The user may first print the consent forms, have the patient sign them, scan the signed consent forms and upload those signed consent forms into the system 10. The consent forms screen 385 of FIG. 36H operates in a similar manner as the forms screen 274 of FIG. 26.

FIG. 36I is an illustration of a pre-operative assessment notes screen 386 that appears for the user to make notes about the pre-operative assessment. From the pre-operative assessment notes screen 386, the user may enter notes about the patient that were not entered elsewhere in the pre-operative assessment. Such notes may include: if the patient was blind, whether they had pace makers, or other information.

A user (i.e., operative nurse) may monitor the endoscopic procedure with an embodiment of computer 11 in electrical communication with the vital signs equipment 42. The computer 11 of the user may also include the microphone 36 and speaker 46, or the user may be in communication with the computer 11 through the wireless communication interface 48 by way of a wireless headset. The system 10 is configured to load an interface on the computer 11 operable to interface with the vital signs equipment 42 and capture data associated with the patient's vital signs. That interface, in one embodiment, is a vital signs ActiveX control that monitors the data communicated to a port of computer 11 in electrical communication with the vital signs equipment 42 to capture vital signs data. The vital signs ActiveX control does not have any visual presence on the screen and may be used whenever there is a need to capture data from vital signs equipment 42. One having ordinary skill in the art will appreciate that other equipment may be connected to computer 11, and that other hardware ActiveX controls may be used to interface with that equipment without departing from the scope of the invention.

The system 10 is configured to load an interface on the computer 11 operable to interface with the microphone 36 or wireless headset to record voiced utterances and/or convert voiced utterances of the user into machine readable input. That interface, in one embodiment, is a voice recognition ActiveX control. The voice recognition ActiveX control may utilize a Microsoft Speech Application Programming Interface (“SAPI”). The SAPI is used with a speech recognition engine and speech library by the system 10 to provide speech recognition and speech synthesis. The speech library may be stored in the database 28 and be responsive to particular words that may correspond data, commands, or other information. The system 10 may also use an XML based markup language, such as the Speech Application Language Tags (“SALT”), to add voice recognition to all screens displayed by the system 10. As such, each screen may include commands that, in combination with the voice recognition ActiveX control, allow users to verbally command the system 10. Thus, in one specific embodiment, a voice recognition ActiveX control is always configured on computer 11 when a user is logged onto the system 10.

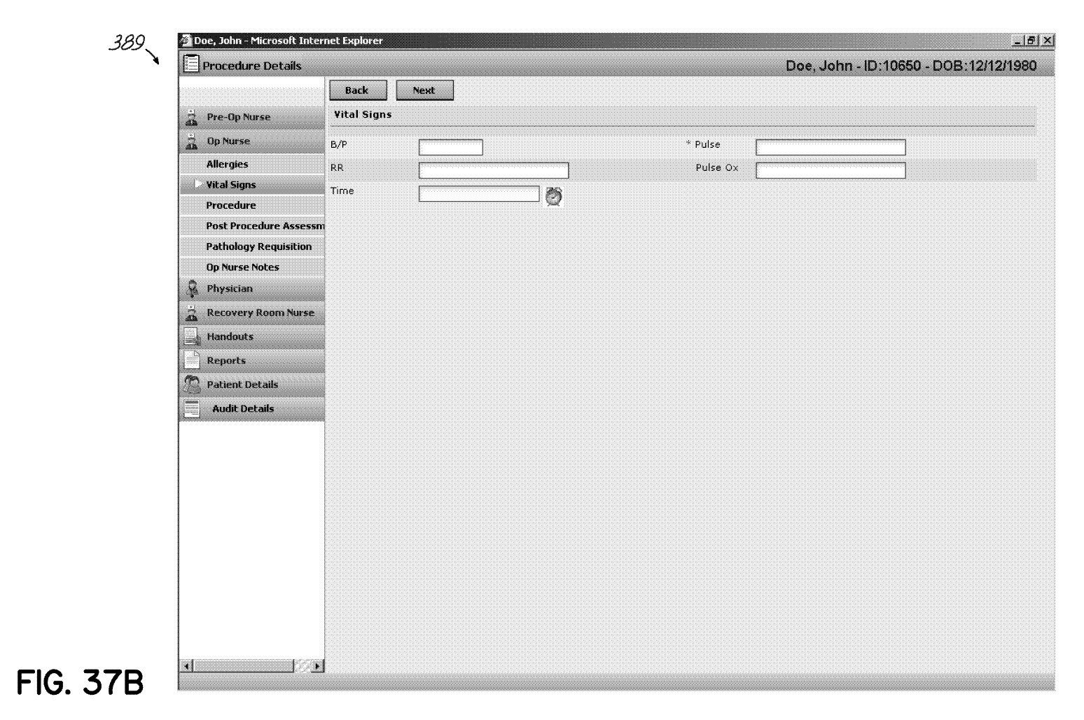

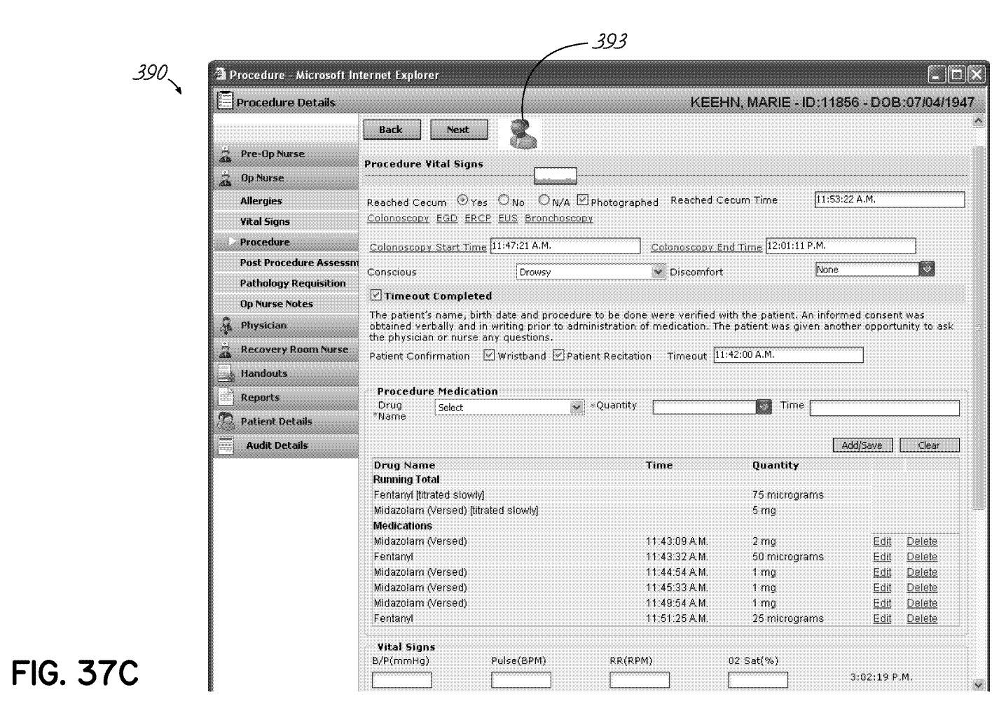

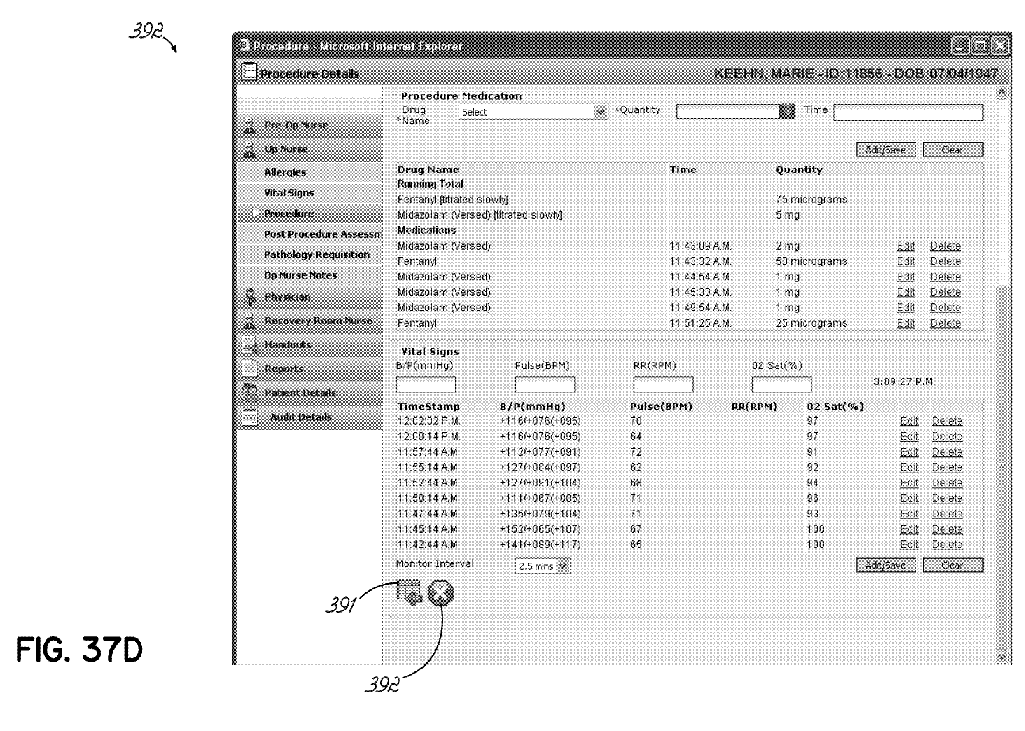

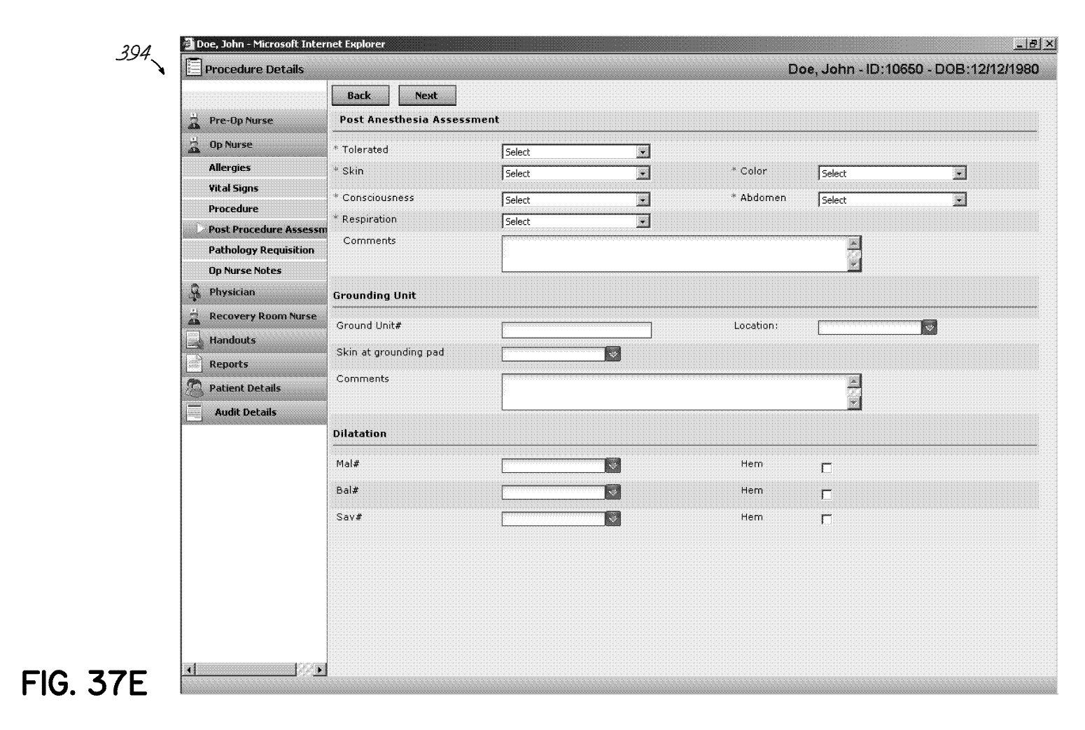

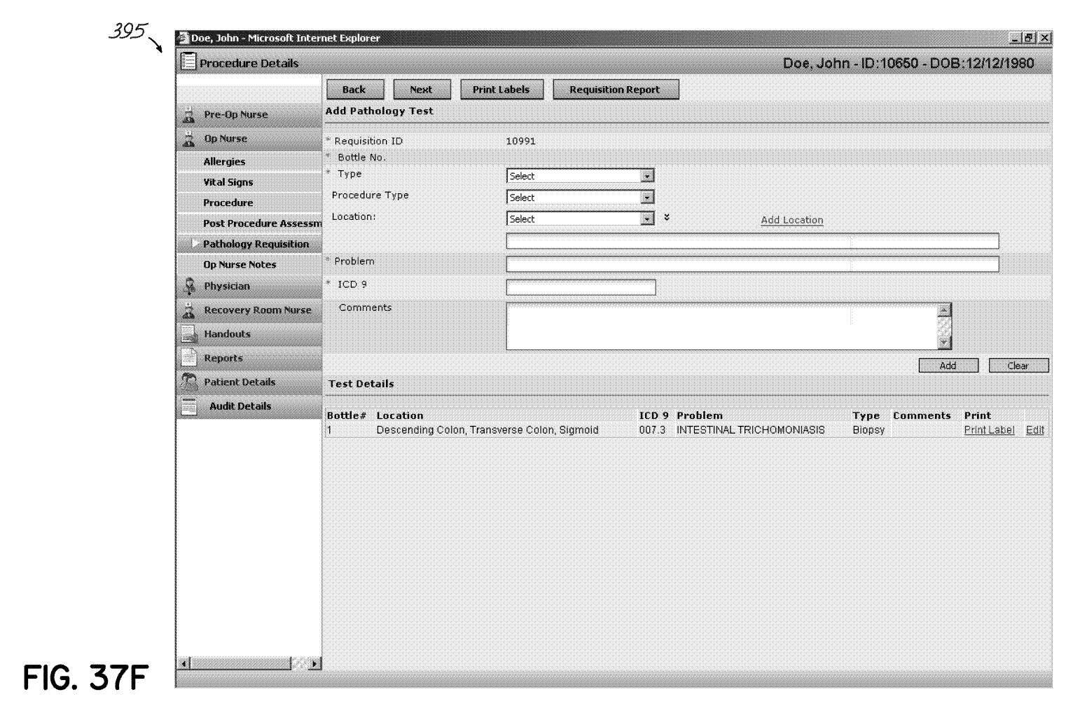

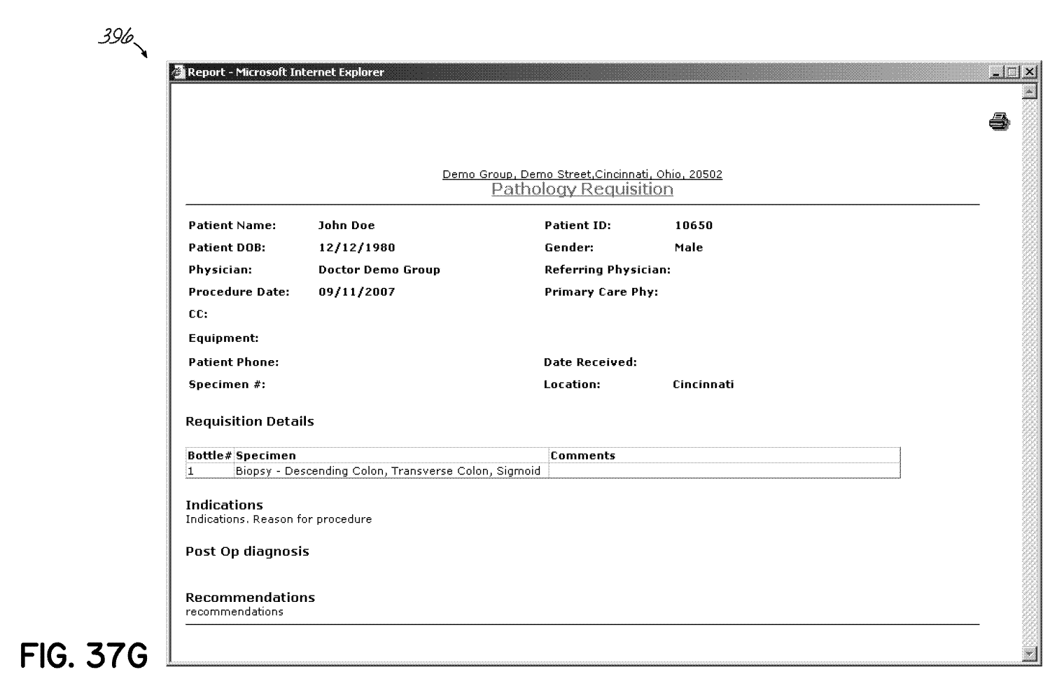

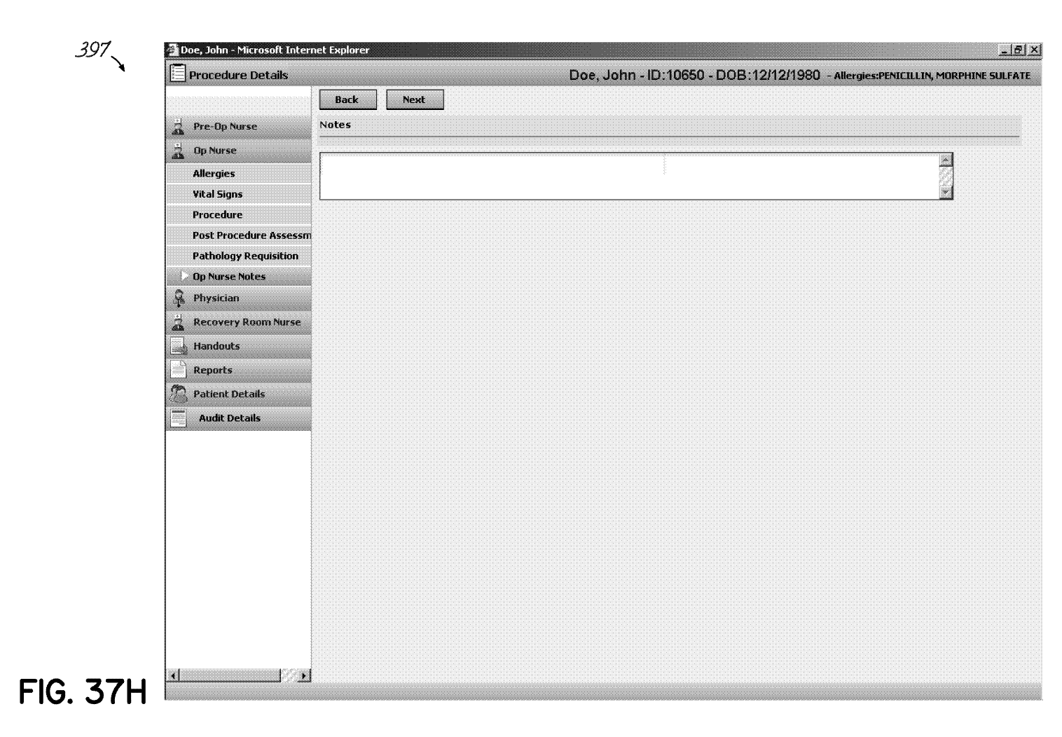

FIG. 37A is an illustration of the operative allergy screen 388 that appears for the user view and configure patient allergies.

FIG. 37B is an illustration of the vital signs screen 389 that appears for the user to document the vital signs of the patient before the endoscopic procedure begins. From the vital signs screen 389, the user may enter information corresponding to the blood pressure, pulse, resting rate, pulse oxygen, and time the vital signs were taken.

FIGS. 37C and 37D are illustrations of an operative procedure screen 390 in which the user may capture information associated with the endoscopic procedure. The operative procedure screen 390 provides components for the user to configure information associated with the endoscopic procedure. From the operative procedure screen 390, the user may specify the type of endoscopic procedure being performed as well as the start time and end time of the endoscopic procedure. The user may select the “Start Time” link on the operative procedure screen 390, which may be customized to show the exact endoscopic procedure being performed, or verbalize a command to begin voice activation, such as “Begin Procedure.” When the user begins the procedure, a report template is automatically created by the system 10 and associated with the endoscopic procedure.

When a user navigates to the operative procedure screen 390 the system 10 may configure the vital signs ActiveX control on computer 11 to detect and record the patient vital signs communicated from the vital signs equipment 42. The user begins recording vital signs by selecting the Start Vital Signs Capture button 391 on the operative procedure screen 390. The user may set an interval for to record vital signs, for example the vital signs may be recorded every ten seconds. Additionally, the user may enter vital signs into the text boxes provided on the operative procedure screen 390. The user may stop recording vital signs by selecting Stop Vital Signs Capture button 392 or ending the endoscopic procedure.

When a user navigates to the operative procedure screen 390, the voice recognition ActiveX control may be selectively activated or deactivated by selecting the Voice Recognition button 393.

The user may issue commands to the system 10 through the voice recognition ActiveX control to store information associated with medications administered to the patient, information associated with the method of administration of medications, information associated with the time of administration of the medication, and/or information associated with the dosages of the medication, among other information. The user may also issue commands to the system 10 through the voice recognition ActiveX control to retrieve data, modify data, or delete data of the system 10. Thus, the user may utilize the voice recognition functionality to interact with the system 10, freeing their hands for other tasks. The voice recognition ActiveX control recites the last command recognized through the speaker 46 and associates each command with a time stamp. In this way, the user may listen to the last command or information converted by the system 10 control to verify that last command or information entered and correct any errors. The endoscopic procedure may be ended by the user verbalizing a “Procedure Ended” command, which stops the vital signs ActiveX control and timestamps the end-time of the endoscopic procedure. The user may also stop the endoscopic procedure by selecting the “End Time” link, which may be customized to show the exact endoscopic procedure being ended.

FIG. 37E is an operative assessment screen 394 that appears for the user to document an initial post-operative assessment of the patient after the endoscopic procedure is complete. From the operative assessment screen 394, the user may enter information about the post-anesthesia assessment, including at least one of the following: whether it was tolerated, the skin condition, the color of the skin, the consciousness level of the patient, a brief description of the patient's abdomen, an indication of respiration of the patient, and comments. From the operative assessment screen 394, the user may also enter information corresponding to the grounding unit including the ground unit number, the location the ground unit was placed, the skin condition at the grounding pad, and comments about the ground unit or the patient. Finally, from the operative assessment screen 394, the user may enter information corresponding to the dilation of the patient including their MAL number, their BAL number and their SAV number.

FIG. 37F is an illustration of a pathology requisition screen 395 that appears for the user to configure a new pathology requisition. The pathology requisition may be generated when a tissue sample is removed from the patient during the endoscopic procedure. The user may configure the data fields on the pathology requisition screen 395 with information that may include the problem, the type of sample, procedure type, and location where the sample was taken. The “Problem” text box is configured with an autocomplete function. As the user is configuring the patient problem, the system 10 may display a list of problems that match the problem entered in the text box. The problems that match are retrieved from data stored in the System Tables 68. In this way, the user may select the correct problem from the autocomplete menu list. The “ICD 9 code” text box may be populated with appropriate data associated with that problem by the system 10 in response to the user choosing the problem. From the pathology requisition screen 395, the user may also enter information about at least one of the following: the type of pathology test, the requested procedure type that was performed, the location that the tissue was removed from, and general comments about the pathology requisition. The user may print all labels of all pathology requisitions for that patient by selecting the Print Labels button. The user may print specific labels by select the “Print Label” link beside a specific pathology requisition. The user may view pathology requisitions for a patient by selecting the Requisition Report button. FIG. 37G is an illustration of a requisition report 396 that appears for the user to review and print after pathology requisitions have been generated.

FIG. 37H is an illustration of an operative nurse notes screen 397 that appears for the user to make notes about the endoscopic procedure.

A user (i.e., a physician) may perform the endoscopic procedure with an embodiment of computer 11 in electrical communication with the camera system 38 and electronic switching interface 40. The computer 11 of the user may also include the microphone 36 and speaker 46, or the user may be in communication with the computer 11 through the wireless communication interface 48 by way of a wireless headset. In a similar manner as described above, the system 10 is configured to load interfaces on computer 11 that are operable to interface with the camera system 38 to display video and capture images associated with the endoscopic procedure. The interfaces, in one embodiment, are a video ActiveX controls that monitors to the data communicated on a port of computer 11 in electrical communication with the camera system 38 and an electronic switching interface ActiveX control that monitors the electronic switching interface 40. In some embodiments, the video ActiveX control is further configured to capture an image in response to activation of the electronic switching interface 40. Upon activation of the electronic switching interface 40, the system 10 is configured to store an image currently displayed by the video ActiveX control and convert voiced utterances of the user into machine readable input with the voice recognition ActiveX control.

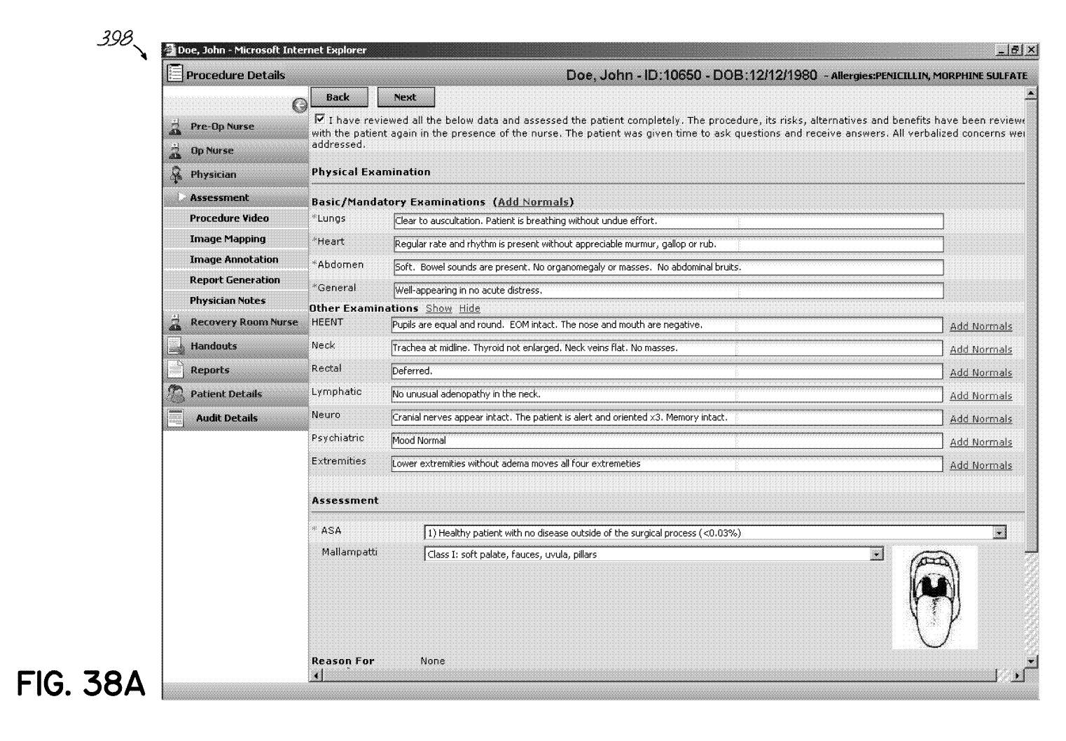

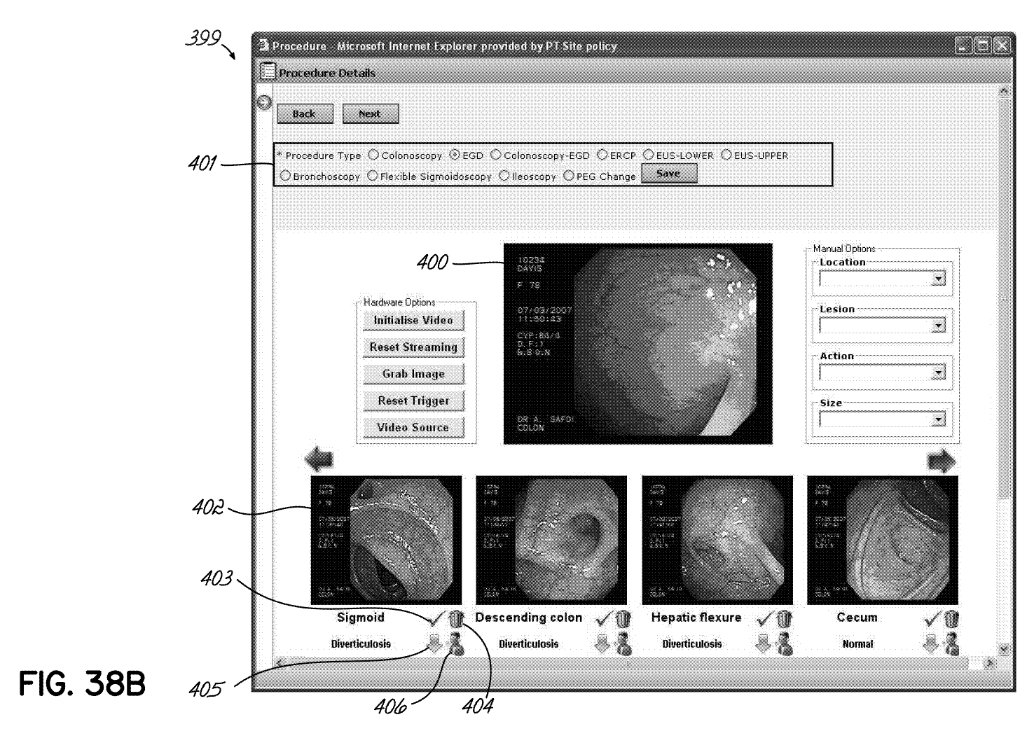

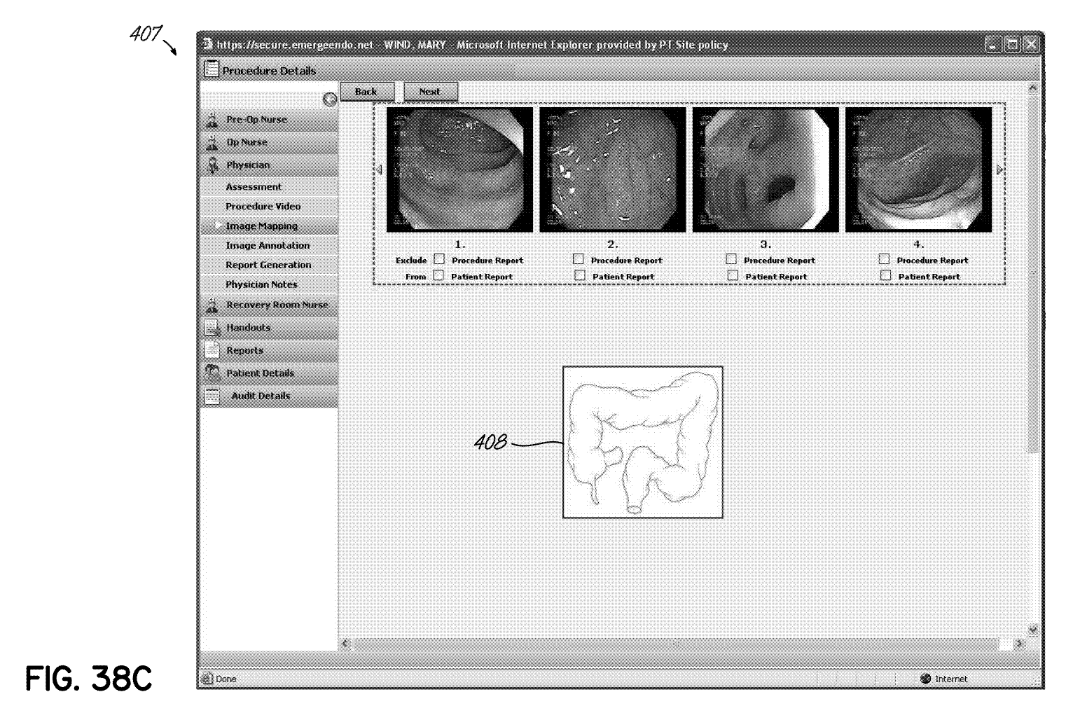

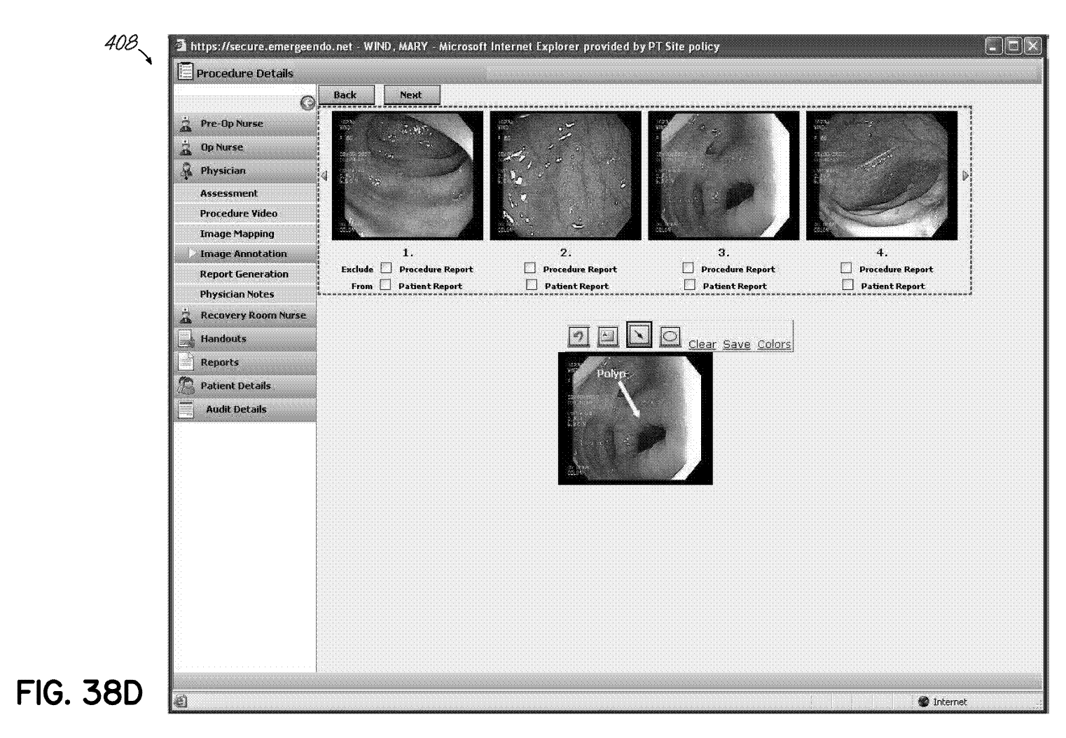

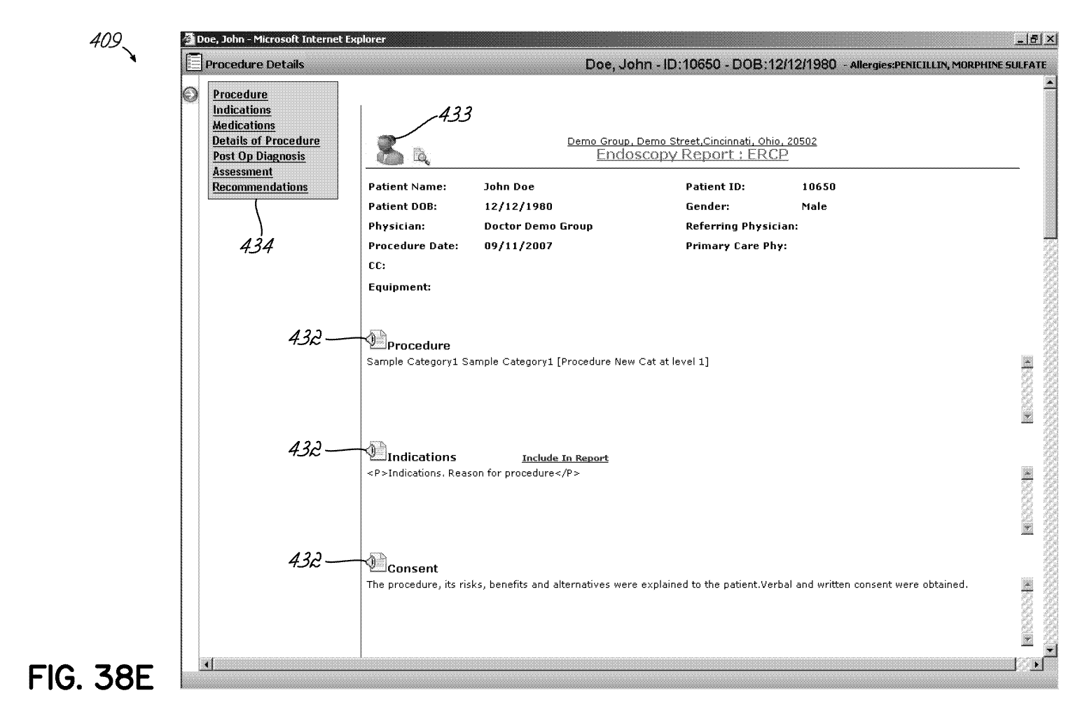

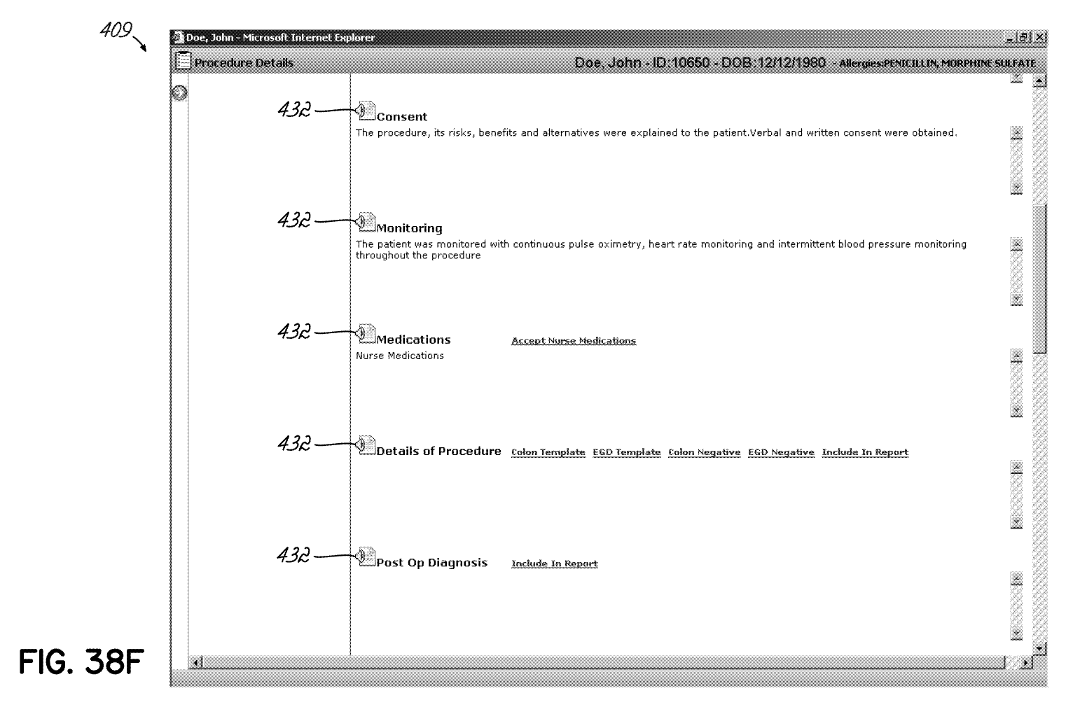

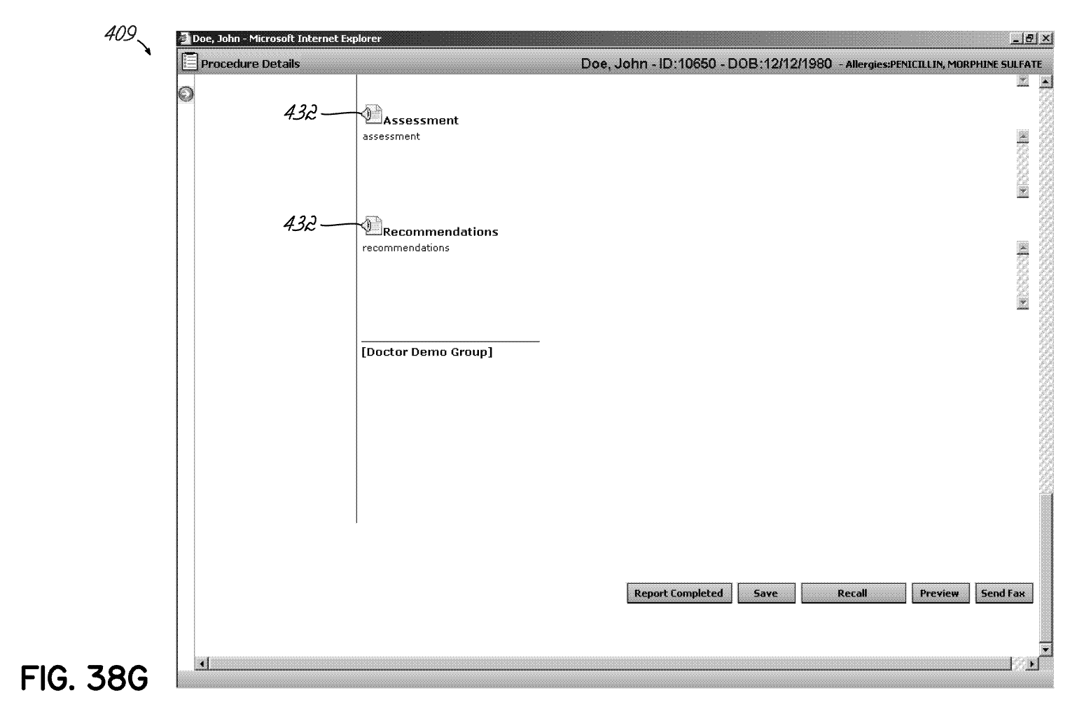

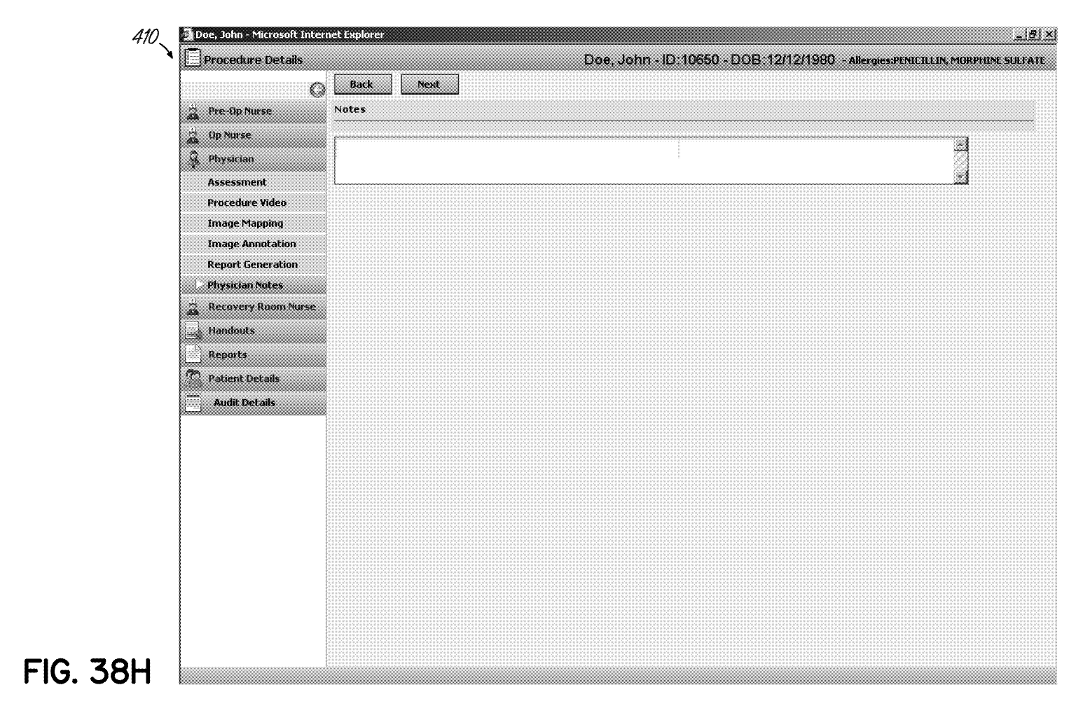

The system 10 is configured to load appropriate templates for each endoscopic procedure that are dependent on the appointment configured during patient scheduling (e.g., different templates or reference pictures may be loaded for a colonoscopy than are loaded for a bronchoscopy). These templates may change in response to user interaction with operative screens. FIG. 38A is an illustration of the operative assessment screen 398 that appears for the user to fill in and document an operative assessment. The user must check that they have the informed consent of the patient before the endoscopic procedure can begin. The user may indicate that some, or all, of the examinations have indicated normal conditions by selecting the “Add Normals” link for that assessment. The user selects the risk to the patient of the procedure in the ASA selection menu, and then selects the Mallampati score of the patient in the Mallampati selection menu.

FIG. 38B is an illustration of a procedure video screen 399 that appears for the user to view a video signal 400 from the camera system 38, captured images from the video signal 400, and associate data with the captured images. The user initializes the video signal 400 by selecting the Initialize Video button. This activates the video signal 400 and displays video from the camera system 38 on the procedure video screen 399. The video stream from the camera system 38 displayed in the video signal 400 may be stored by the computer 11 or system 10.

The user may capture an image from the video stream displayed on the video signal 400 by selecting the Grab Image button or activating the electronic switching interface 40. The video ActiveX control stores the image displayed on the video signal 400 at the time the electronic switching interface 40, but otherwise does not disrupt the video signal 400. The image is uploaded to the Procedure Tables 60 without user intervention and associated with a timestamp corresponding to the time the image was captured.

Capturing an image may cause the system 10 to activate the voice recognition ActiveX control and convert any voiced utterances of the user into machine-readable input. In this way, the system 10 allows the user to associate metadata (i.e., location of a lesion, lesion type, action taken in regards to the lesion, and size of lesion) with the captured image. The voice recognition ActiveX control may be active for a sufficient time to allow the user to input relevant metadata. In one embodiment, the voice recognition ActiveX control is active for about twenty-five seconds after each image is captured. The user may keep the voice recognition ActiveX control active for longer by saying “Extend.” The user may also configure the image with metadata by selecting the appropriate entry from the menus shown on the procedure video screen 399 when the user does not want to use voice recognition.

If the video signal has malfunctioned the user may reset the video stream by selecting the Reset Streaming button. When the camera capture control 46 has malfunctioned, the user may reset the capture control by selecting the Reset Trigger button. The user may cycle through video ports of the computer 11 to search for a video stream by selecting the Video Source button.

In rare or emergency situations, the patient may undergo two or more endoscopic procedures during an appointment or have a different endoscopic procedure performed than that scheduled. To this end, the user may select or change the procedure type from the procedure video screen 399 in the procedure type selection box 401 and select the Save button. When there is a change in selection, the system 10 internally updates the details of the patient, generates a new appointment which is immediately scheduled, and loads corresponding templates and menus for report generation.

One or more images captured from the video signal 400 are displayed on the procedure video screen 399 below the video signal 400. The procedure video screen 399 illustrates one or more images 402, each associated with metadata indicating the area the image was taken and the condition of the organ in the image. If there are multiple images, the user may navigate to other images using the arrow buttons. The user may import the image to the endoscopic procedure report by selecting the Approve for Report button 403. The user may delete an image by selecting the Delete button 404. The user may enter text about an image by selecting the Open Text Box button 405 and entering text about the image into a text input window (not shown). Finally, the user may dictate information about the image by selecting the Image Dictation button 406. This activates the voice recognition ActiveX control for a sufficient time to allow the user to enter input relevant metadata.

FIG. 38C is an illustration of the image mapping screen 407 that appears for the user to select capture images and include them in the endoscopic procedure report. The user may select whether a captured image is to be excluded from a user or patient version of the endoscopic procedure report, then drag and drop captured images to a master image 408. This master image 408 is an image that corresponds to the type of endoscopic procedure performed (i.e., a lower gastrointestinal and upper gastrointestinal tract image may be used as a master image for a colonoscopy, while a stomach image may be used as a master image for a gastroscopy). Thus, the user may associate the captured image with a location on the master image 408 where the captured image was taken. As such, the user may drag the captured image onto a specific location of the master image 108 and the system 10 documents the location where the captured image was placed on the master image 108. When two or more procedures have occurred in one appointment, the image mapping screen 407 will display all master images associated with those procedures, allowing the user to map captured images to multiple master images.

FIG. 38D is an illustration of the image annotation screen 408 that appears for the user to annotate captured images. The user may annotate the captured images to point out features of importance in the captured image. These annotations may include text distinctly defining the feature of importance. The annotations are shown on the image annotation screen 408 and in a report with their associated images, but are stored in the database 28 separately from the captured images in the event that the original captured images are later desired.

FIGS. 38E, 38F, and 38G are illustrations of the endoscopic procedure report generation screen 409 that appears for the user to generate an endoscopic procedure report. This screen will be described in detail later.

FIG. 38H is an illustration of the physician notes screen 410 that appears for the user to make notes about the patient and/or endoscopic procedure. These notes may not be viewed by the patient, but may be viewed by other users of the system 10. Thus, the system 10 allows information about a patient, such as their demeanor, attitude, handling instructions or other information that may wished to be kept from the patient, from being seen by the patient.

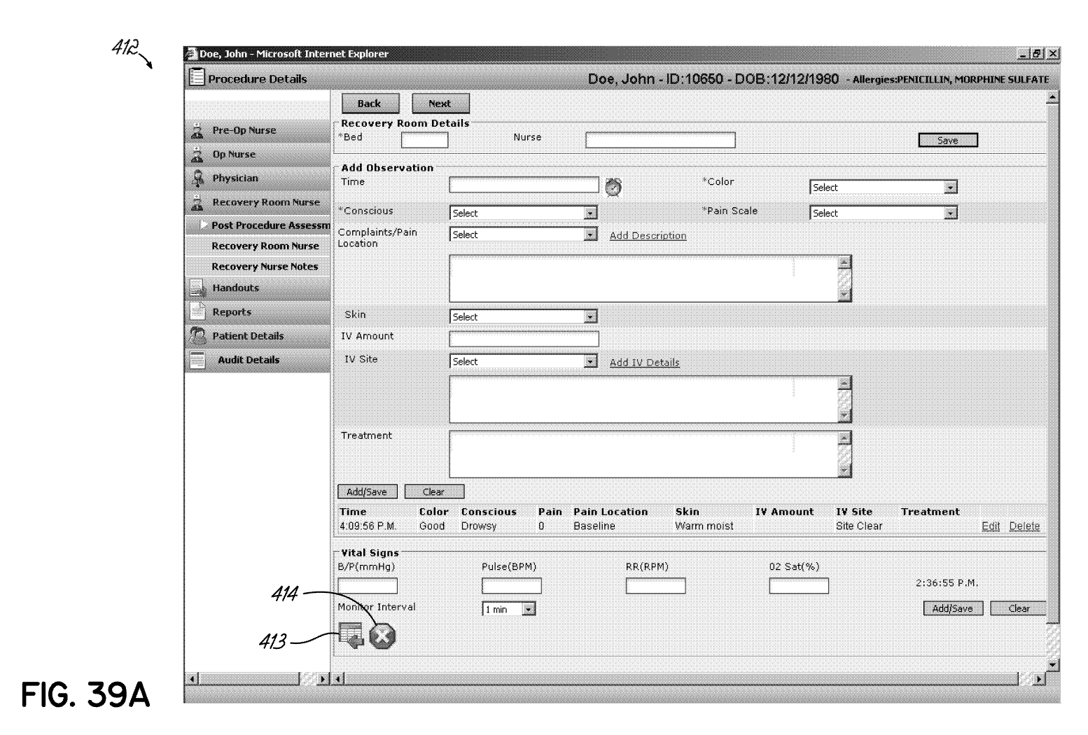

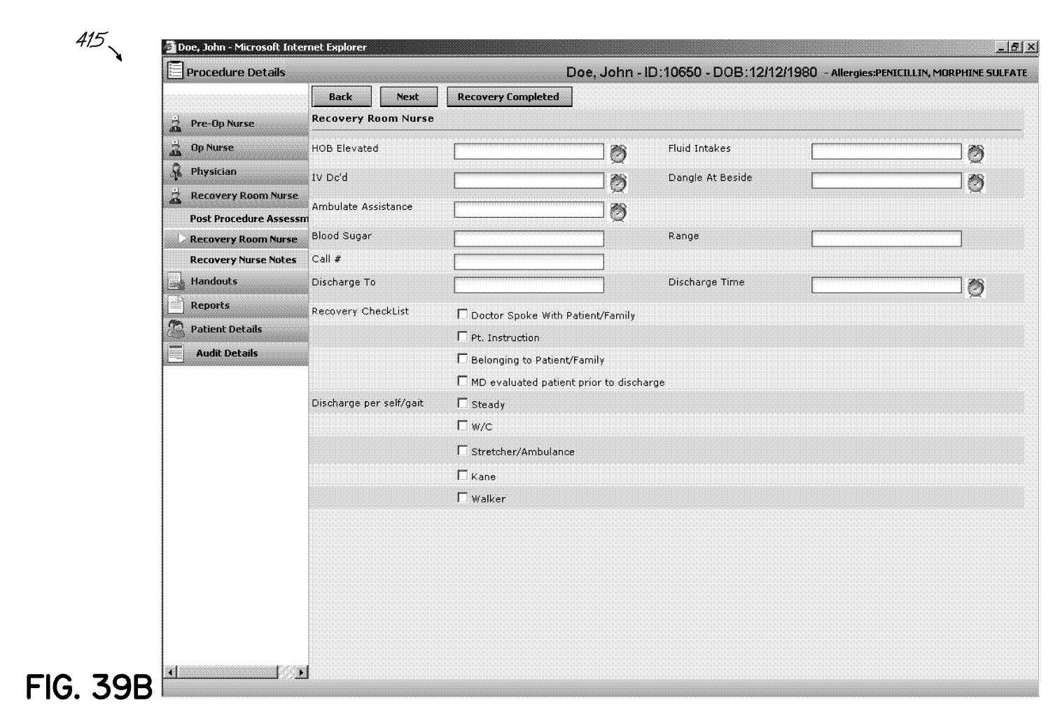

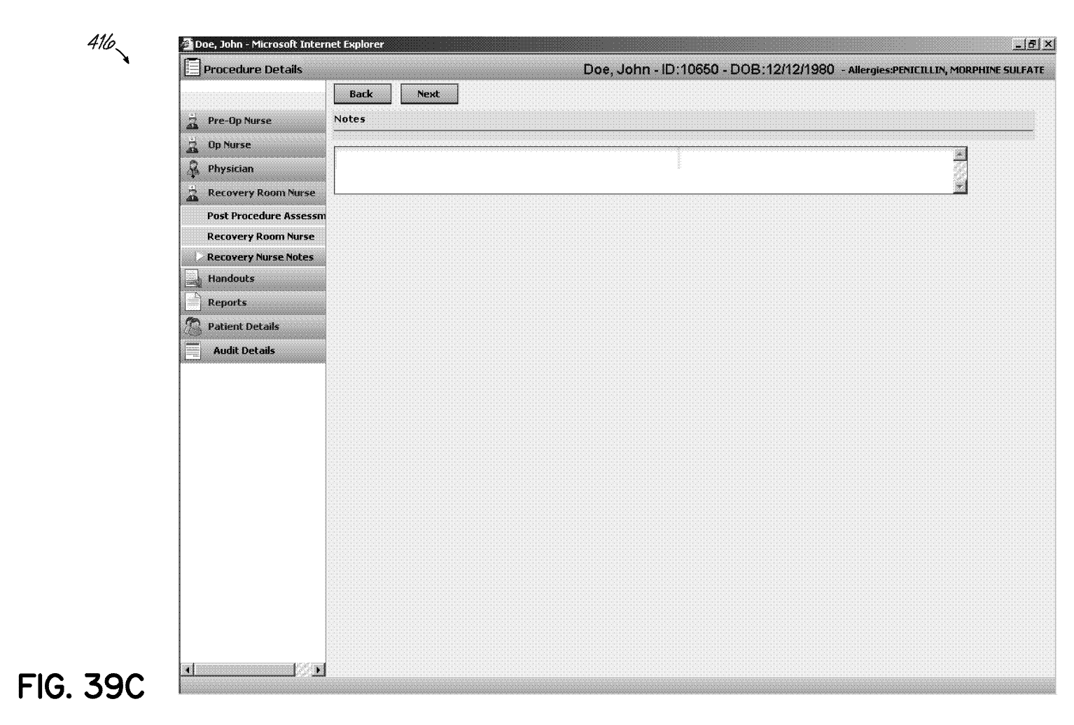

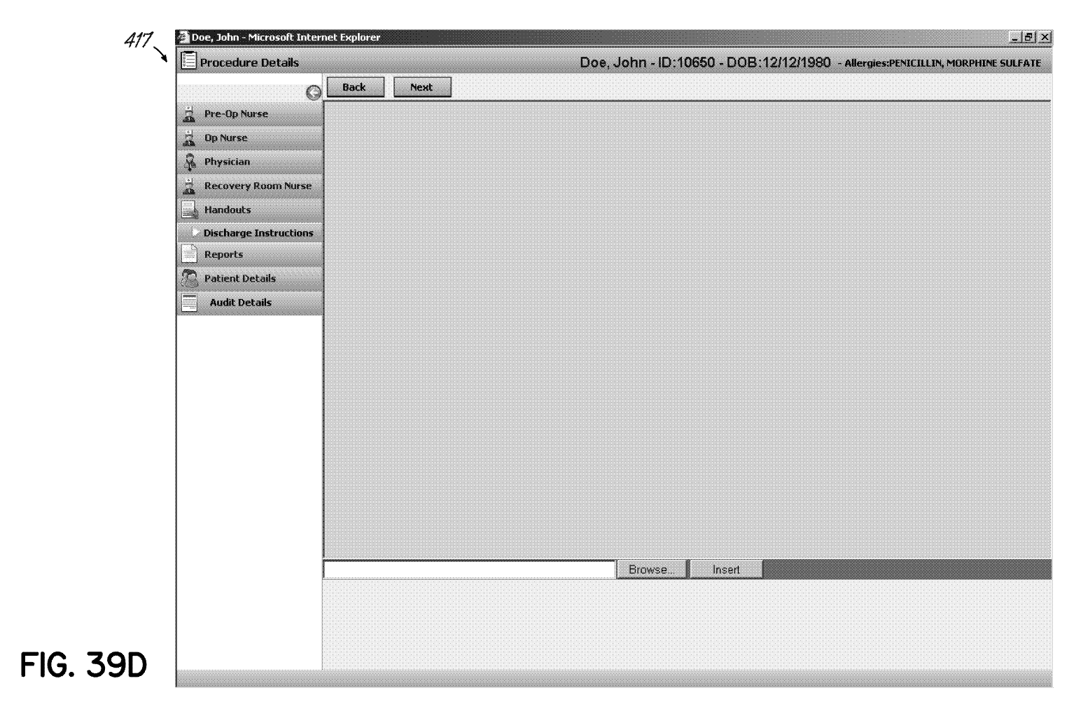

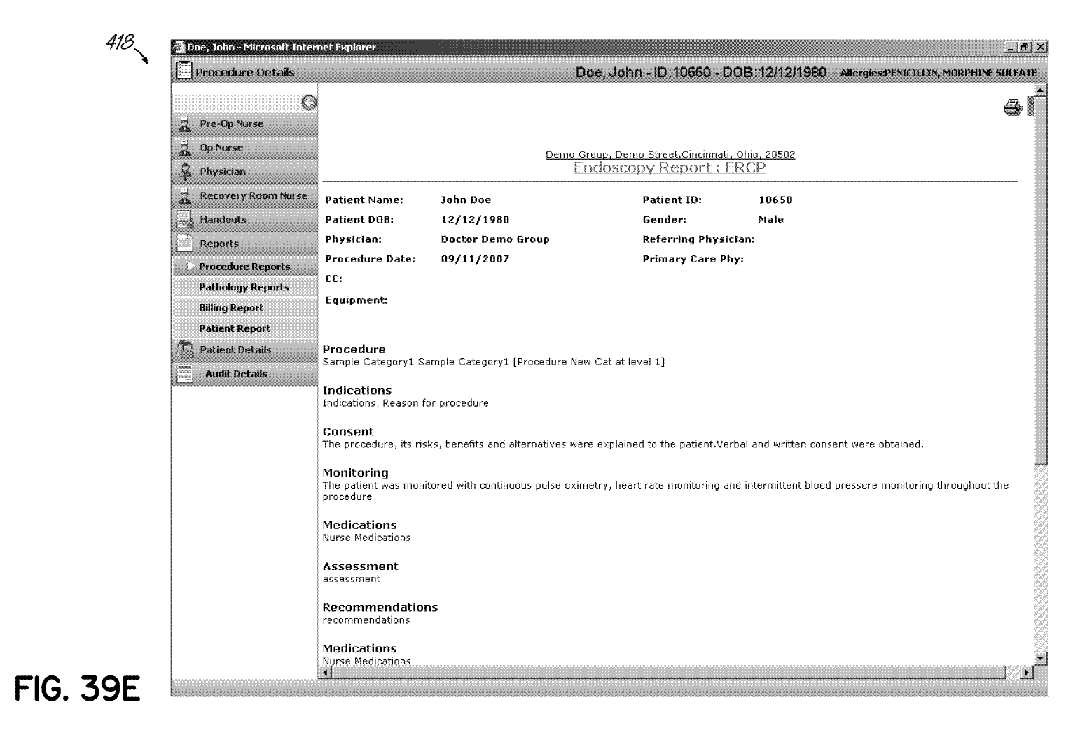

The patient is generally provided time to recover after the endoscopic procedure. A user typically monitors the patient after the endoscopic procedure, performs a post-procedure assessment, provides information handouts, and discharges the patient with an embodiment of computer 11 in electrical communication with the vital signs equipment 42. The computer 11 of the user may also include the microphone 36 and speaker 46, or the user may be in communication with the computer 11 through the wireless communication interface 48 by way of a wireless headset. FIG. 39A is an illustration of a post-procedure assessment screen 412 that appears for the user to document observations about the patient. When the user navigates to the post-procedure assessment screen 412 the system 10 loads the vital signs ActiveX control on computer 11 to detect and document the patient vital signs communicated from the vital signs equipment 42. The user begins documenting vital signs by selecting the Start Vital Signs Capture button 413. Additionally, the user may enter vital signs into the text boxes provided on the post-procedure assessment screen 412, as well as information about at least one of the following: a bed number, the user who supervised the patient, the time of the observation, the color of the skin at the observation, the consciousness of the patient, pain suffered by the patient, a complaint and pain location of the patient, an indication of the skin of the patient, and an IV administered to the patient, including the amount, the IV site, and the treatment administered to the patient. The user may stop documenting vital signs by selecting the Stop Vital Signs Capture button 414

FIG. 39B is an illustration of the recovery room nurse screen 415 that appears for the user to enter final observations of the patient before discharge. From the recovery room nurse screen 415, the user may enter information about at least one of the following: whether the HOB was elevated, fluid intake of the patient, IV information of the patient, whether the patient was able to dangle at the bedside, whether the patient required ambulatory assistance, the blood sugar of the patient, the blood sugar range of the patient, the CAL number of the patient, who the patient was discharged to, and the time of the discharge. The user may also indicate whether the doctor spoke to the patient or family, whether patient instructions were given, whether belongings were given to the patient or the family and whether the doctor evaluated the patient prior to the discharge. On the recovery room nurse screen 415, the user may also indicate the state of the patient at discharge including whether they were steady, whether they went to the water closet, whether they required a stretcher or other ambulatory assistance, and whether they required a cane or a walker.

FIG. 39C is an illustration of the recovery room nurse notes screen 416 that appears for the user to make notes about the patient and/or patient recovery.

FIG. 39D is an illustration of the handouts screen 417 that appears for the user to print off handouts for the user.

FIG. 39E is an illustration of a reports screen 418 that appears for the user to view and/or print off reports that may be useful for the patient. As shown in FIG. 39E, the user may view and/or print the endoscopic procedure report, pathology report, billing report, and patient report that correspond to the appointment and endoscopic procedure.

From the screens shown throughout FIGS. 36A-36I, FIGS. 37A-37G, FIGS. 38A-38H, and FIGS. 39A-39E the user may view and/or edit patient details by selecting the Patient Details button, or view audit details of the procedure by selecting the Audit Details button. Referring back to FIG. 35, the user may export one or more procedures to an Excel spreadsheet by selecting the procedures on the procedure screen 376 desktop 210 and selecting the Export to Excel button. Similarly, the user may print a procedure by selecting the procedure on the procedure screen 376 desktop 210 and selecting the Print Procedure button.

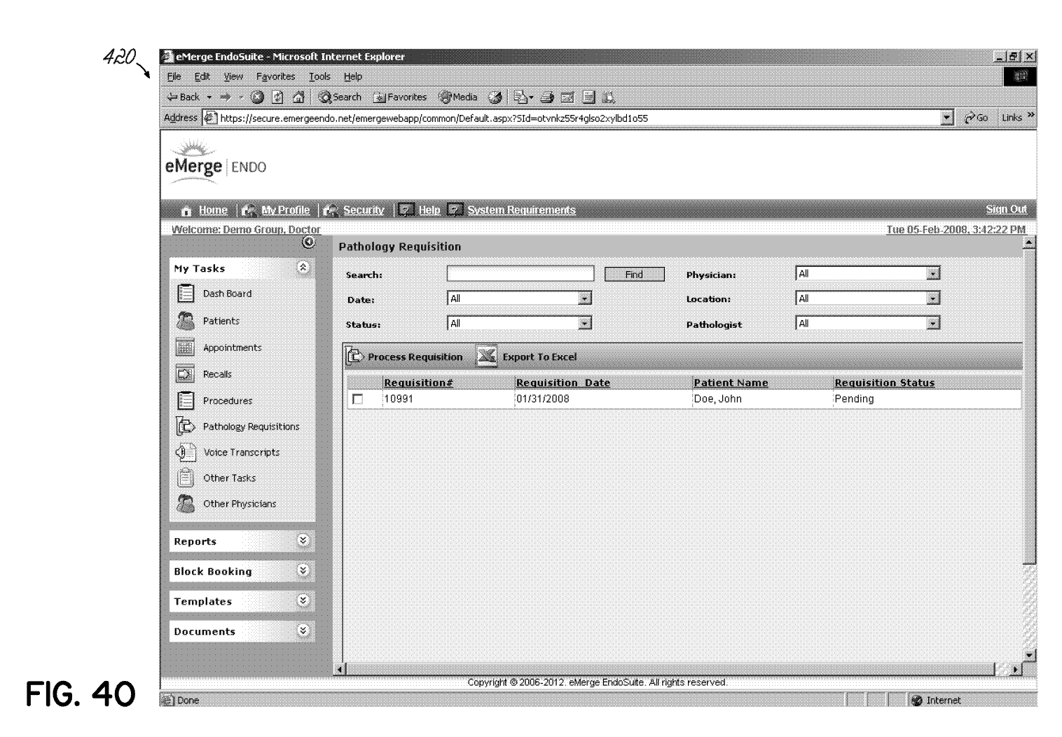

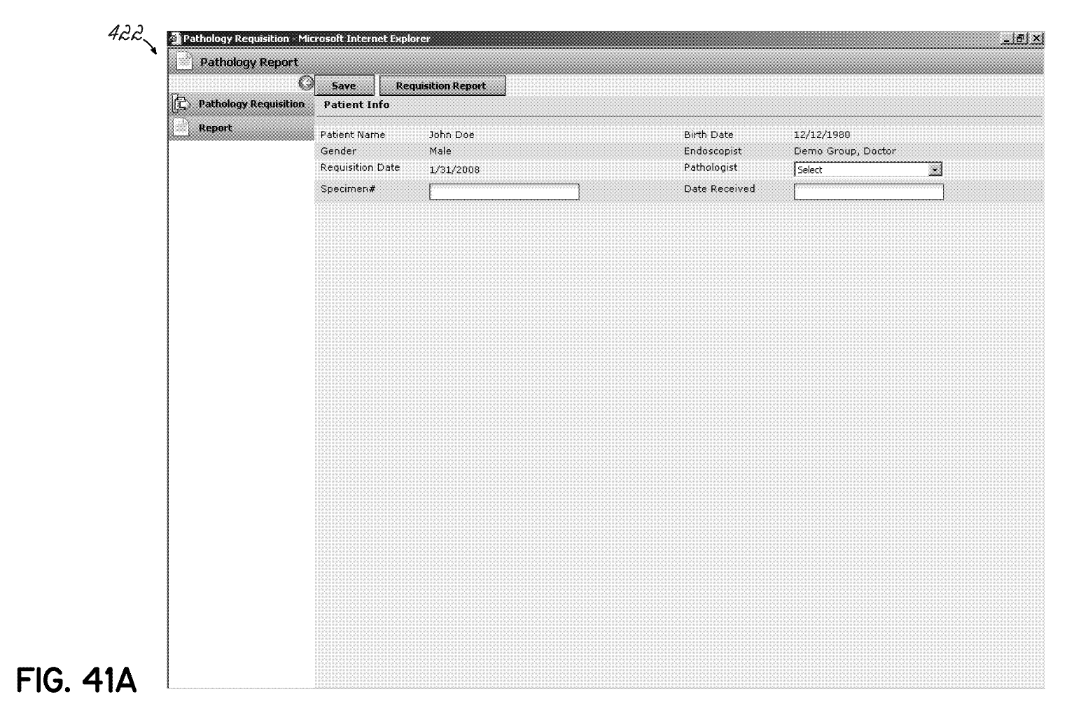

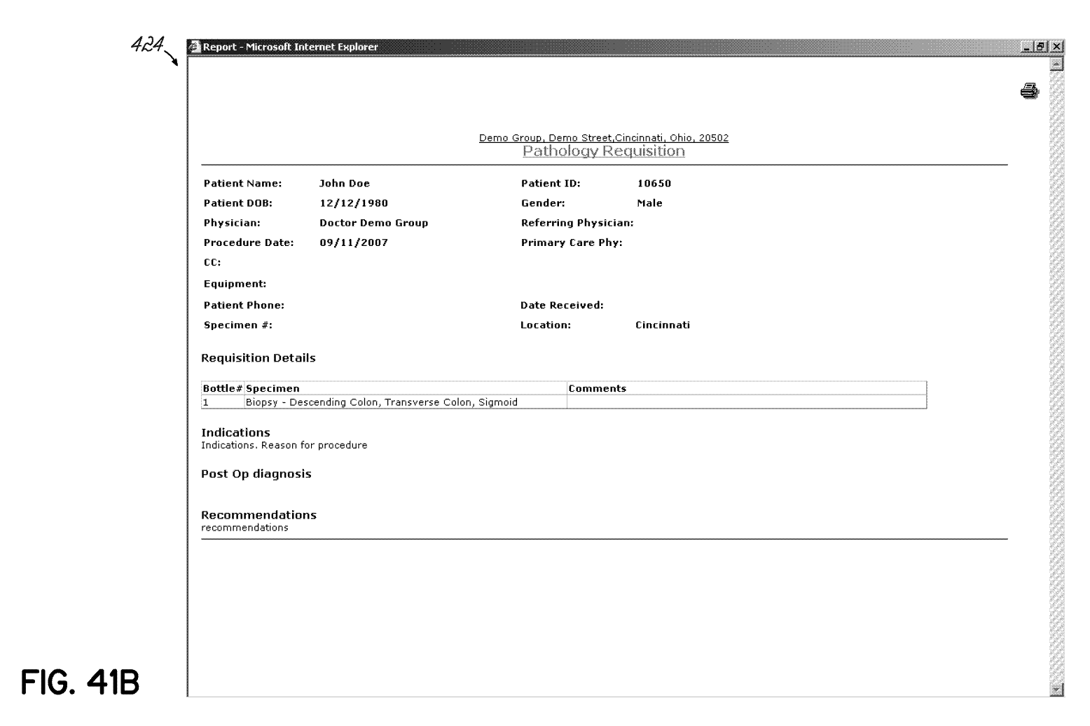

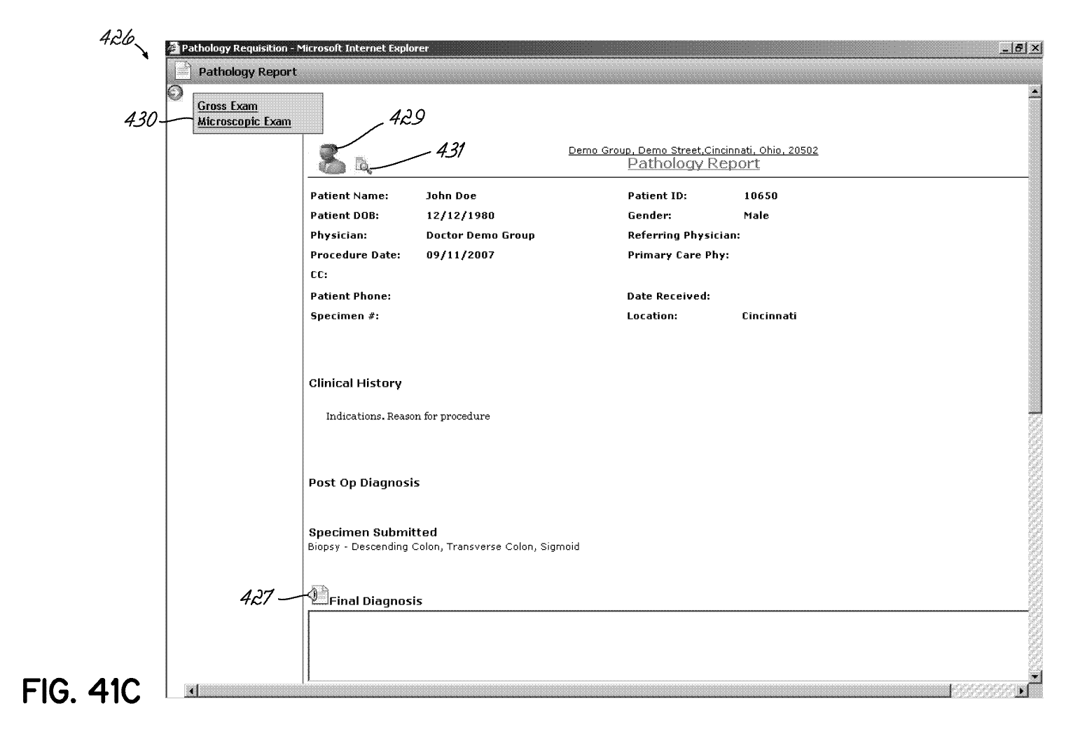

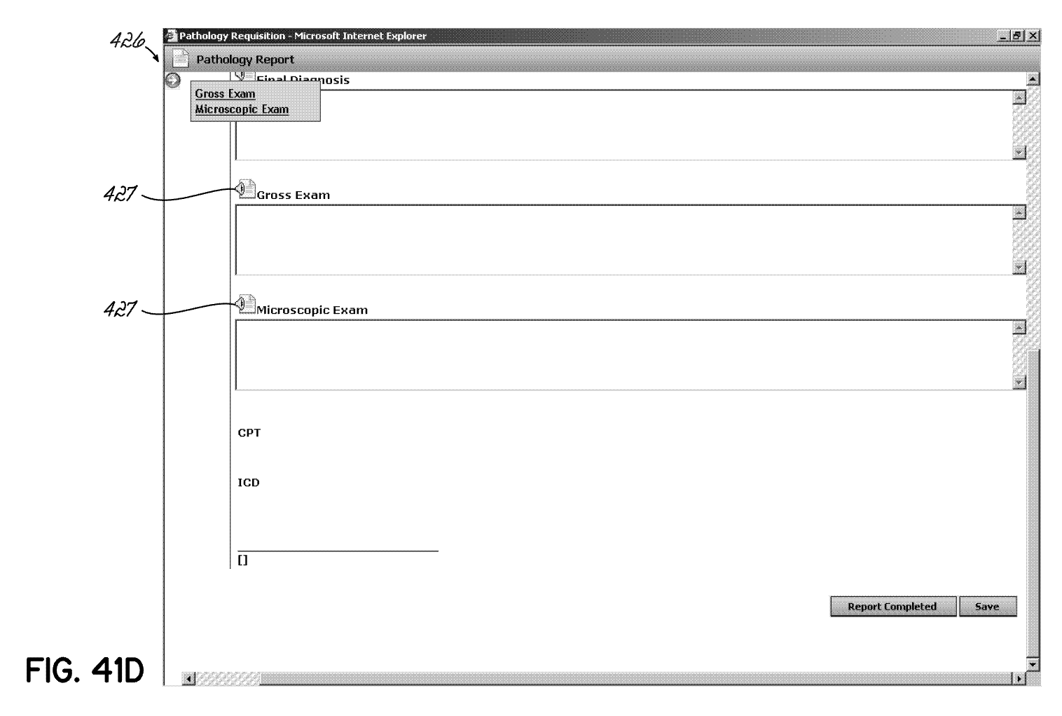

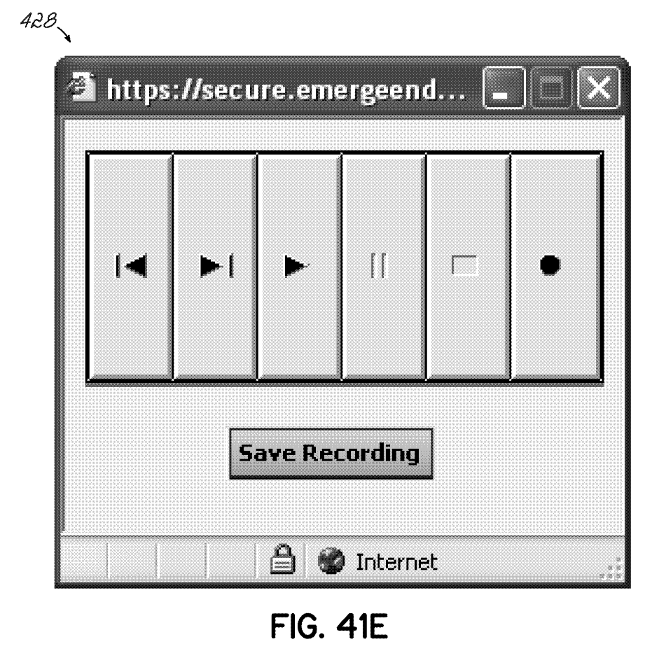

Referring back to FIG. 28, the pathologist generates a pathology report in block 308. A pathological analysis and report may be performed by a user (i.e., pathology technician and/or pathologist) with an embodiment of computer 11 that includes the microphone 36 and speaker 46, or the user may be in communication with the computer 11 through the wireless communication interface 48 by way of a wireless headset. FIG. 40 is an illustration of a pathology requisition screen 420 that the user views after selecting the “Pathology Requisitions” link in the “My Tasks” dropdown in the user menu 208. The user may access a pathology requisition by selecting the requisition from the pathology requisition screen 420 desktop 210 and selecting the Process Requisition button. FIG. 41A is an illustration of a pathology requisition screen 422 that appears for the user to enter the specimen number and other details associated with the pathology requisition. From the pathology requisition screen 422, the user may enter information about the pathologist, the specimen number and the date received. Data from the pathology requisition screen 422 is saved in the Procedure Tables 60. The user may select the Save button to save the entered data or select the Requisition Report button to view information about the requisition. FIG. 41B is an illustration of the requisition report 424 that the user may view to understand the context of the pathology requisition. Returning to FIG. 41A, the user may select the Report button to proceed to a pathology report generation screen.

FIGS. 41C through 41D are illustrations of a pathology report generation screen 426 that appears for the user to generate a pathology report. On the pathology report generation screen 426, report text boxes to enter information include the final diagnosis, the gross examination, and the microscopic examination of the tissue sample. After performing an examination on the specimen, the user enters their findings in the report section text boxes provided. Alternately, the user can select an Audio Dictation button 427 above any of the report sections and dictate findings that can later be transcribed by a transcriber. FIG. 41E is an illustration of an screen 428 that includes an audio ActiveX control to capture the pathologist's dictation. As such, the audio ActiveX control is operable to document the voice of the pathologist picked up by the microphone 36 and store the dictation as an audio file in the database. This audio file can later be accessed by a transcriber and transcribed into the associated report section text box of the pathology report screen 426. The user begins recording the dictation by selecting the Record button on the audio ActiveX control. Other standard playback controls allow the user to review, overwrite, play, fast forward, and rewind the audio file. The pathologist saves the recording by selecting the Save Recording button.

In addition to transcription, the user may utilize the voice recognition ActiveX control to issue commands and generate the pathology report. In one embodiment, the pathologist selects the Voice Recognition button 429 on the pathology report generation screen 426 to begin the voice recognition and convert voiced utterances to machine-readable input. In an alternate embodiment, the pathologist may say “Begin Pathology Report” to begin the voice recognition and convert voiced utterances to machine-readable input. In one embodiment, to stop the voice recognition, the pathologist selects the Voice Recognition button 429 again. In an alternate embodiment, to stop the voice recognition, the pathologist may say “End Pathology Report.”

The pathology report generation screen 426 is configured with report templates that are operable to automatically generate text and formatting for the pathology report. The pathology report generation screen 426 is further configured with a pathologist template menu 430 that is customized for generating pathology reports. The pathologist template menu 430 may draw upon data stored in the database 28 to automatically generate content that can be inserted into the pathology report.

The pathologist may review the pathology report by selecting a Pathology Report Preview button 431. This causes a new window to appear that contains a preview of the pathology report. The pathology report is saved by selecting a Save button at the bottom of the pathology report screen 426. The pathology report is finalized by selecting a Report Completed button at the bottom of the pathology report screen 426. Finalizing the pathology report updates the status of the pathology requisition and saves the pathology report in the Report Tables 64. Referring back to FIG. 40, the user may export one or more pathology requisitions to an Excel spreadsheet by selecting the pathology requisition on the pathology requisition screen 420 desktop 210 and selecting the Export to Excel button

Referring back to FIG. 28, a user (i.e., physician) generates the endoscopic procedure report in block 310. The computer 11 of the user may also include the microphone 36 and speaker 46, or the user may be in communication with the computer 11 through the wireless communication interface 48 by way of a wireless headset. Referring back to FIGS. 38E through 38G, these figures are illustrations of the endoscopic procedure report generation screen 409 that appears for the user to generate an endoscopic procedure report. The user may access the endoscopic procedure report generation screen 409 by selecting the “Procedures” link of the “My Tasks” dropdown in the user menu 208 of FIG. 35, selecting a procedure from the procedure screen 376 desktop 210 and selecting the Encounter button, then selecting the Report Generation selection shown throughout FIGS. 38A through 38D. The endoscopic procedure report generation screen 409 may include report text boxes for the physician to enter information about the procedure, indications, consent of the patient, monitoring of the patient that was performed, medications administered to the patient, details of the procedure, a post-operative diagnoses, an assessment of the patient and recommendations of the patient.

The user may configure report section text boxes with general endoscopic procedure information, indications, patient consent, results of patient monitoring, medications (i.e., patient medications already taken and user administered medications), details of the endoscopic procedure, post-operative diagnoses, recommendations, and details of various assessments. The user may select an Audio Dictation button 432 above any of the report sections to launch the audio ActiveX control and dictate a report section that can later be transcribed by the transcriber. The user may also use the voice recognition ActiveX control to convert speech to machine-readable input by selecting the Voice Recognition button 433. To stop the voice recognition ActiveX control the user selects the Voice Recognition button 433 again.

The endoscopic procedure report generation screen 409 is configured with report templates automatically generate text and formatting for the endoscopic procedure report. The endoscopic procedure report generation screen 409 is further configured with a physician template menu 434 that may be customized to generate endoscopic procedure reports. The physician template menu 434 may draw upon data stored in the database to automatically generate content that can be inserted into the endoscopic procedure report in response to a selection by the user of that data.

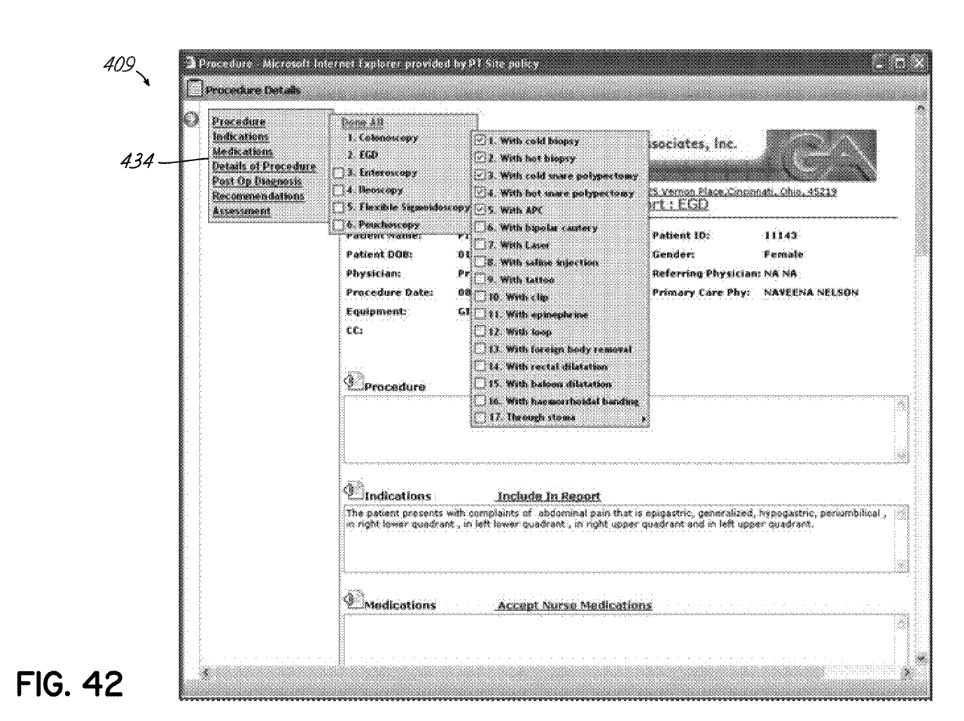

FIG. 42 is an exemplary illustration of an endoscopic procedure report generation screen 409 in which the “Procedure” menu link of the physician template menu 434 has been expanded to show menus operable to fill in the “Procedure” report section. By selecting various checkboxes, the physician indicates that those actions were performed during the endoscopic procedure. The actions are then automatically entered into the “Procedure” text box of the endoscopic procedure report generation screen 409 with a sentence structure defined by the template. The endoscopic procedure report generation screen 409 may be configured with other templates specific to the report sections. For example, the endoscopic procedure report may include an “Indications” section, which describes the symptoms of the patient. The user documents the symptoms of the patient during the pre-operative assessment as details in the discussion of FIG. 36D. Referring back to FIG. 38E, by selecting the “Include In Report” link above the “Indications” report section, the indications report template accesses the data associated with the patient symptoms stored in the database, automatically generates text documenting the symptoms suffered by the patient, and inserts that text into the endoscopic procedure report.

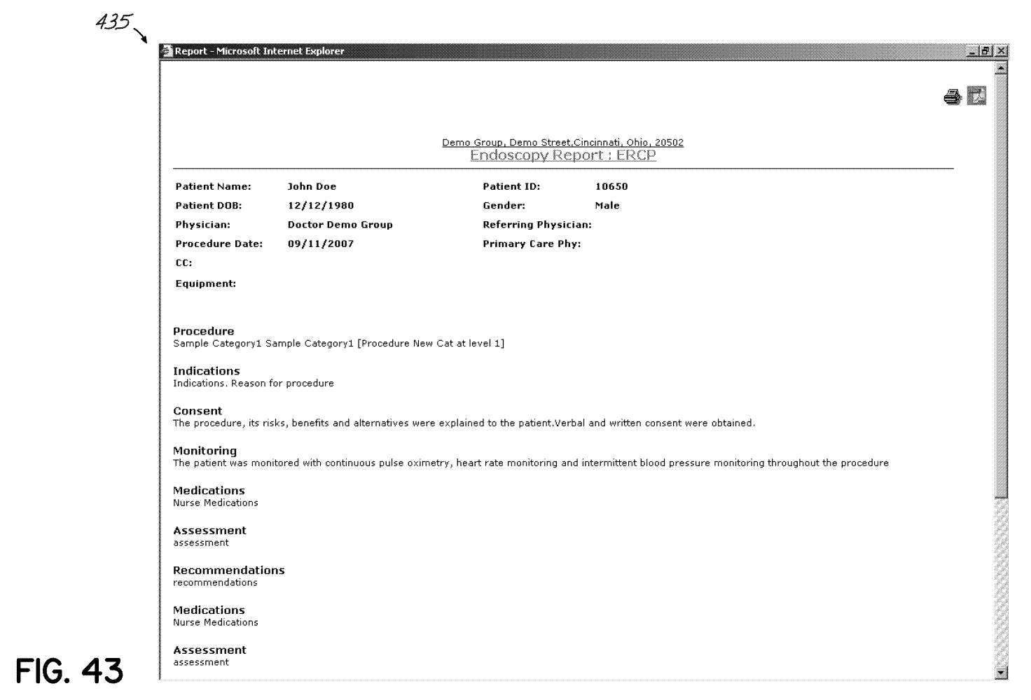

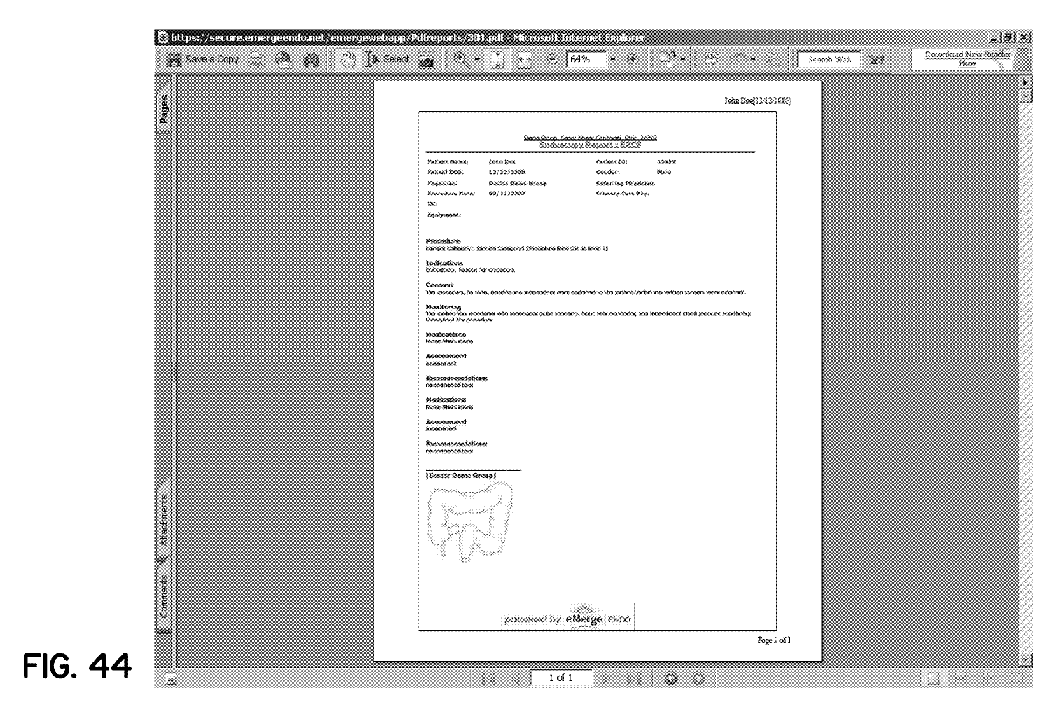

The user may review the endoscopic procedure report by selecting a Preview button on the endoscopic procedure report generation screen 409. FIG. 43 is an illustration of an endoscopic report preview screen 435 that appears for the user to preview the endoscopic procedure report. From this screen the endoscopic procedure report may be printed or converted to an Adobe PDF. FIG. 44 is an illustration of an endoscopic procedure report displayed as an Adobe PDF. The endoscopic procedure report in the PDF format can be saved or printed from the screen illustrated in FIG. 44.

Returning to FIG. 38E, the report is saved by selecting a Save button at the bottom of the endoscopic procedure report generation screen 409. The report is finalized by selecting a Report Completed button. Finalizing the report updates the status of the report and saves the report in the Report Tables 64.

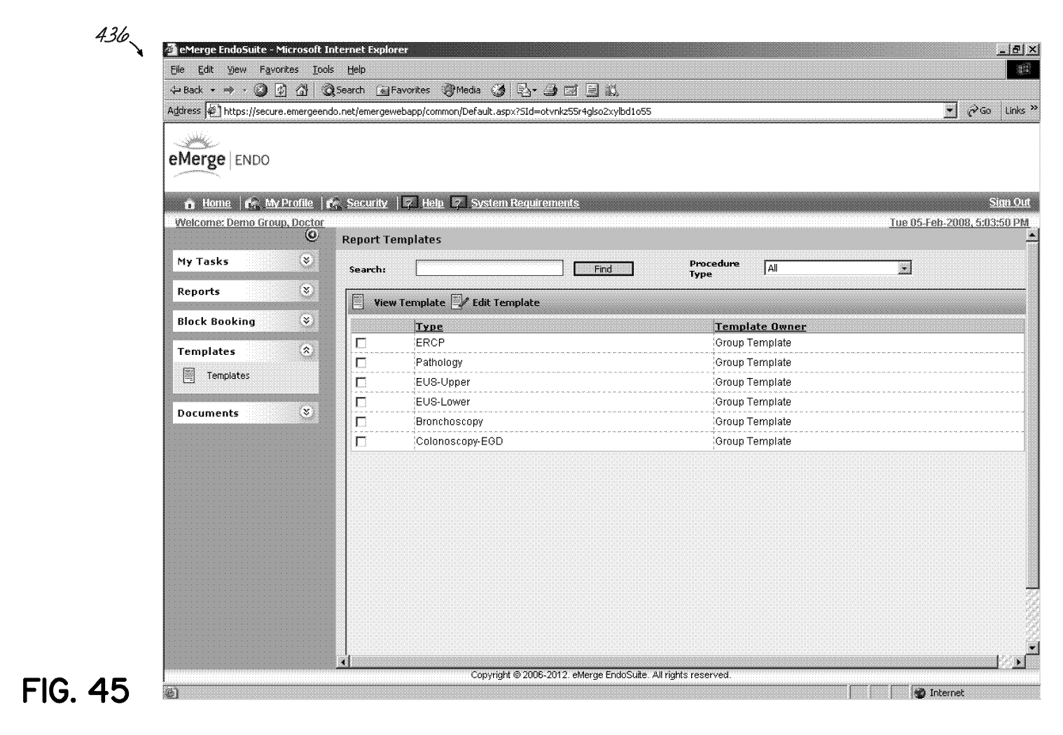

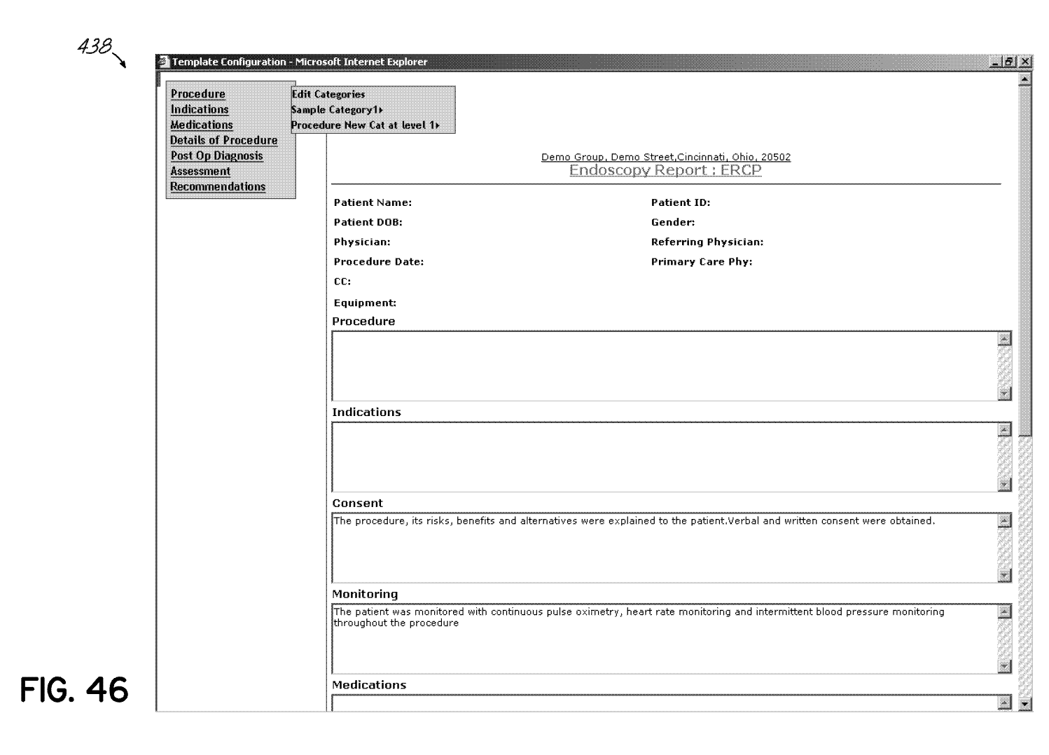

The templates used for report generation may be user specific or group practice specific. Default templates of the system 10 are specific to each group practice, but users may create their own templates. As such, each user authorized to generate reports may create their own templates. FIG. 45 is an illustration of the template screen 436 accessible by the user (i.e., pathologist and physician) by selecting the “Templates” link in the “Templates” dropdown of the user menu 208. The user may view a template by selecting a template in the desktop and selecting the View Template button on the template screen 436. The user may create a template by selecting a template in the desktop 210 and selecting the Edit Template button on the template screen 436. FIG. 46 is an illustration of a template editing screen 438 that appears for the user to edit templates. The templates that may be edited are the text boxes for the reports and the categories or sub-categories in the template menu. The user may enter text into the text boxes that are stored as a template for use with future reports. As shown in FIG. 46, the user is attempting to edit the “Procedure” category of the template menu. The user may edit a category or sub-category of the template menu by expanding the template menu for that category or sub-category and selecting the “Edit Categories” link from the template menu.

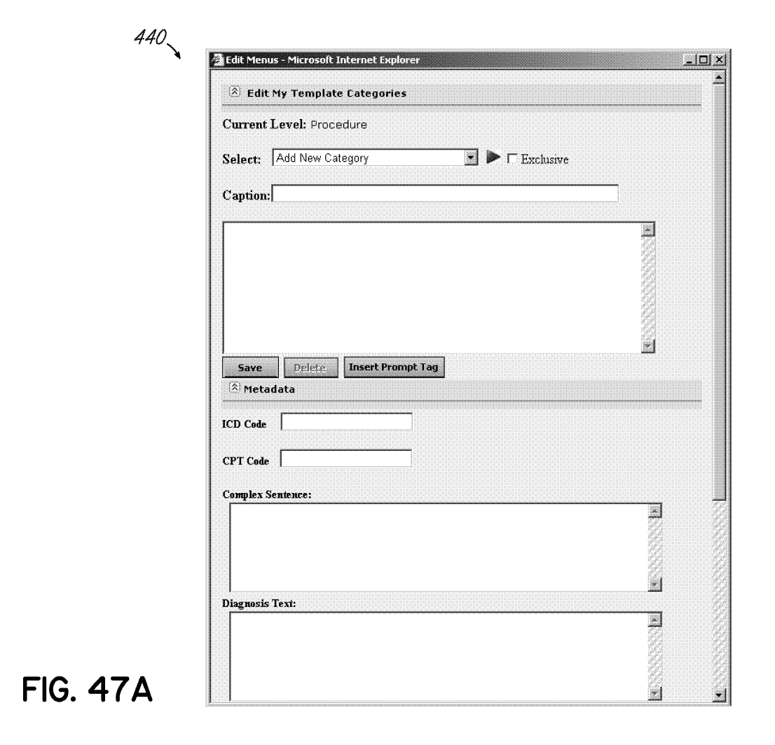

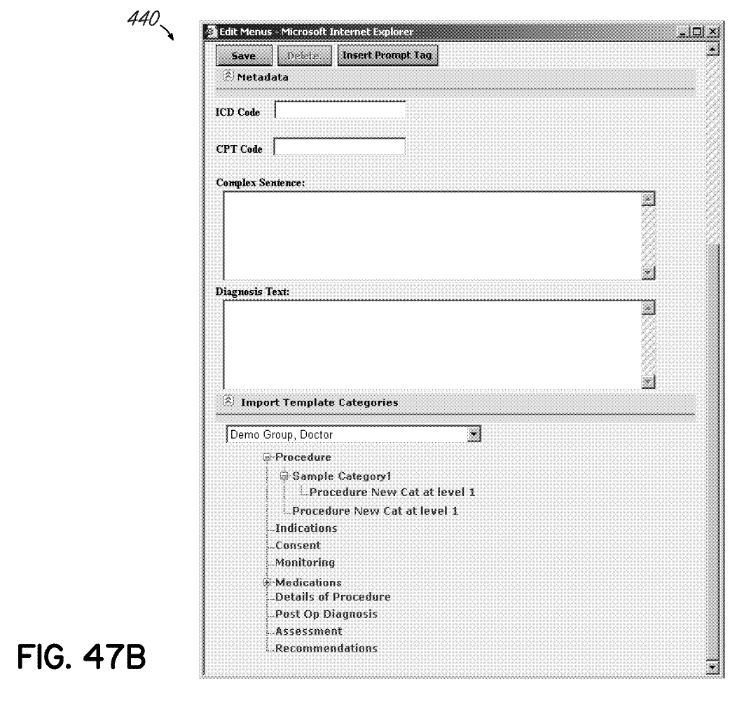

FIGS. 47A and 47B are illustrations of a template menu editing screen 440 that appears for the user to add, edit, or delete items from a category or sub-category of the template menu. The user may also add or edit the text of menu categories or sub-categories, add or edit text to be configured in report sections, utilize a tree view to traverse through the complete menu hierarchy, and assign CPT and ICD codes to import data to a report during report generation when those codes are selected in the menu. As such, the user may enter information about at least one of the following from the template menu editing screen 440: a new category of template, a caption for the template, ICD codes for the template, CPT codes for the template, complex sentences for the template, diagnosis text for the template, and general metadata for the template. Each template menu category or sub-category may be defined for a group practice or a specific user. The user saves the template by selecting the Save button.

Returning to FIG. 46 and the template editing screen 438, the user saves the report template by selecting the Save button at the bottom of the screen (not shown). The system 10 saves the report template as a new template, preventing the original from being changed.

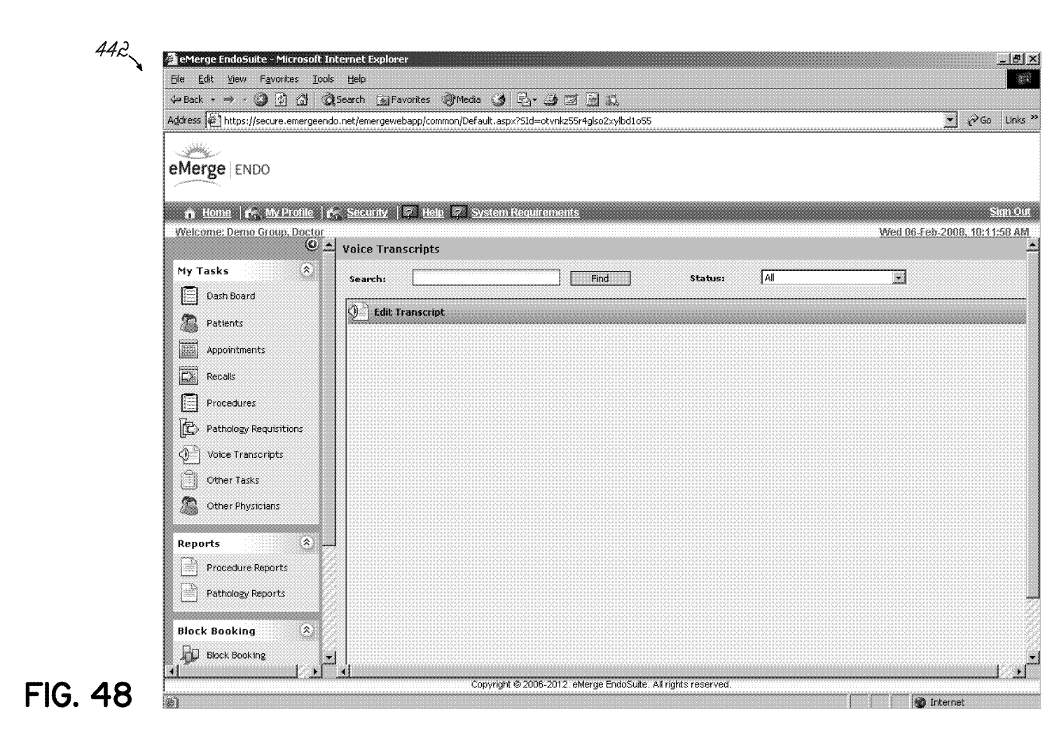

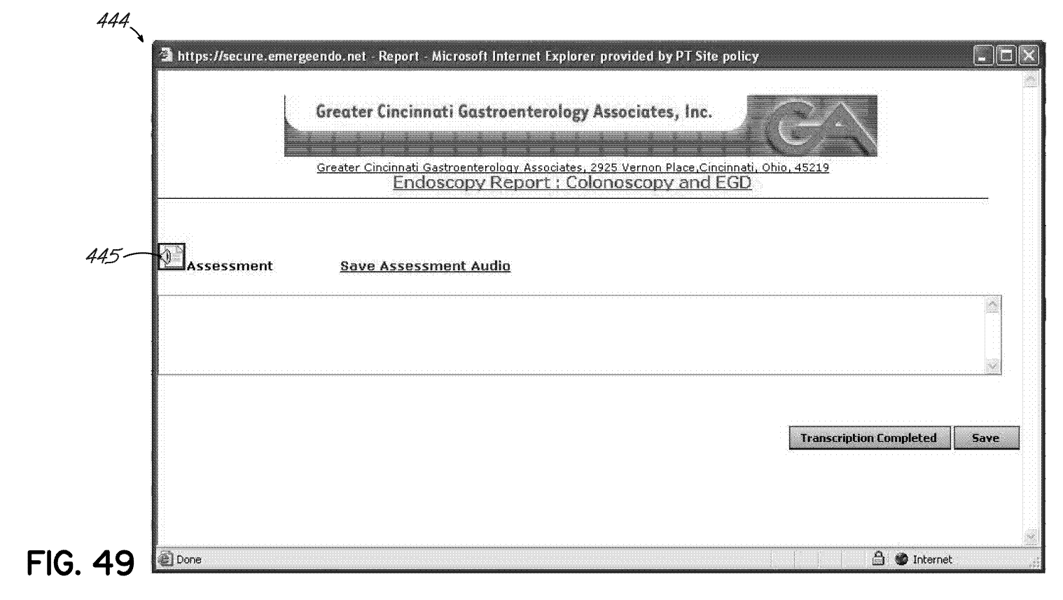

Transcriptions must be complete before the pathology report or endoscopic procedure report can be approved. FIG. 48 is an illustration of a voice transcripts screen 442 that the user (i.e., the physician or transcriber) views after selecting the “Voice Transcripts” link in the “My Tasks” dropdown in the user menu 208. The user may process a voice transcription by selecting a transcript from the voice transcripts screen 442 desktop 210 and selecting the Edit Transcript button. FIG. 49 is an illustration of a transcription screen 444 that appears for the user to transcribe the voice transcript. The transcription screen 444 includes at least one report section with a report section audio button 445. Selecting the report section audio button 445 launches a multimedia application (not shown) to play the audio file associated with that report section. The multimedia application is operable to play audio files, and in one embodiment may be a Microsoft Multimedia Control or other multimedia application that is bundled with an operating system of computer 11. As the audio file plays, the transcriber transcribes the dictation into the appropriate report section text box. The text entered into each report section is saved by selecting a Save button at the bottom of the voice transcripts screen 444. The transcription is finalized by selecting a Transcription Completed button at the bottom of the voice transcripts screen 444. Finalizing the transcription updates the status of the transcription to “Transcription Completed” and saves the text entered into each report section.

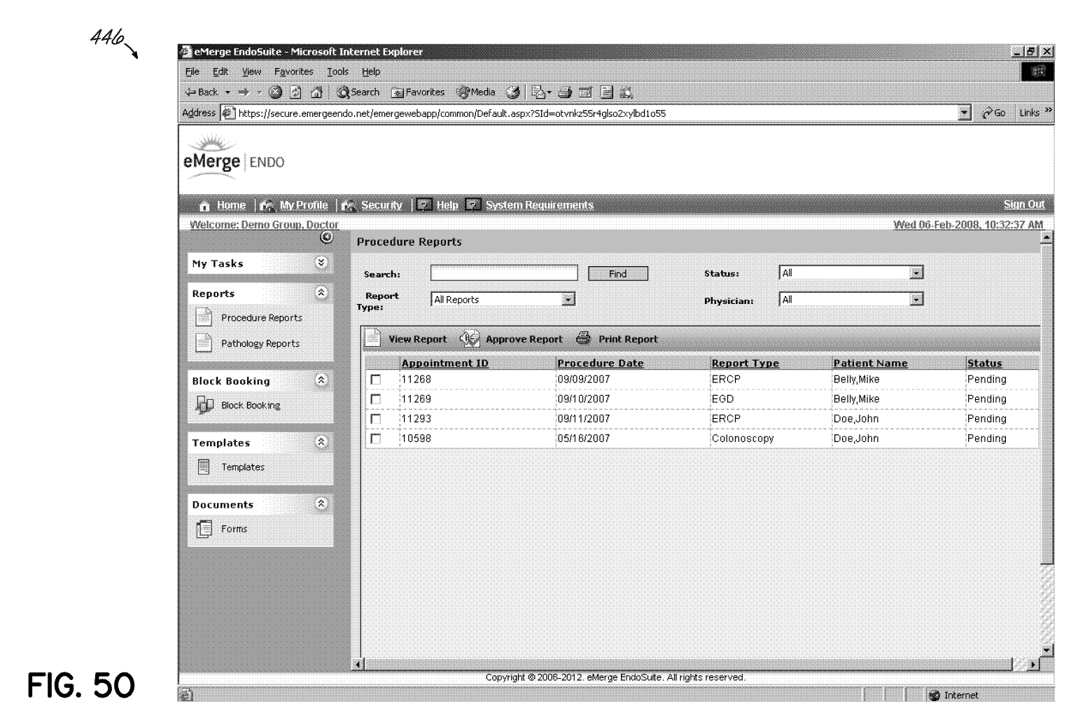

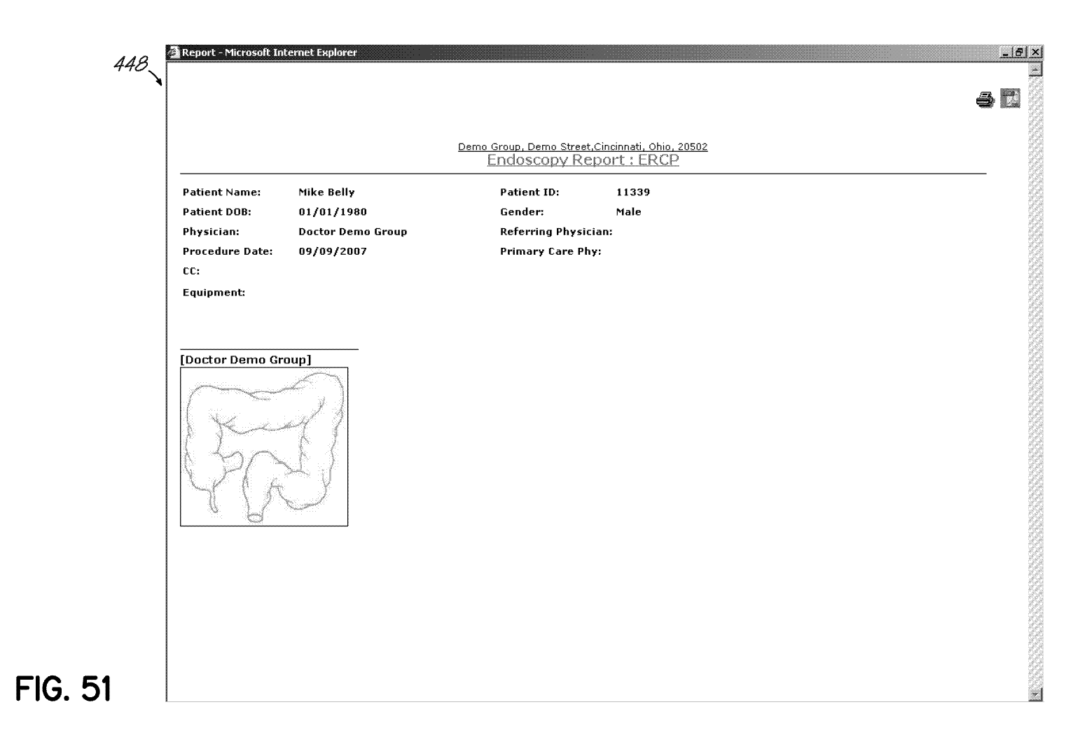

The final step in generating the endoscopic procedure report is to approve the report. FIG. 50 is an illustration of a report approval screen 446 that the user views after selecting the “Procedure Reports” link from the “Reports” dropdown in the user menu 208. From the report approval screen 446, the user (i.e., physician or medical assistant) may approve the endoscopic procedure report. The user may first view the endoscopic procedure report by selecting a report from the desktop 210 and selecting the View Report button. This causes a new window to appear in which the user may view and edit the endoscopic procedure report. FIG. 51 is an illustration of a final report screen 448 in which the user may review the endoscopic procedure report. Returning to FIG. 50, if the endoscopic procedure report is acceptable, the user approves the endoscopic procedure report by selecting that report from the report approval screen 446 desktop 210 and selecting the Approve Report button. The user may print a report by selecting that report from the report approval screen 446 desktop 210 and selecting the Print Report button.

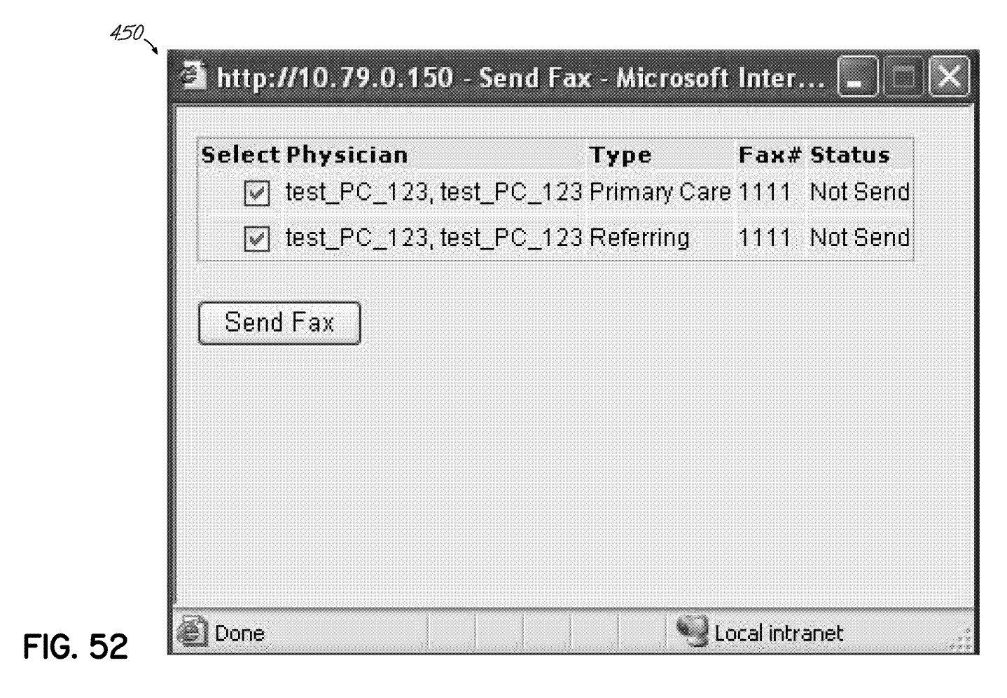

When the user approves an endoscopic procedure report, the system 10 opens a new window to send a communication of the report to the primary care physician, referring care physician, and/or any other physicians previously specified to receive the endoscopic procedure report. FIG. 52 is an illustration of the report fax screen 450 in which the user may review and select which persons will receive a copy of the approved endoscopic procedure report by placing a checkmark next to their name. The persons who may receive a copy of the approved endoscopic procedure report are retrieved from database 28 data that indicates other physicians of the patient. The user sends the approved endoscopic procedure report to selected parties by selecting the Send Fax button or chooses not to send the approved endoscopic procedure report by closing the report fax screen 450.

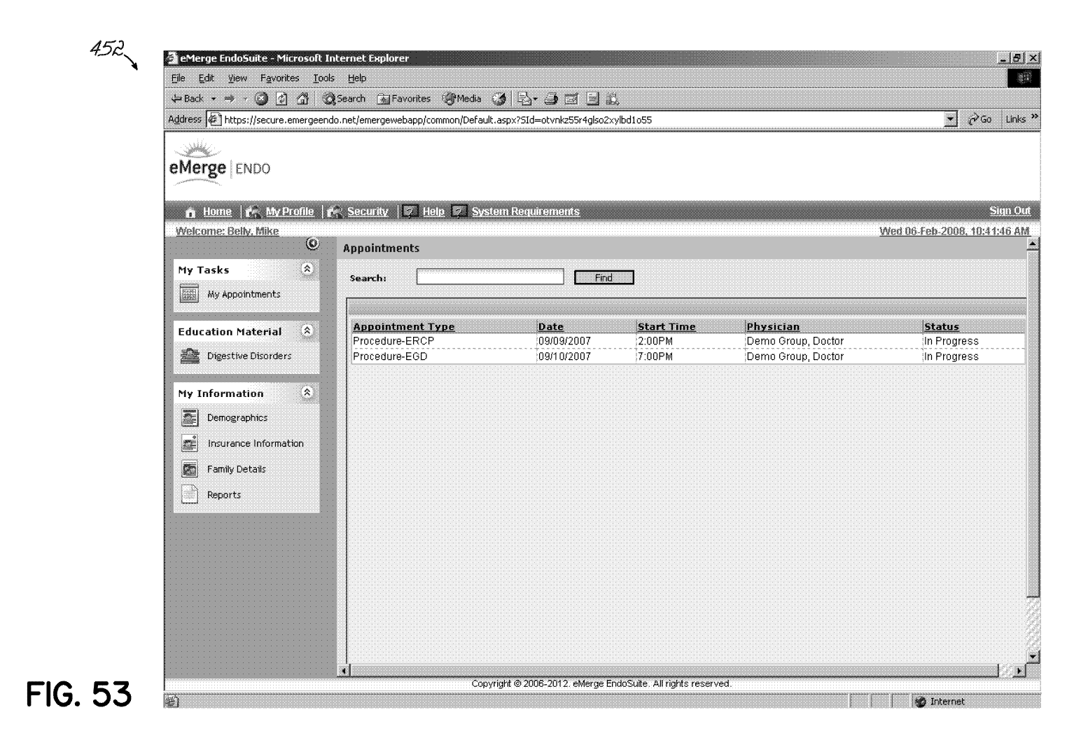

Referring back to FIG. 28, the system 10 provides a patient portal for the patient to view information specific to their diagnosis, endoscopic procedures, endoscopic appointments, and personal information in block 312. In this way, the system 10 allows the patient to login and view or edit limited details. FIG. 53 is an illustration of a patient appointment screen 452 that the patient views after selecting the “My Appointments” link from the “My Tasks” link in the user menu 208. The patient appointment screen 452 provides the patient a view to past or future endoscopic procedure appointments.

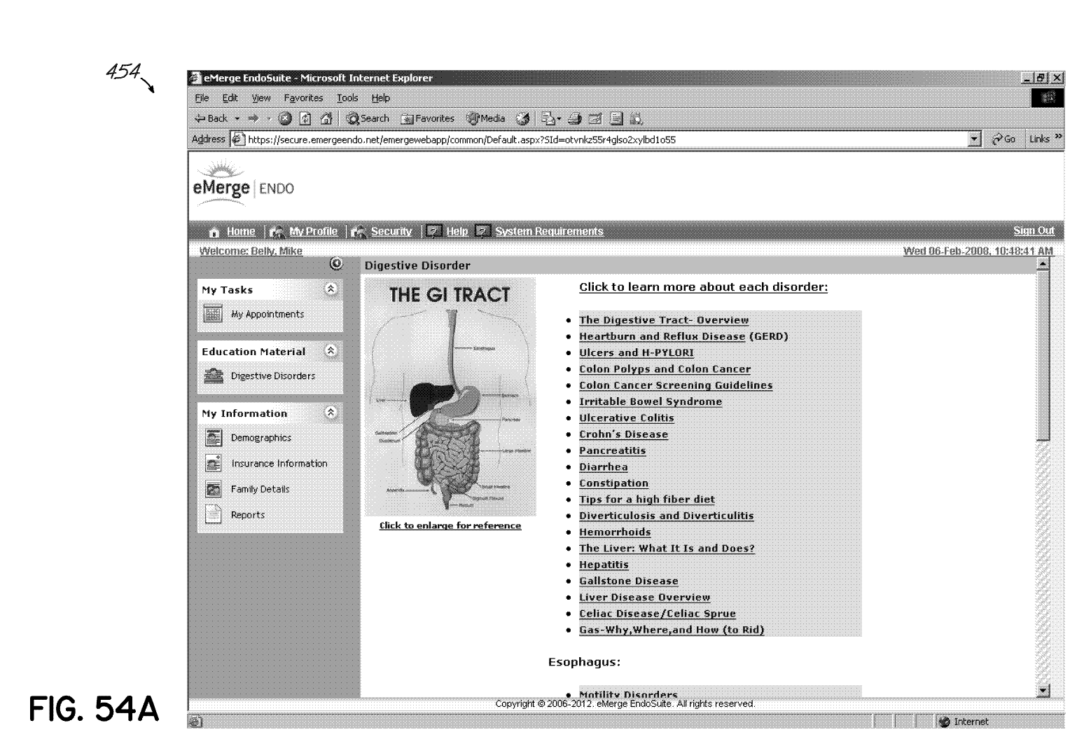

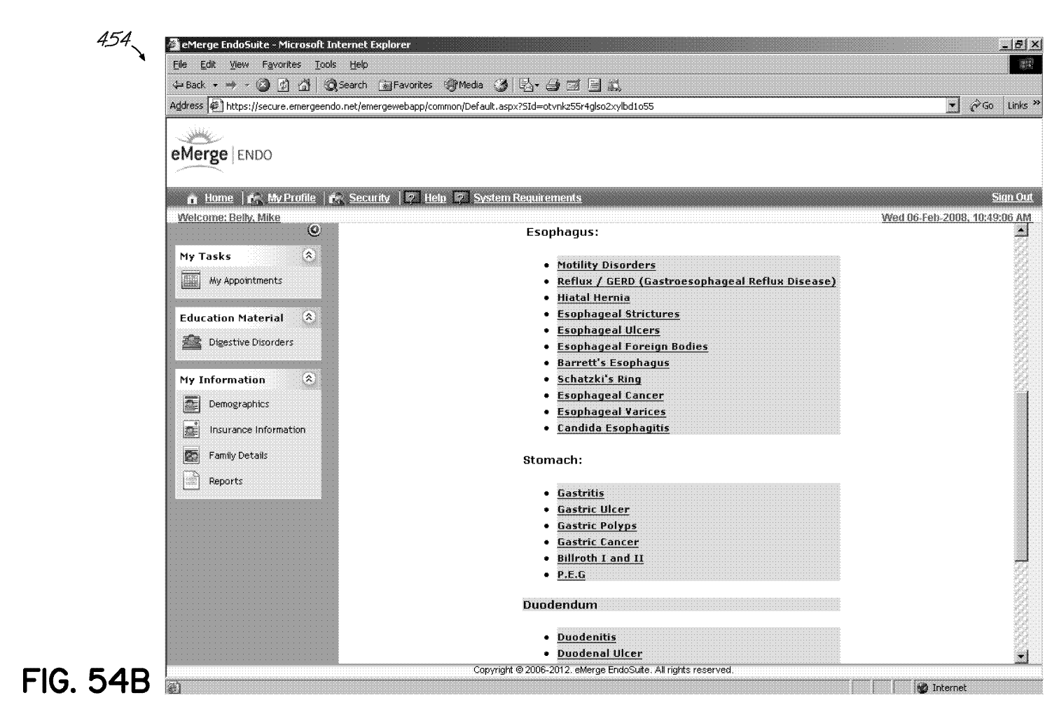

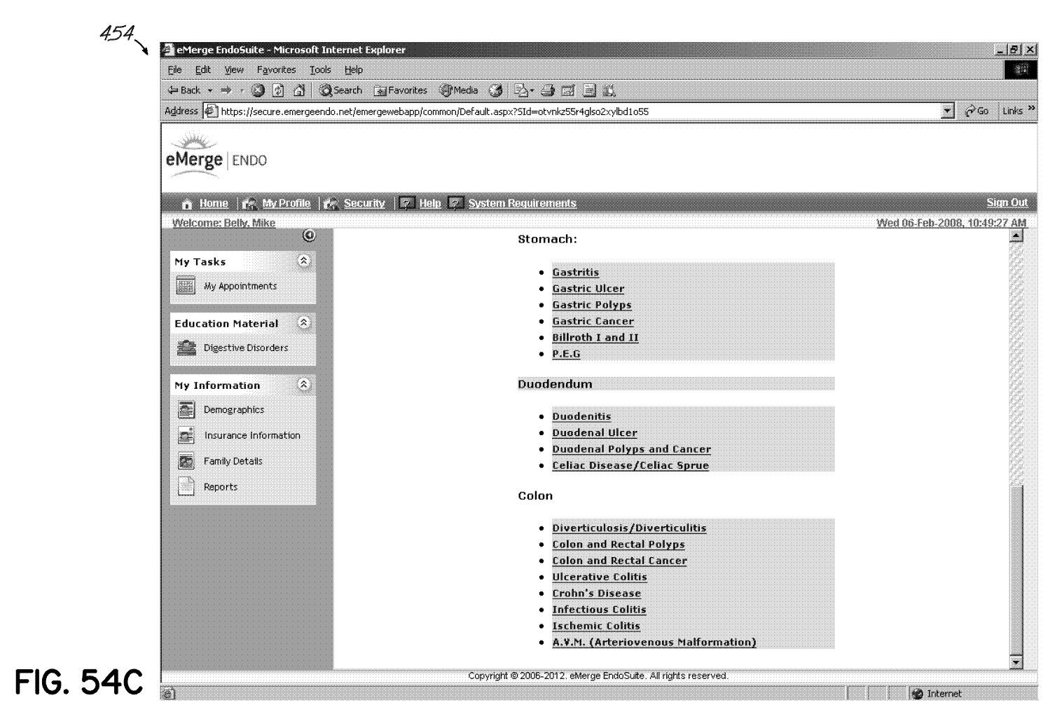

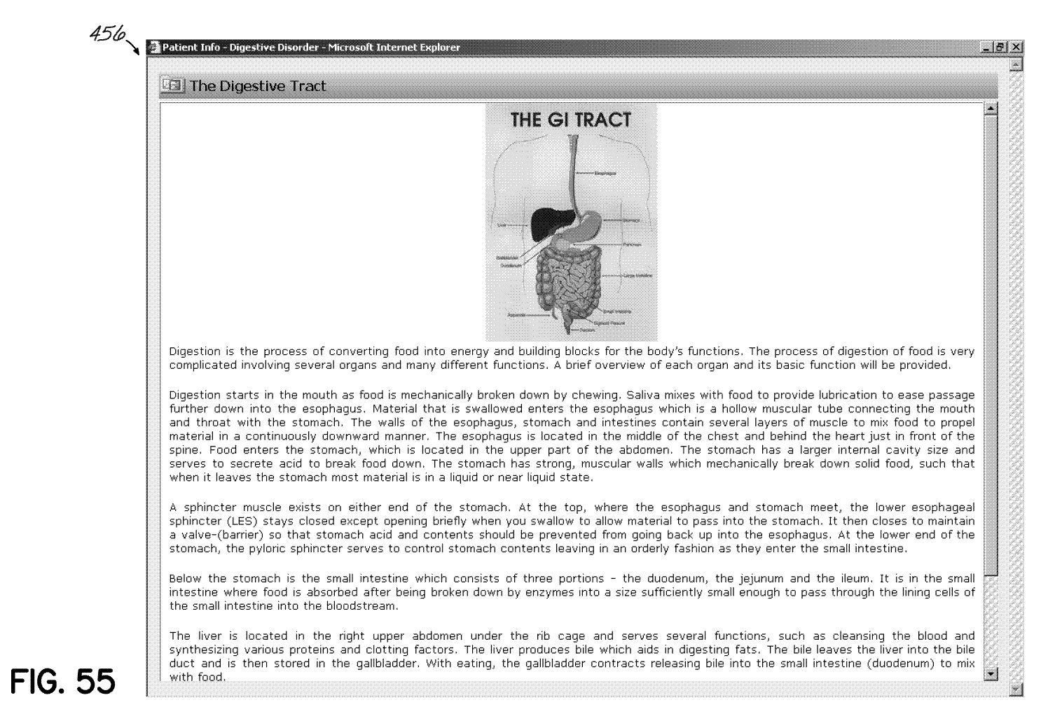

FIGS. 54A through 54C are illustrations of a patient information screen 454 that the patient views after selecting the “Digestive Disorders” link from the “Education Material” selection in the user menu 208. The patient information screen 454 provides the patient with information that may be maintained by the system 10 or on Internet web pages outside the system 10 (i.e., on authoritative medical websites). For example, FIG. 55 is an illustration of an information screen 456 that shows general information about the digestive tract that appears when the user selects the “The Digestive Tract-Overview” link from the patient information screen 454 desktop shown in FIG. 54A.

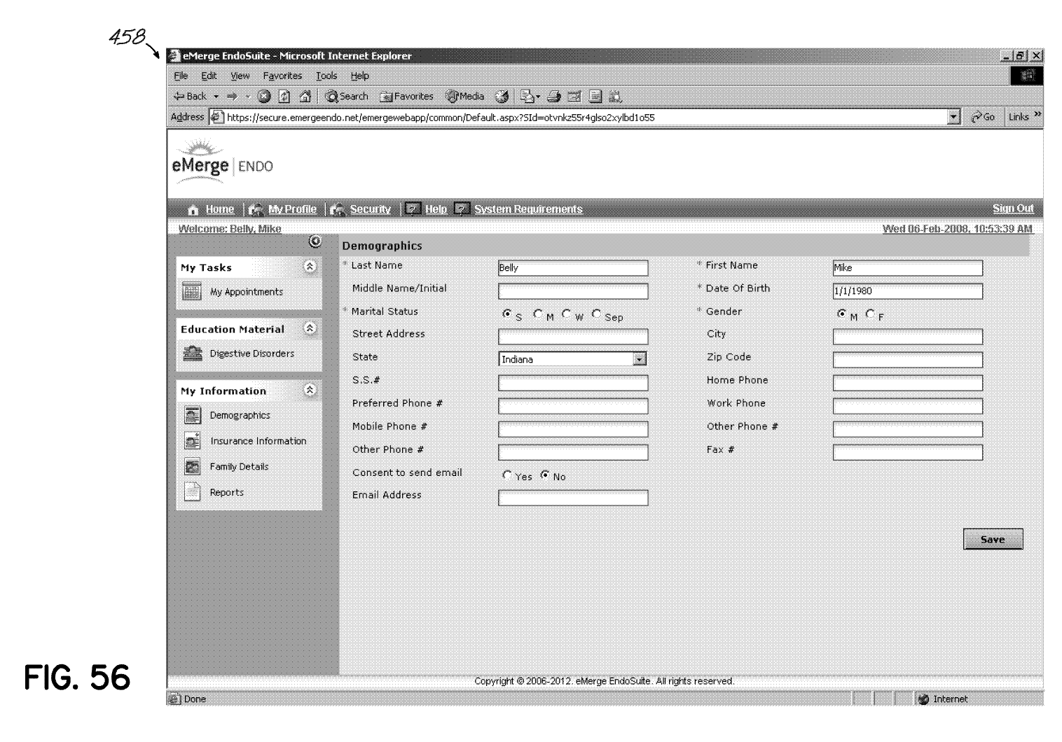

The system 10 provides access for the patient to edit some personal data. FIG. 56 is an illustration of a patient demographics editing screen 458 that the patient views after selecting the “Demographics” link from the “My Information” selection in the user menu 208. The patient may fill in the data fields for the patient demographics editing screen 458 and select the Save button to store the data.

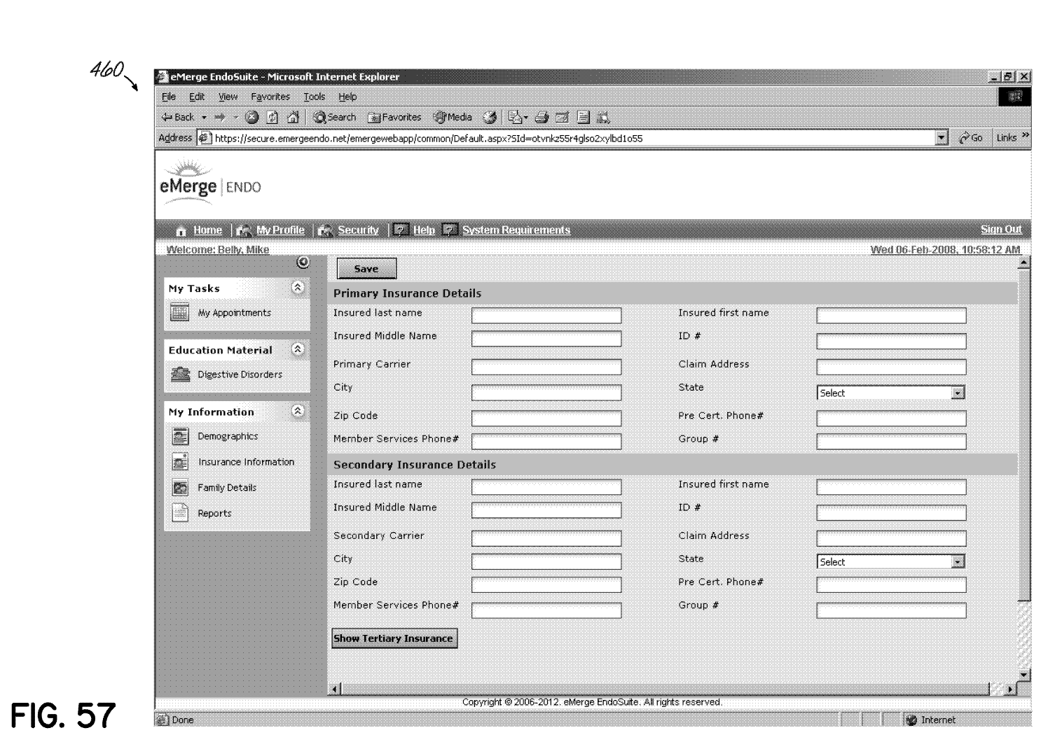

FIG. 57 is an illustration of a patient insurance information editing screen 460 that the patient views after selecting the “Insurance Information” link from the “My Information” selection in the user menu 208. The patient may fill in the data fields for the patient insurance information editing screen 460 and select the Save button to store the data.

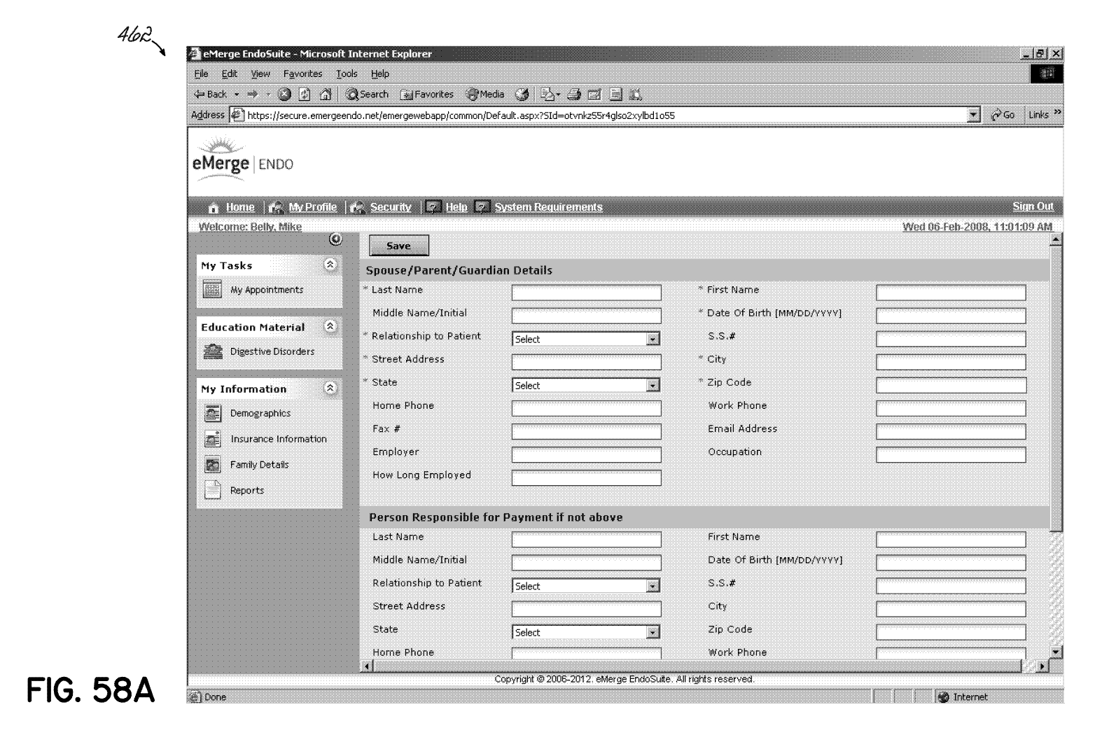

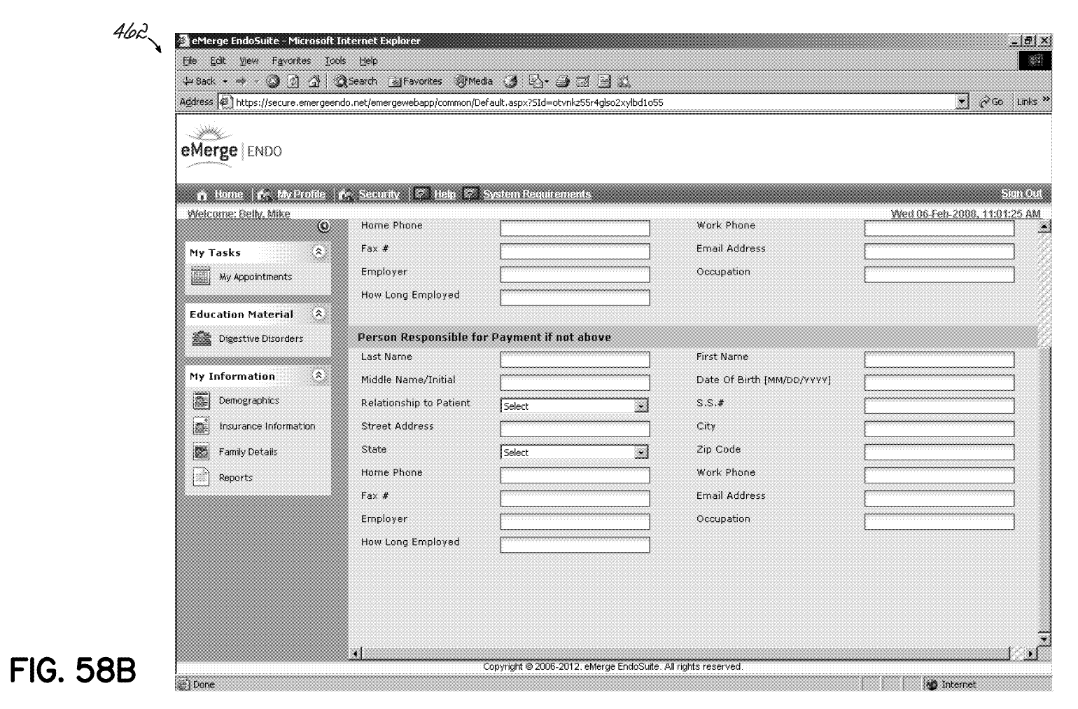

FIGS. 58A and 58B are illustrations of a patient family details editing screen 462 that the patient views after selecting the “Family Details” link from the “My Information” selection in the user menu 208. The patient may fill in the data fields for the patient family details editing screen 462 and select the Save button to store the data.

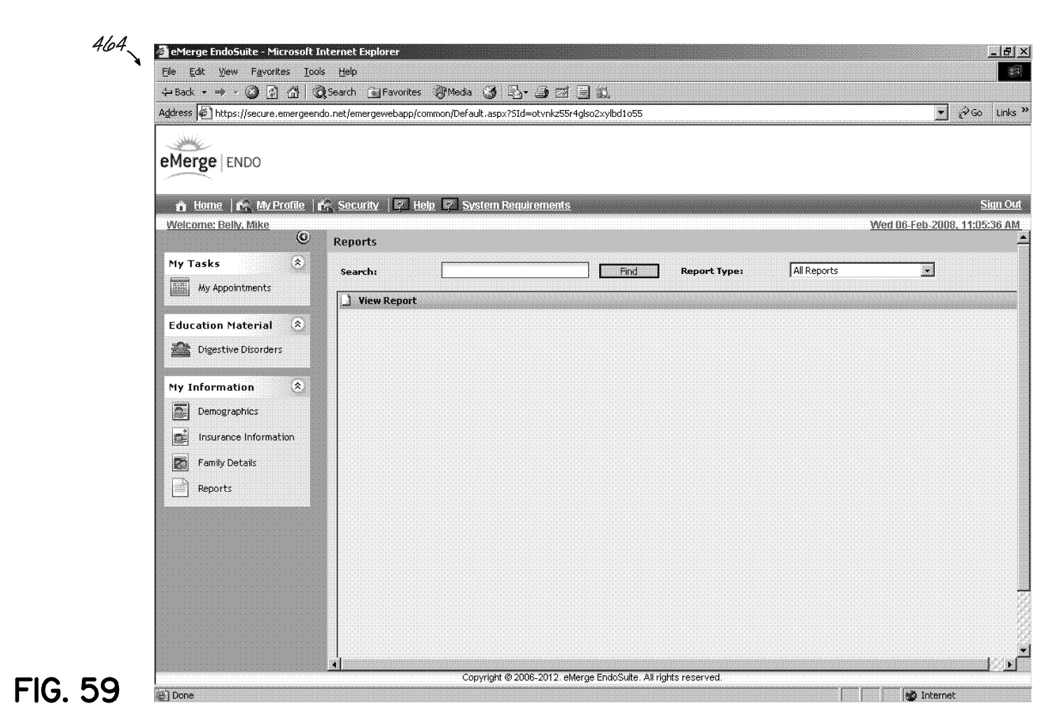

FIG. 59 is an illustration of a patient reports screen 464 that the patient views after selecting the “Reports” link from the “My Information” selection in the user menu 208. The patient may view or print an endoscopic procedure report by selecting the report from the patient reports screen 464 desktop and selecting the View Report button. This causes a new window to display in which the endoscopic procedure report is displayed. From this screen, the patient only has access to view those parts of the endoscopic procedure report the physician has allowed the patient to view.

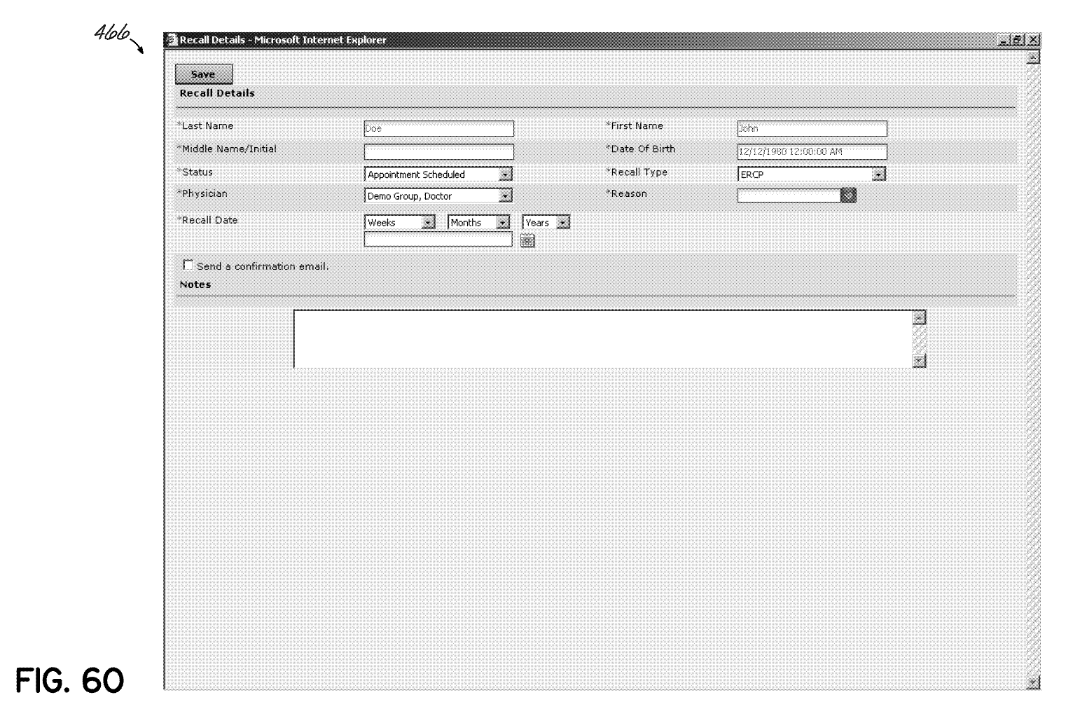

The patient may be scheduled for follow-up appointments by the user (i.e., the physician) when the patient requires further treatment or check-ups. These appointments are generally referred to as “recall appointments” or “recalls.” During report generation, the user may select the Recall button on the endoscopic procedure report generation screen 409 of FIG. 38G to schedule a recall. FIG. 60 is an illustration of a recall appointment screen 466 that appears for the user to configure the recall for the patient. From the recall appointments screen 466, the user may enter information about the recall, including at least one of the following: the last name of the patient, the first name of the patient, the middle name or middle initial of the patient, the date of birth of the patient, a status of the patient, a type of recall, a physician who will perform the recall, a reason for the recall, a date of the recall, whether the patient should be sent a confirmation email before the recall, and notes about the recall. The user may configure the data fields on the recall appointment screen 466, then select the Save button to create the recall. This automatically creates a recall record in the database 28 and is accessible by users of the system 10.

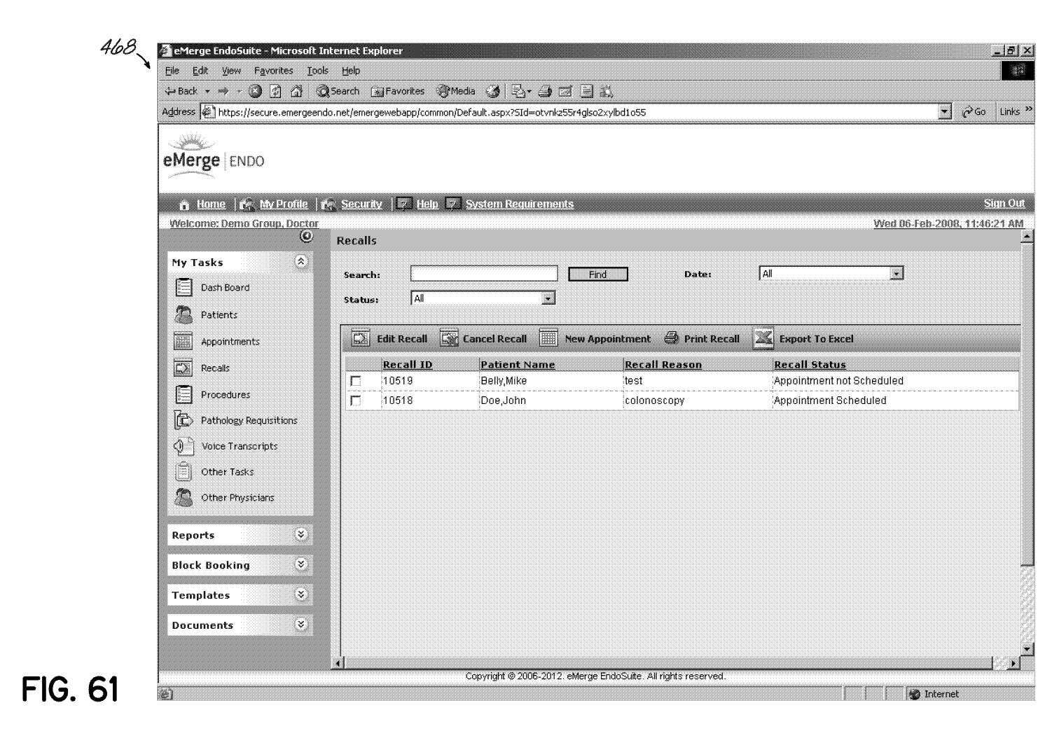

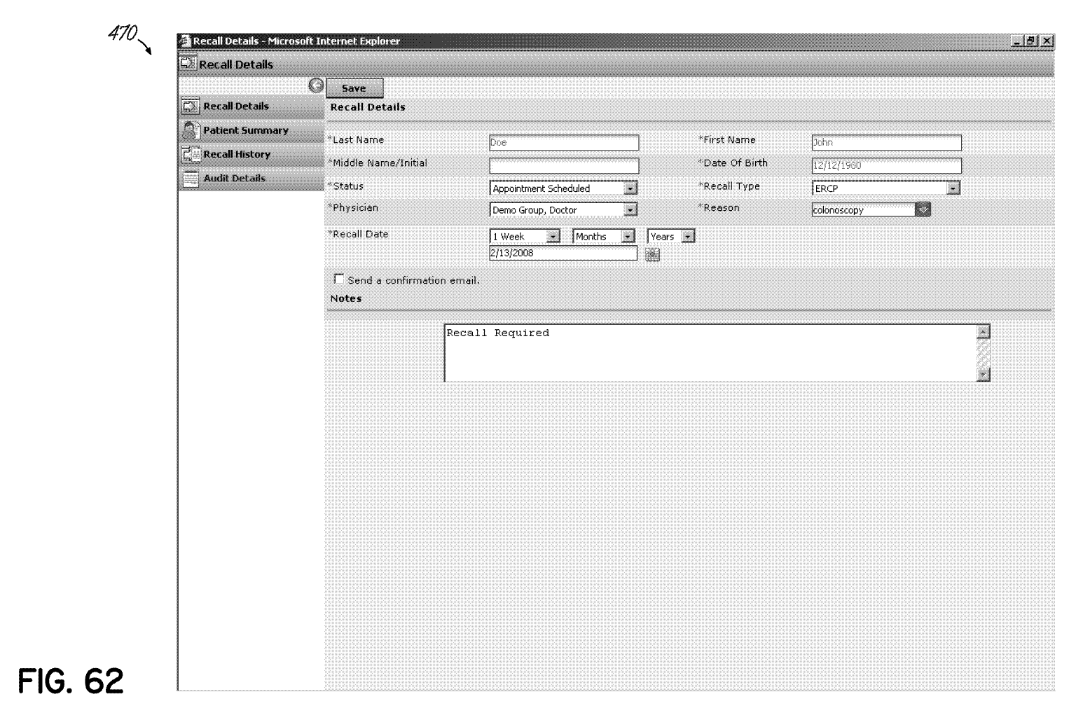

The user may view recalls by selecting the “Recalls” link from the “My Tasks” selection in the user menu 208. FIG. 61 is an illustration of a recall screen 468 that the user views to manage recalls. The user may edit a recall by selecting the recall from the recall screen 468 desktop 210 and selecting the Edit Recall button. FIG. 62 is an illustration of a recall details screen 470 that appears for the user to view and edit details of the recall. The user selects the Save button to save the recall details and close the recall details screen 470. The user selects the Patient Summary button to view summary of patient information for the patient associated with the recall, the user selects the Recall History button to view a history of the recall, and the user selects the Audit Details to view an audit history of the recall.

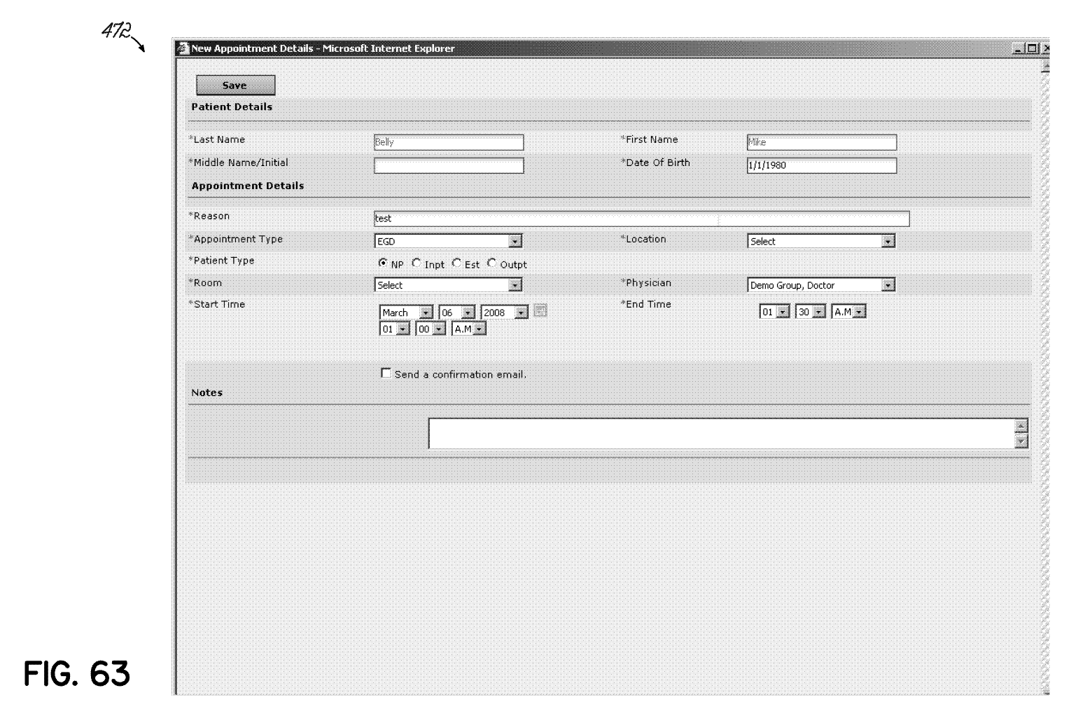

Returning to FIG. 61, the user cancels a recall by selecting the recall and selecting the Cancel Recall button on the recall screen 468. The user schedules an appointment for a recall that has not already had an appointment scheduled by selecting the recall on the recall screen 468 desktop 210 and selecting the New Appointment button. FIG. 63 is an illustration of a new appointment details screen 472 that appears for the user to create an appointment for the recall. The user fills in the data fields of the new appointment details screen 472 and selects the Save button to create an appointment for the recall.

Returning to FIG. 61, the user prints a recall by selecting the recall and selecting the Print Recall button on the recall screen 468. The user may export one or more recalls to an Excel spreadsheet by selecting the recalls on the recall screen 468 desktop 210 and selecting the Export to Excel button.

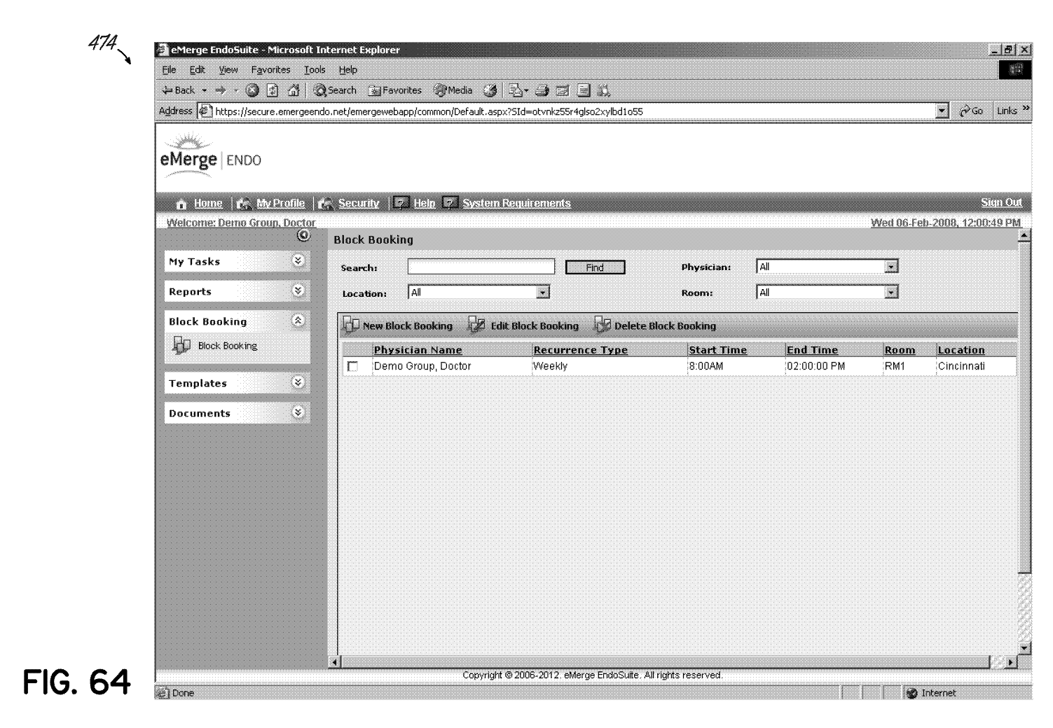

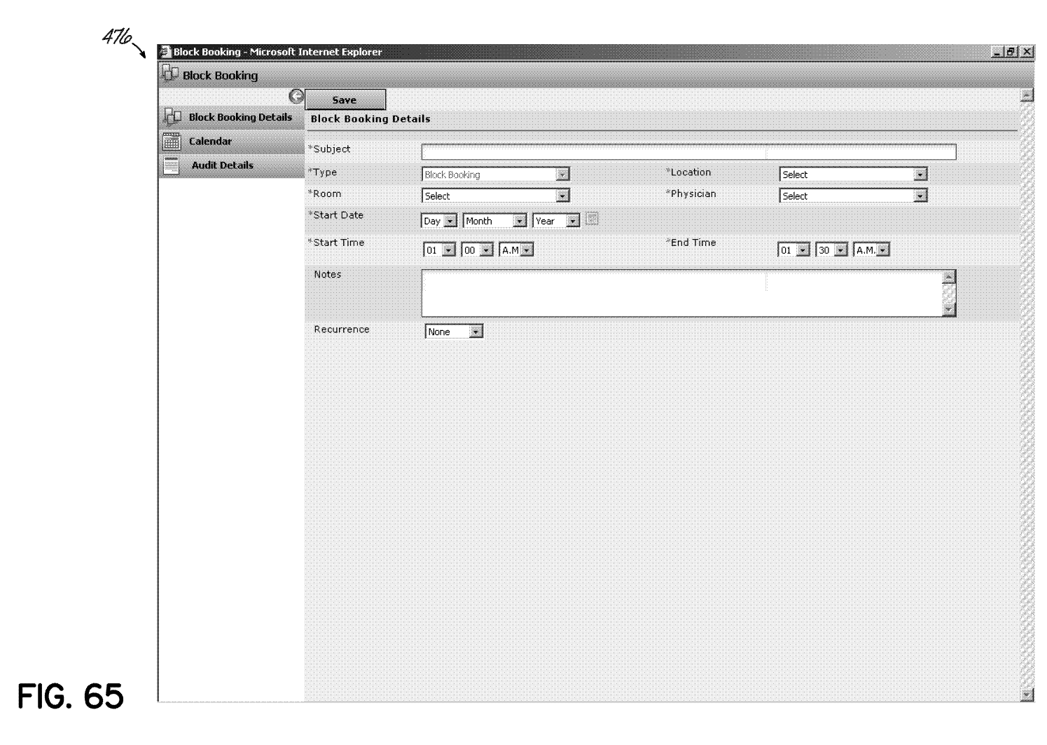

The system 10 simplifies patient scheduling by using block booking to schedule a physician at a specific location and/or room at a recurring day or time. The user may then easily view the physician's schedule and schedule appointments. FIG. 64 is an illustration of the block booking screen 474 accessible by the physician by selecting the “Block Booking” link from “Block Booking” dropdown in the user menu 208. The physician may create a new block booking by selecting the New Block Booking button. FIG. 65 is an illustration of the block booking details screen 476 that appears for the physician to configure a new block booking. The block booking details screen 476 provides components for the physician to configure a daily, weekly, bi-weekly, monthly, bimonthly, or yearly block booking. From the block booking details screen 476, the physician may enter information about block booking, including at least one of the following: a subject of the block booking, the type of the block booking, a location for the block booking, a room for the block booking, a physician assigned to the block booking, a start date, a start time and end time for the block booking, a recurrence of the block booking, and notes about the block booking. The physician may complete the data fields on the block booking details screen 476 and select the Save button to configure the new block booking. Block booking data is saved in the Procedure Tables 60. They physician may view the calendar of their bookings and block bookings by selecting the Calendar button on the block booking details screen 476. Similarly, the physician may view the audit details of their block bookings by selecting the Audit Details button.

Referring back to FIG. 64, the physician may edit or delete a block booking by selecting the block booking from the block booking screen 474 desktop 210 and selecting the Edit Block Booking or Delete Block Booking buttons, respectively.

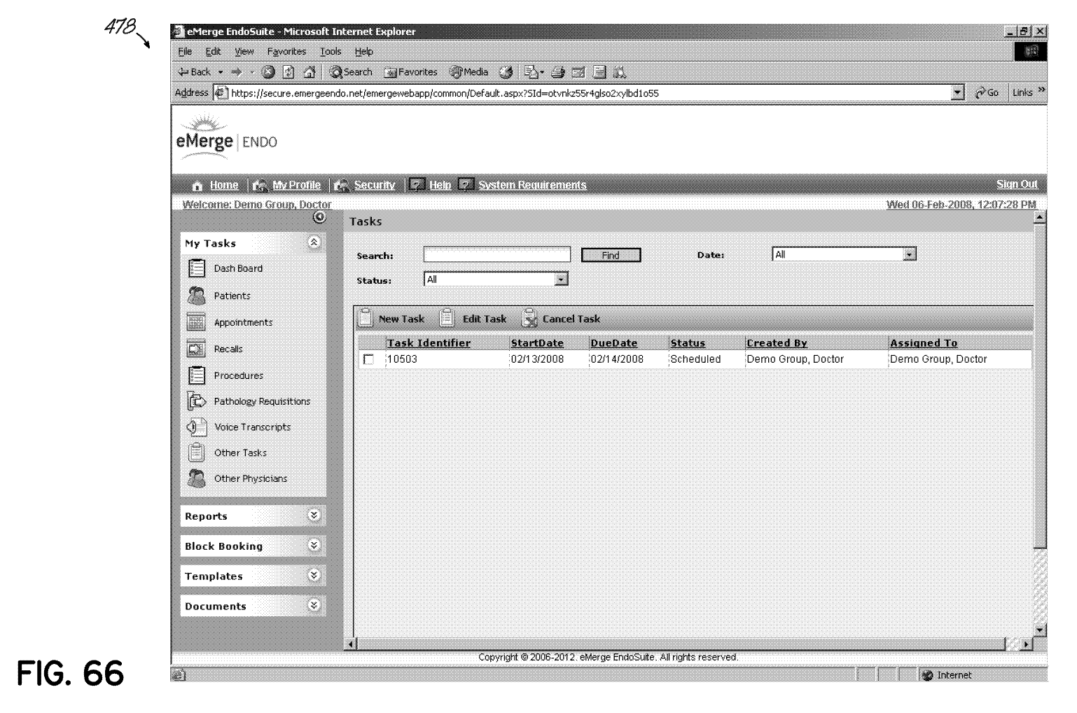

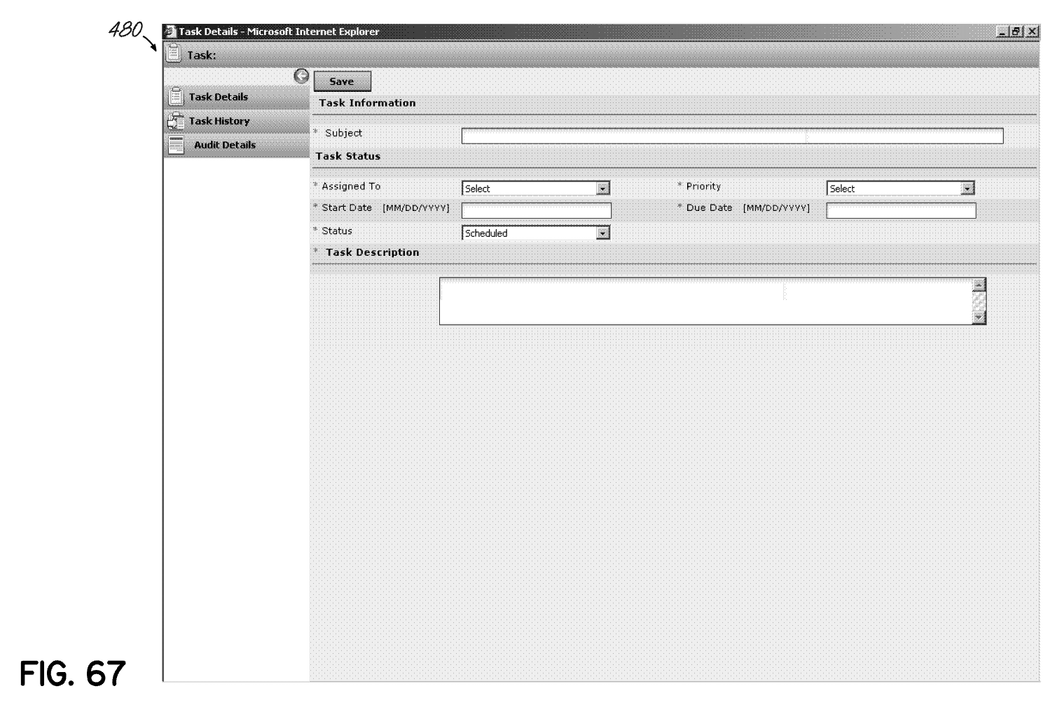

Each user may create, edit, or view tasks. Tasks are assigned to users and specify actions that the user should take. FIG. 66 is an illustration of the task screen 478 accessible by the user by selecting the “Other Tasks” link from the “My Tasks” dropdown in the user menu 208. The user may create a task specific to themselves or another user by selecting a New Task button. FIG. 67 is an illustration of the task details screen 480 that appears for the user to configure a new task. Each user may configure a task for any user of the same group practice and assign that task a priority. From the task details screen 480, the user may enter information about the task, including at least one of the following: a subject of the task, the user the task is assigned to, a priority of the task, a start date of the task, a due date of the task, a status of the task, and a description of the task. The user selects the Save button to create and save the task. Task data is saved in the User Tables 54. The user may view the task history by selecting the Task History button on the task details screen 480. The user may view audit details of the task by selecting the Audit Details button on the task details screen 480. Returning to FIG. 66, the user may edit or delete a task by selecting the task from the task screen 478 desktop 210 and selecting the Edit Task or Cancel Task buttons, respectively.

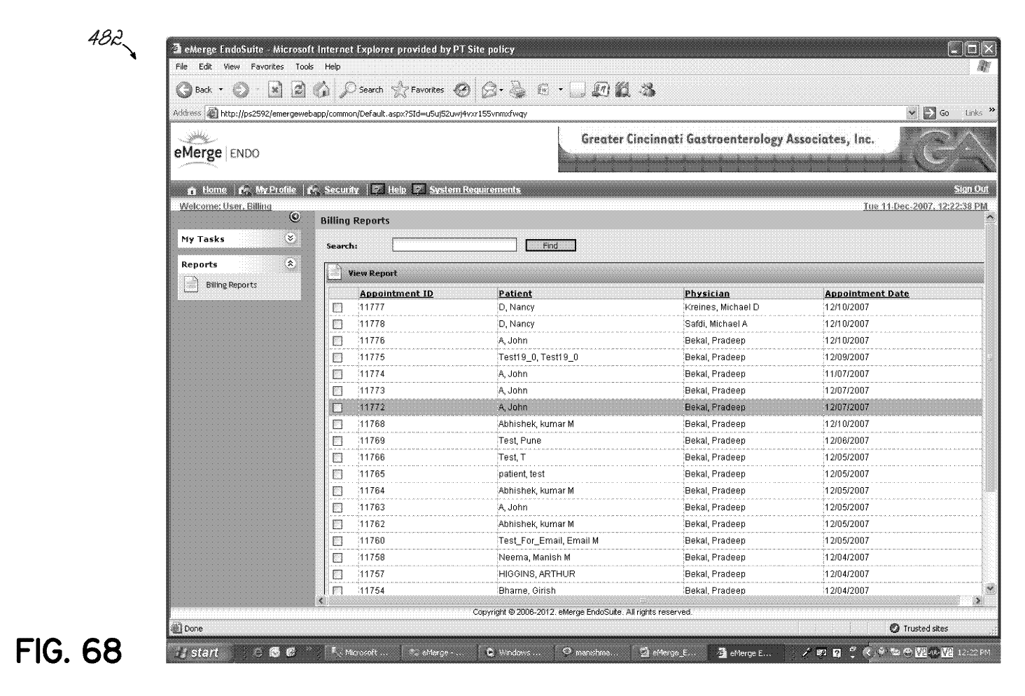

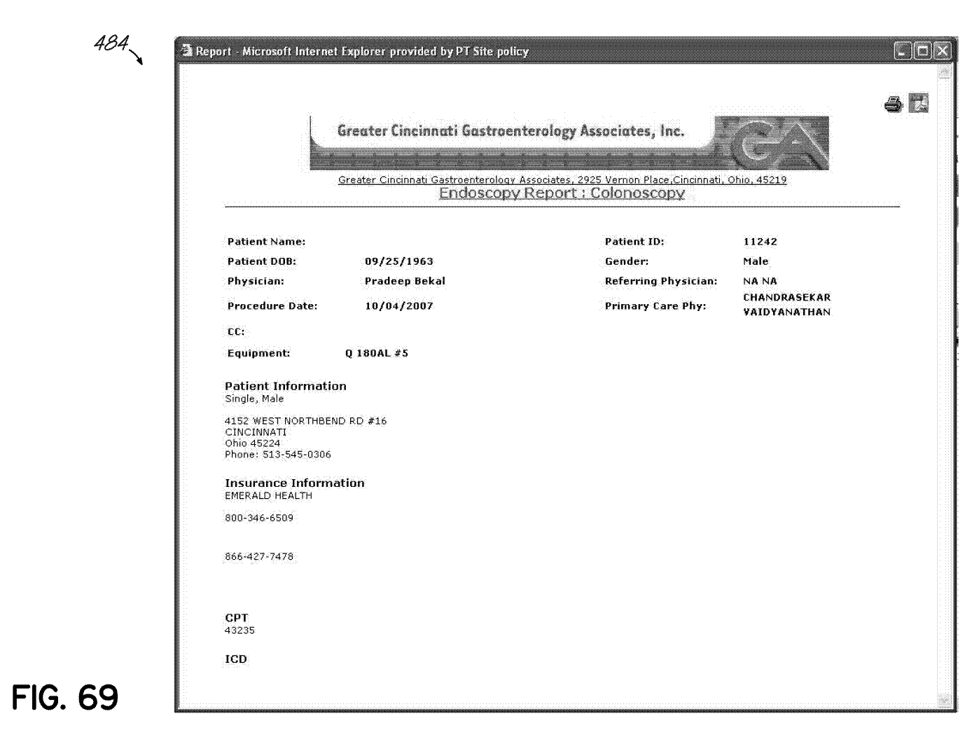

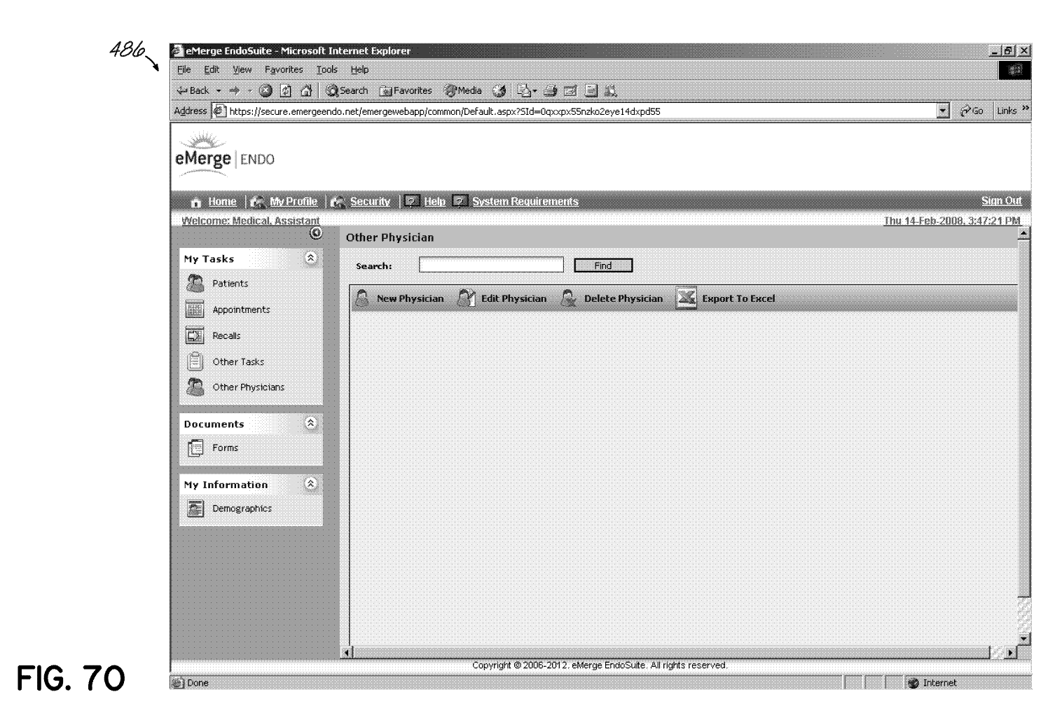

The system 10 tracks the cost of each procedure and appointment to generate accurate billing reports for each patient. In particular, the system 10 may track the equipment used for each appointment, the medications administered for each appointment, the procedures actually performed during the appointment, the time required for each procedure, the actions performed during each procedure, the type of procedure, and pathology examination costs for each procedure. The system 10 is configured to assign a value to the items or services and generate a total cost for each appointment and/or endoscopic procedure. This information may be used to automatically generate and save a billing report in the Report Tables 64. FIG. 68 is an illustration of a billing reports screen 482 where a billing user can search reports to view or print. The billing user may search through the billing reports by using the search feature above the desktop 210. The billing user may view a report by selecting the report from the billing reports screen 482 and selecting a View Report button. FIG. 69 is an illustration of a billing report screen 484 that appears for the billing user to view and print billing reports. The billing report may include itemized lists showing the costs of item or service, as well as patient information, insurance information, and the total cost to the patient.

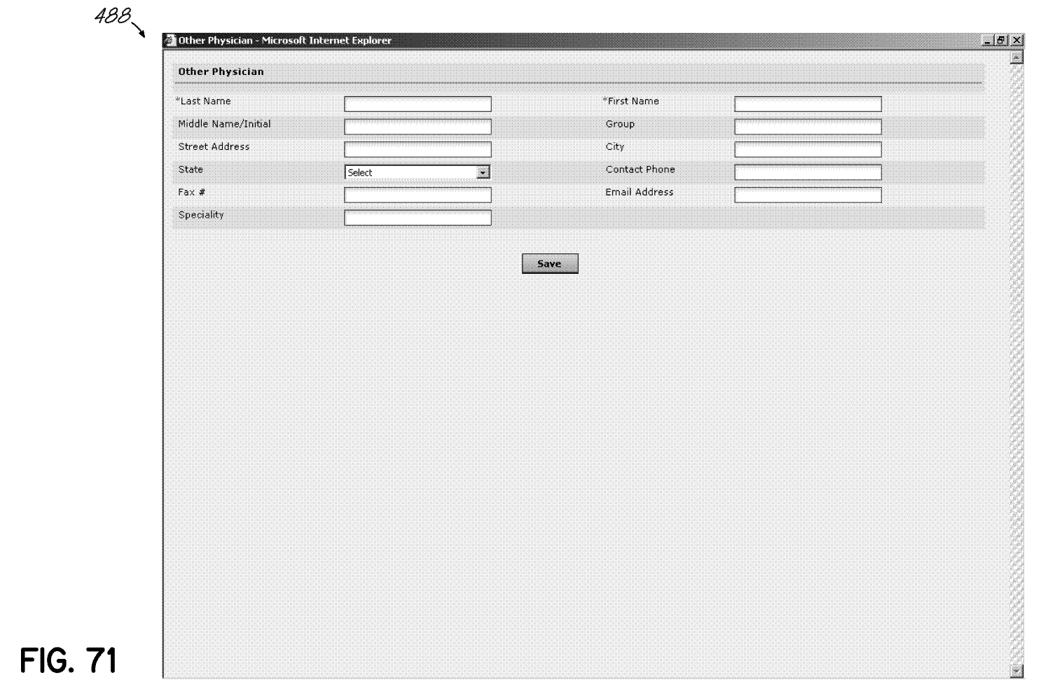

The system 10 is configured to track other physicians. These other physicians may be associated with a patient or through referrals, or otherwise be physicians that are in frequent contact with the group practice. FIG. 70 is an illustration of another physicians screen 486 where a user may view and edit information for other physicians. The user may configure a new physician by selecting the New Physician button on the other physicians screen 486. FIG. 71 is an illustration of another physician creation screen 488 that appears for the user to configure information about the other physician. From the another physician creations screen 488, the user may enter information about other physicians including at least one of the following: last name, first name, middle name or middle initial, group name, street address, city, state, zip code, contact phone number, fax phone number, email address, and the specialty of the physician. The user may save the other physician information by selecting the Save button on the physician creation screen 488. This data is stored in the User Tables 52. Referring back to FIG. 70, the user may edit or delete another physician by selecting the other physician from the other physicians screen 486 desktop 210 and selecting the Edit Physician or Delete Physician buttons, respectively. Similarly, the user may also export a list of selected physicians to an Excel spreadsheet by selecting corresponding entries on the other physicians screen 486 desktop 210 and selecting the Export to Excel button.

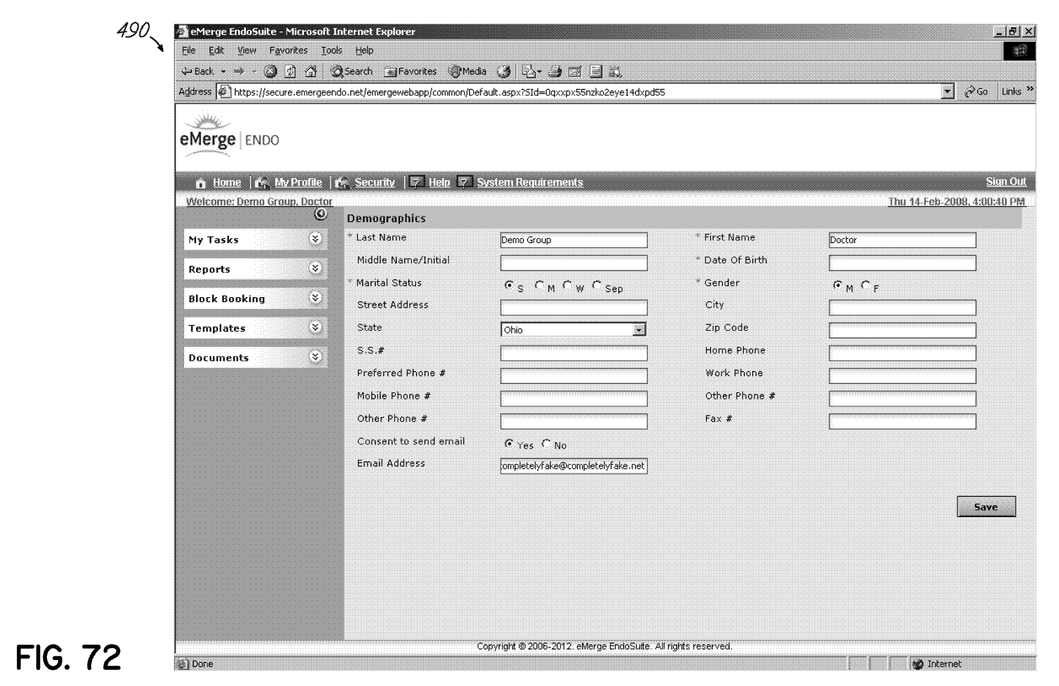

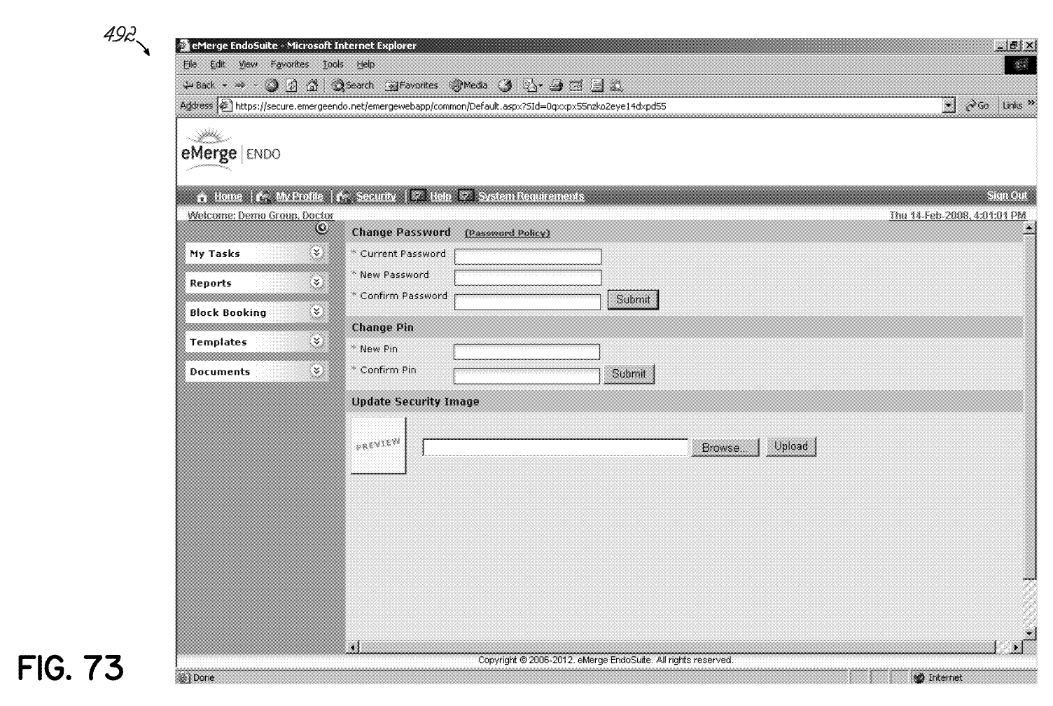

Each user has the ability to edit their demographic information and passwords. FIG. 72 is an illustration of the user demographics screen 490 that appears when the user selects the “My Profile” link in system menu 206. The user may fill in the user demographics screen 490 and select the Save button to save their information. FIG. 73 is an illustration of a user security screen 492 that appears when the user selects the “Security” link in the system menu 206. From the user security screen 492, the user may enter change their password, including creating a new password, change their PIN number, and update their image. The user may adjust their password, PIN, or image on the user security screen 492 and select the Save button to save their information.

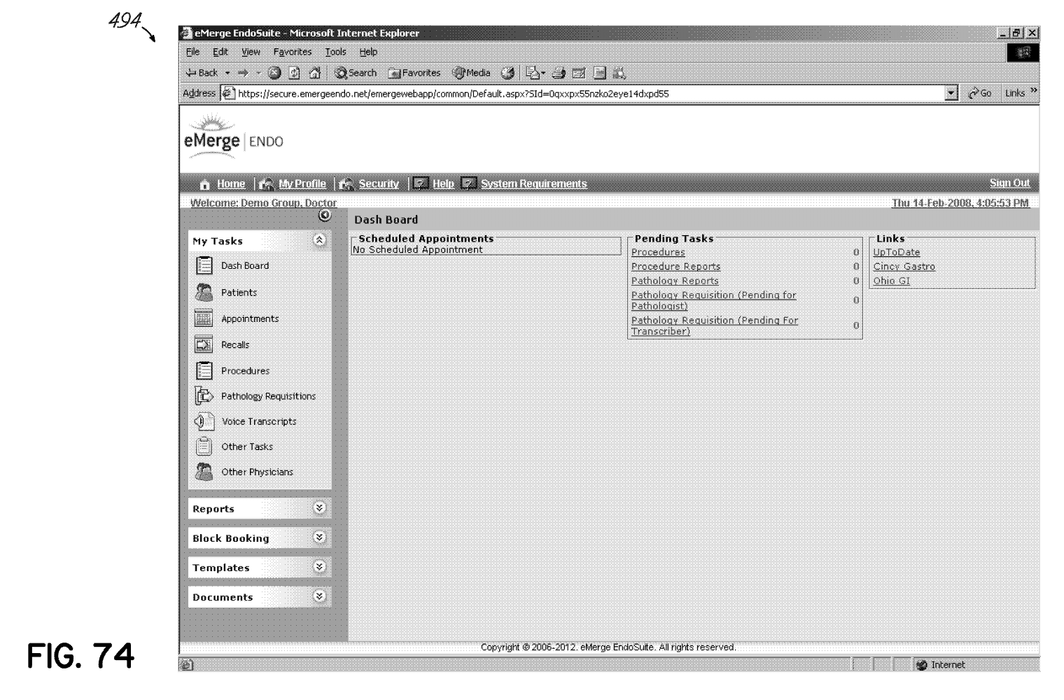

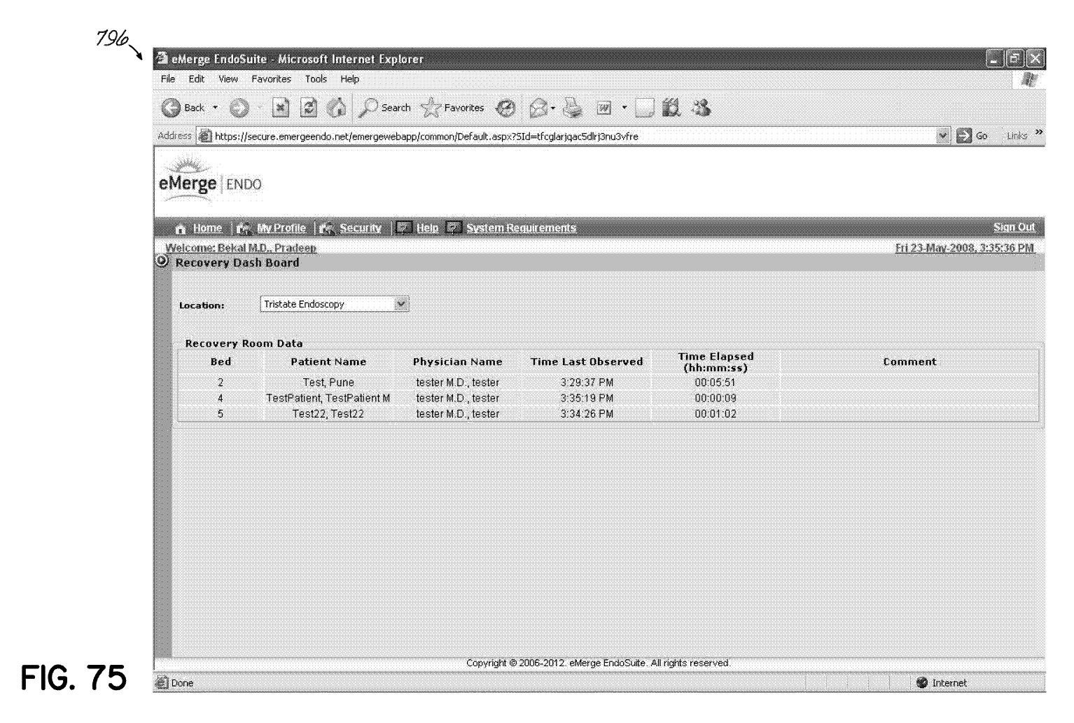

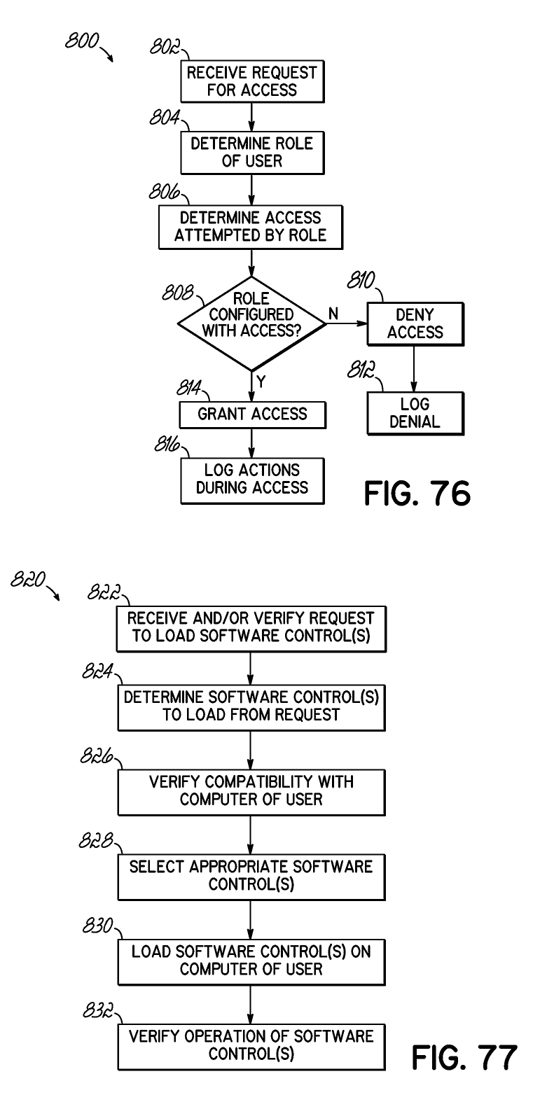

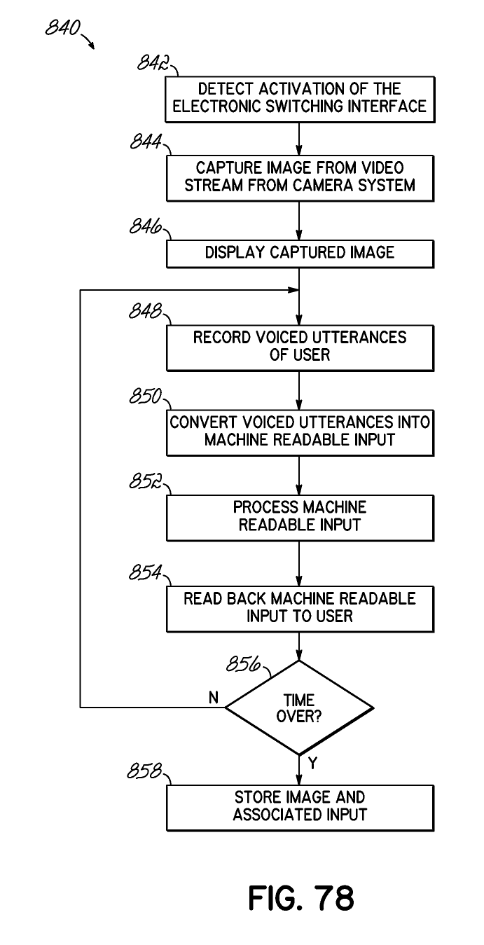

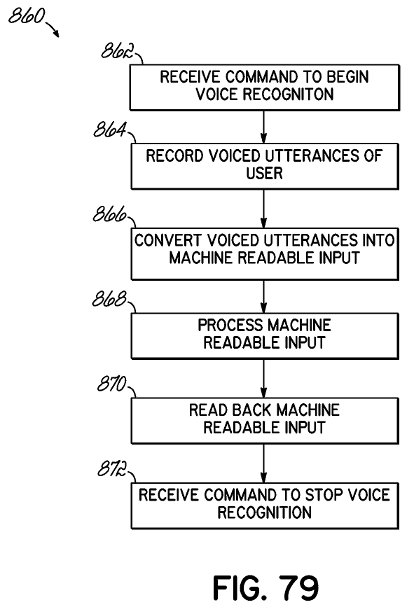

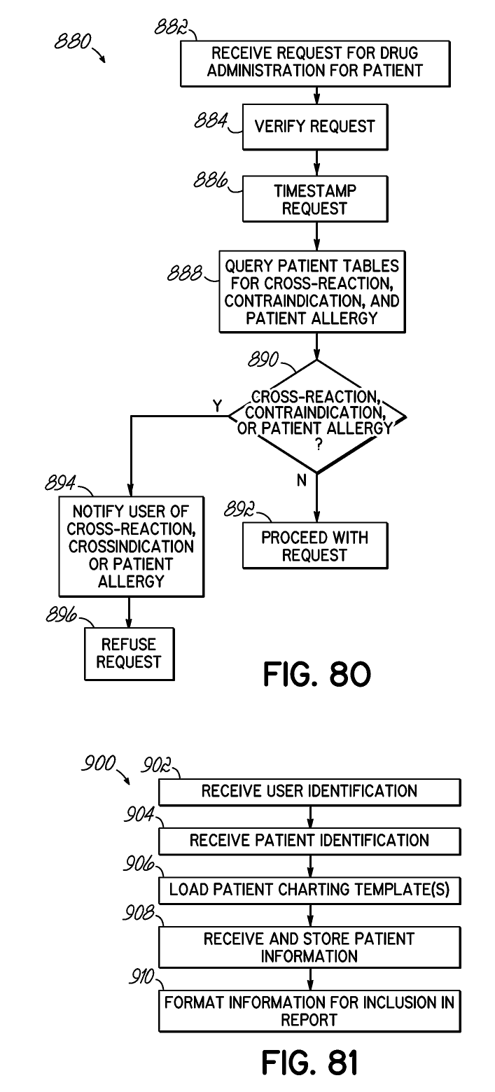

The system 10 keeps users up to date on their obligations. Some users may be provided with an informational screen, or dashboard, upon logging in that indicates their activities for the day and whether they have pending tasks. FIG. 74 is a dashboard screen 494 for the user that shows tasks. The dashboard screen 494 illustrated in FIG. 74 is a dashboard screen for a physician that indicates the appointments that are scheduled for that day. This data is retrieved from database 28. From the dashboard screen 494, a user can quickly determine what their tasks and obligations are for that day, or view past and future tasks and obligations. Additionally, FIG. 75 is a recovery room dashboard screen 496 that may be viewed by users to monitor patient recovery. After a medical procedure, the patient may be taken to a recovery room, assigned a bed, and undergo the post procedure assessment. Typically, the patient is kept for the next 45 minutes and allowed to recover, while being checked by one or more users at regular intervals. When the post-operative assessment of the patient is initially entered into the system 10, the system 10 tracks the recovery of the patient. As such, the recovery room dashboard screen 496 displays a list of all patients in recovery rooms for users to view. Additionally, the system 10 tracks the patients as they recover and tracks the users as they monitor the patient in recovery. As such, the system 10 tracks how long a patient has been in the recovery room and also the time between instances when they are monitored. When the time after which a patient has been monitored by a user is about eleven minutes or more, the system 10 highlights that patient on the recovery room dashboard screen 496 in yellow, thus alerting the user that the patient needs attention. When the time after which a patient has been monitored by a user is about fifteen minutes or more, the system 10 highlights that patient on the recovery room dashboard screen 496 in red, thus alerting the user that the patient needs immediate attention. After a patient is discharged, the system 10 automatically removes the patient from the dashboard recovery room screen 496 and indicates that a bed is free for another patient.

In light of the foregoing, FIG. 76 illustrates a role access flowchart 800 with blocks executable by the program code of the system 10 to determine whether a user has access to data, functionality, or access a portion of the system 10. The program code may execute the blocks of the role access flowchart 800 in response to the user performing an action that attempts to navigate to a screen, view, add, delete, or modify data, load controls, or access a portion of the system 10. Thus, the program code prevents users who do not have access to perform an action from performing that action, and allows users to do have such access to perform that action.

In block 802, the program code receives a request for access to at least a portion of the system 10. The request may be from a user and indicate an attempt to navigate to a screen, view data, add data, modify data, load an ActiveX control, or access a portion of the system 10. In block 804, the program code determines the role associated with the user attempting access. The program code may determine the role by cross-referencing the user identification with their assigned role. In block 806, the program code determines the access attempted by the role. In block 808, the program code determines whether the role is configured to access the portion of the system 10 that the request indicates. The program code may determine this by determining the privilege of the role as well as whether the privilege for the portion of the system 10 indicated by the request allows the corresponding access. When the role is not allowed the access to the portion of the system 10 indicated by the request, the role is denied access in block 810 and the denial is logged in block 812. In block 810, the program code may indicate to the user that they were denied access.

When the role is allowed the access to the portion of the system 10 indicated by the request, the program code grants the access in block 814 and logs the actions taken by the user during the access in block 816. For example, if the access is to view data, the program code may store a log entry that indicates the user viewed particular data in the database. Similarly, the program code may store a log entry that indicate the user added, deleted, or modified particular data during the access.

FIG. 77 illustrates a control loading flowchart 820 with blocks executable by the program code of the system 10 to load at least one software control to the computer 11 of a user of the system 10 to interact with the user, computer 11, or equipment connected to the computer 11. The software controls, in some embodiments, be one or more ActiveX controls, AJAX controls, programs, applications, and/or other software control configured as part of the system 10. In block 822, the program code receives and verifies a request to load the software control(s) on the computer 11 of a user of the system 10. The request may be verified to determine if the user has access to load the software control in a similar manner as the process described in the role access flowchart 800 of FIG. 76. In one particular embodiment, this request may occur when a computer 11 first logs into the system 10 and desires to load the voice recognition ActiveX control. In an alternative embodiment, this request may occur when a user navigates to a procedure page that requires the video ActiveX control or the audio ActiveX control. Returning to FIG. 77, the program code determines the software control(s) to load on the computer 11 by analyzing the request in block 824. In block 826, the program code verifies that the computer 11, or equipment connected to the computer 11, that requested the software control(s) is compatible with the software control. For example, the request for a software control may request a software control to capture vital signs data from the vital signs equipment 42. In response to this, the program code of the system 10 may query the computer 11 to determine the operating system of the computer 11, the version of the operating system of the computer 11, or the exact vital signs equipment 42 connected to the computer 11.

In block 828, the program code selects the software control(s) that is appropriate for the request, computer 11, and/or equipment connected to the computer 11, then loads the software control(s) in block 830. In block 832, the program code verifies that the software control(s) is operating correctly. The program code may determine that a software control is operating correctly by querying the computer 11 that received that control about the software control's functionality. As shown in FIG. 77, the program code may load one or more software controls on the computer 11 in response to the request from that computer 11. For example, the user may be a physician that navigates to a procedure screen that may utilize a software control to capture video and a software control to capture voiced utterances of the user. As such, the program code may operate to load both a software control to capture video from a camera system 38 and capture voiced utterances from a microphone 36.

FIG. 78 illustrates a image and voice capture flowchart 840 with blocks executable by the program code of the system 10 to capture images and voiced utterances of a user during a medical procedure in response to activation of an electronic switching interface 40. During a medical procedure, the user may control computer 11 to capture data, video, images, and/or voiced utterances. During the medical procedure, a video stream may be displayed that corresponds to the video recorded by the camera system 38. This video stream may be displayed on the display 34, and through computer 11, by way of a software control. The computer 11 may further be configured with software controls to record the voiced utterances of the user through the microphone 36 and detect activation of the electronic switching interface 40. In block 842, the program code detects an activation of the electronic switching interface 40. The activation may be detected through a software control on the computer 11 that monitors for the activation of the electronic switching interface 40. In block 844, the program code captures an image from the camera system 38 in response to the detected activation of the electronic switching interface 40. The image may be captured directly from the camera system 38, the image may be captured from the video stream displayed on the computer 11, or the image may be captured from a software control that displays the video stream on the computer 11. In block 846, the program code may display the captured image on the display 34 of the computer 11. While this image is displayed, and still in response to detecting activation of the camera capture control, the program code may activate a software control operable to interface with the microphone 36 and record voiced utterances of the user for a period of time of about twenty-five seconds in block 848. In block 850, the program code converts the voiced utterances of the user into machine readable input (i.e., the program code converts the voiced utterances of the user into a format capable of indicating commands for the program code to perform or data for the program code to store) and processes that machine readable input in block 852. For example, the machine readable input may be commands indicating data to associate with the displayed image, such as information about an abnormality or information about the image. Alternately, the machine readable input may be a command for the program code to extend the time to record information, or a command for the program code to manipulate portions of the data in the system 10.

In block 854, the program code reads back the machine readable input converted in block 850. Thus, when the computer 11 is configured with the speaker 46, the user may listen to the voiced utterances that were converted into machine readable input to verify that the correct commands were entered. In block 856, the program code determines whether the time to record the voiced utterances of the user has expired. When the time has not expired, the program code proceeds back to block 848 to continue recording the voiced utterances of the user. When the time has expired, the program code stores the image and the associated machine readable input in block 858.

FIG. 79 illustrates a voice capture flowchart 860 with blocks executable by the program code of the system 10 to capture voiced utterances of the user. In block 862, the program code receives a command to begin voice recognition. The command to begin voice recognition may be received in response to activation of the electronic switching interface 40, in response to a user's voiced utterances to begin voice recognition, or the command may be automatically issued in response to picking up a voiced utterance of a user through the microphone 36. In block 864, the program code records the voice utterances of the user. In block 866, the program code converts the voiced utterances into machine readable input. In block 868, the program code processes the machine readable input. In one embodiment, the machine readable input is a command for the program code to perform an action, such as retrieve data from the database 28, store data in the database 28, load a software control, or otherwise interact with the system 10, computer 11, or user. In block 870, the program code reads back the machine readable input converted in block 866. Thus, when the computer 11 is configured with the speaker 46, the user may listen to the voiced utterances that were converted into machine readable input to verify that the correct commands were entered. In block 872, the program code receives a command to stop the voice recognition, and the voice recognition of the voice recognition ActiveX control ends.

FIG. 80 illustrates a drug interaction flowchart 880 with blocks executable by the program code of the system 10 to monitor drug administration requests and orders for a patient and prevent them in the event of cross-reactions, contraindications, and patient allergies. During a medical procedure, a user of the system may request to administer drugs to the patient. As such, the user may indicate a drug, dosage, and administration route for the request. In block 882, the program code receives the request to administer drugs to a patient along with an identification of the patient. In block 882, the patient may be identified by navigating to a page displayed by the system 10 and inputting the patient identification or by identifying the patient through an identification reader 33. The request for drug administration may come from user interaction with the system through the general input devices 32 or through voice recognition. In block 884, the program code verifies the request. In block 884, the program code may determine that the user has a role that allows them to administer drugs to the patient. The program code may also repeat the drug administration request back to the user when the user has requested the drug administration through command-driven voice recognition, providing the user an opportunity to correct erroneous input. Thus, in block 884, the program code attempts to verify that the command it has received is correct.

In block 886, the program code documents the user that requested the drug administration, the time and date of the request, and stores the request for drug administration in the Patient Tables 56. In block 888, the program code queries the Patient Tables 56 and System Tables 68 to determine if the requested drug cross-reacts with any drugs currently or previously administered to the patient, whether the patient has a contraindication for that drug, and whether the patient has an allergy to that drug. For example, the program code may query the Patient Tables 56 to determine drugs currently or previously administered to the patient, then query the System Tables 68 to determine if any of those drugs currently or previously administered interact, or cross-react, with the requested drug in block 888. Also for example, the program code may query the Patient Tables 56 to determine if the patient suffers from a particular condition or malady, then query the System Tables 68 to determine if the requested drug is contraindicated in relation to that condition or malady in block 888.

In block 890, the program code determines whether there is a cross-reaction, contraindication, or patient allergy to the drug with regards to the queries of block 888. When there is no cross-reaction, contraindication, or patient allergy to the requested drug, the program code proceeds with the request and attempts to fill the order in block 892. For example, an approved request may cause the system 10 to contact a pharmacy or other part of a group practice or medical facility to fill the drug request, and the program code proceeds with the order in block 892.

When there is a cross-reaction, contraindication, or allergy to the requested drug, the program code notifies the user of that cross-reaction, contraindication, or allergy in block 894 and refuses to process the request in block 896. In particular, the program code may display a warning to the user on the display 34 in block 894. Additionally, the program code may notify the user through a speaker 46 that the drug has a cross-reaction, contraindication, or that the patient is allergic to the drug in block 894. Additionally, when the request is for the system 10 to contact a pharmacy or other part of a group practice or medical facility to fill the drug request, the program code prevents the system from doing so in block 896.

Embodiments of the invention provide for monitoring patients throughout medical treatment, including gathering information such as vital signs, administered medications, treatment, and status of patients throughout their treatment. As such, the system 10 may be configured to “chart” the progress of the patient as they are treated. In particular embodiments, the system 10 is further configured to format this information for inclusion in a report. FIG. 81 illustrates a flowchart 900 for program code to chart information about a patient. In block 902, the program code receives identification of a user. In particular, the user may be a nurse attempting to chart information about a patient, and the identification of the user may be entered through the general input devices 32 or through data on an RFID chip associated with the nurse received through the identification reader 33. In block 904, the program code receives the patient identification. In a similar manner as receiving the user identification, the program code may receive the patient identification through the general input devices 32 or through the identification reader 33.

In response to receiving the patient information, the program code may load a patient charting template in block 906. In some embodiments, the patient charting template is responsive to input from the user and is operable to access data from the Patient Tables 56, Procedure Tables 60, and Report Tables 64. Thus, patient charting template provides the user access to configure data in those tables directly without having to navigate throughout the system 10 to specific screens. In some embodiments, the patient charting template is responsive to specific voice commands from the user and is operable to allow the user to enter information through the microphone 36 or wireless headset.

In block 908, the program code receives and stores the patient information. In a specific embodiment, the program code may receive voiced utterances from the user, convert them into machine readable input, and store the information from the user in block 908. Additionally, the program code may receive information from the user through the computer 11, and in particular the general input devices. As such, the system 10 is operable to enter information about a patient to track the patient while they are present at a medical facility, and in particular the system 10 is operable to implement command-driven voice recognition charting of patients. Thus, the system 10 provides for real time charting of patients by voice command recognition.

In block 910, the program code formats the stored information to include that information in a report. This formatted information may be stored separately from the received and stored information.

Further details and embodiments of the present invention will be described by way of the following examples.

### EXAMPLE 1

### Command-Driven Voice Recognition

By way of example, the system 10 may be utilized in a medical facility and accessed through a computer 11 with a wireless communication interface 48. Users of the system may interact with the system 10 through the general input devices 32, identification reader 33, and wireless headsets that incorporate the microphone 36 and speaker 46. As such, users may be able to interact with the system 10 through templates and command-driven voice recognition to enable real-time information gathering. In some embodiments, each category of data that can be stored in the database 28 is configured with a voice command. The user may speak the specific voice command, or a combination of voice commands, to store data associated with that category. For instance, to access data in the Facility Tables 58 the user may speak “Facility” and then a specific category, such as “Equipment,” followed by a particular command, such as “Type,” to input data in the “Equipment_Type” entry of the Facility Equipment Table 114. Similarly, the user may speak “Groups,” “User,” “Patient,” “Procedure,” “Recall,” “Report,” “Audit,” or “System” to access the Groups Table 52, User Tables 54, Patient Tables 56, Procedure Tables 60, Recall Tables 62, Report Tables 64, Audit Tables 66, or System Tables 68, respectively. Alternately, some data may be configured to be accessed quickly by setting up one or more templates of commands to input data.

As an example, a nurse may wish to enter information about a patient. The nurse may move to the patient's location, which may be an emergency room, operating room, patient room, or office, and use a patient charting template to input data about the patient. The patient charting template may be configured to allow access to that patient's information and enter information about the patient to the system through specific voice commands. In this manner, the nurse may input an identification of the patient through a RFID chip or the patient's unique identification number and use voice commands to input patient vital signs, complaints, allergies, past medical history, status, and alcohol use, among other information. This allows the nurse to quickly gather information about the patient without preventing use of their hands. For example, the nurse may take a measurement with a piece of medical equipment, such as the blood pressure of the patient with a sphygmomanometer, and immediately input that data to the system through voice commands. As a specific example, the nurse may record the blood pressure by saying “Vital Signs,” then “Blood Pressure” and “126 over 70.” The system 10 timestamps the words as they are converted, and may timestamp that the nurse recorded the blood pressure of the patient at 3:22 p.m. on Friday, Apr. 11, 2009. The words “Blood Pressure” may indicate to the system 10 that the following information will be about the blood pressure of the patient, while the words “126 over 70” indicate the specific information. The system 10 converts the voiced utterances into machine readable input and reads back the commands. Thus, the system 10 plays back the commands “Blood Pressure” and “126 over 70” to the user. This allows the user the ability to verify the converted commands. The system 10 timestamps the commands, and stores the information in the database 28. In particular, and in this example, the system stores the information about the blood pressure of the patient in the Patient Tables 56, Procedure Tables 60, and/or Report Tables 64. Thus, the system 10 is operable to provide real-time charting on patients through voice command recognition.

In addition, once the nurse has identified the patient, particular templates may be loaded by the system 10 to enable the nurse to enter additional information. For example, to enter additional vital signs the nurse may say “Vital Signs” then specify the additional vital sign and the measurement. As further examples, the nurse may enter other complaints, allergies, medical histories, alcohol histories, smoking histories, or other patient information though command-driven voice recognition supplied by the system 10. In some embodiments, all information that may be stored by the system 10 may be entered through command-driven voice recognition.

In some embodiments, command-driven voice recognition is set up as a tree, with the data in each of the Groups Table 52, User Tables 54, Patient Tables 56, Facility Tables 58, Procedure Tables 60, Recall Tables 62, Report Tables 64, Audit Tables 66, and System Tables 68 accessible by navigating throughout their individual tables (shown throughout FIGS. 3-10). In alternate embodiments, command-driven voice recognition includes user configurable command-driven voice recognition templates, as described in connection with this Example. Thus, the system 10 provides for user configurable command-driven voice recognition that can be set up by system or facility administrators to allow users to input data through voice recognition.

### EXAMPLE 2

### Formatting Stored Data For Report

In addition to real-time charting, the system 10 may automatically format stored patient data for inclusion into reports. When a user documents information, that information may be formatted for a report to read as more than just a listing of data. As such, the report may include user-configurable templates that combine information into paragraphs that are insertable into the report. For example, and with reference to the documentation of blood pressure in Example 1, a report template may format that data for a report to read, “The patient's blood pressure was recorded as 126/70 mmHg at 3:22 p.m. on Friday, Apr. 11, 2009.” The formatting of the data may occur as the data is entered, after the data is entered but before inclusion into the report, or “on-the-fly” as the data is incorporated into the report.

### EXAMPLE 3

### Equipment Interfaces

The system 10 may be configured to interface with a variety of equipment and instruments. For example, interfaces are configured to interface with the vital signs equipment 22, microphone 36, camera system 38, electronic switching interface 40, and speaker 46. Additionally, the system 10 may be configured to interface with additional equipment, such as x-ray equipment, urology equipment, pulmonary equipment, gastroenterology equipment, radiographic equipment, and cardiology equipment, among others. As such, the system 10 is configured to accept additional interfaces as needed to interface with that additional equipment. In some embodiments, additional interfaces for the additional equipment may be configured to selectively activate command-driven voice recognition for the user in response to an action of the user in a similar manner as that disclosed when an image is captured from the camera system 38 in response to activation of the electronic switching interface 40. In some embodiments, the additional interfaces for the additional equipment are further configured to selectively deactivate command-driven voice recognition for the user. For example, upon taking an x-ray with an x-ray machine, an interface for the x-ray machine may selectively activate command-driven voice recognition. The user may then selectively deactivate the command-driven voice recognition through voice commands or other interaction with the system 10, computer 11, or the x-ray machine.

The additional interfaces may also each include a standard set of identifiers responsive to voice commands from the user. In a specific embodiment, the identifiers provide for identification of lesions in endoscopic, surgical, cardiologic, therapeutic, and other procedure oriented fields. Thus, the identifiers may be utilized to accept voice commands that indicate information about a lesion location, lesion type, lesion size, and action taken. The identifiers may also be utilized to accept voice commands that indicate information about anatomy as well as the lack of a significant pathologic process, among other information. Thus, the physician is provided with standard identifiers that may be used to implement real-time charting on patients through voice command recognition.

### EXAMPLE 4

### Patient Charting

Multiple users are needed in conventional medical facilities to document medication administration, vital signs, or to avoid drug reactions, cross-reactions, and interactions. These users may be everything from physicians, nurses, and other employees to additional personnel, such as anesthesiologists, endoscopic assistants, and surgical assistants. As such, vast amounts of users are often needed for documentation of medication administration, vital signs, drug administration, and medical procedures themselves. However, the system 10 provides for automatic interfaces that import vital signs into the database 12 as well as components that prevent drug reactions, cross-reactions, and interactions. Thus, the system 10 may be operated by fewer personnel, thus saving significant resources in a medical facility.

For example, during a medical procedure, a nurse or physician may input a drug to be administered as well as the dose and route. The input may be through voice commands or the general input devices 32. When the drug to be administered is specified through voice commands, the system 10 reads back the drug, dose, and route for the nurse or physician to verify that the system 10 received the correct information. In response to verifying the drug, dose, and route, the system 10 may check for cross-reactions, drug interactions, and whether the patient has an allergy to that drug. If there are no cross-reactions, drug interactions, and patient allergies, the system allows administration of the drug.

In addition, during the medical procedure the system 10 is configured to import patient vital signs into the database 28, thus “charting” the vital signs of the patient. Furthermore, the nurse or physician my input other information about the patient, such as the patient's level of consciousness, skin condition, and other parameters that may be important for anesthesiology or nursing documentation. Thus, users may import most information about the patient into the database 28 to chart the patient.

In one embodiment, the system 10 is configured to be completely voice activated. Thus, users interact with the system 10 through the computer 11, and in particular through a microphone 36 and/or a wireless headset that incorporates a microphone 36 and speaker 46. In this manner, the users may roam throughout a facility and interact with the computer 11 and system 10 through the wireless communication interface 48. The system may therefore be responsive to voice commands on every displayed screen and allow input of information stored in the database through voice commands. For example, the users may speak information about the patient and the system 10 may convert those spoken utterances into machine readable input. For example, one format well known in the art to implement voice recognition is speaking a command followed by the information to be stored. Thus, when the user identifies a patient to the system then says “Vital Signs” followed by “Blood Pressure” then “120 over 60,” the system 10 converts those voiced utterances into machine readable input and stores information in the Vital Signs Table 132 of the database 28 indicating that the blood pressure of that patient was 120/60 at the time it received the command. One having ordinary skill in the art will appreciate that predefined commands may include alternate categories, and that voice commands based on the title of tables in the database 28 is merely illustrative and not meant to be limit the scope of the invention. Thus, data may be stored based on alternate subsets, such as medications, vital signs, patient status, patient information, etc.

### EXAMPLE 5

### Associating Data with Captured Images

During a procedure, the user may desire to capture an image and associate that image with metadata. With reference to the procedure video screen 399 of FIG. 38B, live video of the procedure is streamed from the camera system 38 to the computer 11. During the procedure, the user may capture an image from the video stream displayed on the video signal 400 by selecting the Grab Image button or activating the electronic switching interface 40. To associate label information and/or metadata with the image, the user may use voice commands. As previously discussed, the system 10 may provide the user with a window to accept voice commands to the system 10 to be associated with that image, or the user may select appropriate information from the dropdown menus shown on FIG. 38B. As shown in FIG. 38B, this information may include the location of the captured image, the lesion shown in the captured image, the action taken before, during, or after the image, and the size of the lesion. Thus, the user may speak the following commands and information to associate label information and/or metadata with the captured image: “Location Cecum,” “Lesion Polyp,” “Action Cold Biopsy,” “Size Five Millimeters.”

When the images are associated with label information and/or metadata, the system 10 may transform that information into sentence structure and display that sentence on the report generation screen 409 shown throughout FIGS. 38E, 38F, and 38G. Thus, in a report associated with the procedure and/or image, the system 10 transforms the commands associated with that image (i.e., “Location Cecum,” “Lesion Polyp,” “Action Cold Biopsy,” “Size Five Millimeters”) into the sentence, “In the cecum, a 5 mm polyp was noted and cold biopsied.” This sentence may be included in the “Details of Procedure” report section shown on the report generation screen 409, and in particular in FIG. 38F. Thus, the user does not have to describe the image again in the report, as correct labeling of the image enables the system 10 to form sentences that can be inserted into reports automatically.

While the present invention has been illustrated by a description of various embodiments and examples, and while these embodiments and examples have been described in considerable detail, it is not the intention of the applicants to restrict, or in any way limit, the scope of the appended claims to such detail. For example, another embodiment consistent with the invention supports a database with a different structure that may have fewer or more tables than that described herein. Additionally, though default roles have been described, it will be apparent to one skilled in the art that the roles may be changed or otherwise altered in any way that a user may see fit. As such, and for example, the facility manager may be configured with access to all functions of the system. Similarly, the screens illustrated throughout the various figures, and the data captured thereupon, are merely illustrative and not limiting.

The invention in its broader aspects is therefore not limited to the specific details, representative apparatus, methods, and illustrative examples shown and described. In particular, the invention is not limited to endoscopic procedures, and may be adapted to perform any medical procedure or fulfill an alternate medical need. For example, the invention may be adapted to provide command driven voice recognition that can be used by pharmacists, urologists, cardiologists, nurses (floor nurses, emergency room nurses, operating room nurses, home health nurses, etc.), surgeons, and physicians, among others. As such, the invention may be adapted to operate, and provide command driven voice recognition for pharmacies, hospitals, urgent care centers, physician offices, or other medical facilities, among others. Accordingly, departures may be made from such details without departing from the scope of applicant's general inventive concept.

What is claimed is:

1. A system for managing information regarding a medical procedure performed on a patient at a medical facility, comprising:
a database server for storing a relational database with a plurality of tables storing information relating to patients and procedures, the information including text and at least one or more of audio, video and images;
an application server connectable to the database server for interacting with the database server and to process information in response to commands from a user of the system;
a web server connected to a network and connectable to the application server for interacting with the application server to relay commands or information from the user and to format information from the application server in a manner suitable to display on a web page accessed by the user; and
the user interacting with the system to create, compile and view medical reports from said information.

2. The system of claim 1, wherein the user is selected from a group consisting of a medical assistant, a receptionist, a billing user, a pre-operative nurse, a physician, an operative nurse, a recovery room nurse, a pathologist, a pathology technician, a transcriber, a system administrator and a facility administrator.

3. The system of claim 1, wherein the plurality of tables in the relational database further comprises:
a user table that includes user information;
a patient table that includes patient information;
a medical procedure table that includes information gathered before, during and after the medical procedure;
a report table that includes information about report sections as well as report section templates;
a facility table that includes information about the medical facility and equipment therein; and
a system table that includes information about current procedural terminology codes, international statistical classification of diseases and related health problems codes, and Food and Drug Administration drug information.

4. The system of claim 3, wherein the patient utilizes the system to interact with at least a subset of the information in the user and patient tables.

5. The system of claim 3, wherein the user is a medical assistant who utilizes the system to interact with at least a subset of the information in the user, patient, and medical procedure tables.

6. The system of claim 3, wherein the user is a receptionist who utilizes system to interact with at least a subset of the information in the user, patient, and medical procedure tables.

7. The system of claim 3, wherein the user is a pre-operative nurse who utilizes the system to interact with at least a subset of the information in the user, patient, and medical procedure tables.

8. The system of claim 3, wherein the user is a physician who utilizes the system to interact with at least a subset of the information in the user, patient, report, and medical procedure tables.

9. The system of claim 3, wherein the user is an operative nurse who utilizes the system to interact with at least a subset of the information in the user, patient, and medical procedure tables.

10. The system of claim 3, wherein the user is a recovery room nurse who utilizes the system to interact with at least a subset of the information in the user, patient, and medical procedure tables.

11. The system of claim 3, wherein the user is a pathologist who utilizes the system to interact with at least a subset of the information in the user and medical procedure tables.

12. The system of claim 3, wherein the user is a pathology technician who utilizes the system to interact with at least a subset of the information in the user and medical procedure tables.

13. The system of claim 3, wherein the user is a transcriber who utilizes the system to interact with at least a subset of the information in the user and medical procedure tables.

14. The system of claim 3, wherein the user is a system administrator who utilizes the system to interact with at least a subset of the information in the user, patient, medical procedure, report, audit, facility and system tables.

15. The system of claim 3, wherein the user is a facility administrator who utilizes the system to interact with at least a subset of the information in the user and facility tables.

16. The system of claim 3, wherein the user is a billing user who utilizes the system to interact with at least a subset of the information in the user, medical procedure and facility tables to create a bill for a patient in response to the completion of an medical procedure.

17. The system of claim 1, wherein the network is the Internet.

18. The system of claim 1, further comprising:
a computing system connected to the network for interacting with the user and with the web server, the computing system receiving commands or information from the user in the form of manual input.

19. The system of claim 18, the computing system further comprising:
a microphone to record the voiced utterances of the user, the computing system receiving commands or information from the user in the form of voiced utterances or manual input.

20. The system of claim 18, the computing system further comprising:
a vital signs monitor to record vital signs of a patient during the medical procedure.

21. The system of claim 18, the computing system further comprising:
an endoscopic camera to provide a video signal during the medical procedure; and
a microphone to record the voiced utterances of the user, the computing system receiving commands or information from the user in the form of voiced utterances or manual input.

22. The system of claim 21, the computing system further comprising:
an external interface to provide a command to store an image from video signal of the endoscopic camera during the medical procedure and record voiced utterances of the user for a predetermined period of time.

23. The system of claim 18, wherein the user utilizes the information in the user, patient, medical procedure, and report tables to generate a report associated with the medical procedure.

24. The system of claim 1, wherein the medical procedure is an endoscopic procedure.

25. A method for endoscopic procedure report generation, the method comprising:
initiating endoscopic procedure report generation by connecting across a network with a computer to a server, wherein the server provides access to at least one report template that automatically configures at least a portion of an endoscopic procedure report that includes information gathered in the course of an endoscopic procedure;
receiving from a user of the computer interaction with the computer to input data into the at least one report template;
in response to the user completing one or more report templates for the endoscopic procedure report, generating the endoscopic procedure report; and
in response to a changed standard in the course of the endoscopic procedure, updating the at least one report template to reflect the changed standard.

26. The method of claim 25, wherein the changed standard is a new documentation standard for endoscopic reports.

27. The method of claim 25, wherein the changed standard is a new treatment standard to be followed during the endoscopic procedure.

28. A computer-implemented method of providing a patient information about a medical treatment of the patient, the method comprising:
providing a patient portal available to the patient through a network for communicating information about the medical treatment of a patient, wherein the patient portal manages medical information of the patient in a central repository that can be accessed by the patient at any time and from any connected computer.

29. The method of claim 28, further comprising:
communicating results of the medical treatment of the patient to the patient through the patient portal.

30. The method of claim 28, further comprising:
communicating educational material about the medical treatment of the patient to the patient through the patient portal.

31. The method of claim 28, further comprising:
communicating medical updates to the patient through the patient portal.

32. The method of claim 28, further comprising:
gathering patient information through the patient portal.

33. The method of claim 32, wherein the patient information includes patient medical information from other physicians.

34. The method of claim 28 wherein the patient portal permits access to a first part of the medical information related to the patient in the repository but prevents access to a second part of the medical information related to the patient in the repository.

35. A system for collecting information regarding a medical procedure performed on a patient, comprising:
a database server for storing a relational database with a plurality of tables storing data relating to patients and procedures, the data including text and at least one or more of audio, video and images;
a computer for interacting with a user and with data stored or to be stored in the database server, the computer receiving commands from the user in the form of voiced utterances or manual input and responding to said commands by the manipulation of data for the database server, generation of text, or storage of an audio file.

36. The system of claim 35, wherein the commands instruct the database server to manipulate data to document medication administered to the patient.

37. The system of claim 35, wherein the commands instruct the database server to manipulate data to document pathological examinations.

38. A medical treatment management system for managing information regarding a medical procedure performed on a patient, comprising:
a database server for storing a relational database with a plurality of tables storing data relating to patients and medical procedures, the data including text and at least one or more of medical procedure report templates, audio, video and images;
an application server connectable to the database server for interacting with the database server and to process data in response to commands from a user of the system;
a web server connected to a network and connectable to the application server for interacting with the application server to relay commands or data from the user, the web server to further format information from the application server in a manner suitable to display on a web page accessed by the user; and
a computer connected to the network for interacting with the user and the web server, the computer further comprising:
an endoscopic camera to provide a video signal during the medical procedure;
a microphone to record the voiced utterances of the user; and
an external interface to provide a command to store an image from video signal of the endoscopic camera during the medical procedure and record voiced utterances of the user for a predetermined period of time.

39. The medical treatment management system of claim 38, wherein the medical treatment management system converts the recorded voiced utterances of the user into machine readable input, wherein the machine readable input includes commands or data from the user.

40. A medical treatment management system for managing information regarding a medical procedure performed on a patient at a medical facility, comprising:
a database server for storing a relational database with a plurality of tables storing data relating to patients and medical procedures, the data including text and at least one or more of medical procedure report templates, audio, video and images;
an application server connectable to the database server for interacting with the database server and to process data in response to commands from a user of the system;
a web server connected to a network and connectable to the application server for interacting with the application server to relay commands or data from the user, the web server to further format information from the application server in a manner suitable to display on a web page accessed by the user;
a computer connected to the network for interacting with the user and the web server, the computer further comprising:
an endoscopic camera to provide a video signal during the medical procedure;
a microphone to record the voiced utterances of the user; and
an external interface to provide a command to store an image from video signal of the endoscopic camera during the medical procedure and record voiced utterances of the user for a predetermined period of time, and
a medical facility server connected to the network for interacting with the web server to receive a copy of the data in the relational database.
